(19) United States
(12) Patent Application Publication
(10) Pub. No.: US 2026/0090869 A1
(43) Pub. Date: Apr. 2, 2026

(54) SYSTEMS AND DEVICES FOR THE DELIVERY OF TAILORABLE MEDICAMENT TO THE GINGIVAL CREVICE AND METHODS THEREOF

(71) Applicant: 31 Biotech, LLC, Lubbock, TX (US)

(72) Inventors: David Syn, Lubbock, TX (US); Rohan Ingrole, Lubbock, TX (US); Seth Boese, Lubbock, TX (US); Harvinder Singh Gill, Lubbock, TX (US); Ghanesh Kesav Venkatesa Prabhu, Raleigh, NC (US)

(73) Assignee: 3i Biotech LLC, Lubbock, TX (US)

(21) Appl. No.: 19/319,188

(22) Filed: Sep. 4, 2025

Related U.S. Application Data
(63) Continuation of application No. 19/210,906, filed on May 16, 2025.
(60) Provisional application No. 63/648,285, filed on May 16, 2024.
(60) Provisional application No. 63/653,876, filed on May 30, 2024.
(60) Provisional application No. 63/653,894, filed on May 30, 2024.

(51) Int. Cl. A61C 19/06

(52) U.S. Cl. CPC A61C 19/063

(57) ABSTRACT

A Junctional Epithelial Targeting (JET) device and a system for delivery of medicaments to the gingival crevice of a patient, and/or methods of manufacturing and/or using the JET device and system. The JET device comprises a carrier configured to carry and release medicaments within the gingival crevice over a controllable period of time, ensuring efficient absorption into the patient's system. The carrier is configured to dissolve in response to the moist environment of the gingival crevice, with the dissolution rate being adjustable based on the carrier's composition. A detachable handle facilitates the precise placement and subsequent detachment of the carrier within the gingival crevice. Additionally, a stop tab is incorporated to prevent over-insertion of the carrier. The JET device offers a non-invasive, rapid, and user-friendly approach to medicament delivery, potentially improving adherence to supplementation regimens, particularly for post-bariatric surgery patients and others at risk of micronutrient deficiencies.

### CROSS-REFERENCE TO RELATED APPLICATIONS

The present application is a continuation of U.S. patent application Ser. No. 19/210,906, filed on May 16, 2025, entitled “SYSTEMS AND DEVICES FOR THE DELIVERY OF TAILORABLE MEDICAMENT TO THE GINGIVAL CREVICE AND METHODS THEREOF,” which claims priority to U.S. Provisional Patent Application Ser. No. 63/648,285, filed on May 16, 2024, entitled “JUNCTIONAL EPITHELIUM TARGETER,” U.S. Provisional Patent Application Ser. No. 63/653,894, filed on May 30, 2024, entitled “DEVICES, SYSTEMS, AND METHODS FOR JUNCTIONAL EPITHELIAL TARGETING (JET) BY AGITATION,” and U.S. Provisional Patent Application Ser. No. 63/653,876, filed on May 30, 2024, entitled “DEVICES, SYSTEMS, AND METHODS FOR GUM POCKET DEPOSITION OF TAILORABLE MEDICAMENTS,” the contents of which are incorporated herein in their entireties for all purposes.

### STATEMENT REGARDING FEDERALLY SPONSORED RESEARCH OR DEVELOPMENT

This invention was made with Government support under grants No. R01AI135197 and R01AI137846, awarded by the National Institutes of Health. The Government has certain rights in the invention.

### TECHNICAL FIELD

The present disclosure relates generally to delivery of medicaments to a subject, and more particularly to devices and methods of making devices for targeting the junctional epithelium (JE) in the gingival crevice for delivery of medicaments.

### BACKGROUND

Without limiting the scope of the invention, its background is described in connection with delivery of active agents.

The field of medicament delivery has seen a variety of methods and devices developed over the years. These methods and devices are designed to deliver a range of medicaments, including but not limited to nutrients, micronutrients, antibiotics, antigens, anti-inflammatory agents, antimicrobial agents, antibodies, steroids, DNA, vaccines, and minerals. The delivery of these medicaments is often targeted to specific areas of the body to maximize their efficacy and minimize potential side effects.

One such area of the body that has been a focus of targeted medicament delivery is the gingival crevice, which includes the junctional epithelium (JE). For example, tooth eruption through the gingiva creates a break in an otherwise continuous and uninterrupted human mucosal surface. To seal this discontinuity, the gingival tissue attaches to each tooth through the JE. The JE is attached to the tooth and forms a seal between the oral cavity and the underlying tissues. The JE seal is leaky and has high permeability because it is only a few cell layers thick and has wide intercellular spaces amongst these cells. The gingival tissue beyond this zone of attachment forms the gingival crevice. The high permeability of the JE, a characteristic not seen elsewhere within the mucosal system, offers easy passage to commensal bacteria, potential pathogens, and food allergens. The gingival niche has an extensive network of immune cells, including both innate and adaptive immune cells such as neutrophils, natural killer cells, macrophages, dendritic cells, CD4+/CD8+ T cells, B cells, and innate lymphoid cells. This network helps to defend and create immune responses against the constant stimulation by microbes, allergens, and food proteins.

Mucosal surfaces are the first point of contact with the environment (e.g., internal and/or external environment) and thus naturally serve as portals of entry for a vast majority of pathogens and allergens. For example, the coronavirus is transmitted primarily through respiratory mucosa, HIV is transmitted primarily through reproductive and gastrointestinal mucosa, pollens which cause respiratory allergies initiate contact at the respiratory mucosa, and peanut a food allergen initiates first contact in the oral cavity mucosa. It is recognized and widely reported in literature that a strong mucosal and systemic immune response is more effective at combating infections as compared to just a systemic immune response. However, vaccine delivery via injections does not stimulate a strong mucosal immunity, it only stimulates a strong systemic immunity. To generate strong mucosal immunity and strong systemic immunity vaccines must be delivered through mucosal surfaces. However, mucosal surfaces are designed to keep material out, thus merely placing vaccines on top of the mucosal surface does not lead to their efficient uptake.

One such prior art patent is U.S. Pat. No. 9,271,899, issued to Francois, and entitled “Methods, articles and kits for allergic desensitization, via the oral mucosa,” which is said to teach Compositions and methods of use for desensitizing a subject to an allergen via regions of the oral mucosa are provided, specifically, targeting vestibular mucosa to cause oral immune tolerance.

In addition, the conventional method of delivering medicaments to a patient has included the intake of pills, patches, injections, nasal sprays, and sublingual applications. However, these methods have their limitations, including cost, pain associated with injections, and limitations in the types of medicaments that can be delivered.

### BRIEF SUMMARY

The present disclosure achieves technical advantages as systems, devices, and methods for controlled delivery of medicaments to the gingival crevice. In particular embodiments, a junctional epithelial targeting (JET) device may be configured to deposit or place a carrier into the gingival crevice of a patient, where the carrier is configured to release a medicament in a controlled manner over a predetermined period of time. In embodiments, the carrier may be constructed to begin dissolving upon contact with the moist environment within the gingival crevice, beginning the release of the medicament for direct absorption into the patient's system. The rate of dissolution (and consequently, the rate of medicament release) may be configured to the specific therapeutic requirements by adjusting the composition and properties of the carrier material.

In embodiments, the JET device may include a handle that is configured to facilitate the placement of the carrier within the gingival crevice. The handle may be detachably connected to the carrier, enabling detachment and leaving the carrier in place within the gingival crevice once the correct placement is achieved. In some embodiments, a stop tab may operate to ensure that the carrier is not inserted beyond the desired depth within the gingival crevice, preventing over-insertion and potential discomfort or injury to the patient.

The present disclosure also or alternatively achieves technical advantages as systems, devices, and methods for a JET device configured for delivery of medicaments by agitation. In embodiments, a JET device may be configured to include an arm attached to a handle. The arm may be configured to carry medicament on at least a portion of the surface of the arm. The arm may be configured to be inserted into the gingival crevice of a patient, and to release the medicament into the gingival crevice in response to an agitation action applied to the handle of the JET device by the patient. The agitation action, which may include a back-and-forth motion, may cause the medicament coated surface of the arm to brush, graze, or otherwise rub against the gingival crevice causing the medicament to be scraped off the surface of the arm and to be deposited into the gingival crevice to be absorbed into the patient's system.

The JET device of embodiments may be beneficial for delivering medicaments or active agents to patients via the gingival crevice. In embodiments, the patients may include patients with micronutrient deficiencies, such as those who have undergone bariatric surgery and require lifelong supplementation. The JET device's configuration may allow for the delivery of a wide range of medicaments, including but not limited to vaccines, vitamins, minerals, antibiotics, anti-inflammatory agents, etc. By providing a method of delivery that bypasses the gastrointestinal tract, the JET device of embodiments ensures higher bioavailability of the medicaments, which can lead to improved patient outcomes and adherence to supplementation regimens. The non-invasive nature of the JET device of embodiments, combined with its ease of use and rapid medicament release, renders it an advantageous solution for addressing the challenges associated with traditional supplementation methods.

The JET device of embodiments represents a practical solution to micronutrient supplementation that results in improved patient compliance and thus reduces the risks and harms of micronutrient deficiency. The JET device of embodiments can be loaded with the recommended dosage of medicaments, and placed into the gingival crevice of a patient where the medicaments can be directly absorbed into the patient's system through the junctional epithelium. The delivered medicaments avoid the gastrointestinal tract and liver and become 100% bioavailable. The JET device of embodiments may enable a patient to receive medicament dosages one time daily, in less than a few seconds to complete the insertion, and even after evening oral hygiene routines. The reduction in application frequency, the non-invasive application, rapid bioavailability, and ease of use of the JET device of embodiments offer the easiest access to medicament supplementation and helps improve adherence to prescribed regimens.

It is an object of the disclosure to provide a JET system that includes functionality for controlled delivery of medicaments to the gingival crevice. It is a further object of the disclosure to provide a method of manufacturing a JET device configured for controlled delivery of medicaments to the gingival crevice. It is still a further object of the disclosure to provide a JET device that includes functionality for controlled delivery of medicaments to the gingival crevice.

In one particular embodiment, a JET system is provided. The JET system includes a carrier configured to carry a medicament to be delivered to a patient. In embodiments, the carrier is configured to deliver the medicament over a controllable period of time upon placement of the carrier within a gingival crevice of the patient to be absorbed into the patient's system. The JET system also includes a handle configured to detachably secure the carrier during delivery of the medicament to the gingival crevice of the patient. In embodiments, the handle detachably secures the carrier such that the carrier is configured to detach from the handle and remain within the gingival crevice after detachment over the controllable period of time until the medicament is delivered into the gingival crevice of the patient to be absorbed into the patient's system.

In another embodiment, a method of manufacturing a JET device is provided. The method includes depositing a molten polymer mixture onto a carrier mask. In embodiments, the carrier mask includes a predetermined shape of a carrier. The method also includes allowing the molten polymer mixture to solidify into a carrier. In embodiments, the carrier is configured to carry a medicament to be delivered to a patient, and to deliver the medicament over a controllable period of time upon placement of the carrier within a gingival crevice of the patient to be absorbed into the patient's system. The method also includes detachably attaching the carrier to a handle configured to detachably secure the carrier during delivery of the medicament to the gingival crevice of the patient. In embodiments, the handle detachably secures the carrier such that the carrier is configured to detach from the handle and remain within the gingival crevice after detachment over the controllable period of time until the medicament is delivered into the gingival crevice of the patient to be absorbed into the patient's system.

In yet another embodiment, a JET device is provided. The JET device includes a carrier configured to carry a medicament to be delivered to a patient. In embodiments, the carrier is configured to deliver the medicament over a controllable period of time upon placement of the carrier within a gingival crevice of the patient to be absorbed into the patient's system. The JET device also includes a stop tab configured to prevent the carrier from being inserted beyond the gingival crevice.

It is also an object of the disclosure to provide a JET device that includes functionality for delivery of medicaments to the gingival crevice by agitation. It is a further object of the disclosure to provide a method of manufacturing a JET device configured for delivery of medicaments to the gingival crevice by agitation.

In one particular embodiment, a JET device is provided. The JET device includes an arm including an insertable portion having at least a portion of a surface coated with a medicament to be delivered to a patient. In embodiments, the medicament may be configured to be absorbed into the patient's system. In embodiments, the arm is configured to facilitate insertion of the insertable portion of the arm into a gingival crevice of the patient, and to deposit, upon insertion of the insertable portion into the gingival crevice of the patient, the medicament into the gingival crevice in response to an agitation action applied upon the arm. In embodiments, the agitation action may be configured to move the insertable portion back-and-forth within the gingival crevice to cause the medicament to be released from the at least a portion of the surface of the insertable portion to be absorbed into the patient's system. The JET device also includes a handle configured to attach to the arm to facilitate insertion of the insertable portion of the arm into the gingival crevice of the patient and to facilitate applying the agitation action upon the arm.

In another embodiment, a method of manufacturing a JET device is provided. The method includes forming an arm of the JET device for insertion of an insertable portion of the arm into a gingival crevice of a patient, coating at least a portion of a surface of the insertable portion of the arm with a medicament to be delivered to the patient, the medicament configured to be absorbed into the patient's system, and attaching the arm to a handle, the handle configured to facilitate manipulation of the JET device to insert the insertable portion of the arm into the gingival crevice of the patient and to deposit the medicament into the gingival crevice of the patient in response to an agitation action upon the handle, the agitation action configured to move the insertable portion back-and-forth within the gingival crevice to cause the medicament to be released from the at least a portion of the surface of the insertable portion to be absorbed into the patient's system.

The present disclosure also or alternatively achieves technical advantages as systems, devices, and methods for a JET device configured for delivery of one or more active agents to a subject. In embodiments, the JET device includes: an arm connected to a substrate, grip or handle that extends at an angle from the substrate, grip, or handle, wherein the arm comprises one or more active agents and is sized to have a length and a cross section capable of being inserted into a gingival crevice, wherein at least a portion of the arm is at least one of: disintegrable, pocketed, swellable, patterned, reservoir, or combinations thereof. In one aspect, the portion of the arm is at least one of: disintegrable, pocketed, swellable, patterned, reservoir, or combinations thereof, is triggered to release the one or more active agents by one or more environmental stimuli selected from moisture, pH, enzymes, temperature, ion composition, ion concentration in a gingival crevice. In another aspect, release of the one or more active agents from the disintegrable, pocketed, swellable, patterned, reservoir, or combinations thereof is a controlled or a prolonged disintegration over minutes to hours to days. In one aspect, at least part of the portion that is disintegrable, pocketed, swellable, patterned, reservoir, or combinations thereof is selected to have sufficient mechanical strength to allow it to be handled and inserted into a gingival crevice. In one aspect, at least part of the portion that is disintegrable, pocketed, swellable, patterned, reservoir, or combinations thereof is reinforced to enhance its mechanical properties by adding inactive ingredients such as starches, sugar alcohols, cellulose derivatives, polyvinyl alcohol, binders, or excipients. In one aspect, at least part of portion that is disintegrable, pocketed, swellable, patterned, reservoir, or combinations thereof is reinforced to enhance its mechanical properties by compression or compaction during fabrication. In one aspect, at least part of portion that is disintegrable, pocketed, swellable, patterned, reservoir, or combinations thereof is reinforced to enhance its mechanical properties with a net, a mesh, or strips, that are a biocompatible and/or biodegradable material or generally regarded as safe (GRAS), or other safe to consume material. In one aspect, at least part of a shape of the portion that is disintegrable, pocketed, swellable, patterned, reservoir, or combinations thereof is selected from at least one of a wedge shape, a cone or a frustum. In one aspect, at least part of the portion that is disintegrable, pocketed, swellable, patterned, reservoir, or combinations thereof further comprises a mucoadhesive, the one or more active agents further comprises a mucoadhesive, or both. In one aspect, the one or more active agents is at least one of: entrapped, encapsulated, or mixed in one or more inactive excipients. In one aspect, at least part of the portion that is disintegrable, pocketed, swellable, patterned, reservoir, or combinations thereof is formed in a mold selected from: solvent casting, hot-melt-extrusion, a Meyer bar coating, a slot die coating, 3D printing, spray, or gravure printing. In one aspect, at least part of the portion that is disintegrable, pocketed, swellable, patterned, reservoir, or combinations thereof comprising the one or more active agents is a film or coated with a film. In one aspect, the portion that is disintegrable, pocketed, swellable, patterned, reservoir, or combinations thereof comprising the one or more active agents is a film selected from mucoadhesive film, pressure sensitive film, lined with a mucoadhesive material, a pressure sensitive material, a temperature sensitive material, or combinations thereof. In one aspect, the portion that is disintegrable, pocketed, swellable, patterned, reservoir, or combinations thereof can be attached to the grip or handle with joint selected from butt joint, lap joint, mortise and tenon joint, dado joint, tongue and groove joint, half-lap joint. In one aspect, the portion that is disintegrable, pocketed, swellable, patterned, reservoir, or combinations thereof can be attached to the substrate or grip or handle with at least one of: a glue, hot melt, or solvent melting after the said substrate or grip or handle has been fabricated; or by inserting it into said substrate or grip or handle while they are being fabricated. In one aspect, the portion that is disintegrable, pocketed, swellable, patterned, reservoir, or combinations thereof further comprises one or more flavors, taste masking agents, color, or combinations thereof. In one aspect, the one or more active agents are formed in, into, or about, one or more portions that are disintegrable, pocketed, swellable, patterned, reservoir, or combinations thereof is formed with a liquid or gel coating, pockets hollowed out in a substrate, film, or strip. In one aspect, the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof. In one aspect, the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to a substrate, film, or strip, in a thermoplastic polymer deposited or adhered to a substrate, film, or strip, in a polysaccharide formulation deposited or adhered to a substrate, film, or strip, in pockets alternating between liquids, gels, solids deposited or adhered to a substrate, film, or strip, in a biodegradable material deposited or adhered to a substrate, film, or strip, in a swellable material deposited or adhered to a substrate, film, or strip, in a mucoadhesive deposited or adhered to a substrate, film, or strip. In one aspect, the one or more active agents are formed or carved in, into, or about, one or more portions that are disintegrable, pocketed, swellable, patterned, reservoir, or combinations thereof that have a depth of 10%, 20%, 30%, 40%, 50%, 60%, 70%, 80%, 90% or 100% of a thickness of a substrate, film, or strip. In one aspect, the one or more active agents are formed or carved in, into, or about, one or more portions that are disintegrable, pocketed, swellable, patterned, reservoir, or combinations thereof that form a flat surface, wedged shape, cylindrical shape, tapered cylindrical shape, bullet shape, parabolic shape or combinations thereof. In one aspect, the one or more active agents are formed or carved in, into, or about, one or more portions that are disintegrable, pocketed, swellable, patterned, reservoir, or combinations thereof that further comprise one or more sensors. In one aspect, the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof. In one aspect, the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to the substrate, film, or strip, in a thermoplastic polymer deposited or adhered to the substrate, film, or strip, in a polysaccharide formulation deposited or adhered to the substrate, film, or strip, in pockets alternating between liquids, gels, solids deposited or adhered to the substrate, film, or strip, in a biodegradable material deposited or adhered to the substrate, film, or strip, in a swellable material deposited or adhered to the substrate, film, or strip, in a mucoadhesive deposited or adhered to the substrate, film, or strip, or the reservoirs are porous in the substrate, film, or strip. In one aspect, the one or more active agents are formed in, into, or about, one or more portions that are disintegrable, pocketed, swellable, patterned, reservoir, or combinations thereof that are connected by one or more channels, hollow tubes, slits, or capillaries formed or carved in, on, or into, a substrate, film, or strip, wherein the channels can be straight lines, curved lines, irregular and can connect reservoirs having one or more shapes selected from circles, rectangles, squares, or regular shapes, irregular shapes, or combinations thereof. In one aspect, the one or more active agents are formed in, one, or about an applicator that comprises a mucoadhesive and a film comprising the one or more active agents on the arm, and a cap or coating surrounding the mucoadhesive and the film, wherein the mucoadhesive and the film is shaped to contact the gingival crevice at a junction with a tooth, is flexible to contour on or about the gingival crevice at a tooth junction, or wherein the mucoadhesive, the film, or both are pressure-sensitive. In one aspect, the one or more active agents are formed in, one, or about an applicator that comprises a spring, electrical actuator, magnetic actuator, mechanical actuator, or combinations thereof attached to move the arm to position the arm into a gingival crevice or to attach the active agent to a surface in, on, or about the gingival crevice. In one aspect, the one or more active agents are formed in, one, or about portions that are disintegrable, pocketed, swellable, patterned, reservoir, or combinations thereof is a material comprising a swellable polymer, hydrogel, of combinations thereof. In one aspect, the one or more active agents are formed in, one, or about portions that are disintegrable, pocketed, swellable, patterned, reservoir, or combinations thereof is a material selected from methacrylated hyaluronic acid, or gelatin-methacryloyl, or co-polymer of poly(methylvinylether co. maleic acid) crosslinked with poly(ethylene glycol), or co-polymer of poly(methylvinylether co. maleic anhydride) crosslinked with poly(ethylene glycol), or polyvinyl alcohol, or poly(2-hydroxyethyl methacrylate), or poly(styrene)-block-poly(acrylic acid), of combinations thereof. In one aspect, the one or more active agents are formed in, one, or about portions that are disintegrable, pocketed, swellable, patterned, reservoir, or combinations thereof is a material that is biodegradable, made from a compound or formulation generally regarded as safe, or both, or the material comprises one or more layers that release as the swellable material expands upon contact with one or more environmental stimuli selected from moisture, pH, enzymes, temperature, ion composition, ion concentration, or combinations thereof. In one aspect, the one or more active agents is selected for local or systemic delivery. In one aspect, the one or more active agents are selected from immunogens, vaccines, allergens, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, nucleic acids, antibiotics, antifungal agents, anti-inflammatory agents, and combinations thereof. In one aspect, the one or more active agents activate, or anergize, an immune response by targeting a junctional epithelium in the gingival crevice. In one aspect, the JET device may include one or more pharmaceutically acceptable excipients, diluents, buffers, salts, viscosity enhancers, plasticizers, thickening agents, surface tension reducing agents, polymers, or combinations thereof. In one aspect, the viscosity enhancers are selected from Hydroxypropyl cellulose (HPC) Hydroxyethyl cellulose (HEC), Sodium carboxymethyl cellulose (NaCMC), Methyl cellulose (MC), Ethyl cellulose (EC), Carbomer, Xanthan gum, Guar gum, Carrageenan, Sodium alginate, Acacia gum, Pectin, Polyvinyl alcohol (PVA), Polyethylene glycol (PEG), Polyvinylpyrrolidone (PVP), Polyacrylic acid (PAA), Poloxamer, Pluronic, Sodium hyaluronate, Gelatin, Bentonite, Magnesium aluminum silicate, Veegum, Tragacanth gum, Sodium starch glycolate, Microcrystalline cellulose, Sorbitol, Mannitol, Glycerin, Propylene glycol, Caprylyl glycol, Butylene glycol, Pentylene glycol, Dimethicone, Cyclomethicone, Jojoba oil, Sorbitan esters, Cetearyl alcohol, Stearyl alcohol, Behenyl alcohol, Cetyl alcohol, Oleic acid, Stearic acid, Isopropyl myristate, Polysorbate 20, Eudragit(s), or combinations thereof. In one aspect, the plasticizers are selected from Glycerin (glycerol), Propylene glycol, Polyethylene glycols (PEGs), Sorbitol, Mannitol, Polyvinyl alcohol (PVA), Polyvinylpyrrolidone (PVP), Ethylene glycol, Diethylene glycol, Triethylene glycol, Butylene glycol, Trimethylolpropane, Ethanolamine, Isopropyl alcohol, Tetrahydrofurfuryl alcohol, Dimethyl sulfoxide (DMSO), Polyethylene oxide (PEO), Poloxamers (Pluronics), Cyclodextrins, Saccharides, Eudragit(s), or combinations thereof. In one aspect, the method further comprises adding one or more additional agents that increase permeability of the one or more active agents into the gingival crevice. In one aspect, between 0.001, 0.01, 0.1, 1, 2, 3, 4, 5, 6, 7, 8, 9, 10, 15, 20, 25, 30, 40, 50, 60, 70, 75, 80, 90, 95, 96, 97, 98, 99 to 100% of the one or more active agents is in a depot at a junctional epithelium of the gingival crevice. In one aspect, the one or more active agents are provided repeatedly to a junctional epithelium of the gingival crevice. In one aspect, delivery of the one or more one or more active agents to a junctional epithelium is before or after consumption of a food or drink. In one aspect, the one or more active agents is applied once or more than once with a frequency on a daily or weekly or monthly basis, such as 1, 2, 3, 4, 5, or 6 times daily or 1, 2, 3, 4, 5, 6, or 7 times weekly or 1, 2, 3, or 4 times monthly. In one aspect, two or more active agents are delivered to a junctional epithelium of the gingival crevice. In one aspect, delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks water, or both. In one aspect, delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks water, or both. In one aspect, an amount of the one or more active agents is delivered to a junctional epithelium range from picograms to milligrams. In one aspect, at least a portion of the arm has a thickness less than 5 mm, preferably less than 3 mm, and preferably less than 1 mm. In one aspect, at least a portion of the arm comprises natural or synthetic polymers, organic materials, metals, inorganic materials or combinations thereof. In one aspect, at least a portion of the arm comprises a mucoadhesive layer or a hydrophobic layer or a hydrophilic layer or a combination. In one aspect, at least a portion of the arm comprises a microporous structure allowing diffusion of antigen to gingival crevice. In one aspect, construction of the grip and arm is unitary. In one aspect, a viscosity of the one or more active agents deposited is 0.01 centipoise (cp), 1 cp, 10 cp, 100 cp, 1000 cp, 10000 cp, 100000 cp, 200000 cp, 300000 cp, 500000 cp, 1000000, or 100000000 cp. In one aspect, the one or more active agents are formed in, into, or about, one or more micro-nano-sized carriers or nanoparticles. In one aspect, the one or more active agents are formed in, into, or about, one or more liposomes, polymeric particles, inorganic particles, or lipid particles, or hybrid particles in which the one or more active agents are attached or encapsulated.

As embodied and broadly described herein, an aspect of the present disclosure relates to a method of delivering one or more active agents to a gingival crevice of a subject comprising: providing an effective amount of the one or more active agents into a gingival crevice using a JET device for delivery of one or more active agents to a subject comprising: an arm connected to a substrate, grip or handle that extends at an angle from the substrate, grip, or handle, wherein the arm comprises one or more active agents and is sized to have a length and a cross section capable of being inserted into a gingival crevice, wherein at least a portion of the arm is at least one of: disintegrable, pocketed, swellable, patterned, reservoir, or combinations thereof. In one aspect, the portion of the arm is at least one of: disintegrable, pocketed, swellable, patterned, reservoir, or combinations thereof, is triggered to release the one or more active agents by one or more environmental stimuli selected from moisture, pH, enzymes, temperature, ion composition, ion concentration in a gingival crevice. In another aspect, release of the one or more active agents from the disintegrable, pocketed, swellable, patterned, reservoir, or combinations thereof is a controlled or a prolonged disintegration over minutes to hours to days. In one aspect, at least part of the portion that is disintegrable, pocketed, swellable, patterned, reservoir, or combinations thereof is selected to have sufficient mechanical strength to allow it to be handled and inserted into a gingival crevice. In one aspect, at least part of the portion that is disintegrable, pocketed, swellable, patterned, reservoir, or combinations thereof is reinforced to enhance its mechanical properties by adding inactive ingredients such as starches, sugar alcohols, cellulose derivatives, polyvinyl alcohol, binders, or excipients. In one aspect, at least part of portion that is disintegrable, pocketed, swellable, patterned, reservoir, or combinations thereof is reinforced to enhance its mechanical properties by compression or compaction during fabrication. In one aspect, at least part of portion that is disintegrable, pocketed, swellable, patterned, reservoir, or combinations thereof is reinforced to enhance its mechanical properties with a net, a mesh, or strips, that are a biocompatible material and/or biodegradable or generally regarded as safe (GRAS), or other safe to consume material. In one aspect, at least part of a shape of the portion that is disintegrable, pocketed, swellable, patterned, reservoir, or combinations thereof is selected from at least one of a wedge shape, a cone or a frustum. In one aspect, at least part of the portion that is disintegrable, pocketed, swellable, patterned, reservoir, or combinations thereof further comprises a mucoadhesive, the one or more active agents further comprises a mucoadhesive, or both. In one aspect, the one or more active agents is at least one of: entrapped, encapsulated, or mixed in one or more inactive excipients. In one aspect, at least part of the portion that is disintegrable, pocketed, swellable, patterned, reservoir, or combinations thereof is formed in a mold selected from: solvent casting, hot-melt-extrusion, a Meyer bar coating, a slot die coating, 3D printing, spray, or gravure printing. In one aspect, at least part of the portion that is disintegrable, pocketed, swellable, patterned, reservoir, or combinations thereof comprising the one or more active agents is a film or coated with a film. In one aspect, the portion that is disintegrable, pocketed, swellable, patterned, reservoir, or combinations thereof comprising the one or more active agents is a film selected from mucoadhesive film, pressure sensitive film, lined with a mucoadhesive material, a pressure sensitive material, a temperature sensitive material, or combinations thereof. In one aspect, the portion that is disintegrable, pocketed, swellable, patterned, reservoir, or combinations thereof can be attached to the grip or handle with joint selected from butt joint, lap joint, mortise and tenon joint, dado joint, tongue and groove joint, half-lap joint. In one aspect, the portion that is disintegrable, pocketed, swellable, patterned, reservoir, or combinations thereof can be attached to the substrate or grip or handle with at least one of: a glue, hot melt, or solvent melting after the said substrate or grip or handle has been fabricated; or by inserting it into said substrate or grip or handle while they are being fabricated. In one aspect, the portion that is disintegrable, pocketed, swellable, patterned, reservoir, or combinations thereof further comprises one or more flavors, taste masking agents, color, or combinations thereof. In one aspect, the one or more active agents are formed in, into, or about, one or more portions that are disintegrable, pocketed, swellable, patterned, reservoir, or combinations thereof is formed with a liquid or gel coating, pockets hollowed out in a substrate, film, or strip. In one aspect, the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof. In one aspect, the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to a substrate, film, or strip, in a thermoplastic polymer deposited or adhered to a substrate, film, or strip, in a polysaccharide formulation deposited or adhered to a substrate, film, or strip, in pockets alternating between liquids, gels, solids deposited or adhered to a substrate, film, or strip, in a biodegradable material deposited or adhered to a substrate, film, or strip, in a swellable material deposited or adhered to a substrate, film, or strip, in a mucoadhesive deposited or adhered to a substrate, film, or strip. In one aspect, the one or more active agents are formed or carved in, into, or about, one or more portions that are disintegrable, pocketed, swellable, patterned, reservoir, or combinations thereof that have a depth of 10%, 20%, 30%, 40%, 50%, 60%, 70%, 80%, 90% or 100% of a thickness of a substrate, film, or strip. In one aspect, the one or more active agents are formed or carved in, into, or about, one or more portions that are disintegrable, pocketed, swellable, patterned, reservoir, or combinations thereof that form a flat surface, wedged shape, cylindrical shape, tapered cylindrical shape, bullet shape, parabolic shape or combinations thereof. In one aspect, the one or more active agents are formed or carved in, into, or about, one or more portions that are disintegrable, pocketed, swellable, patterned, reservoir, or combinations thereof that further comprise one or more sensors. In one aspect, the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof. In one aspect, the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to the substrate, film, or strip, in a thermoplastic polymer deposited or adhered to the substrate, film, or strip, in a polysaccharide formulation deposited or adhered to the substrate, film, or strip, in pockets alternating between liquids, gels, solids deposited or adhered to the substrate, film, or strip, in a biodegradable material deposited or adhered to the substrate, film, or strip, in a swellable material deposited or adhered to the substrate, film, or strip, in a mucoadhesive deposited or adhered to the substrate, film, or strip, or the reservoirs are porous in the substrate, film, or strip. In one aspect, the one or more active agents are formed in, into, or about, one or more portions that are disintegrable, pocketed, swellable, patterned, reservoir, or combinations thereof that are connected by one or more channels, hollow tubes, slits, or capillaries formed or carved in, on, or into, a substrate, film, or strip, wherein the channels can be straight lines, curved lines, irregular and can connect reservoirs having one or more shapes selected from circles, rectangles, squares, or regular shapes, irregular shapes, or combinations thereof. In one aspect, the one or more active agents are formed in, one, or about an applicator that comprises a mucoadhesive and a film comprising the one or more active agents on the arm, and a cap or coating surrounding the mucoadhesive and the film, wherein the mucoadhesive and the film is shaped to contact the gingival crevice at a junction with a tooth, is flexible to contour on or about the gingival crevice at a tooth junction, or wherein the mucoadhesive, the film, or both are pressure-sensitive. In one aspect, the one or more active agents are formed in, one, or about an applicator that comprises a spring, electrical actuator, magnetic actuator, mechanical actuator, or combinations thereof attached to move the arm to position the arm into a gingival crevice or to attach the active agent to a surface in, on, or about the gingival crevice. In one aspect, the one or more active agents are formed in, one, or about portions that are disintegrable, pocketed, swellable, patterned, reservoir, or combinations thereof is a material comprising a swellable polymer, hydrogel, of combinations thereof. In one aspect, the one or more active agents are formed in, one, or about portions that are disintegrable, pocketed, swellable, patterned, reservoir, or combinations thereof is a material selected from methacrylated hyaluronic acid, or gelatin-methacryloyl, or co-polymer of poly(methylvinylether co. maleic acid) crosslinked with poly(ethylene glycol), or co-polymer of poly(methylvinylether co. maleic anhydride) crosslinked with poly(ethylene glycol), or polyvinyl alcohol, or poly(2-hydroxyethyl methacrylate), or poly(styrene)-block-poly(acrylic acid), of combinations thereof. In one aspect, the one or more active agents are formed in, one, or about portions that are disintegrable, pocketed, swellable, patterned, reservoir, or combinations thereof is a material that is biodegradable, made from a compound or formulation generally regarded as safe, or both, or the material comprises one or more layers that release as the swellable material expands upon contact with one or more environmental stimuli selected from moisture, pH, enzymes, temperature, ion composition, ion concentration, or combinations thereof. In one aspect, the one or more active agents is selected for local or systemic delivery. In one aspect, the one or more active agents are selected from immunogens, vaccines, allergens, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, nucleic acids, antibiotics, antifungal agents, anti-inflammatory agents, and combinations thereof. In one aspect, the one or more active agents activate, or anergize, an immune response by targeting a junctional epithelium in the gingival crevice. In one aspect, the JET device may include one or more pharmaceutically acceptable excipients, diluents, buffers, salts, viscosity enhancers, plasticizers, thickening agents, surface tension reducing agents, polymers, or combinations thereof. In one aspect, the viscosity enhancers are selected from Hydroxypropyl cellulose (HPC) Hydroxyethyl cellulose (HEC), Sodium carboxymethyl cellulose (NaCMC), Methyl cellulose (MC), Ethyl cellulose (EC), Carbomer, Xanthan gum, Guar gum, Carrageenan, Sodium alginate, Acacia gum, Pectin, Polyvinyl alcohol (PVA), Polyethylene glycol (PEG), Polyvinylpyrrolidone (PVP), Polyacrylic acid (PAA), Poloxamer, Pluronic, Sodium hyaluronate, Gelatin, Bentonite, Magnesium aluminum silicate, Veegum, Tragacanth gum, Sodium starch glycolate, Microcrystalline cellulose, Sorbitol, Mannitol, Glycerin, Propylene glycol, Caprylyl glycol, Butylene glycol, Pentylene glycol, Dimethicone, Cyclomethicone, Jojoba oil, Sorbitan esters, Cetearyl alcohol, Stearyl alcohol, Behenyl alcohol, Cetyl alcohol, Oleic acid, Stearic acid, Isopropyl myristate, Polysorbate 20, Eudragit(s), or combinations thereof. In one aspect, the plasticizers are selected from Glycerin (glycerol), Propylene glycol, Polyethylene glycols (PEGs), Sorbitol, Mannitol, Polyvinyl alcohol (PVA), Polyvinylpyrrolidone (PVP), Ethylene glycol, Diethylene glycol, Triethylene glycol, Butylene glycol, Trimethylolpropane, Ethanolamine, Isopropyl alcohol, Tetrahydrofurfuryl alcohol, Dimethyl sulfoxide (DMSO), Polyethylene oxide (PEO), Poloxamers (Pluronics), Cyclodextrins, Saccharides, Eudragit(s), or combinations thereof. In one aspect, the method further comprises adding one or more additional agents that increase permeability of the one or more active agents into the gingival crevice. In one aspect, between 0.001, 0.01, 0.1, 1, 2, 3, 4, 5, 6, 7, 8, 9, 10, 15, 20, 25, 30, 40, 50, 60, 70, 75, 80, 90, 95, 96, 97, 98, 99 to 100% of the one or more active agents is in a depot at a junctional epithelium of the gingival crevice. In one aspect, the one or more active agents are provided repeatedly to a junctional epithelium of the gingival crevice. In one aspect, delivery of the one or more one or more active agents to a junctional epithelium is before or after consumption of a food or drink. In one aspect, the one or more active agents is applied once or more than once with a frequency on a daily or weekly or monthly basis, such as 1, 2, 3, 4, 5, or 6 times daily or 1, 2, 3, 4, 5, 6, or 7 times weekly or 1, 2, 3, or 4 times monthly. In one aspect, two or more active agents are delivered to a junctional epithelium of the gingival crevice. In one aspect, delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks water, or both. In one aspect, delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks water, or both. In one aspect, an amount of the one or more active agents is delivered to a junctional epithelium range from picograms to milligrams. In one aspect, at least a portion of the arm has a thickness less than 5 mm, preferably less than 3 mm, and preferably less than 1 mm. In one aspect, at least a portion of the arm comprises natural or synthetic polymers, organic materials, metals, inorganic materials or combinations thereof. In one aspect, at least a portion of the arm comprises a mucoadhesive layer or a hydrophobic layer or a hydrophilic layer or a combination. In one aspect, at least a portion of the arm comprises a microporous structure allowing diffusion of antigen to gingival crevice. In one aspect, construction of the grip and arm is unitary. In one aspect, a viscosity of the one or more active agents deposited is 0.01 centipoise (cp), 1 cp, 10 cp, 100 cp, 1000 cp, 10000 cp, 100000 cp, 200000 cp, 300000 cp, 500000 cp, 1000000, or 100000000 cp. In one aspect, the one or more active agents are formed in, into, or about, one or more micro-nano-sized carriers or nanoparticles. In one aspect, the one or more active agents are formed in, into, or about, one or more liposomes, polymeric particles, inorganic particles, or lipid particles, or hybrid particles in which the one or more active agents are attached or encapsulated.

As embodied and broadly described herein, an aspect of the present disclosure relates to a method of making a disintegrable JET device for delivery of one or more active agents to a subject comprising: an arm connected to a substrate, grip or handle that extends at an angle from the substrate, grip, or handle, wherein the arm comprises one or more active agents and is sized to have a length and a cross section capable of being inserted into a gingival crevice, wherein at least a portion of the arm is at least one of: disintegrable, pocketed, swellable, patterned, reservoir, or combinations thereof; depositing in, on, or about the portion of the arm that receives one or more active agents in a disintegrable pharmacologically acceptable carrier, wherein each deposit has a known, pre-determined amount of the one or more active agents. In one aspect, the portion of the arm is at least one of: disintegrable, pocketed, swellable, patterned, reservoir, or combinations thereof, is triggered to release the one or more active agents by one or more environmental stimuli selected from moisture, pH, enzymes, temperature, ion composition, ion concentration in a gingival crevice. In another aspect, release of the one or more active agents from the disintegrable, pocketed, swellable, patterned, reservoir, or combinations thereof is a controlled or a prolonged disintegration over minutes to hours to days. In one aspect, at least part of the portion that is disintegrable, pocketed, swellable, patterned, reservoir, or combinations thereof is selected to have sufficient mechanical strength to allow it to be handled and inserted into a gingival crevice. In one aspect, at least part of the portion that is disintegrable, pocketed, swellable, patterned, reservoir, or combinations thereof is reinforced to enhance its mechanical properties by adding inactive ingredients such as starches, sugar alcohols, cellulose derivatives, polyvinyl alcohol, binders, or excipients. In one aspect, at least part of portion that is disintegrable, pocketed, swellable, patterned, reservoir, or combinations thereof is reinforced to enhance its mechanical properties by compression or compaction during fabrication. In one aspect, at least part of portion that is disintegrable, pocketed, swellable, patterned, reservoir, or combinations thereof is reinforced to enhance its mechanical properties with a net, a mesh, or strips, that are a biocompatible and/or biodegradable material or generally regarded as safe (GRAS), or other safe to consume material. In one aspect, at least part of a shape of the portion that is disintegrable, pocketed, swellable, patterned, reservoir, or combinations thereof is selected from at least one of a wedge shape, a cone or a frustum. In one aspect, at least part of the portion that is disintegrable, pocketed, swellable, patterned, reservoir, or combinations thereof further comprises a mucoadhesive, the one or more active agents further comprises a mucoadhesive, or both. In one aspect, the one or more active agents is at least one of: entrapped, encapsulated, or mixed in one or more inactive excipients. In one aspect, at least part of the portion that is disintegrable, pocketed, swellable, patterned, reservoir, or combinations thereof is formed in a mold selected from: solvent casting, hot-melt-extrusion, a Meyer bar coating, a slot die coating, 3D printing, spray, or gravure printing. In one aspect, at least part of the portion that is disintegrable, pocketed, swellable, patterned, reservoir, or combinations thereof comprising the one or more active agents is a film or coated with a film. In one aspect, the portion that is disintegrable, pocketed, swellable, patterned, reservoir, or combinations thereof comprising the one or more active agents is a film selected from mucoadhesive film, pressure sensitive film, lined with a mucoadhesive material, a pressure sensitive material, a temperature sensitive material, or combinations thereof. In one aspect, the portion that is disintegrable, pocketed, swellable, patterned, reservoir, or combinations thereof can be attached to the grip or handle with joint selected from butt joint, lap joint, mortise and tenon joint, dado joint, tongue and groove joint, half-lap joint. In one aspect, the portion that is disintegrable, pocketed, swellable, patterned, reservoir, or combinations thereof can be attached to the substrate or grip or handle with at least one of: a glue, hot melt, or solvent melting after the said substrate or grip or handle has been fabricated; or by inserting it into said substrate or grip or handle while they are being fabricated. In one aspect, the portion that is disintegrable, pocketed, swellable, patterned, reservoir, or combinations thereof further comprises one or more flavors, taste masking agents, color, or combinations thereof. In one aspect, the one or more active agents are formed in, into, or about, one or more portions that are disintegrable, pocketed, swellable, patterned, reservoir, or combinations thereof is formed with a liquid or gel coating, pockets hollowed out in a substrate, film, or strip. In one aspect, the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof. In one aspect, the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to a substrate, film, or strip, in a thermoplastic polymer deposited or adhered to a substrate, film, or strip, in a polysaccharide formulation deposited or adhered to a substrate, film, or strip, in pockets alternating between liquids, gels, solids deposited or adhered to a substrate, film, or strip, in a biodegradable material deposited or adhered to a substrate, film, or strip, in a swellable material deposited or adhered to a substrate, film, or strip, in a mucoadhesive deposited or adhered to a substrate, film, or strip. In one aspect, the one or more active agents are formed or carved in, into, or about, one or more portions that are disintegrable, pocketed, swellable, patterned, reservoir, or combinations thereof that have a depth of 10%, 20%, 30%, 40%, 50%, 60%, 70%, 80%, 90% or 100% of a thickness of a substrate, film, or strip. In one aspect, the one or more active agents are formed or carved in, into, or about, one or more portions that are disintegrable, pocketed, swellable, patterned, reservoir, or combinations thereof that form a flat surface, wedged shape, cylindrical shape, tapered cylindrical shape, bullet shape, parabolic shape or combinations thereof. In one aspect, the one or more active agents are formed or carved in, into, or about, one or more portions that are disintegrable, pocketed, swellable, patterned, reservoir, or combinations thereof that further comprise one or more sensors. In one aspect, the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof. In one aspect, the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to the substrate, film, or strip, in a thermoplastic polymer deposited or adhered to the substrate, film, or strip, in a polysaccharide formulation deposited or adhered to the substrate, film, or strip, in pockets alternating between liquids, gels, solids deposited or adhered to the substrate, film, or strip, in a biodegradable material deposited or adhered to the substrate, film, or strip, in a swellable material deposited or adhered to the substrate, film, or strip, in a mucoadhesive deposited or adhered to the substrate, film, or strip, or the reservoirs are porous in the substrate, film, or strip. In one aspect, the one or more active agents are formed in, into, or about, one or more portions that are disintegrable, pocketed, swellable, patterned, reservoir, or combinations thereof that are connected by one or more channels, hollow tubes, slits, or capillaries formed or carved in, on, or into, a substrate, film, or strip, wherein the channels can be straight lines, curved lines, irregular and can connect reservoirs having one or more shapes selected from circles, rectangles, squares, or regular shapes, irregular shapes, or combinations thereof. In one aspect, the one or more active agents are formed in, one, or about an applicator that comprises a mucoadhesive and a film comprising the one or more active agents on the arm, and a cap or coating surrounding the mucoadhesive and the film, wherein the mucoadhesive and the film is shaped to contact the gingival crevice at a junction with a tooth, is flexible to contour on or about the gingival crevice at a tooth junction, or wherein the mucoadhesive, the film, or both are pressure-sensitive. In one aspect, the one or more active agents are formed in, one, or about an applicator that comprises a spring, electrical actuator, magnetic actuator, mechanical actuator, or combinations thereof attached to move the arm to position the arm into a gingival crevice or to attach the active agent to a surface in, on, or about the gingival crevice. In one aspect, the one or more active agents are formed in, one, or about portions that are disintegrable, pocketed, swellable, patterned, reservoir, or combinations thereof is a material comprising a swellable polymer, hydrogel, of combinations thereof. In one aspect, the one or more active agents are formed in, one, or about portions that are disintegrable, pocketed, swellable, patterned, reservoir, or combinations thereof is a material selected from methacrylated hyaluronic acid, or gelatin-methacryloyl, or co-polymer of poly(methylvinylether co. maleic acid) crosslinked with poly(ethylene glycol), or co-polymer of poly(methylvinylether co. maleic anhydride) crosslinked with poly(ethylene glycol), or polyvinyl alcohol, or poly(2-hydroxyethyl methacrylate), or poly(styrene)-block-poly(acrylic acid), of combinations thereof. In one aspect, the one or more active agents are formed in, one, or about portions that are disintegrable, pocketed, swellable, patterned, reservoir, or combinations thereof is a material that is biodegradable, made from a compound or formulation generally regarded as safe, or both, or the material comprises one or more layers that release as the swellable material expands upon contact with one or more environmental stimuli selected from moisture, pH, enzymes, temperature, ion composition, ion concentration, or combinations thereof. In one aspect, the one or more active agents is selected for local or systemic delivery. In one aspect, the one or more active agents are selected from immunogens, vaccines, allergens, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, nucleic acids, antibiotics, antifungal agents, anti-inflammatory agents, anti-inflammatories, and combinations thereof. In one aspect, the one or more active agents activate, or anergize, an immune response by targeting a junctional epithelium in the gingival crevice. In one aspect, the JET device may include one or more pharmaceutically acceptable excipients, diluents, buffers, salts, viscosity enhancers, plasticizers, thickening agents, surface tension reducing agents, polymers, or combinations thereof. In one aspect, the viscosity enhancers are selected from Hydroxypropyl cellulose (HPC) Hydroxyethyl cellulose (HEC), Sodium carboxymethyl cellulose (NaCMC), Methyl cellulose (MC), Ethyl cellulose (EC), Carbomer, Xanthan gum, Guar gum, Carrageenan, Sodium alginate, Acacia gum, Pectin, Polyvinyl alcohol (PVA), Polyethylene glycol (PEG), Polyvinylpyrrolidone (PVP), Polyacrylic acid (PAA), Poloxamer, Pluronic, Sodium hyaluronate, Gelatin, Bentonite, Magnesium aluminum silicate, Veegum, Tragacanth gum, Sodium starch glycolate, Microcrystalline cellulose, Sorbitol, Mannitol, Glycerin, Propylene glycol, Caprylyl glycol, Butylene glycol, Pentylene glycol, Dimethicone, Cyclomethicone, Jojoba oil, Sorbitan esters, Cetearyl alcohol, Stearyl alcohol, Behenyl alcohol, Cetyl alcohol, Oleic acid, Stearic acid, Isopropyl myristate, Polysorbate 20, Eudragit(s), or combinations thereof. In one aspect, the plasticizers are selected from Glycerin (glycerol), Propylene glycol, Polyethylene glycols (PEGs), Sorbitol, Mannitol, Polyvinyl alcohol (PVA), Polyvinylpyrrolidone (PVP), Ethylene glycol, Diethylene glycol, Triethylene glycol, Butylene glycol, Trimethylolpropane, Ethanolamine, Isopropyl alcohol, Tetrahydrofurfuryl alcohol, Dimethyl sulfoxide (DMSO), Polyethylene oxide (PEO), Poloxamers (Pluronics), Cyclodextrins, Saccharides, Eudragit(s), or combinations thereof. In one aspect, the method further comprises adding one or more additional agents that increase permeability of the one or more active agents into the gingival crevice. In one aspect, between 0.001, 0.01, 0.1, 1, 2, 3, 4, 5, 6, 7, 8, 9, 10, 15, 20, 25, 30, 40, 50, 60, 70, 75, 80, 90, 95, 96, 97, 98, 99 to 100% of the one or more active agents is in a depot at a junctional epithelium of the gingival crevice. In one aspect, the one or more active agents are provided repeatedly to a junctional epithelium of the gingival crevice. In one aspect, delivery of the one or more one or more active agents to a junctional epithelium is before or after consumption of a food or drink. In one aspect, the one or more active agents is applied once or more than once with a frequency on a daily or weekly or monthly basis, such as 1, 2, 3, 4, 5, or 6 times daily or 1, 2, 3, 4, 5, 6, or 7 times weekly or 1, 2, 3, or 4 times monthly. In one aspect, two or more active agents are delivered to a junctional epithelium of the gingival crevice. In one aspect, delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks water, or both. In one aspect, delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks water, or both. In one aspect, an amount of the one or more active agents is delivered to a junctional epithelium range from picograms to milligrams. In one aspect, at least a portion of the arm has a thickness less than 5 mm, preferably less than 3 mm, and preferably less than 1 mm. In one aspect, at least a portion of the arm comprises natural or synthetic polymers, organic materials, metals, inorganic materials or combinations thereof. In one aspect, at least a portion of the arm comprises a mucoadhesive layer or a hydrophobic layer or a hydrophilic layer or a combination. In one aspect, at least a portion of the arm comprises a microporous structure allowing diffusion of antigen to gingival crevice. In one aspect, construction of the grip and arm is unitary. In one aspect, a viscosity of the one or more active agents deposited is 0.01 centipoise (cp), 1 cp, 10 cp, 100 cp, 1000 cp, 10000 cp, 100000 cp, 200000 cp, 300000 cp, 500000 cp, 1000000, or 100000000 cp. In one aspect, the one or more active agents are formed in, into, or about, one or more micro-nano-sized carriers or nanoparticles. In one aspect, the one or more active agents are formed in, into, or about, one or more liposomes, polymeric particles, inorganic particles, or lipid particles, or hybrid particles in which the one or more active agents are attached or encapsulated.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 depicts a disintegrating junctional epithelium targeting (JET) device being placed in a gingival crevice, its subsequent disintegration, and release of active substance (AS) in the gingival crevice.

FIG. 2 depicts a disintegrating JET made purely out of AS (LEFT) and with AS mixed with excipients (RIGHT).

FIG. 3 depicts a disintegrating JET reinforced with a mesh/net, and containing AS alone (LEFT) or AS mixed with excipients (RIGHT).

FIG. 4 depicts a disintegrating JET reinforced with a structural support substrate.

FIG. 5 depicts a disintegrating JET attached to a grip with a single short connector. LEFT: JET+grip assembly, and RIGHT: Zoom up of the JET-connecter-grip joint.

FIG. 6 depicts a disintegrating JET attached to a grip with two short connectors. LEFT: JET+grip assembly, and RIGHT: Zoom up of the JET-connecter-grip joint.

FIG. 7 depicts a disintegrating JET attached to a grip with single wide connector. LEFT: JET+grip assembly, and RIGHT: Zoom up of the JET-connecter-grip joint.

FIG. 8 depicts a disintegrating JET attached to a grip through different joints. LEFT: Butt joint, Middle: Lap joint, RIGHT: Dowel joint.

FIG. 9, LEFT: depicts a disintegrable JET attached to a mucoadhesive film; RIGHT: mucoadhesive film attaches to teeth/gingiva and secures the JET in the gingival crevice.

FIG. 10 depicts a film made of poly(lactic-co-glycolic acid) containing yellow colored substance as a model drug. The film was made using solvent casting into a mold.

FIG. 11 depicts a film made of aqueous solutions of 10% polyvinyl alcohol, 10% polyvinyl pyrrolidone and, 10% glycerin (% w/w). Solvent casting process was used with molds made of polydimethyl siloxane. Sodium fluorescein was added as a model fluorescent dye to simulate a hydrophilic active substance.

FIG. 12 depicts a film made of aqueous solutions of 10% polyvinyl alcohol, 10% polyvinyl pyrrolidone and, 10% glycerin (% w/w) applied to gingival crevice of a pig cadaver jaw. LEFT: Before application, middle: during application; and RIGHT: after application.

FIG. 13 shows a schematic of a pocketed JET being placed in a gingival crevice. LEFT: Pocketed JET is inserted into gingival crevice. RIGHT: Pocketed JET remains in the gingival crevice to deliver substances.

FIG. 14 shows a pocketed JET. LEFT: Empty pocketed JET. RIGHT: Pocketed JET filled with substance for delivery.

FIG. 15 shows, LEFT: Single pocket. RIGHT: More than one pockets.

FIG. 16 shows, LEFT: More than one rectangular pockets are all carrying the same substance. RIGHT: More than one rectangular pockets are carrying different substances.

FIG. 17 shows, LEFT: More than one circular pockets are all carrying the same substance. RIGHT: More than one circular pockets are carrying different substances.

FIG. 18 shows, LEFT top: Empty pocketed JET with pocket depth equal to 100% of the device thickness. LEFT bottom: Filled pocketed JET with pocket depth equal to 100% of the device thickness; RIGHT top: Empty pocketed JET with pocket depth <100% of the device thickness. RIGHT bottom: Filled pocketed JET with pocket depth <100% of the device thickness.

FIG. 19 shows, LEFT: Pocket present on both sides. RIGHT: Pocket present on both sides filled.

FIG. 20 shows, LEFT: Pocket extending 100% of the device thickness, filled with substance and covered with thin film on either side; MIDDLE: Single pocket extending to <100% of the device thickness, filled with substance and covered with thin film on one side; RIGHT: Two pockets each extending to <100% of the device thickness, filled with substance and each covered with thin film.

FIG. 21 shows, LEFT: Empty pocket extending 100% of the device thickness and complete device length on one end; MIDDLE: Filled pocket extending 100% of the device thickness and complete device length on one end; RIGHT: Filled pocket extending 100% of the device thickness and complete device length on one end, and covered with thin film on both sides.

FIG. 22 shows pockets of different shapes and designs.

FIG. 23 shows devices of different shapes. LEFT: Wedge shaped device with pocket (top: unfilled, bottom: filled); MIDDLE: Bullet shaped device with pocket (top: unfilled, bottom: filled); RIGHT: Conical frustum shaped device with pocket (top: unfilled, bottom: filled).

FIG. 24 shows a significant proportion of the solid is removed. However, the remaining solid is in the form that it forms pockets that can still retain liquids and other formulations.

FIG. 25 shows a significant proportion of the solid is removed to create an outer frame. An external net or mesh is added to form pockets.

FIG. 26 shows a pocketed JET attached to grip for delivery into gingival crevice.

FIG. 27 shows, LEFT: Pocketed JET attached to grip via a single narrow connector. MIDDLE: Pocketed JET attached to grip via two narrow connectors. RIGHT: Pocketed JET attached to grip via single wide connector.

FIG. 28 shows different joints for connecting Pocketed JET to the grip.

FIG. 29 shows, LEFT: Pocketed JET attached to mucoadhesive film. RIGHT: Mucoadhesive film sticks to gingiva/teeth (or both) and holds the pocketed JET in place.

FIG. 30 shows, LEFT: Pocketed JET cut from a thin film of plastic. MIDDLE: One pocketed JET filled with a semi-solid formulation. RIGHT: One pocketed JET filled with a liquid formulation.

FIG. 31 shows, LEFT: Pocketed JET filled with a liquid formulation prior to application in pig gingival crevice. RIGHT: Pig gingival crevice after application of liquid-filled pocketed JET.

FIG. 32 shows, TOP BOX: Schematic of a reservoir JET being placed in a gingival crevice. BOTTOM BOX: Description of how the drug is transported from reservoir to the gingival crevice.

FIG. 33 shows channels extending 100% through material thickness. LEFT: The channel continues beyond the edge. RIGHT: The channel does not extend beyond the edge.

FIG. 34 shows channels extending 100% through material thickness. LEFT: The channel contains interconnected rectangles. RIGHT: The channel contains interconnected rectangle and ovals.

FIG. 35 shows, LEFT: Channel extends 100% of thickness. MIDDLE: Channel extends less than 100% of thickness on one side. RIGHT: A channel each extends less than 100% of the thickness on either side.

FIG. 36 shows, LEFT: Wedge shaped transport conduit with channel carved 100% of thickness. RIGHT: Conical shaped transport conduit with channel carved 100% of thickness.

FIG. 37 shows, LEFT: Conical porous transport conduit. MIDDLE: Planar porous transport conduit. RIGHT. Porous material layered over non-porous material.

FIG. 38 shows, LEFT: Hollow cylindrical transport channel. RIGHT: Hollow conical transport channel.

FIG. 39 shows, LEFT: One cut made in porous film. RIGHT: More than one cut made in porous film.

FIG. 40 shows, LEFT: Reservoir is covered with another outer layer for protection and to prevent drug release from unintended location. RIGHT: A mucoadhesive layer is attached to the side with JET arm to secure the system to the teeth/gingiva.

FIG. 41 shows, LEFT: Transport conduit is towards the top of reservoir. MIDDLE: Transport conduit is towards the middle of reservoir. RIGHT: Transport conduit is towards the bottom of reservoir.

FIG. 42 shows a reservoir JET with a reservoir made from solvent casting of 50 mg/ml of PVA, 50 mg/ml of PVP, 20 mg/ml of Saccharin, 10% glycerin, and trace amounts of sodium fluorescein as model dye. The transport conduit is a hollow conical tube.

FIG. 43 shows a reservoir JET with a reservoir made from solvent casting of 10% PVA, 10% PVP, 10% glycerin (% w/w), and trace amounts of sodium fluorescein as model dye. The transport conduit is a hollow tube.

FIG. 44 shows a reservoir JET with a reservoir made from solvent casting of 100 mg/ml of PVA, 20 mg/ml of PVP, 20 mg/ml of Saccharin, 10% glycerin, and trace amounts of sodium fluorescein as model dye. The transport conduit is a hollow tube. RIGHT: side view. MIDDLE: Top view under white light. RIGHT: Top view under fluorescent light.

FIG. 45 shows a reservoir JET with a reservoir made from solvent casting of 100 mg/ml of PVA, 20 mg/ml of PVP, 20 mg/ml of Saccharin, 10% glycerin, and trace amounts of sodium fluorescein as model dye. The transport conduit is a porous flat film. LEFT: Top view under white light. RIGHT: Top view under fluorescent light.

FIG. 46 shows a schematic of a JET applicator. LEFT: With protective cover on. RIGHT: With protective cover removed.

FIG. 47 shows the steps in use of the applicator.

FIG. 48 shows a JET base film has two layers. One layer is non-sticky to allow detachment from the platform, and the other layer has adhesive property to allow it to stick to the gingiva/teeth, but this layer is only on the side of the JET.

FIG. 49 shows the applicator has no movable piston/platform. The applicator grip is itself used to insert the JET into the gingival crevice and to press the sticky film to the surrounding surfaces of the gingiva/teeth.

FIG. 50 shows a variation of the JET applicator design.

FIG. 51 shows, LEFT: Depiction of a swellable JET being placed in a gingival crevice. RIGHT: Subsequent swelling, and release of active substance (AS) in the gingival crevice.

FIG. 52 shows a swellable JET made by creating swellable drug film over a substrate that offers mechanical support.

FIG. 53 shows a swellable JET attached to a grip with a LEFT: single short connector, MIDDLE: two short connectors, and RIGHT: one larger connector.

FIG. 54 shows, LEFT: A swellable JET attached to a mucoadhesive film. RIGHT: Mucoadhesive film attaches to teeth/gingiva and secures the JET in the gingival crevice for easy retrieval after it is used.

FIG. 55 shows rectangular grooves as mechanical interlocks to improve adhesion of coating.

FIG. 56 shows cylindrical pillars as mechanical interlocks to improve adhesion of coating.

FIG. 57 shows through holes as mechanical interlocks (‘rivets’) to improve adhesion of coating.

FIG. 58 shows the surface of the floss/film is decorated with raised pillars. The pillars can themselves possess additional topographical features such as ridges or raised features.

FIG. 59 shows a thin floss/strip was created from poly(lactic-co-glycolic) (PLGA) acid with micro-patterns using the molding technique. The mold was first created using a plastic wire mesh (Falcon 70 μm cell strainer, catalog number 352350). TOP. Uncoated floss/strip. BOTTOM: The floss was coated with a liquid formulation with food-dye, which was found to localize on the raised portion of the topographical aspects.

FIG. 60 shows embossing of the Teflon floss (Oral-B Glide Pro-health) was manually done by pressing down a polymer mesh (Falcon 70 μm cell strainer, catalog number 352350) onto the Teflon floss. LEFT: Embossed floss. RIGHT: Zoom up view to show embossing.

FIG. 61 shows an exemplary JET device configured with capabilities and functionality for controlled delivery of medicaments to the gingival crevice of a patient in accordance with embodiments of the present disclosure.

FIG. 62A shows a lateral view of the exemplary JET device configured with capabilities and functionality for controlled delivery of medicaments to the gingival crevice of a patient in accordance with embodiments of the present disclosure.

FIG. 62B shows an anterior view of the exemplary JET device configured with capabilities and functionality for controlled delivery of medicaments to the gingival crevice of a patient in accordance with embodiments of the present disclosure.

FIG. 62C shows a caudal view of the exemplary JET device configured with capabilities and functionality for controlled delivery of medicaments to the gingival crevice of a patient in accordance with embodiments of the present disclosure.

FIG. 62D shows another embodiment of an exemplary JET device configured with capabilities and functionality for controlled delivery of medicaments to the gingival crevice of a patient in accordance with embodiments of the present disclosure.

FIG. 63A shows an exemplary embodiment of a carrier of a JET device configured with an internal well configuration for enclosing medicaments in accordance with embodiments of the present disclosure.

FIG. 63B shows an exemplary embodiment of a carrier of a JET device configured with a polymer/medicament mixture configuration in accordance with embodiments of the present disclosure.

FIG. 63C shows an exemplary embodiment of a carrier of a JET device configured with a multi-stage delivery configuration using a polymer/medicament mixture and an internal well in accordance with embodiments of the present disclosure.

FIG. 63D shows an exemplary embodiment of a carrier of a JET device configured with a filament mesh configuration in accordance with embodiments of the present disclosure.

FIG. 64 shows an exemplary location of a gingival crevice and a gingival crevice in accordance with embodiments of the present disclosure.

FIG. 65A-65C illustrate various views of an exemplary location of a target area for delivery of medicaments into a gingival crevice in accordance with embodiments of the present disclosure.

FIG. 66A-6C illustrate example operations for delivery of medicaments into a gingival crevice in accordance with embodiments of the present disclosure.

FIG. 67A-67C illustrate another view of the example operations for delivery of medicaments into a gingival crevice in accordance with embodiments of the present disclosure.

FIG. 68A-68C illustrate example operations for delivery of medicaments into a gingival crevice via dissolvement of the carrier in accordance with embodiments of the present disclosure.

FIG. 69 shows a high-level flow diagram of operations of a JET device for controlled delivery of medicaments to the gingival crevice of a patient in accordance with embodiments of the present disclosure.

FIG. 70 shows an exemplary flow diagram of operations for manufacturing a JET device configured with functionality for controlled delivery of medicaments to the gingival crevice of a patient in accordance with embodiments of the present disclosure.

FIG. 71 shows an exemplary JET device configured with capabilities and functionality for delivery of medicaments to the gingival crevice of a patient by agitation in accordance with embodiments of the present disclosure.

FIG. 72 shows a perspective view of the exemplary JET device configured with capabilities and functionality for delivery of medicaments to the gingival crevice of a patient by agitation in accordance with embodiments of the present disclosure.

FIG. 73 shows a caudal view of the exemplary JET device configured with capabilities and functionality for delivery of medicaments to the gingival crevice of a patient by agitation in accordance with embodiments of the present disclosure.

FIG. 74A shows an exemplary location of a gingival crevice and a junctional epithelium in accordance with embodiments of the present disclosure.

FIG. 74B shows an exemplary location for insertion of a JET device into a gingival crevice in accordance with embodiments of the present disclosure.

FIGS. 75A-75C illustrate various views of an exemplary location of a target area for delivery of medicaments into a gingival crevice in accordance with embodiments of the present disclosure.

FIGS. 76A-76C illustrate example operations for delivery of medicaments into a gingival crevice by agitation using a JET device in accordance with embodiments of the present disclosure.

FIG. 77 shows a high-level flow diagram of operations of a JET device for delivery of medicaments to the gingival crevice of a patient by agitation in accordance with embodiments of the present disclosure.

FIG. 78 shows an exemplary flow diagram of operations for manufacturing a JET device configured with functionality for delivery of medicaments to the gingival crevice of a patient by agitation in accordance with embodiments of the present disclosure.

FIG. 79 illustrates an exemplary embodiment of a JET device configured with a string-based insertable component for delivery of medicament films into the gingival crevice in accordance with embodiments of the present disclosure.

FIG. 80 illustrates another exemplary embodiment of a string-based insertable component for delivering medicament films into the gingival crevice in accordance with embodiments of the present disclosure.

FIG. 81 illustrates yet another exemplary embodiment of the string-based insertable component of a JET device configured for delivery of medicament films into the gingival crevice in accordance with embodiments of the present disclosure.

FIG. 82 illustrates another exemplary embodiment of a string-based insertable component of a JET device configured for delivery of medicament films into the gingival crevice in accordance with embodiments of the present disclosure.

FIG. 83 illustrates another exemplary embodiment of a JET device including a string-based insertable component configured with functionality for delivering multiple medicament films into the gingival crevice in accordance with embodiments of the present disclosure.

FIG. 84 illustrates another exemplary embodiment of a JET device with a plane-based insertable component configured with functionality for delivery of medicament films into the gingival crevice in accordance with embodiments of the present disclosure.

FIG. 85 illustrates an exemplary embodiment of a JET device including a frame-based insertable component configured for delivery of medicament films into the gingival crevice in accordance with embodiments of the present disclosure.

FIG. 86 illustrates exemplary operations for loading a medicament formulation into a frame-based insertable component of a JET device configured for delivery of medicament films into the gingival crevice in accordance with embodiments of the present disclosure.

FIGS. 87 and 88 illustrate another exemplary embodiment of a JET device including a frame-based insertable component configured for delivery of medicament films into the gingival crevice in accordance with embodiments of the present disclosure.

FIG. 89 shows an exemplary multi-headed JET (M-JET) device configured with functionality for concurrent delivery of medicament to multiple gingival crevices in accordance with embodiments of the present disclosure.

FIGS. 90 and 91 show exemplary embodiments of coated-head configurations of the M-JET device configured with functionality for concurrent delivery of medicament to multiple gingival crevices in accordance with embodiments of the present disclosure.

FIGS. 92 and 93 show exemplary embodiments of dissolvable configurations of the M-JET device configured with functionality for concurrent delivery of medicament to multiple gingival crevices in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features de-scribed herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

In embodiments, the present disclosure may describe techniques and devices for medicament delivery to a patient and/or a subject. Herein, a subject and patient may be used interchangeably to refer to a person (or animal in some embodiments) to which medicament is delivered into the gingival crevice for absorption through the junctional epithelium. As such, the use of patient or subject should not be construed as limiting in any way.

The present invention describes novel design aspects and functional features for implementing a device in which the active material is embedded, encapsulated, entrapped, or a combination thereof is delivered into the junctional epithelium (JE) of a gingival crevice.

The gingival crevice contains the junctional epithelium (JE), which has the attractive property of being significantly more permeable than other mucosal surfaces (such as the gut lining). Thus, the JE can be used as a portal for delivery of vaccines, allergens for immunotherapy, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, antibiotics, antifungal agents, anti-inflammatory agents, and combinations of the aforementioned substances. Examples without limitation for biomolecules include insulin, antibodies, natural peptides, synthetic peptides, semaglutide (a glucagon like peptide-1 receptor agonist), peptides with modified amino acids and substitutions, peptides with non-natural amino acids, natural proteins, recombinant proteins, proteins with modified amino acids and non-natural amino acids, DNA, RNA, siRNA, mRNA, etc. In WO2023014950A1, PCT/US2022/039536, it was described that the tissue underneath the JE is rich in immune cells and thus is attractive for allergen immunotherapy and vaccination.

One of the challenges with current technology is that the JE of the gingival crevice lies at the base of the gingival crevice. Therefore, targeting the JE for the delivery of substances is a challenge. Indeed, using a dyed-mouthwash it has been shown that simply using a mouthwash does not lead to penetration of the dye into the gingival crevice (Pitcher, G. R., H. N. Newman, and J. D. Strahan, Access to subgingival plaque by disclosing agents using mouth rinsing and direct irrigation. J Clin Periodontol, 1980. 7(4): p. 300-8). Therefore, to overcome this and other challenges a special approach was invented to enhance delivery or one or more active agents into the JE. The disclosure describes a delivery component called the junctional epithelium targeting (JET) device, which is the component that can be inserted into the gingival crevice. The JET has the property that when it comes in contact with the fluid in the gingival crevice, it starts to disintegrate, releasing the encapsulated/entrapped active substance into the gingival crevice. The active substance solubilizes and is transported across the JE. Disintegration can be through different stimuli including moisture, pH, enzymes, temperature, ion composition, and/or ion concentration that is in the gingival crevice.

It is noted that in some embodiments, the techniques disclosed herein may be applicable to deliver medicaments to a gum pocket of a patient, which may represent a gingival crevice in an abnormal condition, such as diseased or distressed. In these embodiments, the gum pocket may represent an actual space between the tooth and the gum (rather than a potential space represented by a normal or healthy gingival crevice), which may be larger than the space that may be created by a medicament seed inserted into the gingival crevice. In embodiments, a gum pocket may represent a larger space within the gingival crevice, which may enable larger medicament seeds, various medicament formulations, various dosages, and/or various techniques that may not be possible within a healthy gingival crevice for delivery and deposition of medicaments into the gingival crevice for absorption into the patient's system via the junctional epithelium

The one or more active agents or substances for delivery with the present invention can be designed for local or systemic activity. Examples of local action or activity, without limitation, include treatment of local bacterial infection causing gum diseases such as gingivitis and/or periodontitis, or for action on local cells of the surrounding gingiva for treatment of pain, or tissue regeneration. Examples of systemic action or activity, without limitation, include drugs that are delivered at the JE but act throughout the body of the subject such as vaccines, allergens for immunotherapy, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, antibiotics, antifungal agents, anti-inflammatory agents, and combinations of the aforementioned substances. Examples without limitation for biomolecules include insulin, antibodies, natural peptides, synthetic peptides, peptides with modified amino acids and substitutions, peptides with non-natural amino acids, natural proteins, recombinant proteins, proteins with modified amino acids and non-natural amino acids, DNA, RNA, siRNA, mRNA, etc.

Based on the desired predetermined amount to be delivered, the disintegration can be tuned to follow a rapid (within seconds) disintegration, or a more controlled and prolonged disintegration over minutes to hours to days. The tuning of release rate can be tuned by adding ingredients that increase or decrease the solubility of the JET structure.

Often, the JET must possess sufficient mechanical strength to allow it to be handled and inserted into the gingival crevice. However, it is possible to have a JET with lower mechanical strength as the one or more active agents are deposited on the surface of the tooth/gum interface at the JE.

In one embodiment, the JET can be created purely from the one or more active agents or substances if the underlying structure possesses the appropriate mechanical strength for handling and insertion into the gingival crevice. Otherwise, the JET must be reinforced to enhance its mechanical properties. This reinforcement can be done by adding inactive pharmaceutically acceptable ingredients or excipients such as starches, sugar alcohols, cellulose derivatives, polymers, polyvinyl alcohol, and other excipients, especially of the ‘binder’ category of excipients. However, other known excipients can also be used. Compression during fabrication can also be used for compaction and creating higher mechanical strength.

In one embodiment the mechanical strength can be created using reinforcement in the form of a net or mesh. The net or mesh can be made of biocompatible and/or biodegradable material or “generally regarded as safe (GRAS)” or other biocompatible and/or biodegradable materials, such as edible substances or substances that are chromogenic.

In one embodiment, a film is created on top of a thin structurally strong substrate to create a composite structure. The structural member will generally be made from biodegradable or GRAS or other safe to consume material, but can also be non-biodegradable.

To improve the JET's retention within the gingival crevice post-placement, its shape can be engineered to wedge it in the gingival crevice. The shape can be a wedge shape, a cone, or a frustum. Another way to improve the JET's retention within the gingival crevice post-placement, mucoadhesive substances can be incorporated. Yet another way to improve the JET's retention within the gingival crevice post-placement, a combination of shape-design and mucoadhesives can be used.

In another embodiment, the active molecule can be entrapped/encapsulated/mixed in inactive excipients. The JET can be made using different approaches of filling a mold such as solvent casting, hot-melt-extrusion, or use of a doctor blade or a similar technique including and without limitation the Meyer Bar Coating, Slot Die Coating, 3D printing, Gravure Printing. In another embodiment larger films are made from which the appropriately sized JET is cut.

The JET can be placed into the gingival crevice by itself, or it can be attached to a grip for ease of handling. In one embodiment the JET is attached to the grip via a structural element that weakens upon contact with fluid and either quickly dissolves or the user can break the element to allow the JET to be retained in the gingival crevice.

The JET can be attached to the grip using different joint types including and not limited to butt joint, lap joint, mortise and tenon joint, dado joint, tongue and groove joint, half-lap joint. Glue, hot melt, solvent melting, and other approaches of joining can be employed.

The disintegrable JET can be attached to a film designed to secure the JET in the gingival crevice after insertion. The film can be mucoadhesive film, pressure sensitive film or is lined with mucoadhesive material or pressure sensitive material or combination thereof.

Depending on the nature of the one or more active agents, flavors and taste masking agents can be added. In addition, color can also be added as an indicator.

The coating may also include micro-nano-sized carriers or nanoparticles include liposomes, polymeric particles, inorganic particles, or lipid particles, or hybrid particles with active substance can be encapsulated.

The disclosure describes a delivery component called the JET device, which is the component that can be inserted into the gingival crevice and that is disintegrable. The JET surface can be made from, can include, can be coated, or imbued with one or more active agents or substances. When the JET is actively moved back-and-forth in the gingival crevice, the active agents are deposited in the gingival crevice.

The JET can be coated with active substance intended for local action or for systemic action. Examples of local action without limitation include treatment of local bacterial infection causing gum diseases such as gingivitis and/or periodontitis, or for action on local cells of the surrounding gingiva for treatment of pain, or tissue regeneration.

In one example, the JET possesses sufficient mechanical strength to allow it to be handled and inserted into the gingival crevice and can be made from unitary construction or can be assembled from one or more parts. The JET can be attached to a handle/grip for ease of use.

The technology of the present invention specifically targets the junctional epithelium (JE) to deliver picograms to micrograms of biologically active agents or active agents to the JE. The JE is located at the very bottom in the deepest recess of the gingival crevice (also sometimes called gingival sulcus or gingival groove). The JE is not freely exposed, instead, on its one side the JE is attached to the hard tooth surface, and on the other side it is attached to the soft underlying connective tissue. In this manner, JE wraps around the tooth forming an attachment band. The cells in JE are non-keratinized and have wide intercellular spaces. This wide intercellular spacing in JE, confers a unique property of high permeability to JE that is not found elsewhere in the oral mucosa including the mucosa of cheeks, lips, attached gingiva and even the vestibule. This high degree of permeability of JE is even higher than sublingual mucosa, is considered to be the most permeable oral mucosal site. The inventors of this invention have recognized this uniqueness of JE and have shown herein that femto-, pico-, micro-, or milligram quantities of active agents were able to readily permeate through the JE and deliver the active agents across the JE. As such, the technology of the present invention targets the JE because it has high permeability and allows for efficient uptake of the molecules into the underlying tissue.

Embodiments of the present disclosure involve placing material on top of the JE, through which a strong immune modulatory and/or therapeutic response can be achieved. No additional approaches are required to weaken or disrupt the mucosal barrier at the JE, simply placing small molecules such as active agents, deoxyribonucleic acid (DNA) or ribonucleic acid (RNA), or large molecules such as proteins, and even nanoparticles and viruses on the JE can result in, e.g., a strong immune response. In fact, the JE is rich in lymphatic vessels.

Embodiments of the present disclosure involve placing material on top of the JE, through which a strong therapeutic response can be achieved. No additional approaches are required to weaken or disrupt the mucosal barrier at the JE, simply placing small molecules such as nutraceuticals/vitamins may cause a strong therapeutic response.

The present invention is directed to administering active agents through the JE in the gingival crevice in order to access strong systemic distribution of the active agents. Because the JE is only 2 mm long and the gingival crevice is 1-2 mm deep, a thin flat surface similar in dimensions to the gingival crevice can be used having different configurations and methods of assembly, as taught herein. This flat surface can either be coated with the one or more active agents, or the one or more active agents can be encapsulated in the flat surface, formed into one or more cavities, inserts, etc., as shown herein. The inventors have previously shown, using mouse models, that floss can be coated with the antigen/allergen solution, show that the mice teeth can be flossed, and show that this method is as an effective form of active agents' delivery. These new devices serve as a non-invasive, painless, and easy way to administer one or more active agents. In the case of allergies, the immunization of the present invention serves to dampen the allergic immune response and/or induce a protective immune response against allergen/s. Conversely, the present invention can also be used to trigger an immune response against infectious and other agents, target infectious or other diseases directly, deliver nutrients, etc.

The present invention can be used to modify dental inserts to deliver the one or more active agents. For example, a dental insert may be produced as a nylon dental material in which a nylon is polymerized into a polymer that is formed, pumped, or extruded to form monofilaments, films, deposit in or on the dental inserts, or a multitude of layers. The polymer is allowed to harden and the active agent(s) deposited on, in, or about the dental insert. Dental inserts may be produced from polytetrafluoroethylene (PTFE or TEFLON®), polypropylene, polyethylene, styrene butadyene copolymers, of combinations thereof. Once formed, the polymer can be melted and extruded into thin strips or films.

In one non-limiting example, nylon or PTFE is mixed with a basic amino acid (or a salt thereof) and formed or extruded to form one or more filaments, strips or films. In the case of multiple filaments, strips or films, these are generally aligned to form the dental insert. Alternatively, one or more films or strips, such as PTFE, can be formed.

One or more active agents are then deposited onto the dental insert, as will be known to the skilled artisan. For example, the dental strip or film is treated in a bath comprising the one or more active agents. The bath may include one or more waxes that adhere to the strip or film, and thereby cause the one or more active agents to adhere to the strip or film. In one example, a dental strip or film comprising a nylon or a PTFE fiber is coated with the one or more active agents. A wax or polymer, e.g., such as polyvinyl alcohol, polyvinyl acetate, can be used to coat the one or more active agents in, or, or about the dental strip or film. See e.g., U.S. Pat. No. 6,289,904, which is incorporated herein by reference in its entirety for all purposes.

For JET devices with a filamentous floss, strip, or film, the antigen and/or allergen can be embedded into the bundle of thin filaments, e.g., nylon filaments, prior to the bundles being formed, while the bundles are formed, or even after they are formed. The bundles may then also be, optionally, coated with a wax or polymer. The number of filaments can be from about 2 to about 500, e.g., from about 2 to about 250, depending on the denier of the dental strip or film filaments. The dental strip or film filaments are often twisted with about 1 to 5 twists per inch to form the strip or film. The twisting provides integrity to the floss, strip, or film of the JET device when placed on a spool and/or during subsequent handling. For delivery, the floss, strip, or film of the JET device may spread out and splay against tooth surfaces at the JE of the gingiva, thereby delivering the one or more active agents. The floss, strip, or film of the JET device may also be formed of interlocking fibers or strips. The floss, strip, or film of the JET device may have a thickness that allows it to fit not only between the teeth, but to reach the JE of the gingiva. Where multiple filaments are used, the coating may be applied before and/or after twisting and generally after application of the one or more active agents. Other additives may be applied to the floss, strip, or film of the JET device to preserve the one or more active agents to achieve controlled release of the one or more active agents.

In addition, a flavor can be applied as a liquid or a solid to the JET device (e.g., floss-based, strip-based, and/or film-based). Flavors can be spray dried in liquid or solid form. When flavor is applied as a liquid, the floss, strip, or film of the JET device may be dried prior to being wound onto a spool. The drying can be air drying or drying until heat, after which the floss, strip, or film of the JET device is wound onto a spool.

### Active Agents

In embodiments, the present disclosure may describe techniques and devices for medicament and/or active agents delivery to a patient. As described herein, medicaments may include active agents/substances, etc. Herein, the description of a particular technique or device being used to deliver active agents/substances/active pharmaceutical ingredients (API) into the gingival crevice of a patient should not be construed as limiting in any way. Indeed, the techniques or devices described herein may be used to deliver any other type of medicament (as described herein) into the gingival crevice of a patient.

One or more of the following active agents may be combined with one or more carriers and the present invention (which may itself be the carrier).

As used herein, the term “active ingredient(s),” “pharmaceutical ingredient(s),” “active agents”, “active substances”, “active pharmaceutical ingredient(s)”, and “bioactive agent” are defined as drugs and/or pharmaceutically active ingredients. The present invention may be used to encapsulate, attach, bind or otherwise be used to affect the storage, stability, longevity and/or release of any of the following drugs as the pharmaceutically active agent in a composition.

Non-limiting examples of active agents include, but are not limited to, antibiotics, analgesics, vaccines, anticonvulsants; antidiabetic agents, antifungal agents, anti-inflammatory agents, antineoplastic agents, antiparkinsonian agents, antirheumatic agents, appetite suppressants, biological response modifiers, cardiovascular agents, central nervous system stimulants, contraceptive agents, dietary supplements, vitamins, minerals, lipids, saccharides, metals, amino acids (and precursors), nucleic acids and precursors, contrast agents, diagnostic agents, dopamine receptor agonists, erectile dysfunction agents, fertility agents, gastrointestinal agents, hormones, immunomodulators, antihypercalcemia agents, mast cell stabilizers, muscle relaxants, nutritional agents, ophthalmic agents, osteoporosis agents, psychotherapeutic agents, parasympathomimetic agents, parasympatholytic agents, respiratory agents, sedative hypnotic agents, skin and mucous membrane agents, smoking cessation agents, steroids, sympatholytic agents, urinary tract agents, uterine relaxants, vaginal agents, vasodilator, anti-hypertensive, hyperthyroids, anti-hyperthyroids, anti-asthmatics and vertigo agents. In certain embodiments, the one or more therapeutic compounds are water-soluble, poorly water-soluble drug or a drug with a low, medium or high melting point. The therapeutic compounds may be provided with or without a stabilizing salt or salts.

Antigens can include molecule(s) that can initiate a humoral and/or cellular immune response in a recipient of the antigen. Antigen may be used in different contexts with the present invention, for example, but not limited to: (1) as an agent to generate an immune response to prevent or treat a disease or condition for which a vaccination would be advantageous treatment, and/or (2) as an agent that anergizes an immune response, that is, it causes immune cells that have been activated to reduce their level of activation, and/or (3) as an agent to modulate the immune response to achieve a beneficial therapeutic effect in the subject. Antigens include any type of biologic molecule, including, for example, simple intermediary metabolites, sugars, lipids and hormones as well as macromolecules such as peptides, polypeptides, complex carbohydrates, phospholipids, nucleic acids and/or glycoproteins or combinations thereof. Common categories of antigens include, but are not limited to, viral antigens, bacterial antigens, fungal antigens, protozoal and other parasitic antigens, tumor antigens, and conversely, antigens involved in autoimmune disease, allergy and graft rejection, and other miscellaneous antigens.

Examples of viral antigens disclosed herein include, e.g., retroviral antigens such as retroviral antigens from the human immunodeficiency virus (HIV) antigens such as gene products of the gag, pol, and env genes, the Nef protein, reverse transcriptase, and other HIV components; coronavirus antigens such as spike protein, nucleoprotein, messenger RNA (mRNA); hepatitis viral antigens such as the S, M, and L proteins of hepatitis B virus, the pre-S antigen of hepatitis B virus, and other hepatitis, e.g., hepatitis A, B, and C, viral components such as hepatitis C viral RNA; influenza viral antigens such as hemagglutinin and neuraminidase and other influenza viral components; measles viral antigens such as the measles virus fusion protein and other measles virus components; rubella viral antigens such as proteins E1 and E2 and other rubella virus components; rotaviral antigens and other rotaviral components; cytomegaloviral antigens such as envelope glycoprotein B and other cytomegaloviral antigen components; respiratory syncytial viral antigens such as the RSV fusion protein, the M2 protein and other respiratory syncytial viral antigen components; herpes simplex viral antigens such as immediate early proteins, glycoprotein D, and other herpes simplex viral antigen components; varicella zoster viral antigens such as gpI, gpII, and other varicella zoster viral antigen components; Japanese encephalitis viral antigens such as proteins E, M-E, M-E-NS1, NS1, NS1-NS2A, 80% E, and other Japanese encephalitis viral antigen components; rabies viral antigens such as rabies glycoprotein, rabies nucleoprotein and other rabies viral antigen components, west nile virus; yellow fever; tularemia; hepatitis (viral; bacterial); RSV (respiratory syncytial virus); HPIV 1 and HPIV 3; adenovirus; small pox (See Fundamental Virology, Second Edition, eds. Fields, B. N. and Knipe, D. M. (Raven Press, New York, 1991)) for additional examples of viral antigens, relevant portions incorporated herein by reference.

Other examples of antigens include whole, heat-killed, or portions, thereof, including picornavirus, coronavirus, togavirus, flavivirus, rhabdovirus, paramyxovirus, orthomyxovirus, bunyavirus, arenavirus, reovirus, retrovirus, papillomavirus, parvovirus, herpesvirus, poxvirus, hepadnavirus, spongiform virus, influenza, herpes simplex virus 1 and 2, measles, dengue, smallpox, polio or HIV. Other antigens may be against pathogens such as trypanosomes, tapeworms, roundworms, helminths, malaria. Specific examples of organisms, allergens and nucleic and amino sequences for use in vectors and ultimately as antigens with the present invention may be found in U.S. Pat. No. 6,541,011, relevant portions incorporated herein by reference, in particular, the tables that match organisms and specific sequences that may be used with the present invention.

Examples of bacterial antigens disclosed herein include, e.g., bacterial antigens such as pertussis toxin, filamentous hemagglutinin, pertactin, adenylate cyclase and other pertussis bacterial antigen components; diphtheria bacterial antigens such as diphtheria toxin or toxoid and other diphtheria bacterial antigen components; tetanus bacterial antigens such as tetanus toxin or toxoid and other tetanus bacterial antigen components; streptococcal bacterial antigens such as M proteins and other streptococcal bacterial antigen components; gram-negative bacilli bacterial antigens such as lipopolysaccharides and other gram-negative bacterial antigen components, Mycobacterium tuberculosis bacterial antigens such as mycolic acid, heat shock protein 65 (HSP65), the 30 kDa major secreted protein, antigen 85A and other mycobacterial antigen components; Helicobacter pylori bacterial antigen components; pneumococcal bacterial antigens such as pneumolysin, pneumococcal capsular polysaccharides and other pneumococcal bacterial antigen components; Haemophilus influenza bacterial antigens such as capsular polysaccharides and other Haemophilus influenza bacterial antigen components; anthrax bacterial antigens such as anthrax protective antigen and other anthrax bacterial antigen components; rickettsiae bacterial antigens such as rompA and other rickettsiae bacterial antigen component. Also included with the bacterial antigens described herein are any other bacterial, mycobacterial, mycoplasmal, rickettsial, or chlamydial antigens, such as Neisseria meningitidis; Streptococcus pneumoniae; Neisseria gonorrhoeae; Salmonella serotype typhi; Shigella; Vibrio cholerae; Dengue Fever; Encephalitides; Japanese Encephalitis; lyme disease; Yersinia pestis.

Examples of fungal antigens for use with the present invention include, but are not limited to, e.g., Candida fungal antigen components; Histoplasma fungal antigens such as heat shock protein 60 (HSP60) and other Histoplasma fungal antigen components; cryptococcal fungal antigens such as capsular polysaccharides and other cryptococcal fungal antigen components; coccidiodes fungal antigens such as spherule antigens and other coccidiodes fungal antigen components; and tinea fungal antigens such as trichophytin and other coccidiodes fungal antigen components.

Examples of protozoal and other parasitic antigens for use with the present invention include, but are not limited to, e.g., Plasmodium falciparum antigens such as merozoite surface antigens, sporozoite surface antigens, circumsporozoite antigens, gametocyte/gamete surface antigens, blood-stage antigen pf 155/RESA and other plasmodial antigen components; toxoplasma antigens such as SAG-1, p30 and other toxoplasmal antigen components; schistosomae antigens such as glutathione-S-transferase, paramyosin, and other schistosomal antigen components; Leishmania major and other leishmaniae antigens such as gp63, lipophosphoglycan and its associated protein and other leishmanial antigen components; and Trypanosoma cruzi antigens such as the 75-77 kDa antigen, the 56 kDa antigen and other trypanosomal antigen components.

Examples of tumor antigens for use with the present invention include, but are not limited to, e.g., CEA, prostate specific antigen (PSA), HER-2/neu, BAGE, GAGE, MAGE 1-4, 6 and 12, MUC (Mucin) (e.g., MUC-1, MUC-2, etc.), GM2 and GD2 gangliosides, ras, myc, tyrosinase, MART (melanoma antigen), Pmel 17(gp 100), GnT-V intron V sequence (N-acetylglucoaminyltransferase V intron V sequence), Prostate Ca psm, PRAME (melanoma antigen), beta-catenin, MUM-1-B (melanoma ubiquitous mutated gene product), GAGE (melanoma antigen) 1, BAGE (melanoma antigen) 2-10, c-ERB2 (Her2/neu), EBNA (Epstein-Barr Virus nuclear antigen) 1-6, gp75, human papilloma virus (HPV) E6 and E7, p53, lung resistance protein (LRP), Bcl-2, and Ki-67. In addition, the immunogenic molecule can be an autoantigen involved in the initiation and/or propagation of an autoimmune disease, the pathology of which is largely due to the activity of antibodies specific for a molecule expressed by the relevant target organ, tissue, or cells, e.g., CII, SLE or MG. In such diseases, it can be desirable to direct an ongoing antibody-mediated (i.e., a Th1/Th17-type) immune response to the relevant autoantigen towards a cellular (i.e., a Th2-type) immune response. Alternatively, it can be desirable to prevent onset of or decrease the level of a Th1/17 response to the autoantigen in a subject not having, but who is suspected of being susceptible to, the relevant autoimmune disease by prophylactically inducing a Th2 response to the appropriate autoantigen. Autoantigens of interest include, without limitation: (a) with respect to SLE, the Smith protein, RNP ribonucleoprotein, and the SS-A and SS-B proteins; and (b) with respect to MG, the acetylcholine receptor. Examples of other miscellaneous antigens involved in one or more types of autoimmune response include, e.g., collagen type II protein/peptides, myelin oligodendrocyte glycoprotein (MOG), endogenous hormones such as luteinizing hormone, follicular stimulating hormone, testosterone, growth hormone, prolactin, and other hormones.

Example of antigens involved in autoimmune diseases, allergy, and graft rejection for use with the present invention include, but are not limited to, e.g., diabetes, diabetes mellitus, arthritis (including rheumatoid arthritis, juvenile rheumatoid arthritis, osteoarthritis, psoriatic arthritis), multiple sclerosis, myasthenia gravis, systemic lupus erythematosus, autoimmune thyroiditis, dermatitis (including atopic dermatitis and eczematous dermatitis), psoriasis, Sjogren's Syndrome, including keratoconjunctivitis sicca secondary to Sjogren's Syndrome, alopecia areata, allergic responses due to arthropod bite reactions, Crohn's disease, aphthous ulcer, iritis, conjunctivitis, keratoconjunctivitis, ulcerative colitis, asthma, allergic asthma, cutaneous lupus erythematosus, scleroderma, vaginitis, proctitis, drug eruptions, leprosy reversal reactions, erythema nodosum leprosum, autoimmune uveitis, allergic encephalomyelitis, acute necrotizing hemorrhagic encephalopathy, idiopathic bilateral progressive sensorineural hearing loss, aplastic anemia, pure red cell anemia, idiopathic thrombocytopenia, polychondritis, Wegener's granulomatosis, chronic active hepatitis, Stevens-Johnson syndrome, idiopathic sprue, lichen planus, Crohn's disease, Graves ophthalmopathy, sarcoidosis, primary biliary cirrhosis, uveitis posterior, and interstitial lung fibrosis. Examples of antigens involved in autoimmune disease include collagen type II, collagen type II peptide (CII250-270), proteoglycan, citrullinated peptide antigens, vimentin, fibrinogen, α-enolase, peptidyl arginine deiminase-4, insulin, islet antigen 2 (IA2), zinc transporter 8 (ZnT8), islet specific glucose-6-phosphatase catalytic subunit related protein (IGRP), chromogranin A (ChgA), islet amyloid polypeptide (IAPP), glutamic acid decarboxylase 65 (GAD 65), native DNA, myelin basic protein, myelin proteolipid protein, acetylcholine receptor components, thyroglobulin, and the thyroid stimulating hormone (TSH) receptor. Examples of antigens involved in allergy include pollen antigens such as Japanese cedar pollen antigens, ragweed pollen antigens, rye grass pollen antigens, insects derived antigens such as house dust mite (i.e, Der p1, Der p2, LTN-DP2-1, LTN-DPE-1), cockroach antigens (i.e., Bla g2), animal derived antigens such as feline antigens (i.e., Fel d1), dog antigens (i.e., Can f1), histocompatibility antigens, food allergens such as peanut antigens (Aral h1, Ara h2, Ara h3, Ara h6), milk antigens (i.e., Bos d11, Bos d4, Bos d6, Bos d8), egg protein (i.e., Gal d2, Gal d3, Gal d4), shrimp antigens (i.e., Tropomyosin), nuts (i.e., hazelnut Cor a 9, almond Pru du6), legumes (i.e., soybean Gly m6) and antibiotics such as penicillin, cephalosporins and other therapeutic drugs (such as insulin, epinephrine). Examples of antigens involved in graft rejection include antigenic components of the graft to be transplanted into the graft recipient such as heart, lung, liver, pancreas, kidney, and neural graft components. The antigen may be an altered peptide ligand useful in treating an autoimmune disease. The antigen can be crude or purified extract from the allergy-causing agent, such as extract from respiratory allergen (such as pollens, dust mite, insect and others), food allergens (such as peanut, cashew nut, walnut, soy, shellfish, and other), venom (such as bee venom) and other allergens.

Analgesic anti-inflammatory agents such as, acetaminophen, aspirin, salicylic acid, methyl salicylate, choline salicylate, glycol salicylate, 1-menthol, camphor, mefenamic acid, fluphenamic acid, indomethacin, diclofenac, alclofenac, ibuprofen, ketoprofen, naproxene, pranoprofen, fenoprofen, sulindac, fenbufen, clidanac, flurbiprofen, indoprofen, protizidic acid, fentiazac, tolmetin, tiaprofenic acid, bendazac, bufexamac, piroxicam, phenylbutazone, oxyphenbutazone, clofezone, pentazocine, mepirizole, and the like.

Drugs having an action on the central nervous system, for example sedatives, hypnotics, antianxiety agents, analgesics and anesthetics, such as, chloral, buprenorphine, naloxone, haloperidol, fluphenazine, pentobarbital, phenobarbital, secobarbital, amobarbital, cydobarbital, codeine, lidocaine, tetracaine, dyclonine, dibucaine, cocaine, procaine, mepivacaine, bupivacaine, etidocaine, prilocaine, benzocaine, fentanyl, nicotine, and the like.

Antihistaminics or antiallergic agents such as, diphenhydramine, dimenhydrinate, perphenazine, triprolidine, pyrilamine, chlorcyclizine, promethazine, carbinoxamine, tripelennamine, brompheniramine, hydroxyzine, cyclizine, meclizine, clorprenaline, terfenadine, chlorpheniramine, and the like. Anti-allergenics such as, antazoline, methapyrilene, chlorpheniramine, pyrilamine, pheniramine, and the like.

Decongestants such as phenylephrine, ephedrine, naphazoline, tetrahydrozoline, and the like.

Antipyretics such as aspirin, salicylamide, non-steroidal anti-inflammatory agents, and the like. Antimigraine agents such as, dihydroergotamine, pizotyline, and the like.

Acetonide anti-inflammatory agents, such as hydrocortisone, cortisone, dexamethasone, fluocinolone, triamcinolone, medrysone, prednisolone, flurandrenolide, prednisone, halcinonide, methylprednisolone, fludrocortisone, corticosterone, paramethasone, betamethasone, ibuprofen, naproxen, fenoprofen, fenbufen, flurbiprofen, indoprofen, ketoprofen, suprofen, indomethacin, piroxicam, aspirin, salicylic acid, diflunisal, methyl salicylate, phenylbutazone, sulindac, mefenamic acid, meclofenamate sodium, tolmetin, and the like.

Steroids such as, androgenic steroids, such as, testosterone, methyltestosterone, fluoxymesterone, estrogens such as, conjugated estrogens, esterified estrogens, estropipate, 17-f3 estradiol, 17-f3 estradiol valerate, equilin, mestranol, estrone, estriol, 17f3 ethinyl estradiol, diethylstilbestrol, progestational agents, such as, progesterone, 19-norprogesterone, norethindrone, norethindrone acetate, melengestrol, chlormadinone, ethisterone, medroxyprogesterone acetate, hydroxyprogesterone caproate, ethynodiol diacetate, norethynodrel, 17-α hydroxyprogesterone, dydrogesterone, dimethisterone, ethinylestrenol, norgestrel, demegestone, promegestone, megestrol acetate, and the like.

Respiratory agents such as, theophilline and f32-adrenergic agonists, such as, albuterol, terbutaline, metaproterenol, ritodrine, carbuterol, fenoterol, quinterenol, rimiterol, solmefamol, soterenol, tetroquinol, and the like.

Sympathomimetics such as, dopamine, norepinephrine, phenylpropanolamine, phenylephrine, pseudoephedrine, amphetamine, propylhexedrine, arecoline, and the like.

Local anesthetics such as, benzocaine, procaine, dibucaine, lidocaine, and the like.

Antimicrobial agents including antibacterial agents, antifungal agents, anti-inflammatory agents, antimycotic agents and antiviral agents; tetracyclines such as, oxytetracycline, penicillins, such as, ampicillin, cephalosporins such as, cefalotin, aminoglycosides, such as, kanamycin, macrolides such as, erythromycin, chloramphenicol, iodides, nitrofrantoin, nystatin, amphotericin, fradiomycin, sulfonamides, purrolnitrin, clotrimazole, miconazole chloramphenicol, sulfacetamide, sulfamethazine, sulfadiazine, sulfamerazine, sulfamethizole and sulfisoxazole; antivirals, including idoxuridine; clarithromycin; and other anti-infectives including nitrofurazone, and the like.

Antihypertensive agents such as, clonidine, α-methyldopa, reserpine, syrosingopine, rescinnamine, cinnarizine, hydrazine, prazosin, and the like. Antihypertensive diuretics such as, chlorothiazide, hydrochlorothrazide, bendoflumethazide, trichlormethiazide, furosemide, tripamide, methylclothiazide, penfluzide, hydrothiazide, spironolactone, metolazone, and the like. Cardiotonics such as, digitalis, ubidecarenone, dopamine, and the like. Coronary vasodilators such as, organic nitrates such as, nitroglycerine, isosorbitol dinitrate, erythritol tetranitrate, and pentaerythritol tetranitrate, dipyridamole, dilazep, trapidil, trimetazidine, and the like. Vasoconstrictors such as, dihydroergotamine, dihydroergotoxine, and the like. f3-blockers or antiarrhythmic agents such as, timolol pindolol, propranolol, and the like. Humoral agents such as, the prostaglandins, natural and synthetic, for example PGE1, PGE2α, and PGF2α, and the PGE1 analog misoprostol. Antispasmodics such as, atropine, methantheline, papaverine, cinnamedrine, methscopolamine, and the like.

Calcium antagonists and other circulatory organ agents, such as, aptopril, diltiazem, nifedipine, nicardipine, verapamil, bencyclane, ifenprodil tartarate, molsidomine, clonidine, prazosin, and the like. Anti-convulsants such as, nitrazepam, meprobamate, phenytoin, and the like. Agents for dizziness such as, isoprenaline, betahistine, scopolamine, and the like. Tranquilizers such as, reserprine, chlorpromazine, and antianxiety benzodiazepines such as, alprazolam, chlordiazepoxide, clorazeptate, halazepam, oxazepam, prazepam, clonazepam, flurazepam, triazolam, lorazepam, diazepam, and the like.

Antipsychotics such as, phenothiazines including thiopropazate, chlorpromazine, triflupromazine, mesoridazine, piperacetazine, thioridazine, acetophenazine, fluphenazine, perphenazine, trifluoperazine, and other major tranquilizers such as, chlorprothixene, thiothixene, haloperidol, bromperidol, loxapine, and molindone, as well as, those agents used at lower doses in the treatment of nausea, vomiting, and the like.

Muscle relaxants such as, tolperisone, baclofen, dantrolene sodium, cyclobenzaprine.

Drugs for Parkinson's disease, spasticity, and acute muscle spasms such as levodopa, carbidopa, amantadine, apomorphine, bromocriptine, selegiline (deprenyl), trihexyphenidyl hydrochloride, benztropine mesylate, procyclidine hydrochloride, baclofen, diazepam, dantrolene, and the like. Respiratory agents such as, codeine, ephedrine, isoproterenol, dextromethorphan, orciprenaline, ipratropium bromide, cromglycic acid, and the like. Non-steroidal hormones or antihormones such as, corticotropin, oxytocin, vasopressin, salivary hormone, thyroid hormone, adrenal hormone, kallikrein, insulin, oxendolone, and the like.

Vitamins such as, vitamins A, B, C, D, E and K and derivatives thereof, calciferols, mecobalamin, and the like for dermatologically use. Enzymes such as, lysozyme, urokinase, and the like. Herb medicines or crude extracts such as, Aloe vera, and the like.

Antitumor agents such as, 5-fluorouracil and derivatives thereof, krestin, picibanil, ancitabine, cytarabine, and the like. Anti-estrogen or anti-hormone agents such as, tamoxifen or human chorionic gonadotropin, and the like. Miotics such as pilocarpine, and the like.

Cholinergic agonists such as, choline, acetylcholine, methacholine, carbachol, bethanechol, pilocarpine, muscarine, arecoline, and the like. Antimuscarinic or muscarinic cholinergic blocking agents such as, atropine, scopolamine, homatropine, methscopolamine, homatropine methylbromide, methantheline, cyclopentolate, tropicamide, propantheline, anisotropine, dicyclomine, eucatropine, and the like.

Mydriatics such as, atropine, cyclopentolate, homatropine, scopolamine, tropicamide, eucatropine, hydroxyamphetamine, and the like. Psychic energizers such as 3-(2-aminopropy)indole, 3-(2-aminobutyl)indole, and the like.

Antidepressant drugs such as, isocarboxazid, phenelzine, tranylcypromine, imipramine, amitriptyline, trimipramine, doxepin, desipramine, nortriptyline, protriptyline, amoxapine, maprotiline, trazodone, and the like.

Anti-diabetics such as, insulin, and anticancer drugs such as, tamoxifen, methotrexate, and the like.

Anorectic drugs such as, dextroamphetamine, methamphetamine, phenylpropanolamine, fenfluramine, diethylpropion, mazindol, phentermine, and the like.

Anti-malarials such as, the 4-aminoquinolines, alphaaminoquinolines, chloroquine, pyrimethamine, and the like.

Anti-ulcerative agents such as, misoprostol, omeprazole, enprostil, and the like.

Antiulcer agents such as, allantoin, aldioxa, alcloxa, N-methylscopolamine methylsuflate, and the like. Antidiabetics such as insulin, and the like.

For use with vaccines, one or more antigens, such as, natural, heat-killed, inactivated, synthetic, peptides and even T cell epitopes (e.g., GADE, DAGE, MAGE, etc.) and the like.

The drugs mentioned above may be used in combination as required. Moreover, the above drugs may be used either in the free form or, if capable of forming salts, in the form of a salt with a suitable acid or base. If the drugs have a carboxyl group, their esters may be employed.

The acid mentioned above may be an organic acid, for example, methanesulfonic acid, lactic acid, tartaric acid, fumaric acid, maleic acid, acetic acid, or an inorganic acid, for example, hydrochloric acid, hydrobromic acid, phosphoric acid or sulfuric acid. The base may be an organic base, for example, ammonia, triethylamine, or an inorganic base, for example, sodium hydroxide or potassium hydroxide. The esters mentioned above may be alkyl esters, aryl esters, aralkyl esters, and the like.

When a drug different than an anesthetic agent is used the solvent selected is one in that the drug is soluble. In generally the polyhydric alcohol may be used as a solvent for a wide variety of drugs. Other useful solvents are those known to solubilize the drugs in question.

The active agent can also include nutrients, micronutrients, vitamins and minerals, such as, e.g., any substance that provides nourishment essential for growth and maintenance of life, including but not limited to, one or more of iron, phosphorous, zinc, thiamine, riboflavin, niacin, vitamin B6, folate, vitamin, B12, pantothenic acid, biotin, boron, choline, chromium, copper, manganese, selenium, molybdenum, iodine, coenzyme Q10 (CoQ10), vitamin A, calcium, potassium, magnesium, vitamin E, vitamin C, a carotenoid, vitamin D, or vitamin K. Other examples of nutrients are proteins, amino acids, lipids, carbohydrates, nucleic acids or their physical or chemical combinations. These can be as pure substances or mixtures or extracts from natural sources.

As used herein, the terms “deposit,” “depot”, “deposition” refer to the placing in the form of one or more deposits of the active agent that are separated by a space from adjacent deposit(s) onto a floss, strip, or film of a JET device.

As used herein, the term “epitope(s)” refer(s) to a peptide or protein antigen that includes a primary, secondary or tertiary structure similar to an epitope located within any of a number of pathogen polypeptides encoded by the pathogen DNA or RNA, and/or allergen that is immunogenic.

The antigen(s) and/or epitopes(s) are not limited to peptides, proteins and portions thereof, but can include genes, plasmids, vectors (viral, bacterial and non viral), DNA, RNA, CRISPR molecules, mRNA, siRNA, or other nucleotides either individually or in combination. Pharmaceutically acceptable carriers and formulations maybe used to stabilize these molecules or to enhance their function or to offer controlled release.

As used herein, the term “pharmaceutically acceptable carrier” refers to a carrier that does not cause an untoward effect in subjects (e.g., human beings and pets (such as dog, cat, cows, pigs or other domesticated animals or even non-domesticated animals) to whom it is administered. Suitable pharmaceutically acceptable carriers include, for example, one or more of water, saline, phosphate buffered saline, dextrose, glycerol, ethanol, dimethyl sulfoxide, or the like and combinations thereof. In addition, if desired, the immunization/vaccine can contain minor amounts of auxiliary substances such as wetting or emulsifying agents, pH buffering agents, and/or adjuvants which enhance the effectiveness of the vaccine.

Non-limiting examples of adjuvants that may be effective include but are not limited to: aluminum hydroxide, N-acetyl-muramyl-L-threonyl-D-isoglutamine (thr-MDP), N-acetyl-nor-muramyl-L-alanyl-D-isoglutamine, MTP-PE and RIBI, which contains three components extracted from bacteria, monophosphoryl lipid A, trehalose dimycolate and cell wall skeleton in, e.g., a 2% squalene/Tween 80 emulsion. STING agonists (e.g., 2′3′-cGAMP, c-di-AMP, 2′3′-c-di-AM(PS)2 (Rp,RP), c-di-GMP, CL401, CL413, CL429, Flagellin, Imiquimod, LPS-EB, MPLA, ODN 1585, ODN 1826, ODN2006, ODN2395, ODN 1018, pam3CSK4, poly(J:C), R848, TDB), Other examples of adjuvants include DDA (dimethyldioctadecylammonium bromide), Freund's complete, incomplete adjuvants, QuilA, natural polymer (i.e., poly-7-glutamic acid, chitosan, mannan, lipomannan, lentinan, dextran), synthetic polymer (i.e, poly-N-isopropylacryalmide, copolymers, block polymers, polyphosphazenes, polyelectrolytes, polyanhydrides, polymethacrylates, polyglycolic-co-lactide, polycaprolactones, polyvinylpyrrolidone, cationic polymers). In addition, immune modulating substances such as lymphokines (e.g., IFN-gamma, IL-2 and IL-12) or synthetic IFN-gamma. inducers such as poly I:C can be used in combination with adjuvants described herein.

As used herein, the term “subject” refers to human beings, pets (such as dog, cat, cows, sheep, goats, horses, rabbits, or pigs) or other domesticated animals, or non-domesticated animals such as deer, buffalo, or wild horses.

The junctional epithelium (JE) is located at the bottom of the gingival crevice, which is 1-2 mm deep in healthy gums. Furthermore, the apical tissue of the gingival cavity tightly hugs the teeth, allowing only thin instruments measuring less than 1 mm and preferably less than 500 μm to enter the cavity Thus, administration of material into the gingival crevice is not trivial. To overcome this challenge, the present invention uses an antigen and/or allergen deposited onto a JET device (e.g., floss-based, strip-based, and/or film-based). Typical dental floss may be used by millions of people daily to clean their gingival crevices, and the present disclosure describes a system that may be coated with the antigen/allergen for targeted deposition into the gingival crevice for uptake through the JE. A JET device configuration including floss, strip, or film offers additional benefits of being non-invasive, painless, and possible self-administration in the comfort of home. The JET device configuration including floss, strip, or film should be taken as a non-limiting example of a system with the final goal of delivering material to the JE. Other approaches based on the principle of enabling and allowing devices to enter the gingival crevice to help target the JE such as tapes, films, strips, strings, arms, threads, sutures, gels, hydrogels, polymers, viscous materials, particles or combinations thereof are included in this invention. These systems and devices maybe inserted into the gingival crevice, but may also be placed at the apical aspect of the gingival crevice rather than in to the crevice, and the molecule(s) of interest may then diffuse from the systems and devices into the gingival crevice and ultimately to JE for permeation into the tissues. These systems that are placed on the apical side of the gingival crevice maybe designed such that they maximize diffusion of molecules into the gingival crevice, but minimize their loss outward and into the general oral cavity. In one such approach the delivery system can be coated with an impermeable layer on the side that faces opposite to the gingival crevice. It is noted that although the present disclosure highlights the JET device with a floss, strip, or film, this is not intended to be limiting, and the functionality and features discussed herein may also apply to a JET device with one or more of tapes, films, strips, strings, arms, threads, sutures, gels, hydrogels, polymers, viscous materials, particles or combinations thereof.

Development of a new paradigm for peanut allergen immunotherapy. The mouth is the first place where food makes contact with the body, and the chewed food particles have the potential to enter the gingival crevice and subsequently the tissues through the JE. It is thus not surprising that the immune network in the gingiva may have a major role in maintaining tolerance. Indeed, proof-of-concept study using the coated JET device (e.g., floss-based, strip-based, and/or film-based) for peanut allergen immunotherapy decreased sensitization. This approach provides for the rapid development of allergen immunotherapy for peanut and other food allergens. A JET device (e.g., floss-based, strip-based, and/or film-based) can also be used for, e.g., peanut allergen immunotherapy by targeting JE. The dose of peanut allergen, frequency of flossing, use of adjuvants, use of particles to enhance phagocytosis and antigen processing, and delayed release coatings can be optimized using the present invention.

Administration into the gingival crevice can only be done after tooth eruption, which in humans occurs at 6-12 months. While the proposed paradigm may not become a mainstay in childhood vaccines until an infant is about 1 year old, the amplified immune responses resulting from the new paradigm will certainly impact and inform vaccine development, which could help cancer and HIV vaccines, and offer superior treatment for allergies, which are treated later in life for safety, and autoimmune diseases, which often appear late in life.

Methods for deposits on JET device (e.g., floss-based, strip-based, and/or film-based).

The compositions and methods of the present invention address coating of any molecule in a simple manner through fluid dispensing. The method can be used to coat one or more active agents, molecules on the specific length of the floss, strip, or film of the JET device, specific surfaces of the floss, strip, or film of the JET device, and even at a discrete location. Also, the method can be used to coat both sides if needed.

The present invention provides a novel way to coat a JET device (e.g., floss-based, strip-based, and/or film-based). A substance (for example a synthetic molecule or polymer, amino acid or its polymer, nucleotide or its polymer, lipids, carbohydrates, natural material, antigen/allergen/adjuvant/drug/combinations thereof) can be coated on surface of the floss, strip, or film of the JET device for its delivery into the gingival crevice. The delivery may have any intended use for example to modulate immune response, systemic effect, or local effect. Surface of the floss, strip, or film of the JET device can be coated by depositing the biologics (the deposition process deposits on a single contiguous portion of the floss, strip, or film, of the JET device or on two or more discrete portions of the floss, strip, or film of the JET device with same or different spacing between the each deposited region) over a shorter or a longer distance/length of floss, strip, or film of the JET device (the deposition process comprises placing liquid drops on the floss, strip, or film, of the JET device or dragging the liquid drop(s) on the floss, strip, or film of the JET device to spread it over a certain distance/length on the floss, strip, or film of the JET device using a pipette, or spray coating, or ink jet printing, or pipette based coating, or cartridge printing, or 3D printing, or a combination thereof), and letting the coating to dry. To substantiate the current invention, the inventors have shown effectiveness and proof-of-concept using antigens, allergens, peptides, micro-particles, nano-particles, single stranded deoxyribonucleic acid (DNA). Varying amounts of the biologics can be coated on the surface of the floss, strip, or film of the JET device. The coated material can be easily delivered into the gum tissue by a simple action of flossing.

For the purpose of medical application using a coated JET device (e.g., floss-based, strip-based, and/or film-based), it is important to have the following properties: (a) the coating should be consistent over the short length of the coated floss, strip, or film of the JET device to enable consistent delivery into the gingival crevice by the user; (b) known amounts of formulations should be coated on the JET device (e.g., floss-based, strip-based, and/or film-based); and/or (c) The coating should stay adhered to the surface until intended use.

Floss, strip, or film of the JET device of embodiments can be made of material that is hydrophobic (such as TEFLON® or NYLON®) or hydrophilic, depending on the active agent(s), and it is difficult to wet these surfaces using a coating solution. Because of poor wetting, continuous and uniform coatings are difficult to achieve on the floss, strip, or film of the JET device. While many different solvents can be used to make the coating solution, water is preferred for biological material that must be coated on the JET device (e.g., floss-based, strip-based, and/or film-based), and water-based coating solutions are even harder to coat on the JET device (e.g., floss-based, strip-based, and/or film-based). However, non-aqueous solutions can also be used with the present invention in which the active agent is in a solvent that is not soluble in water (or partially soluble) and the active agent is deposited onto the JET device (e.g., floss-based, strip-based, and/or film-based), and the solvent is evaporated leaving the active agent.

Instead of making a continuous coating, discrete drops of liquid can be deposited on the surface of the JET device (e.g., floss-based, strip-based, and/or film-based). By doing so, there is less need to uniformly spread the coating across a length, and reproducible coatings and patterns can be achieved. (1) Drops can be placed on the floss, strip, or film of the JET device using fluid dispensing systems (manual or automated or their combinations). For proof of concept, manual dispensing was done. (2) The surface of the floss, strip, or film of the JET device may be made hydrophilic (for example by coating with a hydrophilic polymer, or for example by oxygen plasma treatment, or other conventional surface treatment approaches that can change the surface energy of the surface of the floss, strip, or film of the JET device to better allow for the spreading of the coating liquid. (3) Place the coating liquid on the surface of the floss, strip, or film of the JET device. After a certain period and after sufficient solvent has evaporated, the liquid on the floss, strip, or film of the JET device can be mechanically spread. After some solvent has evaporated, the viscosity of the coating liquid increases, and the ability to spread it over the floss, strip, or film of the JET device improves.

Advantages of using dispensing system (manual, automated, or a combination thereof) for depositing the JET device (e.g., floss-based, strip-based, and/or film-based): (1) lesser loss of depositing formulation as compared to spray/dip coating; (2) depositing of a precise amount; (3) depositing of multiple deposited formulations; and/or (4) surface modification of the floss, strip, or film of the JET device can be avoided since even water-based solutions can be deposited as drops to create uniform patterns.

Spray or dip coating can lead to wastage of material. In contrast, use of depositing into discrete deposits on the surface of the floss, strip, or film of the JET device leads to almost none to minimal loss of material. With depositing on the floss, strip, or film of the JET device, precise control (for example if the goal is to deposit a small spot say less than 1 mm in length/diameter of the floss, strip, or film of the JET device) is difficult to achieve. However, with fluid dispensing, even nanoliter to picoliter amounts can be simply deposited on the floss, strip, or film of the JET device at known and precise locations. With fluid dispensing, it is straightforward to also deposit different material(s) with a small gap between the different deposited spots. This level of accuracy and precision is difficult with spray/dip coating. The approach could be used to develop and build depositing devices, which may be placed in pharmacies, homes, or clinician offices. Furthermore, using the proposed invention, active agent with a different solvent requirement for solubility (for example, one active agent, an antigen, with water as a solvent whereas the other active agent, an adjuvant, with organic solvent requirement) can be deposited on floss, strip, or film of the JET device.

A pipette tip can be used to manually coat the JET device (e.g., floss-based, strip-based, and/or film-based) using a solution containing the active agent(s). To increase reproducibility of coating and to increase delivery efficiency, an automated coating approach using computer-controlled linear stages and fluid dispensing systems can be used. A coater can be used to coat a specific length of the floss, strip, or film of the JET device with any active agent by simply switching out a coating liquid vial. Other options for coating include dip-coating, or spray coating, or ink jet printing, or pipette based coating, or cartridge printing, or 3D printing, or a combination thereof. The coating may require excipients such as thickening agents or surface tension reducing agents to improve coating and delivery efficiency. Additionally, to improve stability of molecules, trehalose and other substances known for protecting molecules from desiccating forces can be used. Viral particles can be coated, thus it is possible to coat nanoparticles and microparticles since these might enhance the immune responses. Delivery efficiencies can be evaluated, and imaging can be used to characterize the coatings.

FIG. 1 depicts a cross sectional view of the disintegrating JET device being placed in a gingival crevice, its subsequent disintegration, and release of active substance (AS) in the gingival crevice. The JET is formed with an active substance (AS).

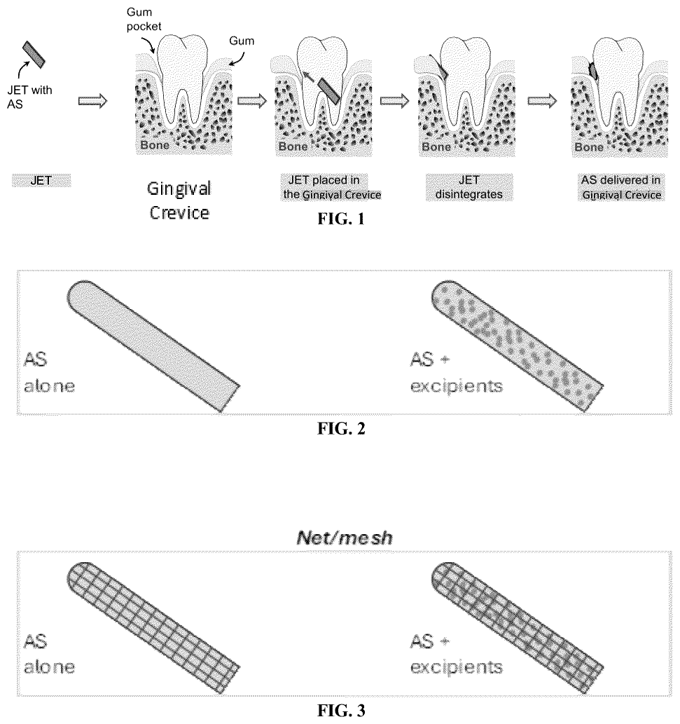

FIG. 2 depicts a disintegrating JET made purely out of AS (LEFT) and with AS mixed with excipients (RIGHT).

FIG. 3 depicts a disintegrating JET reinforced with a mesh/net, and containing AS alone (LEFT) or AS mixed with excipients (RIGHT).

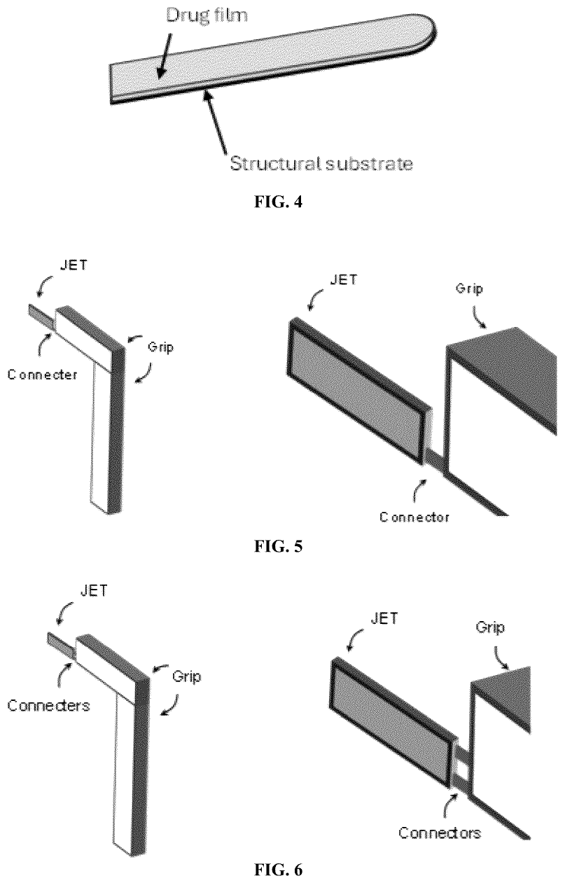

FIG. 4 depicts a disintegrating JET reinforced with structural support substrate.

FIG. 5 depicts a disintegrating JET attached to a grip with a single short connector. LEFT: JET+grip assembly, and RIGHT: Zoom up of the JET-connecter-grip joint. While shown as generally perpendicular, the grip and the disintegrating JET can be at any angle that enhances the efficiency of deposition of the active agent, enhances the convenience for the user, or both.

FIG. 6 depicts a disintegrating JET attached to a grip with two short connectors. LEFT: JET+grip assembly, and RIGHT: Zoom up of the JET-connecter-grip joint.

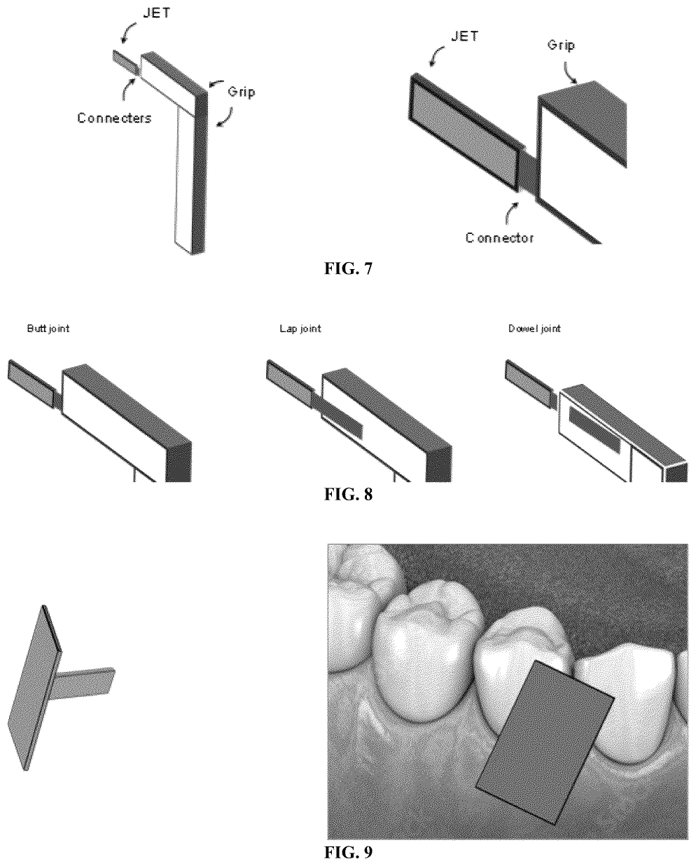

FIG. 7 depicts a disintegrating JET attached to a grip with single wide connector. LEFT: JET+grip assembly, and RIGHT: Zoom up of the JET-connecter-grip joint.

FIG. 8 depicts a disintegrating JET attached to a grip through different joints. LEFT: Butt joint, MIDDLE: Lap joint, RIGHT: Dowel joint.

FIG. 9, LEFT: depicts a disintegrable JET attached to a mucoadhesive film; RIGHT: mucoadhesive film attaches to teeth/gingiva and secures the JET in the gingival crevice.

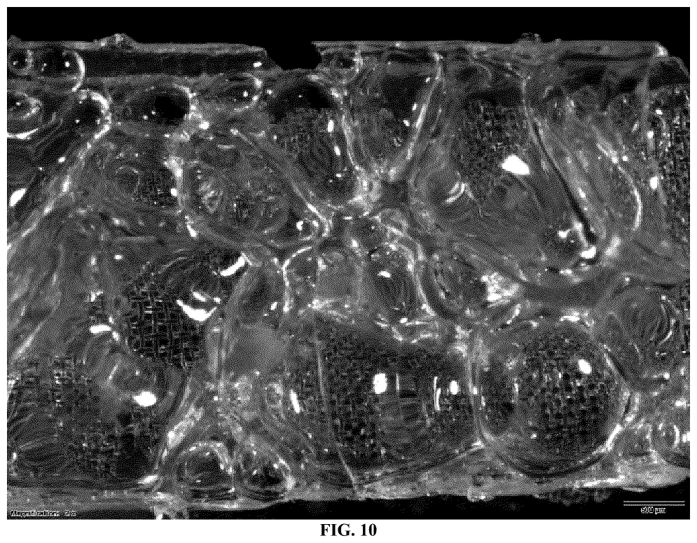

FIG. 10 depicts a film made of poly(lactic-co-glycolic acid) containing yellow colored substance as a model drug. The film was made using solvent casting into a mold.

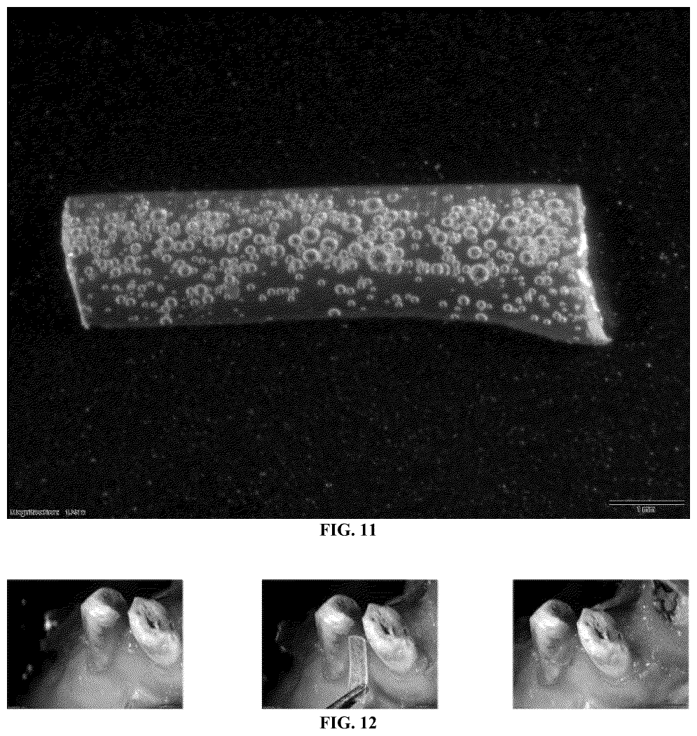

FIG. 11 depicts a film made of aqueous solutions of 10% polyvinyl alcohol, 10% polyvinyl pyrrolidone and, 10% glycerin (% w/w). Solvent casting process was used with molds made of polydimethyl siloxane. Sodium fluorescein was added as a model fluorescent dye to simulate a hydrophilic active substance.

FIG. 12 depicts a film made of aqueous solutions of 10% polyvinyl alcohol, 10% polyvinyl pyrrolidone and, 10% glycerin (% w/w) applied to gingival crevice of a pig cadaver jaw. LEFT: Before application, MIDDLE: during application; and RIGHT: after application.

### Example 1: Pocketed Junctional Epithelium Targeter

The disclosure includes coated and/or encapsulating films or strips for delivering the active substance into the gingival crevice. The present invention solves various problems, including, without limitation, the following two problems.

First, a liquid or a soft gel coating made on top of a solid film/strip cannot be effectively delivered into the gingival crevice. This is because when the film/strip with a coating of a liquid film or gel film on its surface is inserted into the gingival crevice, the liquid or gel will get wiped away and will not enter the gingival crevice effectively.

Second, an encapsulating film/strip could be formulated to deliver the liquid or soft gel. However, to achieve this, the liquid/soft gel must be converted into a mechanically stable solid film/strip such that it can be inserted into the gingival crevice. The encapsulated film/strip cannot be too brittle and must present sufficient cohesion to allow it to be handled during packaging/manufacturing and during use. While through experimentation such a system could be created, each time the amount of the liquid/gel to be delivered is changed or a new type of liquid/gel is to be delivered, a new iterative experimentation will be required all over again to develop the encapsulating film.

To overcome this problem, this invention provides an innovative solution by providing pockets in a mechanically strong film/strip. The material of the film/strip has the required characteristics to allow its handling during manufacturing and use in the gingival crevice. Using the same material, pockets are hollowed out in the film/strip, and the one or more pockets can be filled with liquid or soft gel. Since the liquid and soft gel has a safe cavity to sit into and does not protrude from the surface of the film/strip, the liquid and the soft gel will largely be protected from getting wiped away when the one or more filled pocketed device is inserted into the gingival crevice. In this manner, the same base film material can be reused to deliver different liquids/soft gels and in different amounts, without having to reformulate the entire delivery system.

The advantage of this new delivery system is that not only can it deliver liquids and soft gels, but the pockets can also be filled with coatings. In other words, while the pockets can be filled with formulations that remain in liquid or soft gel state, they can also be filled with a liquid formulation wherein the solvent evaporates from the solution leaving behind a solid dosage form in the pocket. The pockets can also be filled with hydrogels or swellable materials for drug release. Additionally, sensors can be filled into the pockets for sensing applications. By simultaneously integrating drug and sensor, the pocketed JET could be used in theranostic applications.

Since the mechanical property is dictated by the base material used to create the film/strip/arm/etc., of the JET device, wherein the pockets are created, the device can accommodate dosage forms with a broad range of properties. For example, the pockets can be filled with solids, liquids, gels, slurries, particles, nanoparticles, microparticles, liposomes, solid lipid nanoparticles, hydrogels, swellable materials, crosslinked polymers, or combinations of these embodiments.

In one embodiment the pockets are filled with dissimilar liquids, which when mixed forms a gel/solid in the gingival crevice. The active substance can be added to one of the liquids, and the substance can then get trapped in the formed gel/solid. Examples include (i) Substances including but not limited to butyl and octyl cyanoacrylate blends that will rapidly polymerize and solidify in situ when in contact with moisture, (ii) Hydrogel forming substances and polymers like polyvinyl alcohol and polyethylene glycol that can be chemically modified to gel in response to moisture, (iii) Thermoplastic polymers like polyvinyl pyrrolidone and other thermos-reversible gelation agents that can be formulated as liquids and will undergo phase transition to in response to moisture or temperature (iv) Polysaccharide formulations, such as chitosan, that will form gels when interacting with ions such as calcium found in saliva.

In another embodiment one pocket can be filled with liquid, another with solid and another with gel.

In one embodiment different pockets can each be filled with different medicaments and others with different adjuvant(s).

The base material for forming the pocketed JET is a polymer, metal, composite, biodegradable material, GRAS material or combination thereof. Preferably it is a safe material that can be ingested or dissolves/degrades/disintegrates after placing in gingival crevice. Degradation can start at same time as the substance carried in pockets is released or it can start after pockets have delivered the material. For example, the material can be selected from polymers such as polylactic acid, poly glycolic acid, poly(lactic-co-glycolic acid), polycaprolactone. Water soluble materials such as sugars, polyethylene glycol, polyvinyl pyrrolidone can be composited into the polymer to accelerate dissolution/disintegration of the JET.

To achieve delivery of the cargo from the pocketed delivery system, it can either be moved back-and-forth in the gingival crevice using the moist environment and friction for release of the cargo, or it can be left in place in the gingival crevice for disintegration and dissolution of the cargo over time. The time of release can be few seconds to minutes to hours to days.

In one embodiment the pocket can be filled with swellable material for release of active substance. Pockets can be filled with medicament (e.g., including cells, bacteria, viruses, active agents, or their combinations) in either dry form or after suspending in a suitable liquid of choice. Numerous shapes of pockets can be created including but not limited to circles, polygons, stars, free form shapes or combinations. The pockets can be interconnected with channels.

One or more pockets can be created. The one or more pockets can all be filled with the same substance, or they can be filled with one or more different active agent(s). The one or more pockets can be of same shape or different shapes. For example, the different pockets can each hold a different medicament (e.g., a different vaccine or allergen or active agent, etc.). For example, the different pockets can each hold different adjuvants, antigens and/or allergens. For example, the different pockets can hold different antibiotics or analgesics for local action. For example, the different pockets can hold different vitamin(s).

The pocket depth can be tuned from around 10%, 20%, 30%, 40%, 50%, 60%, 70%, 80%, 90% or 100% of the thickness of the film/strip/arm/etc., of the JET device into which one or more pockets is/are created. The multiple pockets in the film/strip/arm/etc., of the JET device can be created to different depths. For example, one pocket depth can be 100% of the thickness while the other can be at 20% of the thickness of the film/strip/arm/etc., of the JET device. While creating pockets, the proportion of the material carved out can be 10%, 20%, 30%, 40%, 50%, 60%, 70%, 80%, 90% or close to 100%. However, the remaining solid piece can still perform the function of holding the liquid and other forms of the active substance and has sufficient mechanical strength for ease of handling and insertion into gingival crevice. In one embodiment significant sections are carved out leaving behind structural members sufficient to support the frame. In one embodiment, just the exterior frame can be left and an external net or mesh is incorporated into a frame. The net or mesh openings serve as the pockets. Besides providing the pockets, the net or mesh can provide structural reinforcement to the frame.

The pocket after it is filled can be covered with another layer to offer additional protection to the cargo during storage or during use or both and/or to control the release rate.

A pocket created to less than 100% of the depth of the delivery device offers a unique possibility of filling with liquid because the liquid is safely secured on all sides except through the open side.

The device that contains pockets can assume any suitable shape including but not limited to flat surface, wedged shape, cylindrical shape, tapered cylindrical shape, bullet shape, parabolic shape or combinations thereof.

The active substance for delivery can be intended for local action or for systemic action. Examples of local action without limitation include treatment of local bacterial infection causing gum diseases such as gingivitis and/or periodontitis, or for action on local cells of the surrounding gingiva for treatment of pain, or tissue regeneration.

The JET must possess sufficient mechanical strength to allow it to be handled and inserted into the gingival crevice. To improve the JET's retention within the gingival crevice post-placement, its shape can be engineered to wedge it in the gingival crevice. The shape can be a wedge shape, a cone, a frustum, bullet shape, cylindrical, etc. To improve the JET's retention within the gingival crevice post-placement, mucoadhesive substances can be incorporated. For example, multiple pockets can be created in a single JET. Of the multiple pockets, some can hold the active substance and some can hold the mucoadhesive substance. To improve the JET's retention within the gingival crevice post-placement a combination of shape-design and mucoadhesives can be used.

The JET can be placed into the gingival crevice by itself or it can be attached to a grip for ease of handling. In one embodiment the JET is attached to the grip via a structural element that weakens upon contact with fluid and either quickly dissolves or the user can break the element to allow the JET to be retained in the gingival crevice. In another embodiment, the joining element is not affected by the fluid in the mouth and the user can still break it.

The JET can be attached to the grip using different joint types including and not limited to butt joint, lap joint, mortise and tenon joint, dado joint, tongue and groove joint, half-lap joint. Glue, hot melt, solvent melting, and other approaches of joining can be employed.

In another embodiment, the pocketed JET is attached to a mucoadhesive film. The mucoadhesive film sticks to the gingiva and/or teeth or both holding the inserted pocketed JET in place.

The JET, the disintegration JET, and swellable JET are included by reference since the pockets can be filled with coating solution or disintegrating systems can be formed in the pockets, or the swellable systems can be formed in the pockets.

The active substance is selected from the group consisting of vaccines, allergens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, antibiotics, antifungal agents, anti-inflammatory agents, insulin, antibodies, semaglutide, DNA, RNA, siRNA, and mRNA, antibodies, natural peptides, synthetic peptides, peptides with modified amino acids and substitutions, peptides with non-natural amino acids, natural proteins, recombinant proteins, proteins with modified amino acids and non-natural amino acids, or combinations thereof.

A pocket can be filled with a sensor. The sensor can be created in the pocket, or the sensor can be created outside and then placed into the pocket. A pocketed JET can carry either a sensor or substance(s) or both.

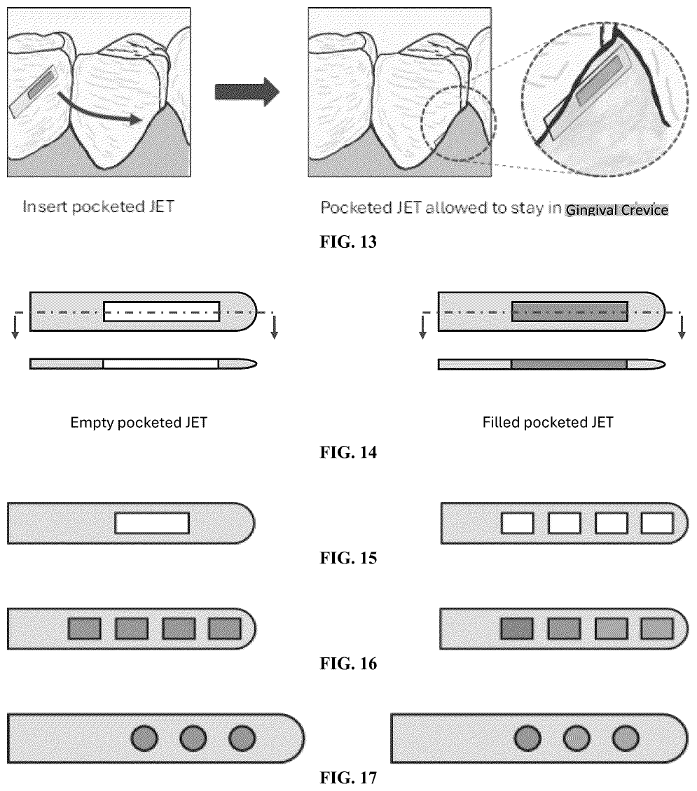

FIG. 13 shows a schematic of a pocketed JET being placed in a gingival crevice. LEFT: Pocketed JET is inserted into gingival crevice. RIGHT: Pocketed JET remains in the gingival crevice to deliver substances.

FIG. 14 shows a pocketed JET. LEFT: Empty pocketed JET. RIGHT: Pocketed JET filled with substance for delivery.

FIG. 15 shows, LEFT: Single pocket. RIGHT: More than one pockets.

FIG. 16 shows, LEFT: More than one rectangular pocket are all carrying the same substance. RIGHT: More than one rectangular pockets are carrying different substances.

FIG. 17 shows, LEFT: More than one circular pockets are all carrying the same substance. RIGHT: More than one circular pockets are carrying different substances.

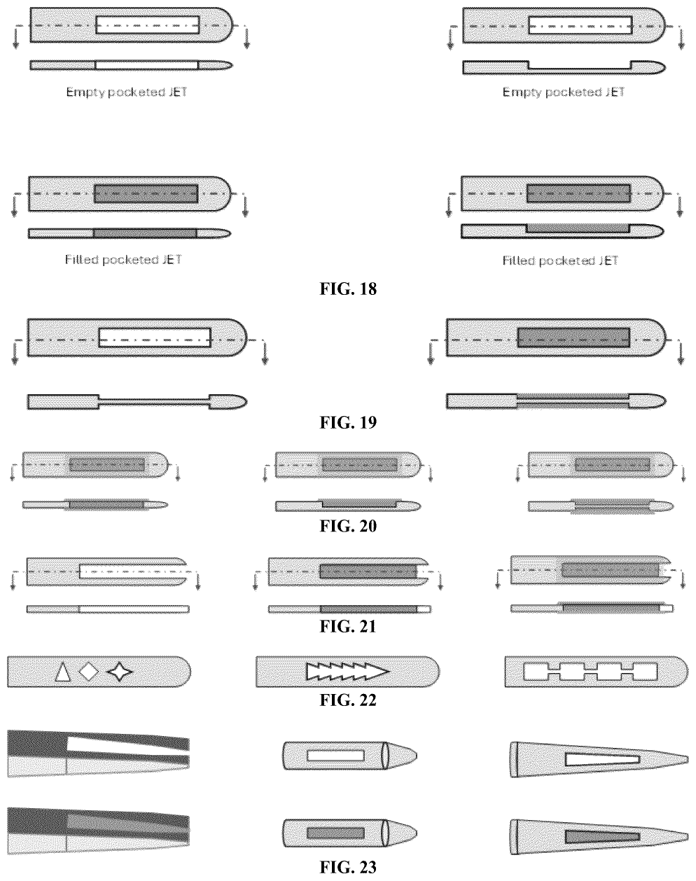

FIG. 18 shows, LEFT top: Empty pocketed JET with pocket depth equal to 100% of the device thickness. LEFT bottom: Filled pocketed JET with pocket depth equal to 100% of the device thickness; RIGHT top: Empty pocketed JET with pocket depth <100% of the device thickness. RIGHT bottom: Filled pocketed JET with pocket depth <100% of the device thickness.

FIG. 19 shows, LEFT: Pocket present on both sides. RIGHT: Pocket present on both sides filled.

FIG. 20 shows, LEFT: Pocket extending 100% of the device thickness, filled with substance and covered with thin film on either side; MIDDLE: Single pocket extending to <100% of the device thickness, filled with substance and covered with thin film on one side; RIGHT: Two pockets each extending to <100% of the device thickness, filled with substance and each covered with thin film.

FIG. 21 shows, LEFT: Empty pocket extending 100% of the device thickness and complete device length on one end; MIDDLE: Filled pocket extending 100% of the device thickness and complete device length on one end; RIGHT: Filled pocket extending 100% of the device thickness and complete device length on one end, and covered with thin film on both sides.

FIG. 22 shows pockets of different shapes and designs.

FIG. 23 shows devices of different shapes. LEFT: Wedge shaped device with pocket (top: unfilled, bottom: filled); MIDDLE: Bullet shaped device with pocket (top: unfilled, bottom: filled); RIGHT: Conical frustum shaped device with pocket (top: unfilled, bottom: filled).

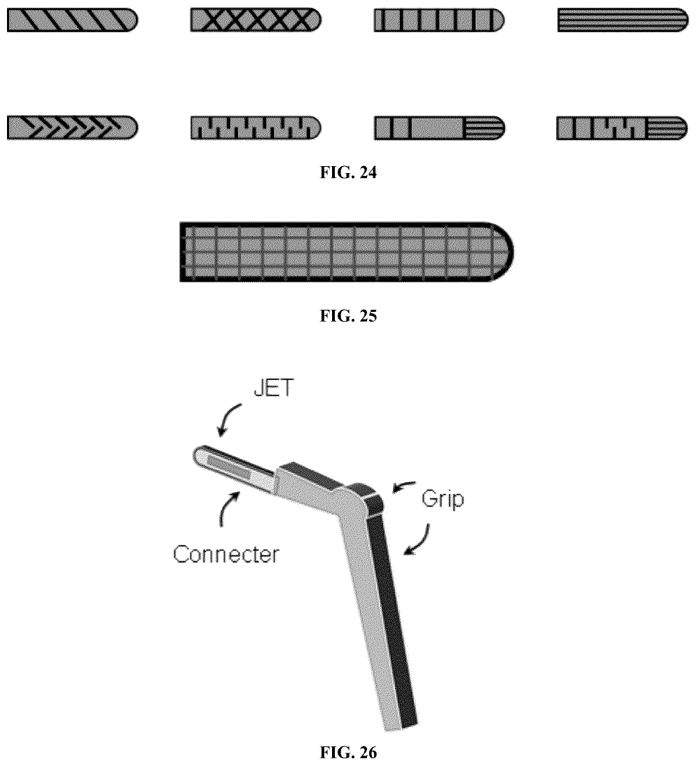

FIG. 24 shows a significant proportion of the solid is removed. However, the remaining solid is in the form that it forms pockets that can still retain liquids and other formulations.

FIG. 25 shows a significant proportion of the solid is removed to create an outer frame. An external net or mesh is added to form pockets.

FIG. 26 shows a pocketed JET attached to grip for delivery into gingival crevice. The grip is angled with regard to the JET, which can include a connector. While shown as being made from different materials (the grip and the JET), the device can also be made of a unitary construction.

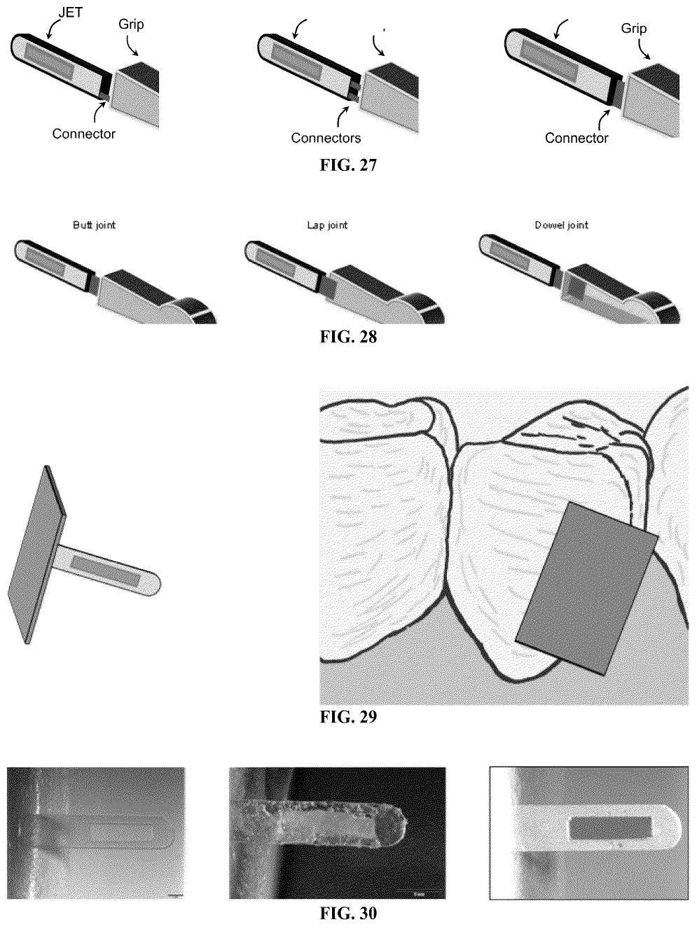

FIG. 27 shows, LEFT: pocketed JET attached to grip via a single narrow connector. MIDDLE: Pocketed JET attached to grip via two narrow connectors. RIGHT: Pocketed JET attached to grip via single wide connector.

FIG. 28 shows different joints for connecting pocketed JET to the grip.

FIG. 29 shows, LEFT: pocketed JET attached to mucoadhesive film. RIGHT: Mucoadhesive film sticks to gingiva/teeth (or both) and holds the pocketed JET in place.

FIG. 30 shows, LEFT: pocketed JET cut from a thin film of plastic. MIDDLE: One pocketed JET filled with a semi-solid formulation. RIGHT: One pocketed JET filled with a liquid formulation.

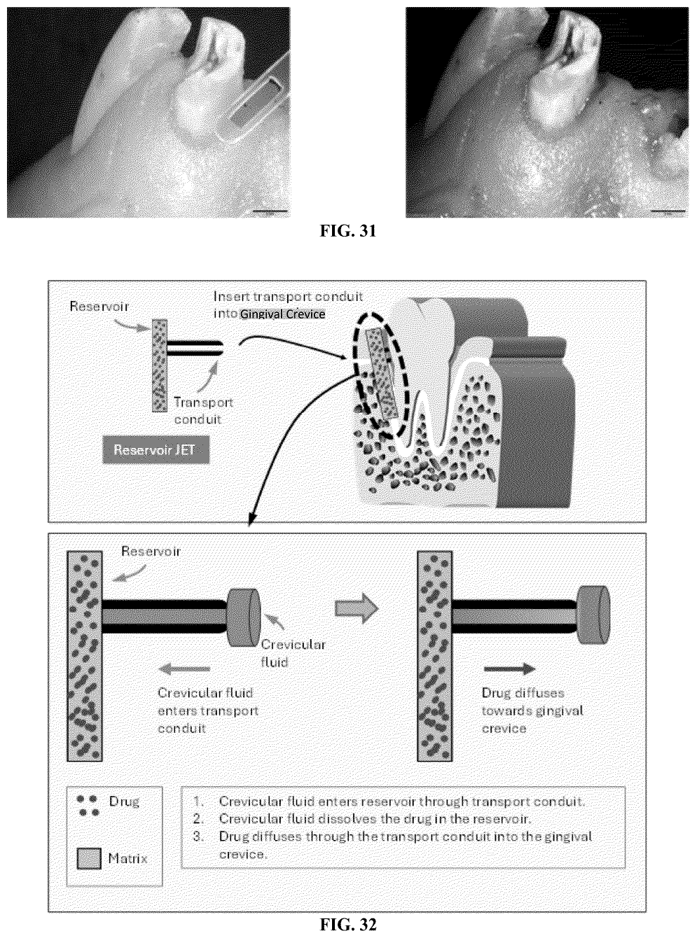

FIG. 31 shows, LEFT: pocketed JET filled with a liquid formulation prior to application in pig gingival crevice (In vitro). RIGHT: Pig gingival crevice after application of liquid-filled pocketed JET.

### Example 2: Reservoir JET Device

The new device comprises a ‘reservoir’ containing the medicament, into which a ‘transport conduit’ is attached. The transport conduit is designed to be insertable into the gingival crevice. The transport conduit is also designed to allow the gingival crevicular fluid from the gingival crevice to transport into the reservoir. In the reservoir, the medicament can be incorporated as a solid, gel or liquid state. Upon entry of the crevicular fluid into the reservoir, if the drug is in solid state, it dissolves and then diffuses through the transport conduit into the gingival crevice. If the reservoir contains drug in already soluble state, the transport conduit allows its diffusion into the gingival crevice. By changing the amount of active substance in the reservoir, the amount to be administered can be tuned. The reservoir can be made larger or smaller as well.

The reservoir can be lined with an outer film to incorporate other function. For example, the film can perform a protective function or act as an adhesive for securing to gingiva/teeth, or can act as impermeable layer to prevent escape of drug from location aside from the transport conduit, or can increase strength of the system. The layer can provide these functions individually or in combination. Multiple layers can be applied each performing some function(s). For example the outer layer can be an impermeable layer and can increase mechanical strength. Subsequently on the side that has the transport conduit, a mucoadhesive layer can be attached to secure the system to gingiva/teeth.

The transport conduit can be formed in a manner that permits diffusion or flow of the fluid. The transport conduit can be any planar shape or three dimensional shape that can allow movement of gingival crevicular fluid from the gingival crevice to the reservoir and maintain this travel pathway for diffusion of substance from reservoir back into the gingival crevice. In one embodiment, one or more channels can be used. The one or more channels can be one or more than one and may be interconnected. The channels can be in planar structures or in three dimensional structures. The channels may be cut 100% of the material thickness from which the transport conduit is made, or less than 100% of the material thickness. The channels can be different shapes including straight lines, curved lines, irregular lines. In one embodiment the channels are connected with shapes such as circles, rectangles, squares or other regular/irregular shapes.

In one embodiment cuts/slits can be used instead of channels.

In another embodiment a hollow tube/capillary can be used. In another embodiment a porous structure can be used. In another embodiment a porous filter can be used. In another embodiment a thin film (porous or non-porous) coated with porous substance/film on one side or all sides can be used. In one embodiment, porous ceramic can be used. In another embodiment the transport conduit is a hydrogel. In another embodiment the transport conduit is a swellable material. In another embodiment the transport conduit is a material coated with hydrogel or swellable material such that they remain attached to the surface of the transport conduit. In another embodiment the transport conduit is a material coated with hydrogel or swellable material such that it degrades over time to control the rate of delivery.

In one embodiment different means of transport can be combined, for example, channels can be made in porous strips, or slits can be made in porous strips, or absorbent material such as fibers can be filled into channels, or absorbent material can be filled into hollow tubes.

The transport conduit should be designed with mechanical properties enabling its insertion into gingival crevice.

The base material for forming the transport conduit is a polymer, metal, inorganic material, composite, filter paper, porous sheet, biodegradable material, GRAS material or combination thereof. Preferably it is a safe material that after its utility can be ingested or dissolves/degrades/disintegrates for elimination. For example, the material can be selected from polymers such as polylactic acid, polyglycolic acid, poly(lactic-co-glycolic acid), polycaprolactone.

The reservoir can be filled with a broad range of dosage forms including solids, liquids, gels, slurries, particles, nanoparticles, microparticles, liposomes, solid lipid nanoparticles, viruses, bacteria, cells, or combinations of these embodiments.

The active substance for delivery can be intended for local action or for systemic action. Examples of local action without limitation include treatment of local bacterial infection causing gum diseases such as gingivitis and/or periodontitis, or for action on local cells of the surrounding gingiva for treatment of pain, or tissue regeneration.

To improve the transport conduits retention within the gingival crevice post-placement, its shape can be engineered to wedge it in the gingival crevice. The shape can be a wedge shape, a cone or a frustum.

To improve retention of the transport conduit within the gingival crevice after its placement, mucoadhesive substances can be incorporated into or on the surface of the conduit.

To improve the transport conduits retention within the gingival crevice post-placement a combination of shape-design and mucoadhesives can be used.

The reservoir JET can be placed into the gingival crevice by itself or it can be attached to a grip for ease of handling.

The active substance is selected from the group consisting of vaccines, allergens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, antibiotics, antifungal agents, anti-inflammatory agents, insulin, antibodies, semaglutide, DNA, RNA, siRNA, and mRNA, antibodies, natural peptides, synthetic peptides, peptides with modified amino acids and substitutions, peptides with non-natural amino acids, natural proteins, recombinant proteins, proteins with modified amino acids and non-natural amino acids, or combinations thereof.

FIG. 32 shows, TOP BOX: Schematic of a reservoir JET being placed in a gingival crevice. BOTTOM BOX: Description of how the drug is transported from reservoir to the gingival crevice.

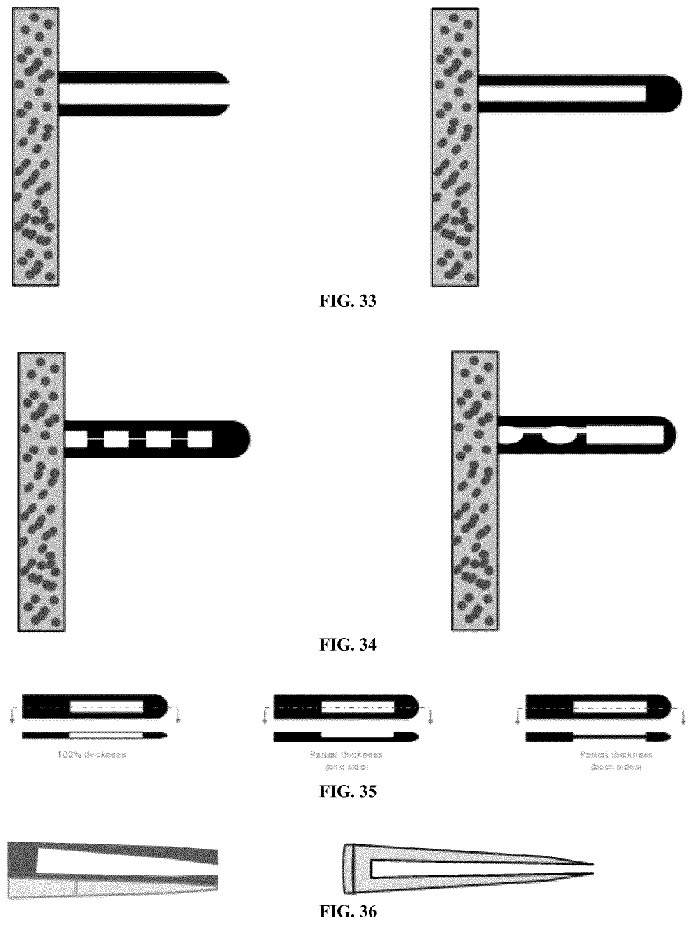

FIG. 33 shows channels extending 100% through material thickness. LEFT: The channel continues beyond the edge. RIGHT: The channel does not extend beyond the edge.

FIG. 34 shows channels extending 100% through material thickness. LEFT: The channel contains interconnected rectangles. RIGHT: The channel contains interconnected rectangle and ovals.

FIG. 35 shows, LEFT: Channel extends 100% of thickness. MIDDLE: Channel extends less than 100% of thickness on one side. RIGHT: A channel each extends less than 100% of the thickness on either side.

FIG. 36 shows, LEFT: Wedge shaped transport conduit with channels carved 100% of thickness. RIGHT: Conical shaped transport conduit with channels carved 100% of thickness.

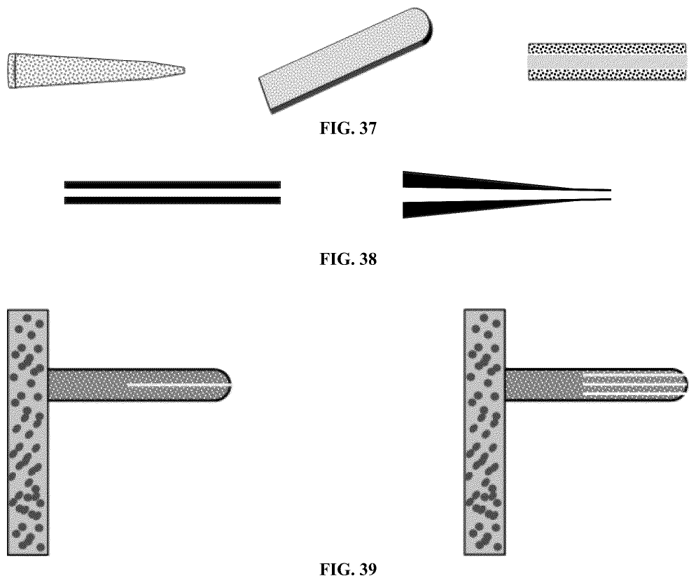

FIG. 37 shows, LEFT: Conical porous transport conduit. MIDDLE: Planar porous transport conduit. RIGHT. Porous material layered over non-porous material.

FIG. 38 shows, LEFT: Hollow cylindrical transport channel. RIGHT: Hollow conical transport channel.

FIG. 39 shows, LEFT: One cut made in porous film. RIGHT: More than one cut made in porous film.

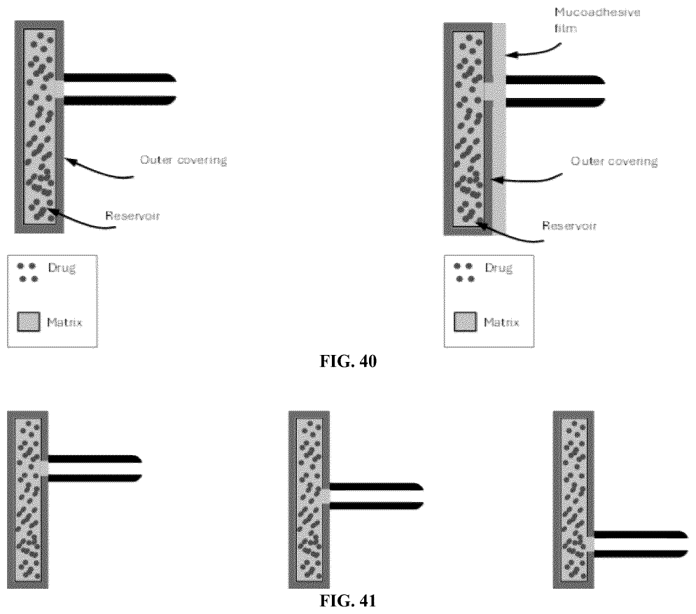

FIG. 40 shows, LEFT: Reservoir is covered with another outer layer for protection and to prevent medicament release from unintended location. RIGHT: A mucoadhesive layer is attached to the side with JET arm to secure the system to the teeth/gingiva.

FIG. 41 shows, LEFT: Transport conduit is towards the top of reservoir. MIDDLE: Transport conduit is towards the middle of reservoir. RIGHT: Transport conduit is towards the bottom of reservoir.

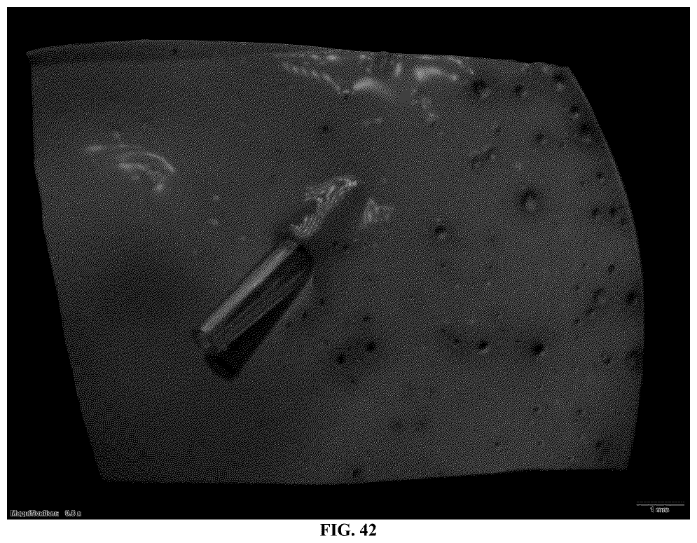

FIG. 42 shows a reservoir JET with a reservoir made from solvent casting of 50 mg/ml of PVA, 50 mg/ml of PVP, 20 mg/ml of Saccharin, 10% glycerin, and trace amounts of sodium fluorescein as model dye. The transport conduit is a hollow conical tube.

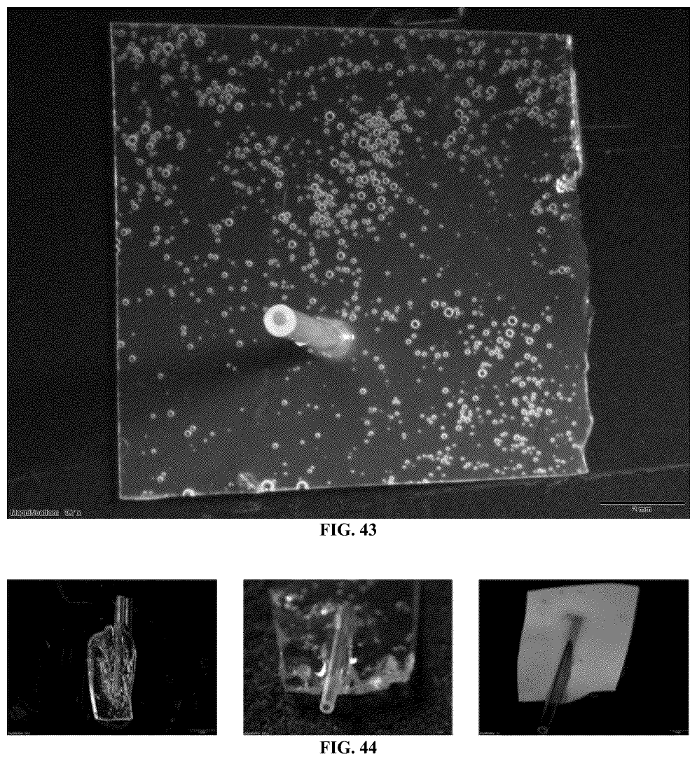

FIG. 43 shows a reservoir JET with a reservoir made from solvent casting of 10% PVA, 10% PVP, 10% Glycerin (% w/w), and trace amounts of sodium fluorescein as model dye. The transport conduit is a hollow tube.

FIG. 44 shows a reservoir JET with a reservoir made from solvent casting of 100 mg/ml of PVA, 20 mg/ml of PVP, 20 mg/ml of Saccharin, 10% glycerin, and trace amounts of sodium fluorescein as model dye. The transport conduit is a hollow tube. RIGHT: side view. MIDDLE: Top view under white light. RIGHT: Top view under fluorescent light.

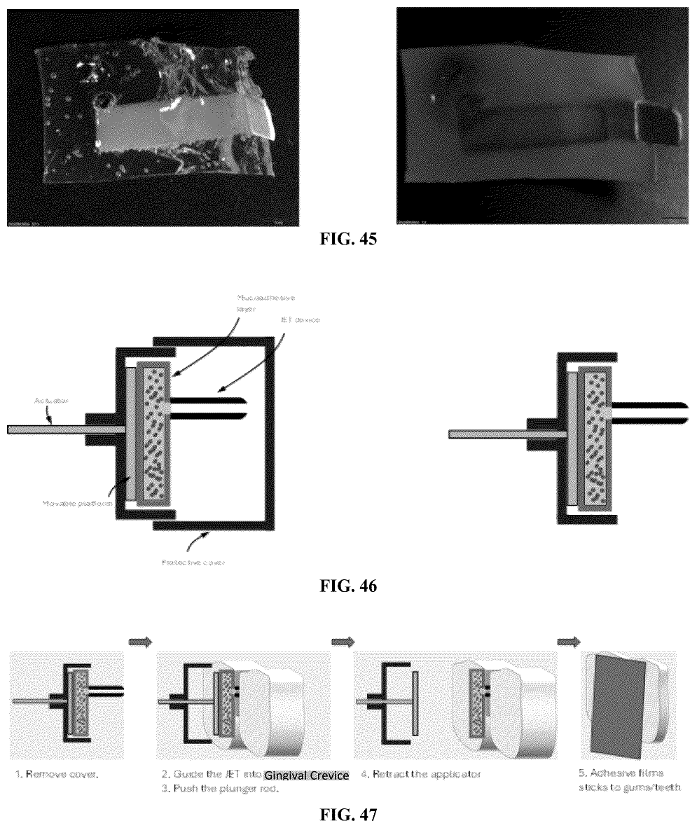

FIG. 45 shows a reservoir JET with a reservoir made from solvent casting of 100 mg/ml of PVA, 20 mg/ml of PVP, 20 mg/ml of Saccharin, 10% glycerin, and trace amounts of sodium fluorescein as model dye. The transport conduit is a porous flat film. LEFT: Top view under white light. RIGHT: Top view under fluorescent light.

### Example 3: Applicator and Container for Junctional Epithelium Targeter

This embodiment is for developing an applicator for junctional epithelium targeter (JET) and a container to safely handle it. The gingival crevice contains the junctional epithelium (JE), which has the attractive property of being significantly more permeable than other mucosal surfaces (such as the gut lining). Thus, the JE can be used as a portal for delivery of vaccines, allergens for immunotherapy, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, antibiotics, antifungal agents, anti-inflammatory agents, and combinations of the aforementioned substances. Examples without limitation for biomolecules include insulin, antibodies, natural peptides, synthetic peptides, semaglutide (a glucagon like peptide-1 receptor agonist), peptides with modified amino acids and substitutions, peptides with non-natural amino acids, hybrid peptides, natural proteins, recombinant proteins, proteins with modified amino acids and non-natural amino acids, DNA, RNA, siRNA, mRNA, etc.

Different types of junctional epithelium targeters (JETs) can be created for delivering into the gingival crevice. All of these JETs especially the pocketed JET, swellable JET, reservoir JET, disintegrable JET, and even the JET in some instances require the JET to stay in the gingival crevice for extended duration. To achieve this, the JET can be mounted on a mucoadhesive film (or pressure sensitive adhesion film or other sticking approach can be used). The film can stick to gingiva and/or teeth keeping the JET secured in the gingival crevice. The mucoadhesive film should be thin and non-intrusive to improve patient convenience and compliance. The thin films are difficult to handle manually and can tear readily or wrap over themselves. This invention provides an applicator that can overcome these challenges.

The invention comprises a sturdy platform over which the mucoadhesive film can be placed. The platform should be made of a material that the mucoadhesive film does not stick to. The platform can be moved manually by pressing a rod/piston/button to allow the mucoadhesive film+JET to move forward. After JET is in the gingival crevice additional pressure can be applied to push the mucoadhesive film onto the teeth/gingiva, allowing it to stick. Since the platform has low binding to mucoadhesive film, it will detach from the platform. The actuation of rod can be manual or mechanically actuated using a spring or other mechanical means, or electrical power, or magnetic force, or a combination thereof.

The platform can be flexible to allow it to conform to the contours of the gingiva/teeth.

The cap/cover is provided to protect the JET.

The cap can be screwed, or friction fit, or a mechanical interlock can be used to secure it. Mechanical interlock can be similar to medicine bottle, or a spring loaded button.

The film can be mucoadhesive or have pressure sensitive adhesive or combination, or other means for sticking to gum/teeth.

In one embodiment to prevent mucoadhesive film from sticking to platform, the mucoadhesive film is only on the side of the JET.

FIG. 46 shows a schematic of a JET applicator. LEFT: With protective cover on. RIGHT: With protective cover removed.

FIG. 47 shows the steps in use of the applicator.

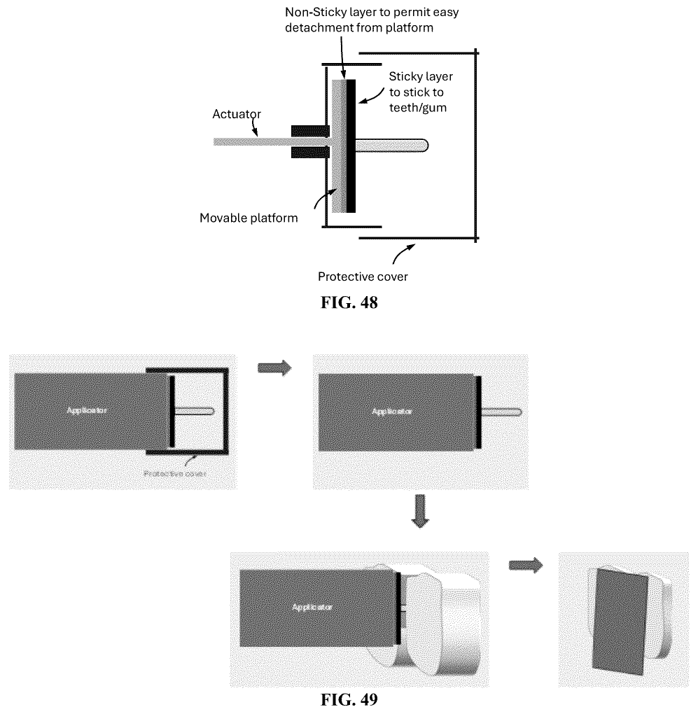

FIG. 48 shows a JET base film has two layers. One layer is non-sticky to allow detachment from the platform, and the other layer has adhesive property to allow it to stick to the gingiva/teeth, but this layer is only on the side of the JET.

FIG. 49 shows the applicator has no movable piston/platform. The applicator grip is itself used to insert the JET into the pocket and to press the sticky film to the surrounding surfaces of the gingiva/teeth.

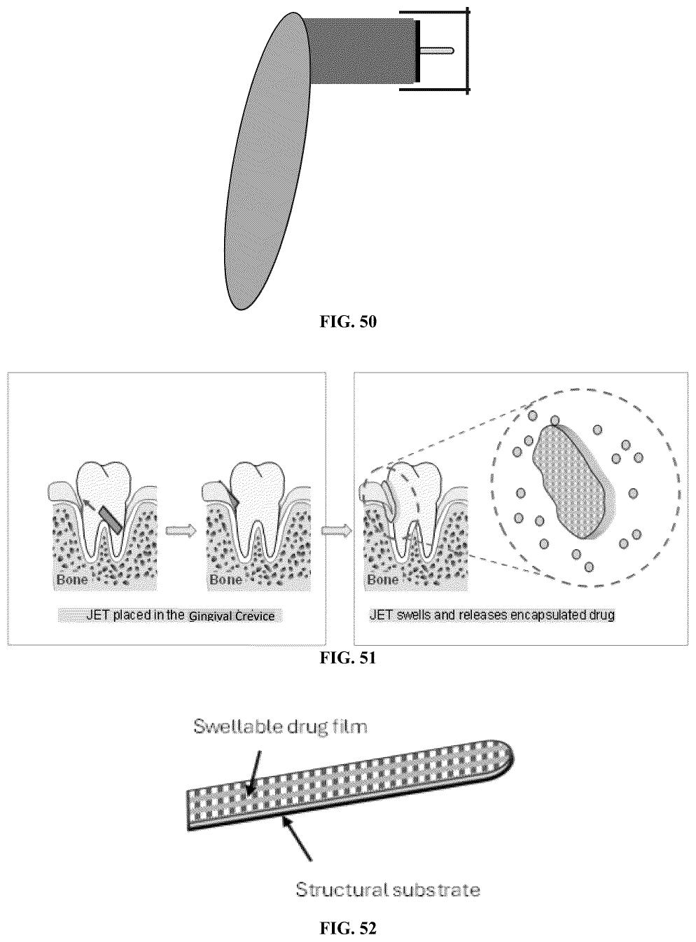

FIG. 50 shows a variation of the JET applicator design.

### Example 4: Swellable Junctional Epithelium Targeter

The gingival crevice contains the junctional epithelium (JE), which has the attractive property of being significantly more permeable than other mucosal surfaces (such as the gut lining). Thus, the JE can be used as a portal for delivery of vaccines, allergens for immunotherapy, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, antibiotics, antifungal agents, anti-inflammatory agents, and combinations of the aforementioned substances. Examples without limitation for biomolecules include insulin, antibodies, natural peptides, synthetic peptides, semaglutide (a glucagon like peptide-1 receptor agonist), peptides with modified amino acids and substitutions, peptides with non-natural amino acids, natural proteins, recombinant proteins, proteins with modified amino acids and non-natural amino acids, DNA, RNA, siRNA, mRNA, etc. The previous application (WO2023014950A1 (PCT/US2022/039536)) describes that the tissue underneath the JE is rich in immune cells and thus is attractive for allergen immunotherapy and vaccination.

The JE lies at the base of the gingival crevice. Therefore, targeting the JE for the delivery of substances is a challenge. Indeed, using a dyed-mouthwash it has been shown that simply using a mouthwash does not lead to penetration of the dye into the gingival crevice (Pitcher, G. R., H. N. Newman, and J. D. Strahan, Access to subgingival plaque by disclosing agents using mouthrinsing and direct irrigation. J Clin Periodontol, 1980. 7(4): p. 300-8.).

There remains a need to develop innovative methods for delivering to the JE. Here we describe an innovative method wherein the delivery system comprises a delivery component called the junctional epithelium targeter (JET), which is the component that can be inserted into the gingival crevice. The JET has the property that when it comes in contact with the fluid in the gingival crevice, it swells, releasing the encapsulated/entrapped active substance into the gingival crevice. The active substance is then transported across the JE. This is different from the JET and the encapsulated films, both of which require the JET to dissolve or disintegrate for the drug release to occur. The swellable JET instead swells to cause release.

To make this swellable JET, a polymer(s) is crosslinked without presence of drug into a certain shape. Multiple components can also be chemically reacted to achieve this. After crosslinking the system can be cleaned to remove any non-reacted components. At this stage, the leachable components are mostly removed. Subsequently the JET can be loaded with drug. A simple drug solution in aqueous media or other solvent is sufficient. The excipients if any will simply be to help solubilize the drug. The drug loading can be done by submerging part (or fully) of the wet (or dried) JET into drug solution for a certain duration and then taking it out. Instead of submerging, a liquid drop can be placed on the system. After evaporation of the solvent the system dries and collapses in thickness. When using, it can be placed in the gingival crevice, where it will swell to release the drug.

The drug (active substance) for delivery can be intended for local action or for systemic action. Examples of local action without limitation include treatment of local bacterial infection causing gum diseases such as gingivitis and/or periodontitis, or for action on local cells of the surrounding gingiva for treatment of pain, or tissue regeneration.

Based on the desired goal, the release can be tuned to follow a rapid (within seconds) release, or a more controlled and prolonged release over minutes to hours to days. The tuning of release rate can be tuned by tuning the porosity, thickness and other aspects of the swellable JET.

The JET must possess sufficient mechanical strength to allow it to be handled and inserted into the gingival crevice.

In one embodiment, the swellable JET can be created from hydrogels.

In one embodiment, the swellable JET can be created from crosslinking of polymers wherein the polymer is selected form methacrylated hyaluronic acid, or gelatin-methacryloyl, or co-polymer of poly(methylvinylether co. maleic acid) crosslinked with poly(ethylene glycol), or co-polymer of poly(methylvinylether co. maleic anhydride) crosslinked with poly(ethylene glycol), or polyvinyl alcohol, or poly(2-hydroxyethyl methacrylate), or poly(styrene)-block-poly(acrylic acid).

In one embodiment, the swellable film is created on top of a structurally strong substrate to create a composite structure. The structural substrate imparts the necessary strength to the crosslinked system/hydrogel. The structural substrate is made from biocompatible and/or biodegradable or GRAS or edible substance.

The swellable structure can degrade over time. Its degradation can be tuned to achieve different release rates ranging from few seconds to minutes to hours to days.

In one embodiment the swellable structure can delaminate from the structural support such that when the support is removed, the swellable material can stay in the pocket for release.

The swellable portion can swell by more than 10%, more than 50%, more than 100%, more than 500%, more than 1000% of its original dry volume.

To improve the JET's retention within the gingival crevice post-placement, its shape can be engineered to wedge it in the gingival crevice. The shape can be a wedge shape, a cone or a frustum.

To improve the JET's retention within the gingival crevice post-placement, mucoadhesive substances can be incorporated.

To improve the JET's retention within the gingival crevice post-placement a combination of shape-design and mucoadhesives can be used.

The JET can be placed into the gingival crevice by itself or it can be attached to a grip for ease of handling. In one embodiment the JET is attached to the grip via a structural element that weakens upon contact with fluid and either quickly dissolves or the user can break the element to allow the JET to be retained in the gingival crevice.

The JET can be attached to the grip using different joint types including and not limited to butt joint, lap joint, mortise and tenon joint, dado joint, tongue and groove joint, half-lap joint. Glue, hot melt, solvent melting, and other approaches of joining can be employed.

In one embodiment the swellable JET is attached to a mucoadhesive film, which can attach to teeth/gingiva to secure the JET in place.

In one embodiment the swellable JET after release is degradable and does not have to be removed.

FIG. 51 shows, LEFT: Depiction of a swellable JET being placed in a gingival crevice. RIGHT: Subsequent swelling, and release of active substance (AS) in the gingival crevice.

FIG. 52 shows a swellable JET made by creating swellable drug film over a substrate that offers mechanical support.

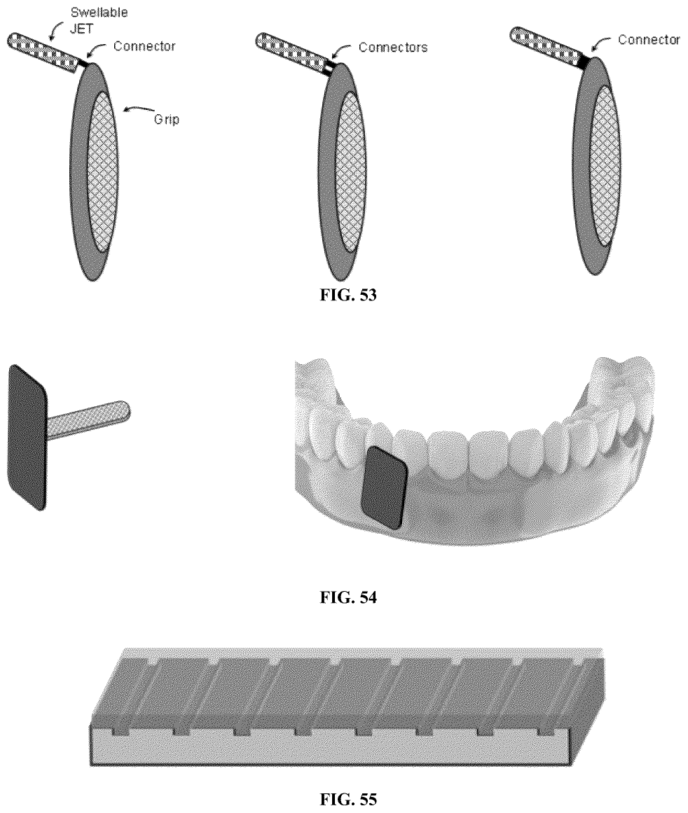

FIG. 53 shows a swellable JET attached to a grip with a LEFT: single short connector, MIDDLE: two short connectors, and RIGHT: one larger connector.

FIG. 54 shows, LEFT: A swellable JET attached to a mucoadhesive film. RIGHT: Mucoadhesive film attaches to teeth/gingiva and secures the JET in the gingival crevice for easy retrieval after it is used.

### Example 5: Surface Microtopography to Manipulate Coatings on Junctional Epithelium Targeter

The JET device (e.g., floss-based, strip-based, and/or film-based) that is to be coated with active substance and used for delivery to the gingival crevice may be able to glide smoothly into the gingival crevice without causing discomfort. For this reason, the floss, strip, or film of the JET device may be made of Teflon or nylon, both of which have good gliding behavior. However, these materials are hydrophobic and difficult to coat with aqueous solutions. Furthermore, when the floss, thin films, and/or strips of the JET device are used for coating, the material selected maybe difficult to wet with water and this can lead to poor spreading of the liquid, producing poor coatings. Furthermore, the adhesion force between the floss/film/strip surface and the dried solid after coating can be poor, leading to accidental removal of coatings even with little force such as during normal handling. Furthermore, if the adhesion force between coating and surface of the floss/strip/film is poor, the coating can get wiped while the device is being inserted into the gingival crevice. Thus, there is a need to develop approaches that can overcome these problems such that coatings are well spread out, and they are able to glide into the gingival crevice without wiping off on the surface.

To overcome these problems the inventors developed an approach using microtopography to physically change the surface to be coated. Physical methods can be used to control the liquid behavior on surfaces. For example, in 1936, Wenzel (Wenzel, R. N., Resistance of solid surfaces to wetting by water. Industrial & Engineering Chemistry, 1936. 28(8): p. 988-994.) reported that the contact angle of a liquid on rough surfaces is different from that measured on smooth surfaces. This “apparent” contact angle can influence the drop behavior, and indeed surface microtopography such as micro-valleys and micro-projections can affect pinning of the liquid drops (Kalinin, Y. V., V. Berejnov, and R. E. Thorne, Contact line pinning by microfabricated patterns: effects of microscale topography. Langmuir, 2009. 25(9): p. 5391-7). This liquid line pinning and apparent change in contact angle can be harnessed to control liquid spreading and hence to produce uniform coatings even on hydrophobic surfaces. Alternatively, these patterns can be designed to localize fluid drops to control where coatings are formed. Besides affecting liquid spreading, another effect that the micropatterns can have is to increase coating adhesion by increasing the surface area over which the coating ‘grips’ onto. Going a step further, ‘rivets’ can be created to help the coatings anchor to the floss/film/strip more robustly. For example, for making ‘rivets’ tiny holes in the floss/film/strip can be formed at regular intervals.

In one embodiment raised features can be created including pillars of different shapes including cylinders. These features can be hollow or solid. The height can be in the range of nanometer to micrometer to millimeter. All features need not be the same shape or height, some can be taller than others.

In another embodiment the features can be depressions created into the floss/film/strip surface. Depressions can be of any shape including circles, rectangles, polygons or other shapes. The depth can be up to 100% of the thickness of the base floss/film/strip of the JET device.

Combinations of raised features and depressions can be made on the same device surface for local control of the behavior over the surface. For example, the topographical features can be designed to create some portions that are more hydrophilic than others, or have greater adhesion (For example at the leading edge being inserted into the gingival crevice).

In some instances, the features are designed to restrict the fluid to certain parts of the floss/tape/strip of the JET device. This can be useful if a surface is highly wettable, and the deposited coating liquid spreads a lot but there is a need to restrict this spreading to within a certain length.

Some example shapes of elevations and depressions but without limitation are crisscross lines, lines angled to the long axis of the floss/film/strip of the JET device, lines parallel to the long axis of the floss/film/strip of the JET device, circles, stars, triangles, polygons, horseshoe shape, etc.

In some instances, rather than forming reliefs, elevations, or depressions in an existing flat floss/film/strip of the JET device, a mold can be used with the appropriate features to then produce the films/strips of the JET device with the desired features.

Elevations and depressions can be used as mechanical interlocks to increase coating adhesion.

In one embodiment, the depressions can extend to 100% of film thickness and the coatings can enter them to create a ‘rivet-like’ interlock. In some embodiments the coating formulation can even travel through the holes and reach the other side from where liquid is applied and form partial or full coating coverage on the other side.

In some instances, random or periodic scratches of different depths can be made on the floss/film/strip surface to provide greater surface area to improve coating adhesion.

The raised or depressed features need not be smooth but they themselves can possess topographical features.

Each topographical feature or groups of topographical features can be designed to be different from one another to impart the required functionality to the JET.

FIG. 55 shows rectangular grooves as mechanical interlocks to improve adhesion of coating.

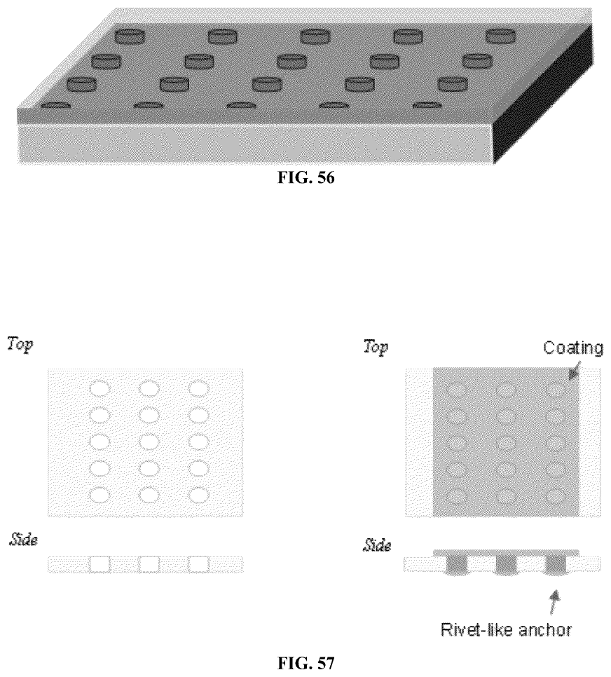

FIG. 56 shows cylindrical pillars as mechanical interlocks to improve adhesion of coating.

FIG. 57 shows through holes as mechanical interlocks (‘rivets’) to improve adhesion of coating.

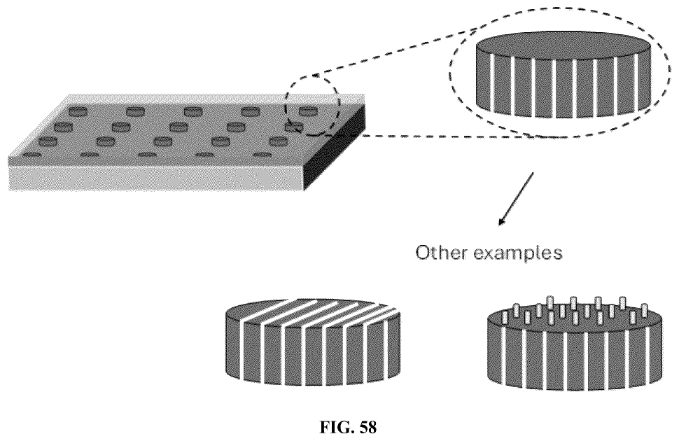

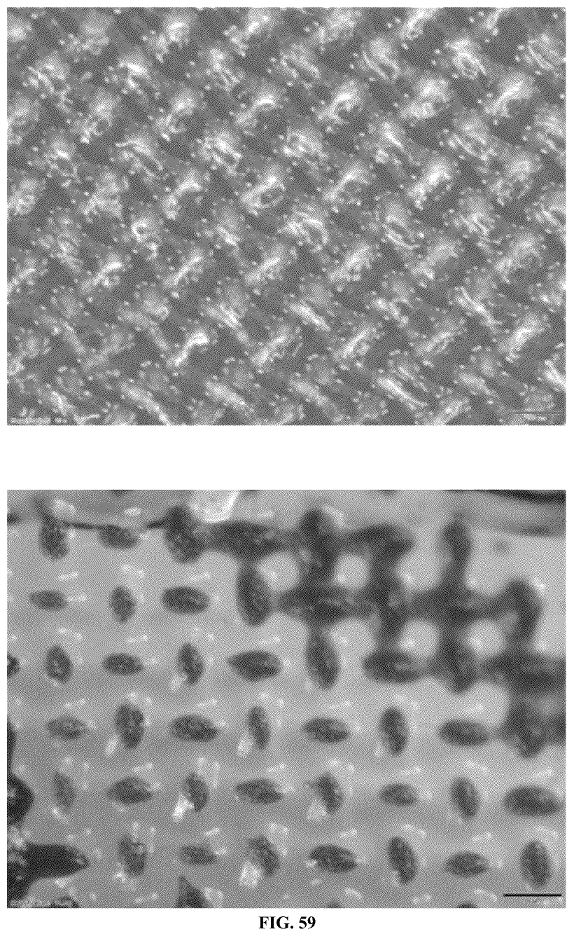

FIG. 58 shows the surface of the floss/film is decorated with raised pillars. The pillars can themselves possess additional topographical features such as ridges or raised features.

FIG. 59 shows a thin floss/strip was created from poly(lactic-co-glycolic) (PLGA) acid with micro-patterns using the molding technique. The mold was first created using a plastic wire mesh (Falcon 70 μm cell strainer, catalog number 352350). TOP. Uncoated floss/strip. BOTTOM: The floss was coated with a liquid formulation with food-dye, which was found to localize on the raised portion of the topographical aspects.

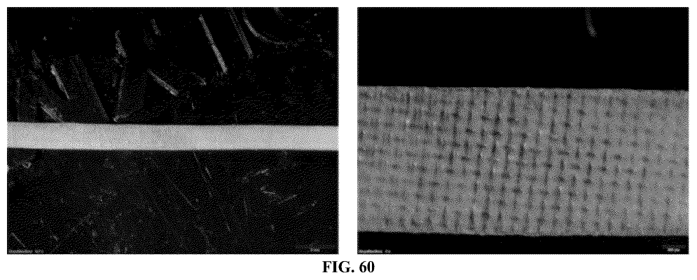

FIG. 60 shows embossing of the Teflon floss (Oral-B Glide Pro-health) was manually done by pressing down a polymer mesh (Falcon 70 μm cell strainer, catalog number 352350) onto the Teflon floss. LEFT: Embossed floss. RIGHT: Zoom up view to show embossing.

### Example 6. Formulations for Coating Junctional Epithelium Targeter

This example describes the formulations that are needed for coating surfaces such as, e.g., strips, films, floss, or bristles of the JET device. In addition, the floss or the film that is to be coated with an active agent or substance and used for delivery to the JE must be able to glide smoothly into the gingival crevice without causing the coating to free itself from the surface. Generally, the coating also must not be brittle, otherwise the coating may chip away during insertion into the gingival crevice. Overall, the required characteristics from a coating deposited on a floss/film for delivery to the gingival crevice are:
(1) Coating must homogeneously cover a certain portion of the floss/film of the JET device (in other words the coating must not be patchy and/or irregular).
(2) Coating must not be brittle and should not chip during insertion into gingival crevice.
(3) Coating must remain adhered to the surface of the floss/film surface of the JET device while it is being inserted into the gingival crevice.

Embodiment. To ensure that the coatings have the desired characteristics, the inventors have developed the following formulations. The formulation comprises (i) a viscosity enhancer with optionally a surfactant to control the spread of the coating and the homogeneity of coverage, and (ii) an agent that imparts plasticizing properties to reduce brittleness. More generally, two substances are required, one to fulfill the role of a viscosity enhancer and the other to fulfil the role of plasticizer. Sometimes the same agent can fulfill both roles. While these agents are often inactive excipients, in some cases the active ingredient might fulfill one or more of these roles. The surfactant is optional in the formulation and maybe required to control spreading of the coating solution.

The viscosity enhancers can be selected from but not limited to Hydroxypropyl cellulose (HPC) Hydroxyethyl cellulose (HEC), Sodium carboxymethyl cellulose (NaCMC), Methyl cellulose (MC), Ethyl cellulose (EC), Carbomer, Xanthan gum, Guar gum, Carrageenan, Sodium alginate, Acacia gum, Pectin, Polyvinyl alcohol (PVA), Polyethylene glycol (PEG), Polyvinylpyrrolidone (PVP), Polyacrylic acid (PAA), Poloxamer, Pluronic, Sodium hyaluronate, Gelatin, Bentonite, Magnesium aluminum silicate, Veegum, Tragacanth gum, Sodium starch glycolate, Microcrystalline cellulose, Sorbitol, Mannitol, Glycerin, Propylene glycol, Caprylyl glycol, Butylene glycol, Pentylene glycol, Dimethicone, Cyclomethicone, Jojoba oil, Sorbitan esters, Cetearyl alcohol, Stearyl alcohol, Behenyl alcohol, Cetyl alcohol, Oleic acid, Stearic acid, Isopropyl myristate, Polysorbate 20, Eudragit(s), or their combinations thereof.

The plasticizers can be selected from but not limited to glycerin (glycerol), Propylene glycol, Polyethylene glycols (PEGs), Sorbitol, Mannitol, Polyvinyl alcohol (PVA), Polyvinylpyrrolidone (PVP), Ethylene glycol, Diethylene glycol, Triethylene glycol, Butylene glycol, Trimethylolpropane, Ethanolamine, Isopropyl alcohol, Tetrahydrofurfuryl alcohol, Dimethyl sulfoxide (DMSO), Polyethylene oxide (PEO), Poloxamers (Pluronics), Cyclodextrins, Saccharides (e.g., glucose, fructose), Eudragit(s), or their combinations thereof.

### Embodiments

1. A junctional epithelium targeter (JET) for delivery of one or more active agents to a subject comprising: an arm connected to a substrate, grip or handle that extends at an angle from the substrate, grip, or handle, wherein the arm comprises one or more active agents and is sized to have a length and a cross section capable of being inserted into a gingival crevice, wherein at least a portion of the arm is at least one of: disintegrable, pocketed, swellable, patterned, reservoir, or combinations thereof.

2. A method of delivering one or more active agents to a gingival crevice of a subject comprising: providing an effective amount of the one or more active agents into a gingival crevice using a junctional epithelium targeter (JET) for delivery of one or more active agents to a subject comprising: an arm connected to a substrate, grip or handle that extends at an angle from the substrate, grip, or handle, wherein the arm comprises one or more active agents and is sized to have a length and a cross section capable of being inserted into a gingival crevice, wherein at least a portion of the arm is at least one of: disintegrable, pocketed, swellable, patterned, reservoir, or combinations thereof.

3. A method of making a disintegrable junctional epithelium targeter (JET) for delivery of one or more active agents to a subject comprising: an arm connected to a substrate, grip or handle that extends at an angle from the substrate, grip, or handle, wherein the arm comprises one or more active agents and is sized to have a length and a cross section capable of being inserted into a gingival crevice, wherein at least a portion of the arm is at least one of: disintegrable, pocketed, swellable, patterned, reservoir, or combinations thereof; depositing in, on, or about the portion of the arm that receives one or more active agents in a disintegrable pharmacologically acceptable carrier, wherein each deposit has a known, pre-determined amount of the one or more active agents.

4. The JET or method of any one of embodiments 1, 2, or 3, wherein the portion of the arm that is at least one of: disintegrable, pocketed, swellable, patterned, reservoir, or combinations thereof, is triggered to release the one or more active agents by one or more environmental stimuli selected from moisture, pH, enzymes, temperature, ion composition, ion concentration in a gingival crevice.

5. The JET or method of any one of embodiments 1 to 4, wherein release of the one or more active agents from the disintegrable, pocketed, swellable, patterned, reservoir, or combinations thereof is a controlled or a prolonged disintegration over minutes to hours to days.

6. The JET or method of any one of embodiments 1 to 5, wherein at least part of the portion that is disintegrable, pocketed, swellable, patterned, reservoir, or combinations thereof is selected to have sufficient mechanical strength to allow it to be handled and inserted into a gingival crevice.

7. The JET or method of any one of embodiments 1 to 6, wherein at least part of the portion that is disintegrable, pocketed, swellable, patterned, reservoir, or combinations thereof is reinforced to enhance its mechanical properties by adding inactive ingredients such as starches, sugar alcohols, cellulose derivatives, polyvinyl alcohol, binders, or excipients.

8. The JET or method of any one of embodiments 1 to 7, wherein the at least part of portion that is disintegrable, pocketed, swellable, patterned, reservoir, or combinations thereof is reinforced to enhance its mechanical properties by compression or compaction during fabrication.

9. The JET or method of any one of embodiments 1 to 8, wherein the at least part of portion that is disintegrable, pocketed, swellable, patterned, reservoir, or combinations thereof is reinforced to enhance its mechanical properties with a net, a mesh, or strips, that are a biocompatible and/or biodegradable material or ‘generally regarded as safe’ (GRAS), or other safe to consume material.

10. The JET or method of any one of embodiments 1 to 9, wherein at least part of a shape of the portion that is disintegrable, pocketed, swellable, patterned, reservoir, or combinations thereof is selected from at least one of a wedge shape, a cone or a frustum.

11. The JET or method of any one of embodiments 1 to 10, wherein at least part of the portion that is disintegrable, pocketed, swellable, patterned, reservoir, or combinations thereof further comprises a mucoadhesive, the one or more active agents further comprises a mucoadhesive, or both.

12. The JET or method of any one of embodiments 1 to 11, wherein the one or more active agents is at least one of: entrapped, encapsulated, or mixed in one or more inactive excipients.

13. The JET or method of any one of embodiments 1 to 12, wherein at least part of the portion that is disintegrable, pocketed, swellable, patterned, reservoir, or combinations thereof is formed in a mold selected from: solvent casting, hot-melt-extrusion, a Meyer bar coating, a slot die coating, 3D printing, spray, or gravure printing.

14. The JET or method of any one of embodiments 1 to 13, wherein at least part of the portion that is disintegrable, pocketed, swellable, patterned, reservoir, or combinations thereof comprising the one or more active agents is a film or coated with a film.

15. The JET or method of any one of embodiments 1 to 14, wherein the portion that is disintegrable, pocketed, swellable, patterned, reservoir, or combinations thereof comprising the one or more active agents is a film selected from mucoadhesive film, pressure sensitive film, lined with a mucoadhesive material, a pressure sensitive material, a temperature sensitive material, or combinations thereof.

16. The JET or method of any one of embodiments 1 to 15, wherein the portion that is disintegrable, pocketed, swellable, patterned, reservoir, or combinations thereof can be attached to the grip or handle with joint selected from butt joint, lap joint, mortise and tenon joint, dado joint, tongue and groove joint, half-lap joint.

17. The JET or method of any one of embodiments 1 to 16, wherein the portion that is disintegrable, pocketed, swellable, patterned, reservoir, or combinations thereof can be attached to the substrate or grip or handle with at least one of: a glue, hot melt, or solvent melting after the said substrate or grip or handle has been fabricated; or by inserting it into said substrate or grip or handle while they are being fabricated.

18. The JET or method of any one of embodiments 1 to 17, wherein the portion that is disintegrable, pocketed, swellable, patterned, reservoir, or combinations thereof further comprises one or more flavors, taste masking agents, color, or combinations thereof.

19. The JET or method of any one of embodiments 1 to 18, wherein the one or more active agents are formed in, into, or about, one or more portions that are disintegrable, pocketed, swellable, patterned, reservoir, or combinations thereof is formed with a liquid or gel coating, pockets hollowed out in a substrate, film, or strip.

20. The JET or method of any one of embodiments 1 to 19, wherein the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof.

21. The JET or method of any one of embodiments 1 to 20, wherein the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to a substrate, film, or strip, in a thermoplastic polymer deposited or adhered to a substrate, film, or strip, in a polysaccharide formulation deposited or adhered to a substrate, film, or strip, in pockets alternating between liquids, gels, solids deposited or adhered to a substrate, film, or strip, in a biodegradable material deposited or adhered to a substrate, film, or strip, in a swellable material deposited or adhered to a substrate, film, or strip, in a mucoadhesive deposited or adhered to a substrate, film, or strip.

22. The JET or method of any one of embodiments 1 to 21, wherein the one or more active agents are formed or carved in, into, or about, one or more portions that are disintegrable, pocketed, swellable, patterned, reservoir, or combinations thereof that have a depth of 10%, 20%, 30%, 40%, 50%, 60%, 70%, 80%, 90% or 100% of a thickness of a substrate, film, or strip.

23. The JET or method of any one of embodiments 1 to 22, wherein the one or more active agents are formed or carved in, into, or about, one or more portions that are disintegrable, pocketed, swellable, patterned, reservoir, or combinations thereof that form a flat surface, wedged shape, cylindrical shape, tapered cylindrical shape, bullet shape, parabolic shape or combinations thereof.

24. The JET or method of any one of embodiments 1 to 23, wherein the one or more active agents are formed or carved in, into, or about, one or more portions that are disintegrable, pocketed, swellable, patterned, reservoir, or combinations thereof that further comprise one or more sensors.

25. The JET or method of any one of embodiments 1 to 24, wherein the one or more active agents are formed in, into, or about, one or more portions that are disintegrable, pocketed, swellable, patterned, reservoir, or combinations thereof is filled with solids, liquids, gels, slurries, particles, nanoparticles, microparticles, liposomes, solid lipid nanoparticles, hydrogels, swellable materials, crosslinked polymers, or combinations thereof.

26. The JET or method of any one of embodiments 1 to 25, wherein the one or more active agents are formed in, into, or about, one or more portions that are disintegrable, pocketed, swellable, patterned, reservoir, or combinations thereof is polymerized in situ, formed ex situ and deposited or adhered to a substrate, film, or strip, in a hydrogel deposited or adhered to the substrate, film, or strip, in a polymer deposited or adhered to the substrate, film, or strip, in a polysaccharide formulation deposited or adhered to the substrate, film, or strip, in pockets alternating between liquids, gels, solids deposited or adhered to the substrate, film, or strip, in a biodegradable material deposited or adhered to the substrate, film, or strip, in a swellable material deposited or adhered to the substrate, film, or strip, in a mucoadhesive deposited or adhered to the substrate, film, or strip, or the reservoirs are porous in the substrate, film, or strip.

27. The JET or method of any one of embodiments 1 to 26, wherein the one or more active agents are formed in, into, or about, one or more portions that are disintegrable, pocketed, swellable, patterned, reservoir, or combinations thereof that are connected by one or more channels, hollow tubes, slits, or capillaries formed or carved in, on, or into, a substrate, film, or strip, wherein the channels can be straight lines, curved lines, irregular and can connect reservoirs having one or more shapes selected from circles, rectangles, squares, or regular shapes, irregular shapes, or combinations thereof.

28. The JET or method of any one of embodiments 1 to 27, wherein the one or more active agents are formed in, one, or about an applicator that comprises a mucoadhesive and a film comprising the one or more active agents on the arm, and a cap or coating surrounding the mucoadhesive and the film, wherein the mucoadhesive and the film is shaped to contact the gingival crevice at a junction with a tooth, is flexible to contour on or about the gingival crevice at a tooth junction, or wherein the mucoadhesive, the film, or both are pressure-sensitive.

29. The JET or method of any one of embodiments 1 to 28, wherein the one or more active agents are formed in, one, or about an applicator that comprises a spring, electrical actuator, magnetic actuator, mechanical actuator, or combinations thereof attached to move the arm to position the arm into a gingival crevice or to attach the active agent to a surface in, on, or about the gingival crevice.

30. The JET or method of any one of embodiments 1 to 29, wherein the one or more active agents are formed in, one, or about portions that are disintegrable, pocketed, swellable, patterned, reservoir, or combinations thereof is a material comprising a swellable polymer, hydrogel, of combinations thereof.

31. The JET or method of any one of embodiments 1 to 30, wherein the one or more active agents are formed in, one, or about portions that are disintegrable, pocketed, swellable, patterned, reservoir, or combinations thereof is a material selected from methacrylated hyaluronic acid, or gelatin-methacryloyl, or co-polymer of poly(methylvinylether-co-maleic acid) crosslinked with poly(ethylene glycol), or co-polymer of poly(methylvinylether-co-maleic anhydride) crosslinked with poly(ethylene glycol), or polyvinyl alcohol, or poly(2-hydroxyethyl methacrylate), or poly(styrene)-block-poly(acrylic acid), of combinations thereof.

32. The JET or method of any one of embodiments 1 to 31, wherein the one or more active agents are formed in, one, or about portions that are disintegrable, pocketed, swellable, patterned, reservoir, or combinations thereof is a material that is biodegradable, made from a compound or formulation generally regarded as safe, or both, or the material comprises one or more layers that release as the swellable material expands upon contact with one or more environmental stimuli selected from moisture, pH, enzymes, temperature, ion composition, ion concentration, or combinations thereof.

33. The JET or method of any one of embodiments 1 to 32, wherein the one or more active agents is selected for local or systemic delivery.

34. The JET or method of any one of embodiments 1 to 33, wherein the one or more active agents are selected from immunogens, vaccines, allergens, antigens, drugs, pharmaceuticals, small molecules, fats, lipids, carbohydrates, nutraceuticals, vitamins, minerals, biopharmaceuticals, biological molecules, cytokines, chemokines, peptides, proteins, amino acids, nucleic acids, antibiotics, antifungal agents, anti-inflammatory agents, and combinations thereof.

35. The JET or method of any one of embodiments 1 to 34, wherein the one or more active agents activate, or anergize, an immune response by targeting a junctional epithelium in the gingival crevice, wherein the one or more active agents have therapeutic effect (by not inducing an immune response) by targeting junctional epithelium.

36. The JET or method of any one of embodiments 1 to 35, wherein the coating further comprises one or more pharmaceutically acceptable excipients, diluents, buffers, salts, viscosity enhancers, plasticizers, thickening agents, surface tension reducing agents, polymers, or combinations thereof.

37. The JET or method of any one of embodiments 1 to 36, wherein the viscosity enhancers are selected from Hydroxypropyl cellulose (HPC) Hydroxyethyl cellulose (HEC), Sodium carboxymethyl cellulose (NaCMC), Methyl cellulose (MC), Ethyl cellulose (EC), Carbomer, Xanthan gum, Guar gum, Carrageenan, Sodium alginate, Acacia gum, Pectin, Polyvinyl alcohol (PVA), Polyethylene glycol (PEG), Polyvinylpyrrolidone (PVP), Polyacrylic acid (PAA), Poloxamer, Pluronic, Sodium hyaluronate, Gelatin, Bentonite, Magnesium aluminum silicate, Veegum, Tragacanth gum, Sodium starch glycolate, Microcrystalline cellulose, Sorbitol, Mannitol, Glycerin, Propylene glycol, Caprylyl glycol, Butylene glycol, Pentylene glycol, Dimethicone, Cyclomethicone, Jojoba oil, Sorbitan esters, Cetearyl alcohol, Stearyl alcohol, Behenyl alcohol, Cetyl alcohol, Oleic acid, Stearic acid, Isopropyl myristate, Polysorbate 20, Eudragit(s), or combinations thereof.

38. The JET or method of any one of embodiments 1 to 37, wherein the plasticizers are selected from Glycerin (glycerol), Propylene glycol, Polyethylene glycols (PEGs), Sorbitol, Mannitol, Polyvinyl alcohol (PVA), Polyvinylpyrrolidone (PVP), Ethylene glycol, Diethylene glycol, Triethylene glycol, Butylene glycol, Trimethylolpropane, Ethanolamine, Isopropyl alcohol, Tetrahydrofurfuryl alcohol, Dimethyl sulfoxide (DMSO), Polyethylene oxide (PEO), Poloxamers (Pluronics), Cyclodextrins, Saccharides, Eudragit(s), or combinations thereof.

39. The JET or method of any one of embodiments 1 to 38, further comprising adding one or more additional agents that increase permeability of the one or more active agents into the gingival crevice.

40. The JET or method of any one of embodiments 1 to 39, wherein between 0.001%-100% of the one or more active agents is in a depot at a junctional epithelium of the gingival crevice.

41. The JET or method of any one of embodiments 1 to 40, wherein the one or more active agents are provided repeatedly to a junctional epithelium of the gingival crevice.

42. The JET or method of any one of embodiments 1 to 41, wherein delivery of the one or more one or more active agents to a junctional epithelium is before or after consumption of a food or drink.

43. The JET or method of any one of embodiments 1 to 42, wherein the one or more active agents is applied once or more than once with a frequency on a daily or weekly or monthly basis, such as 1, 2, 3, 4, 5, or 6 times daily or 1, 2, 3, 4, 5, 6, or 7 times weekly or 1, 2, 3, or 4 times monthly.

44. The JET or method of any one of embodiments 1 to 43, wherein two or more active agents are delivered to a junctional epithelium of the gingival crevice.

45. The JET or method of any one of embodiments 1 to 44, wherein delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks water, or both.

46. The JET or method of any one of embodiments 1 to 45, wherein delivery of the one or more active agents to the gingival crevice is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks water, or both.

47. The JET or method of any one of embodiments 1 to 46, wherein an amount of the one or more active agents is delivered to a junctional epithelium range from picograms to milligrams.

48. The JET or method of any one of embodiments 1 to 47, wherein a least a portion of the arm has a thickness less than 5 mm, preferably less than 3 mm, and preferably less than 1 mm.

49. The JET or method of any one of embodiments 1 to 48, wherein a least a portion of the arm comprises natural or synthetic polymers, organic materials, metals, inorganic materials or combinations thereof.

50. The JET or method of any one of embodiments 1 to 49, wherein a least a portion of the arm comprises a mucoadhesive layer or a hydrophobic layer or a hydrophilic layer or a combination.

51. The JET or method of any one of embodiments 1 to 50, wherein a least a portion of the arm comprises a microporous structure allowing diffusion of antigen to gingival crevice.

52. The JET or method of any one of embodiments 1 to 51, wherein construction of the grip and arm is unitary.

53. The JET or method of any one of embodiments 1 to 52, wherein a viscosity of the one or more active agents deposited is 0.01 centipoise (cp), 1 cp, 10 cp, 100 cp, 1000 cp, 10000 cp, 100000 cp, 200000 cp, 300000 cp, 500000 cp, 1000000, or 100000000 cp.

54. The JET or method of any one of embodiments 1 to 53, wherein the one or more active agents are formed in, into, or about, one or more micro-nano-sized carriers or nanoparticles.

55. The JET or method of any one of embodiments 1 to 54, wherein the one or more active agents are formed in, into, or about, one or more liposomes, polymeric particles, inorganic particles, or lipid particles, or hybrid particles in which the one or more active agents are attached or encapsulated.

Various embodiments of the present disclosure are directed to a JET device and system, and/or methods of manufacturing and/or using a JET device, that includes functionality for controlled delivery of medicaments to the gingival crevice. In particular embodiments, the JET device may be configured to deposit or place a carrier into the gingival crevice of a patient, where the carrier is configured to release a medicament in a controlled manner over a predetermined period of time. In embodiments, the carrier may be constructed to begin dissolving upon contact with the moist environment within the gingival crevice, beginning the release of the medicament for direct absorption into the patient's system. The rate of dissolution (and consequently, the rate of medicament release) can be configured to the specific therapeutic requirements by adjusting the composition and properties of the carrier material.

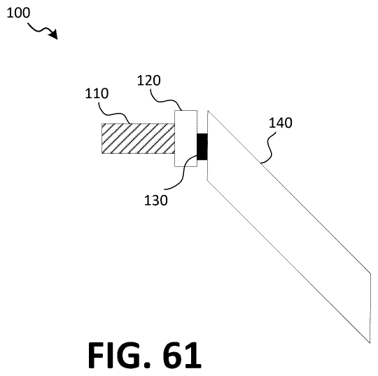

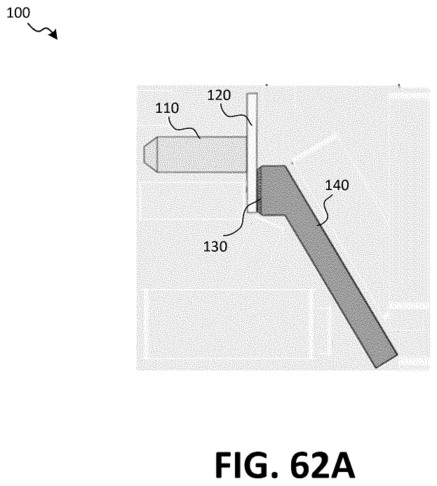

FIG. 61 shows an exemplary JET device 100 configured with capabilities and functionality for controlled delivery of medicaments to the gingival crevice of a patient in accordance with embodiments of the present disclosure. As shown in the particular embodiment illustrated in FIG. 61, JET device 100 may include carrier 110 and handle 140. In some embodiments, the handle 140 may be connected or coupled to the carrier 110 via a detachable connection 130 configured to facilitate detachment of the carrier 110 from the handle 140. In embodiments, a stop tab 120 may be disposed at a distal end of the carrier 110. The stop tab 120 may be configured to prevent the carrier 110 from being inserted beyond the gingival crevice of the patient during operation of JET device 100. In embodiments, these components of JET device 100 may be configured to include various designs and/or configurations for providing functionality as described in various embodiments of the present disclosure.

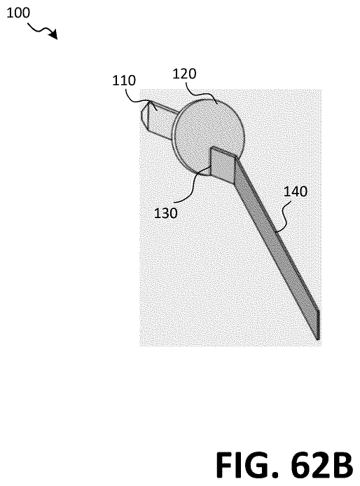

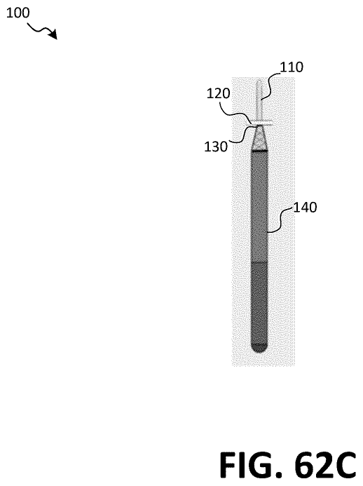

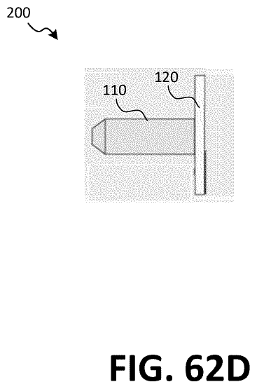

It is noted that in some embodiments, the JET device may be provided without the handle 140, offering a simplified design for ease of use and potential cost reduction. For example, as shown in FIG. 62D, JET device 200 is presented without a handle, comprising the carrier 110. In these embodiments, the user may manipulate the carrier 110 directly to insert the carrier 110 into the gingival crevice. In some embodiments, Jet device 200 may include the stop tab 120. In these embodiments, the stop tab 120 can be utilized by the user to insert the carrier directly into the gingival crevice. This configuration may enable for a more direct and tactile approach to placement of the carrier 110. In embodiments, the stop tab 120 may serve a dual purpose in this configuration, acting both as a guide for insertion and as a safeguard against over-insertion, ensuring that the carrier is deployed accurately within the target area of the gingival crevice.

### The Handle

The handle 140 of the JET device 100 (as shown in FIG. 61) serves as the user interface for positioning and deploying the carrier 110 within the gingival crevice of a patient. In embodiments, the handle 140 may be ergonomically designed to provide a secure grip and precise control during the insertion process (e.g., the insertion of the carrier 110 into the gingival crevice). The handle 140 may be constructed from a variety of materials, including but not limited to, plastics, composites, or metals that are suitable for medical applications and capable of withstanding the forces exerted during use. The shape, size, and texture of the handle 140 may be optimized to accommodate different hand sizes and dexterity levels, ensuring that the device can be used comfortably and effectively by a wide range of individuals.

In some embodiments, the handle 140 may feature a contoured design that naturally aligns with the user's fingers, reducing the risk of slippage and enhancing the accuracy of the carrier 110's placement within the gingival crevice of the patient. In embodiments, the distal end of the handle 140, which connects to the carrier 110 (e.g., via the detachable connection 130), may be configured to transmit the user's applied force efficiently to facilitate the detachment of the carrier 110 from the handle 140 when carrier 110 is correctly positioned within the gingival crevice of the patient. This connection point may be configured to be intuitive, allowing users to detach the carrier 110 with a simple motion, such as a pull or a twist, which can be easily performed even by those with limited manual dexterity.

In some embodiments, the handle 140 may be configured to be reusable, with the ability to attach to multiple carriers 110 for multiple uses, or it may be disposable, intended for a single use to ensure sterility and prevent cross-contamination. The choice between a reusable or disposable handle 140 may depend on various factors, including cost considerations, environmental impact, and the specific medical context in which the JET device 100 is employed.

### The Detachable Connection

The detachable connection 130 may be configured to provide mechanism or means for the temporary and/or detachable attachment of the carrier 110 to the handle 140. The detachable connection 130 may allow for a secure attachment of the carrier 110 to the handle 140 during the insertion of the carrier 110 into the gingival crevice, while facilitating easy detachment of the carrier 110 from the handle 140 once the carrier 110 has been inserted into the gingival crevice of the patient. The detachable connection 130 ensures that the carrier 110 can be left within the gingival crevice to release the medicament over the intended period while the handle is removed.

In embodiments, the detachable connection 130 may employ different mechanisms to achieve this functionality. For example, in some embodiments, the detachable connection 130 may consist of a mechanical coupling between the carrier 110 and the handle 140 that can be disengaged by a simple manual action such as pressing a button, twisting, or pulling. In some embodiments, the detachable connection 130 may comprise an area with perforations or weak mechanical points at which carrier 110 attaches (e.g., via stop tab 120) to handle 140. In additional or alternative embodiments, the detachable connection 130 may utilize a dissolvable adhesive that may be configured to dissolve or lose its bonding strength upon contact with saliva or the moisture within the gingival crevice, allowing for the carrier 110 to detach from the handle 140.

In embodiments, the configuration of the detachable connection 130 may consider the ease of use for the patient or healthcare provider. For example, the detachable connection 130 may be constructed to require a minimum amount of force or dexterity to operate, which may be particularly beneficial for patients with limited hand mobility. The detachable connection 130 may also be configured to prevent accidental detachment during the insertion process, which could lead to premature release of the medicament or the loss of the carrier.

In embodiments, the materials used for the detachable connection 130 may be selected based on their compatibility with the oral environment and their ability to maintain integrity until the moment of detachment. These materials may include medical-grade polymers, biocompatible and/or biodegradable adhesives, or a combination thereof. The choice of material ensures that the connection is strong enough to withstand the insertion forces but weak enough to allow for detachment without causing trauma to the gingival crevice.

The detachable connection 130 may also be configured for safe operation. For example, the detachable connection 130 may be configured to prevent the carrier from being inadvertently swallowed or aspirated by the patient upon detachment. Additionally, the configuration of detachable connection 130 may ensure that no sharp edges or small parts are exposed that could harm the soft tissues of the mouth.

The detachable connection 130 of embodiments may be a carefully engineered component that may operate to balance the requirements of secure attachment during use with the ease of detachment when desired. The configuration of detachable connection 130 may be a result of careful consideration of material properties, mechanical functionality, patient safety, and overall user experience.

It is noted that while the present description primarily details the detachable connection 130 as the mechanism coupling the carrier 110 to the handle 140, there are embodiments in which this connection may serve a slightly different role. Specifically, in configurations where a stop tab 120 is employed, the detachable connection 130 may actually represent the detachable interface between the stop tab 120 and the handle 140. This variation allows for additional flexibility in the design and application of the JET device 100, accommodating different usage scenarios and patient requirements. The inclusion of the stop tab 120 in the detachable connection design ensures that the carrier 110 can be positioned and held in place during the delivery process, while still allowing for straightforward detachment and removal of the handle 140 when the carrier is correctly situated within the gingival crevice. This adaptability in the design of the detachable connection 130 underscores the innovative approach to providing a user-friendly and effective medicament delivery system.

### The Stop Tab

The stop tab 120 may be configured to ensure the correct placement depth of the carrier 110 within the gingival crevice. In embodiments, the stop tab 120 may be affixed or attached to one end of the carrier 110 and may operate as a physical barrier against the tooth, preventing the carrier 110 from being inserted too far into the gingival crevice as to go beyond the confines of the gingival crevice (e.g., to be pushed out of the gingival crevice), and/or potentially causing discomfort or injury to the patient. Affixed to one end of the carrier 110, the stop tab 120 may serve as a physical boundary that abuts against the tooth when the carrier 110 is inserted into the gingival crevice, preventing over-insertion that could potentially push the carrier out of the gingival crevice and compromise the delivery of the medicament. The stop tab 120 may also provide a tactile indication to the user when the carrier 110 has reached its intended position.

In embodiments, the stop tab 120 may be configured to remain attached to the carrier 110 even after the handle 140 has been detached, continuing to serve its purpose as a positional safeguard. In some embodiments, the stop tab 120 may be constructed from a dissolvable material, which allows the stop tab 120 to gradually dissolve within the oral environment, eliminating any potential for discomfort or obstruction during the sustained release of the medicament from the carrier.

It is noted that the length of the carrier 110 is thoughtfully configured to align with the typical dimensions of a gingival crevice, ensuring that it can be fully accommodated without causing undue pressure or discomfort to the patient. This fit is significant to the functionality of the JET device 100, as it facilitates the accurate placement of the carrier 110 for effective medicament delivery.

In addition to its primary function as a depth gauge, the stop tab 120 may also contribute to the overall stability of the carrier 110 during the delivery process. By resting against the tooth, it helps to anchor the carrier in place, reducing the likelihood of slippage or misalignment during the medicament delivery. This stability is particularly beneficial when the carrier is designed to release medicament over an extended period, as it ensures consistent delivery to the targeted area.

The stop tab 120's functionality not only prevents the over-insertion of the carrier 110 but also allows the stop tab 120 to remain with the carrier post-detachment to ensure that the medicament delivery is confined to the target area.

### The Carrier

The carrier 110 may be configured to carry and deliver medicaments to the gingival crevice of the patient. For example, carrier 110 may be configured to be inserted and deposited into the gingival crevice, and to release the medicament in a controlled manner, ensuring that the therapeutic substances are absorbed into the patient's system through the gingival crevice efficiently and effectively. In embodiments, the carrier 110's configuration allows for the medicament to be delivered over a predetermined period of time, which is a function of the carrier 110's composition and structure, as well as the nature of the medicament itself.

For example, the carrier 110 may be manufactured or made to contain, include, encapsulate, or otherwise carry the medicaments to be delivered to the patient. In embodiments, the carrier 110 may be configured to begin its function of medicament delivery upon placement within the gingival crevice. This process may be configured to occur over a controllable period, which may range from immediate release to a sustained release spanning seconds, minutes, hours or even days, depending on the treatment requirements.

In embodiments, the carrier 110's configuration may be optimized to ensure that once it is positioned within the gingival crevice, the medicament is released in a manner that maximizes bioavailability and therapeutic efficacy. This targeted delivery system bypasses the potential for degradation or dilution that can occur with systemic administration routes, placing the medicament directly where it is intended to act. The result is a more efficient use of the medicament, with reduced risk of systemic side effects and improved outcomes for the patient.

### Medicament Composition in the Carrier

In embodiments, the configuration of the carrier 110 may be versatile, allowing the carrier 110 to be loaded with a wide array of medicaments tailored to the specific treatment requirements of the patient. The medicament may be a single agent or a combination of therapeutic agents, depending on the desired outcome. This enables the JET device 100 to address a broad spectrum of conditions and nutritional deficiencies.

In some embodiments, the carrier 110 may be loaded with micronutrients that are imperative for maintaining overall health and preventing deficiencies. These micronutrients may include, but are not limited to, vitamins such as retinoid and carotene (Vitamin A), which are known for their role in vision and immune function; B-complex vitamins like thiamin (Vitamin B1), riboflavin (Vitamin B2), niacin (Vitamin B3), pantothenic acid (Vitamin B5), pyridoxine (Vitamin B6), cobalamin (Vitamin B12), biotin, and folic acid (Vitamin B9), which are integral to energy metabolism and neurological health; ascorbic acid (Vitamin C), a potent antioxidant; and vitamins D (including calciferol, calcifediol, cholecalciferol, and ergocalciferol) and E (alpha-tocopherol), which support bone health and protect cell membranes, respectively. Vitamin K, including phylloquinone and menadione, is also included for its role in blood clotting and bone metabolism.

Essential minerals such as calcium, chloride, chromium, copper, fluoride, iodine, iron, magnesium, manganese, molybdenum, phosphorus, potassium, selenium, sodium, sulfur, and zinc may also be carried by the carrier 110. These minerals may be selected for their known benefits, ranging from bone health and thyroid function to immune response and wound healing.

For patients requiring antimicrobial intervention, the carrier 110 may be equipped with antibiotics such as amikacin, betamethasone, clindamycin, clotrimazole, gentamicin, kanamycin, minocycline, oxytetracycline, penicillin, and tetracycline. These antibiotics may enjoy efficacy against a broad range of bacterial infections.

In addition to antibiotics, the carrier 110 may contain anti-inflammatory agents to reduce swelling and discomfort in the gingival crevice, as well as antimicrobials, antifungals, and antibodies to combat various pathogens. Steroids can be included for their potent anti-inflammatory effects, while antiparasitic, anti-amoebic, anti-helminthic, anti-protozoal, antinematode, anti-cestode, and anti-trematode agents can be used to treat specific parasitic infections.

The ability to mix these medicaments allows for the creation of a comprehensive treatment regimen within a single application of the JET device 100. This multi-faceted approach can be particularly beneficial for patients with complex health issues or those who have undergone procedures such as bariatric surgery, which may affect their ability to absorb nutrients effectively.

The functionality of carrier 110 to carry and deliver a diverse range of medicaments makes it a powerful tool in the management and treatment of various health conditions and nutritional deficiencies. Its configuration, as described herein, ensures that these medicaments can be released in a controlled manner, providing targeted therapy directly to the gingival crevice for maximum efficacy and patient benefit.

### Controlled Delivery of Medicament by the Carrier

In embodiments, the carrier 110 may be configured to deliver medicaments over a controllable period of time. This controlled release is achieved through the carrier 110's ability to dissolve once placed within the gingival crevice of the patient. The dissolution, or dissolvement, of the carrier 110 is a response to the moist environment within the gingival crevice (e.g., the environment of the gingival cavity of the gingival crevice), which may act as a trigger for the release of the medicament contained within the carrier.

The dissolvement of the carrier 110 may represent a carefully orchestrated process that ensures the medicament is released into the gingival crevice and subsequently absorbed into the patient's system. This method of delivery is particularly advantageous as it allows for a direct and localized release of the medicament, enhancing its bioavailability and therapeutic effectiveness. The rate of dissolution, and thus the rate of release of the medicament, may be precisely controlled based on the composition and properties of the carrier material.

For example, the carrier 110 may be composed, in whole or in part, of a dissolvable polymer that is selected for its biocompatibility and dissolution characteristics. The choice of polymer is important, as it may dictate the rate at which the carrier will dissolve and release the medicament. A variety of polymers can be utilized for this purpose, including but not limited to hydroxy acids, lactic acid polymers, glycolic acid polymers, poly (hydroxyl acids), poly(lactic acid) (PLA), poly(glycolic acid) (PGA), poly(lactic-co-glycolic acid) (PLGA), and copolymers with PEG, polyanhydrides, poly(ortho) esters, polyesters, polyurethanes, poly(butyric acid), poly(valeric acid), poly(caprolactone), poly (hydroxyalkanoates), poly(lactide-co-caprolactone), blends and copolymers thereof, natural polymers, proteins, albumin, collagen, gelatin, prolamines, zein, polysaccharides, alginate, cellulose derivatives and polyhydroxyalkanoates, polyhydroxy butyrate blends, and copolymers thereof.

Additionally, natural polymers such as proteins, albumin, collagen, gelatin, prolamines, zein, and polysaccharides like alginate, as well as cellulose derivatives and polyhydroxyalkanoates, polyhydroxy butyrate blends, and copolymers thereof, can be employed to form the carrier 110. These materials offer the advantage of natural decomposition within the body, further aligning with the controlled release strategy of the JET device.

The polymers used in the construction of the carrier 110 may be processed using solvents such as dichloromethane, ethyl acetate, acetone, or a combination thereof, to achieve the desired form and dissolution rate. The solvent selection is based on its ability to effectively dissolve the chosen polymer and its safety profile for use in oral applications.

As such, the carrier 110's configuration incorporates a dissolvable polymer matrix that responds to the oral environment providing functionality of carrier 110 to deliver medicaments over a controllable period of time. This configuration ensures that the medicament is released at a predetermined rate, providing a consistent and targeted therapeutic effect directly within the gingival crevice.

In embodiments, the carrier 110's ability to deliver medicaments over a controllable period of time is a function of its configuration to dissolve at a predetermined rate. This rate is configured based on the characteristics of the carrier 110, which may include the composition, structure, and/or surface energy of the polymer used in its construction. By manipulating one or more of these variables, the dissolution rate of the carrier can be tailored to match the therapeutic requirements of the medicament delivery.

For example, if a slow and steady release of the medicament is desired, the polymer may be selected or treated to dissolve at a slower rate, which would slow down the rate of dissolution in the moist environment of the gingival crevice. Conversely, if a more rapid release is beneficial for the treatment outcome, the polymer may be treated or composed to dissolve at a faster rate subsequently increasing the rate of release of the medicament.

In embodiments, the predetermined rate of dissolution is a function of the interplay between the polymer's physical properties and the oral environment. This dissolution rate is not arbitrary but is chosen to align with the pharmacokinetics of the medicament, ensuring that the medicament release profile matches the absorption capabilities of the gingival crevice's tissues. The goal is to optimize the therapeutic effect while minimizing the potential for medicament waste or diminished efficacy due to improper release timing.

As such, in embodiments, the dissolution rate of the carrier 110 is a controllable parameter. By adjusting the characteristics or composition of the polymer from which carrier 110 may be made, the dissolution rate of carrier 110 can be fine-tuned to deliver the medicament at the rate that is deemed ideal for the patient's specific medical condition and treatment plan.

### Carrier Configurations

The carrier 110 of the JET device 100 may be configured with various configurations to accommodate various methods of medicament delivery, ensuring that the therapeutic and/or preventative agents are effectively administered to the gingival crevice. In embodiments, two primary configurations of the carrier 110 are described, each tailored to maximize the delivery and absorption of medicaments within the oral cavity. It is noted, however, that other carrier configurations may be envisioned by the present disclosure, even if not explicitly described. Indeed, the description of the following two carrier configurations is intended for illustrative purposes and not by way of limitations and as such, should not be construed as limiting in any way.

A first carrier configuration includes the arm configuration. In the arm configuration, the carrier 110 may be provided as a filamental-like extension that is specifically shaped and sized for insertion into the gingival crevice. Once inserted, it remains in place, gradually releasing the medicament. In embodiments, the arm can carry the medicament in several ways, which may include surface coating, incorporation within the material of the arm itself (e.g., making the arm using a polymer/medicament mixture), encapsulating the medicament within an internal well of the arm, or any combination thereof.

A second carrier configuration includes the multifilament mesh. In the multifilament mesh configuration, the carrier may be provided as a network of dissolvable filaments that are intricately woven to create a mesh structure with interstitial spacings between the dissolvable filaments. In embodiments, the multifilament mesh may carry the medicament in several ways. For example, the spacings between the dissolvable filaments may be filled with the medicament, the dissolvable filaments may be made using a polymer/medicament mixture, or any combination thereof. As the mesh dissolves within the gingival crevice, the medicament is released in a controlled manner, providing a sustained therapeutic effect.

Both configurations may be configured to ensure that the medicament is delivered directly to the target area, maximizing bioavailability and efficacy. The choice between an arm or a multifilament mesh configuration may depend on factors such as the type of medicament, the desired release kinetics, and the specific treatment plan for the patient.

### Carrier Arm Configuration

The carrier arm configuration of embodiments will now be discussed with respect to FIGS. 62A-62C. FIG. 62A shows a lateral view of the exemplary JET device 100 configured with capabilities and functionality for controlled delivery of medicaments to the gingival crevice of a patient in accordance with embodiments of the present disclosure. FIG. 62B shows an anterior view of the exemplary JET device 100 configured with capabilities and functionality for controlled delivery of medicaments to the gingival crevice of a patient in accordance with embodiments of the present disclosure. FIG. 62C shows a caudal view of the exemplary JET device 100 configured with capabilities and functionality for controlled delivery of medicaments to the gingival crevice of a patient in accordance with embodiments of the present disclosure.

As shown in FIGS. 62A-62C, the carrier 110 may be configured as a flexible, filamental-like extension or arm configured to navigate the contours of the gingival crevice with ease. The arm's length may be configured to ensure that a substantial portion can be comfortably placed within the gingival crevice, allowing for an effective and localized delivery of the medicament. In embodiments, the length of the arm may be between 4-12 mm, and in some embodiments, the length of the arm may be between 1-50 mm. In embodiments, the length of the arm may be <50 mm, and more preferably <15 mm.

In embodiments, the width of the arm may be configured to fit snugly within the gingival crevice without causing discomfort or irritation to the patient. This precise fit is integral to the functionality of the JET device 100, as it facilitates the accurate placement of the carrier 110 for effective medicament delivery. In embodiments, the width of the arm may be between 0.1-5 mm, and in some embodiments, the width of the arm may be between 0.01-10 mm. In some embodiments, the width of the arm may be <10 mm, and more preferably <5 mm, and more preferably <1 mm.

In embodiments, the thickness of the arm may be configured to fit within the gingival crevice without causing discomfort or irritation to the patient. In embodiments, the thickness of the arm may be between 0.001-3 mm, and in some embodiments, the width of the arm may be between 0.0001-10 mm. In some embodiments, the thickness of the arm may be <10 mm, and more preferably <3 mm.

In some embodiments, the arm is crafted or manufactured using a shaped mask, which serves as a mold to create an engineered structure that contains uniformly distributed medicaments (e.g., micronutrients, active agents, and/or other types of medicaments as described herein, etc.). In some embodiments, the medicaments may include medicaments that are coated with a medicament formulation, ensuring that the medicament is evenly distributed along the length of the arm. This uniform coating is paramount to achieving consistent therapeutic and/or preventative effects as the medicament is released into the gingival crevice.

In embodiments, the arm may be configured to detach from the handle 140 upon insertion into the gingival crevice. This detachment is a deliberate action that leaves the arm within the gingival crevice, where it begins the process of dissolution. As the arm dissolves, it releases the medicament in a controlled manner, ensuring that the medicaments carried by the arm are absorbed directly into the gingival crevice space.

In embodiments, the arm of carrier 110 may be configured in different configurations for medicament delivery, ensuring that the therapeutic agents are effectively administered to the gingival crevice. There are multiple ways in which the arm can carry the medicament, each tailored to maximize the delivery and absorption of medicaments within the oral cavity.

A first medicament delivery configuration for the arm configuration of carrier 110 may include surface coating. In this medicament delivery configuration, at least a portion of the surface of the arm may be coated with the medicament. As the arm remains within the gingival crevice and begins to dissolve, the medicament is progressively released and absorbed through the gingival crevice into the patient's system. The surface coating technique allows for an immediate and localized delivery of the medicament upon the dissolution of the carrier, providing a direct and efficient means of medicament delivery.

In some embodiments, the medicament is uniformly coated across the at least a portion of the surface of the arm. In some embodiments, the surface of the arm may undergo multiple coatings, and in some embodiments potentially receiving at least three layers of medicament to achieve the desired dosage and release profile.

In embodiments, prior to coating with the medicament, a precoat layer may be applied to the arm. This precoat may operate to modify the surface energy of the arm, which can influence the dissolution rate and the subsequent release of the medicament. The precoat layer may also contain medicaments, which could be in free form, entrapped in particles, encapsulated, or a combination thereof, providing an additional layer of therapeutic substance.

In embodiments, the medicaments with which the arm of the carrier 110 may be coated may include medicaments in free form, entrapped in particles, encapsulated, or a combination thereof. In embodiments, the encapsulant for the medicament is selected from one or more polymers of the group consisting of poly(hydroxy acids), poly(lactic acid), Poly(glycolic acid), poly(lactic acid-co-glycolic acid), poly(lactic-co-glycolic acid), derivatives of poly(lactic-co-glycolic acid), PEGylated poly(lactic-co-glycolic acid), poly(lactide), poly(glycolide), poly(lactide-co-glycolide), poly(anhydrides), PEGylated poly(anhydrides), poly(ortho esters), derivatives of poly(ortho esters), PEGylated poly(ortho esters), poly(caprolactones), derivatives of poly(caprolactone), PEGylated poly(caprolactones), polyamines, spermine, spermidine, polylysine, and derivatives thereof, PEGylated polylysine, polyamides, polycarbonates, poly(propylene fumarates), polyamides, polyphosphazenes, polyamino acids, polyethers, polyacetals, polylactides, polyhydroxyalkanoates, polyglycolides, polyketals, polyesteramides, poly(dioxanones), polyhydroxybutyrates, polyhydroxyvalyrates, polycarbonates, polyorthocarbonates, poly(vinyl pyrrolidone), polycyanoacrylates, polyalkylene oxalates, polyalkylene succinates, poly(malic acid), poly(methyl vinyl ether), poly(ethylene imine), poly(acrylic acid), poly (maleic anhydride), poly(ethylene imine), derivatives of poly(ethylene imine), PEGylated poly(ethylene imine), poly (acrylic acid), derivatives of poly(acrylic acid), PEGylated poly(acrylic acid), poly(urethane), PEGylated polyurethane), derivatives of poly(urethane), poly (lactide), poly (glycolide), poly (hydroxyacids), polyesters, poly(arylates), polyalkylenes, polyethylene, polypropylene, polyalkylene glycols, poly(ethyleneglycol), polyalkylene oxides such as poly(ethylene oxide), polyalkylene terepthalates, poly(ethylene terephthalate), polyvinyl alcohols, polyvinyl ethers, polyvinyl esters, polyvinyl halides such as poly(vinyl chloride), polyvinylpyrrolidone, polysiloxanes, poly(vinyl alcohols), poly(vinylacetate), polystyrene, polyurethanes and co-polymers thereof derivatized celluloses, alkyl cellulose, hydroxyalkyl celluloses, cellulose ethers, cellulose esters, nitro celluloses, methyl cellulose, ethyl cellulose, hydroxypropyl cellulose, hydroxy-propyl methyl cellulose, hydroxybutylmethyl cellulose, cellulose acetate, cellulose propionate, cellulose acetate butyrate, cellulose acetate phthalate, carboxylethyl cellulose, cellulose triacetate, cellulose sulfate sodium salt, polymers of acrylic acid, methacrylic acid or copolymers or derivatives thereof, methacrylic acid esters, poly(methyl methacrylate), poly(ethyl methacrylate), poly(butylmethacrylate), polyisobutyl methacrylate), poly(hexylmethacrylate), poly(isodecyl methacrylate), poly(laurylmethacrylate), poly(phenyl methacrylate), poly(methylacrylate), poly(isopropyl acrylate), poly(isobutyl acrylate), and poly(octadecyl acrylate), poly(butyric acid), poly(valeric acid), and poly(lactide-co caprolactone) and/or derivatives thereof, acrylic acid and methacrylic acid copolymers, methyl methacrylate copolymers, ethoxyethyl methacrylates, cyanoethyl methacrylate, aminoalkyl methacrylate copolymer, poly(acrylic acid), poly(methacrylic acid), methacrylic acid alkylamide copolymer, poly(methyl methacrylate), poly(methacrylic acid anhydride), methyl methacrylate, polymethacrylate, poly(methylmethacrylate) copolymer, polyacrylamide, aminoalkyl methacrylate copolymer, glycidyl methacrylate copolymers, polycyanoacrylates, and/or combinations thereof, natural polymers, proteins (such as albumin, collagen, gelatin), prolamines (for example, zein), polysaccharides (such as alginate), cellulose derivatives (such as hydroxypropyl cellulose, sodium carboxymethyl cellulose, ethyl cellulose and cellulose acetate), polyhydroxyalkanoates (for example, poly(hydroxybutyrate), and/or combinations thereof.

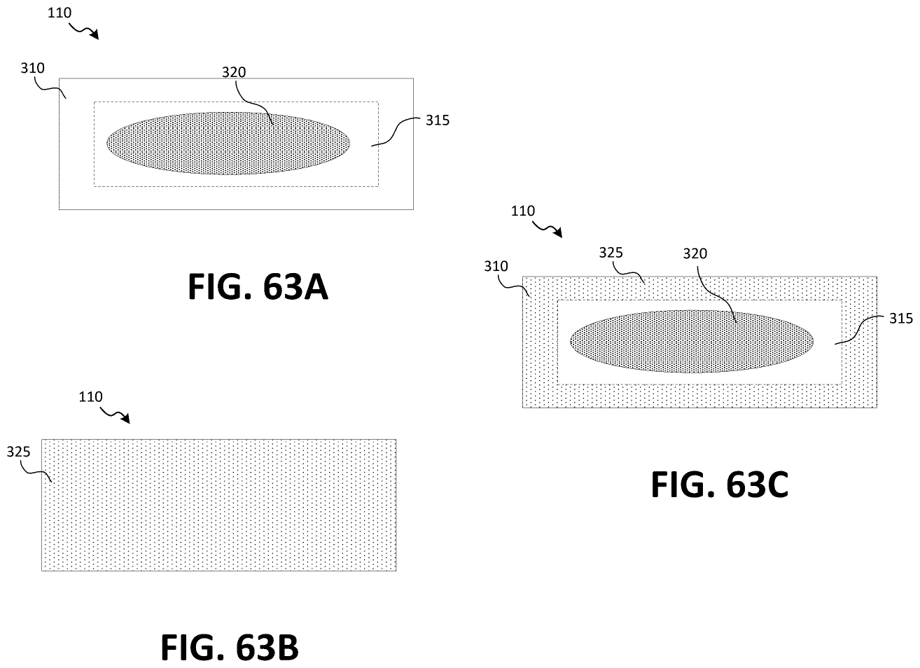

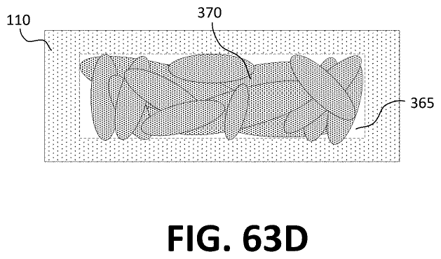

Another medicament delivery configuration for the arm of carrier 110 includes a polymer/medicament mixture configuration, as depicted in FIG. 63B. This polymer/medicament mixture configuration may involve the integration of the medicament directly into the polymer matrix to form a polymer/medicament mixture 325. In this polymer/medicament mixture configuration, the medicament is not merely coated on the surface but is homogeneously distributed throughout the polymer material, making it an intrinsic part of the arm's composition. This configuration ensures that as the polymer constituting the arm dissolves within the gingival crevice, the medicament is consistently released into the target area.

The process of creating the polymer/medicament mixture 325 may involve thoroughly mixing a predetermined dosage of the medicament with a selected polymer prior to the formation of the arm. This ensures that the medicament is evenly dispersed within the polymer, allowing for a controlled release as the polymer degrades. The dissolution rate of the polymer, and consequently the release rate of the medicament, can be precisely engineered by selecting appropriate polymer characteristics and processing techniques.

The polymer used for the polymer/medicament mixture 325 may be a biocompatible, biodegradable polymer that is well-tolerated within the oral environment. The selection of the polymer may be based on its dissolution properties, compatibility with the medicament, and the desired release profile. Polymers such as poly(lactic acid), poly(glycolic acid), and their copolymers, including poly(lactic-co-glycolic acid), may be used due to their ability to degrade into non-toxic byproducts.

The arm's structure, as formed from the polymer/medicament mixture 325, may be configured to maintain its integrity during insertion into the gingival crevice and to begin dissolving upon exposure to the moist environment. As the polymer dissolves, the embedded medicament is gradually released, providing a sustained therapeutic effect. This method of delivery is particularly advantageous for treatments requiring a slow and steady release of medicament, as it can be tailored to match the pharmacokinetics of the therapeutic agents.

The polymer/medicament mixture configuration of the carrier 110 arm, as shown in FIG. 63B, represents a method of medicament delivery that leverages the controlled degradation of the polymer to release the medicament over an extended period. This approach offers the potential for improved patient outcomes by ensuring a consistent and localized delivery of the medicament directly to the gingival crevice.

Yet another medicament delivery configuration for the arm of carrier 110 includes the internal well configuration illustrated in FIG. 63A. In embodiments, the internal well configuration illustrated in FIG. 63A features the formation of an internal well 315 within the carrier frame 310 of the arm of carrier 110. This internal well 315 may be configured to encapsulate or trap the medicament 320 within, which may be in liquid form or another suitable state for controlled release. The encapsulation of medicament 320 within the internal well 315 may represent a strategic approach to medicament delivery, ensuring that the medicament remains secure until the appropriate time for release.

The carrier frame 310, which defines the structure of the arm, may be configured to degrade or dissolve at a predetermined rate once placed within the moist environment of the gingival crevice. As the carrier frame 310 begins to dissolve, it eventually breaches the internal well 315, allowing the encapsulated medicament 320 to escape and be released into the gingival crevice. This release mechanism is activated by the dissolution of the carrier frame 310, which is carefully calibrated to occur over a controllable period, aligning with the desired therapeutic regimen.

The configuration of the internal well 315 and the selection of materials for the carrier frame 310 are based on their biocompatibility and dissolution characteristics. The materials chosen may be biodegradable polymers that can be safely absorbed by the body without causing adverse reactions. The dissolution rate is a function of the polymer's composition, the oral environment, and the interaction between the two. By manipulating these factors, the release of the medicament 320 can be finely tuned to provide a sustained therapeutic effect.

In some embodiments, the internal well 315 may be designed to hold multiple types of medicaments, allowing for a combination therapy approach. For example, in some embodiments, internal well 315 may include multiple sub-wells, each sub-well configured to encapsulate and/or trap a different type and/or dosage of medicament. In some embodiments, each of the sub-wells may be configured to breach at different dissolution times of carrier frame 310, which may allow for a multi-stage delivery of the medicament dosages. In some embodiments, the multiple sub-wells may be laid out side-by-side, or may be laid out one within the other (e.g., a first sub-well may be encapsulated by a second sub-well, etc.). This functionality enables the treatment of complex conditions that may require a synergistic effect of different therapeutic agents. The encapsulation within the internal well 315 may also protect the medicament 320 from premature degradation or interaction with external factors, ensuring that its potency is preserved until the moment of release.

The internal well configuration of the carrier 110 arm, as depicted in FIG. 63A, provides a precise and secure method for delivering medicaments directly to the gingival crevice. The controlled dissolution of the carrier frame 310 to release the medicament 320 represents an improvement in targeted medicament delivery with the potential for enhanced patient outcomes.

Still another medicament delivery configuration for the arm of carrier 110 includes the multi-stage delivery configuration illustrated in FIG. 63C. The multi-stage delivery configuration, as illustrated in FIG. 63C, represents a combination of the features of the polymer/medicament mixture configuration and the internal well configuration described with respect to FIGS. 63B and 63A, respectively. In the multi-stage delivery configuration, the carrier frame 310 may be composed of a polymer/medicament mixture 325, and additionally, an internal well 315 may be incorporated to encapsulate medicament 320. This configuration allows for a sequential release of medicaments, providing a comprehensive treatment strategy.

In the first stage of the multi-stage delivery configuration of carrier 110, as the carrier frame 310 begins to dissolve within the gingival crevice, the medicament embedded within the polymer/medicament mixture 325 may be gradually released. This initial phase of delivery may be controlled by the dissolution rate of the polymer matrix, which may be configured to align with the therapeutic requirements of the medicament. The polymer/medicament mixture stage (e.g., the first stage of the multi-stage delivery configuration of carrier 110) ensures a steady and controlled release of the medicament, providing a baseline level of therapeutic agent in the target area.

The second stage of the multi-stage delivery configuration of carrier 110 may be initiated once the dissolution process reaches the internal well 315, breaching its integrity and allowing the encapsulated medicament 320 to be released into the gingival crevice. This second stage can be designed to occur after a predetermined time interval following the initial release, providing a subsequent boost or a different therapeutic action as dictated by the treatment plan. The encapsulated medicament 320 may consist of the same medicament as in the polymer/medicament mixture 325 for a sustained dosage, or it may contain a different medicament to address additional aspects of the patient's condition.

The dual-release mechanism of this multi-stage delivery configuration offers the advantage of delivering multiple medicaments or doses at different intervals, enhancing the overall efficacy of the treatment. For example, the first stage could provide an immediate anti-inflammatory effect, while the second stage could deliver an antibiotic to combat infection. Alternatively, the two stages could deliver the same medicament at different concentrations to maintain a therapeutic level over an extended period.

### Carrier Filament Mesh Configuration

The multifilament mesh configuration of carrier 110, includes configuring the carrier 110 as a network of dissolvable filaments that are intricately woven to create a multifilament mesh structure with interstitial spacings between the dissolvable filaments. In embodiments, the dissolvable filaments of the multifilament mesh may be made of a cellulose or biocompatible polymer and and/or biodegradable polymer. In embodiments, the composition of the multifilament mesh may be configured as a flexible structure configured to navigate the contours of the gingival crevice with ease.

In some embodiments, the carrier 110 of the multifilament mesh configuration may include a window within which the mesh structure may be contained. For example, as shown in FIG. 3D, carrier 110 may be provided with a window 365 configured to contain the mesh structure 370 including the medicament. In embodiments, the mesh structure 370 may be configured to dissolve at a faster rate than the carrier 110.

In embodiments, the length of the carrier 110 in the multifilament mesh configuration may be configured to ensure that a substantial portion can be comfortably placed within the gingival crevice, allowing for an effective and localized delivery of the medicament. In embodiments, the length of the multifilament mesh may be between 4-12 mm, and in some embodiments, the length of the arm may be between 1-50 mm. In embodiments, the length of the arm may be <50 mm, and more preferably <15 mm.

In embodiments, the width of the multifilament mesh may be configured to fit snugly within the gingival crevice without causing discomfort or irritation to the patient. In embodiments, the width of the multifilament mesh may be between 0.1-5 mm.

In embodiments, the thickness of the multifilament mesh may be configured to fit within the gingival crevice without causing discomfort or irritation to the patient. In embodiments, the thickness of the multifilament mesh may be between 0.001-3 mm. In embodiments, the thickness of the arm may be <3 mm, and more preferably <1 mm.

In embodiments, the size of the spaces between the dissolvable filaments may be configured based on width of the multifilament mesh may be configured to fit snugly within the gingival crevice without causing discomfort or irritation to the patient. In embodiments, the width of the multifilament mesh may be between 0.1-5 mm.

In embodiments, the size of the spaces between the dissolvable filaments may be a customizable feature that can be configured based on the medicament composition and/or the desired release kinetics. The configuration of these spaces may play a role in controlling how the medicament is released as the filaments dissolve. For example, a multifilament mesh with a higher density of filaments results in smaller interstitial spaces, which may contain less medicament and thus release it more slowly. However, in this example, the increased quantity of filaments would contain a greater amount of medicament within their structure, potentially allowing for a faster release rate as the filaments themselves dissolve. Conversely, a mesh with fewer filaments creates larger spaces, accommodating more medicament within these voids, but with less medicament embedded in the filaments due to their reduced number. This configuration can lead to a quicker release of medicament from the spaces, while the release from the filaments may be slower. The functionality to tailor the filament density and space size provides a configuration for achieving the precise control over the release profile of the medicament.

In some embodiments, the multifilament mesh configuration of carrier 110 may include filaments with irregular and amorphous shaping. This configuration may create a mesh structure where the volumetric spacing between filaments is not uniform, but rather tailored to optimize the delivery and retention of medicaments within the gingival crevice. The irregular shaping of the multifilament mesh allows for a more varied distribution of medicament throughout the carrier 110. This can be particularly useful when a heterogeneous release profile is desired, or when the treatment requires a localized concentration gradient of the medicament. The spaces created by the irregular filament arrangement are filled with medicament, ensuring that upon dissolution, the medicament is released into the gingival crevice in a controlled manner.

In embodiments, the multifilament mesh may be configured to detach from the handle 140 upon insertion into the gingival crevice. This detachment is a deliberate action that leaves the multifilament mesh within the gingival crevice, where it begins the process of delivering medicament. For example, as the filaments of the multifilament mesh dissolve, the medicament is released into the gingival crevice in a controlled manner, ensuring that the medicaments carried by the multifilament mesh are absorbed directly into the gingival crevice space.

In embodiments, the multifilament mesh of carrier 110 may be configured in different configurations for medicament delivery, ensuring that the therapeutic agents are effectively administered to the gingival crevice. There are multiple ways in which the multifilament mesh can carry the medicament, each tailored to maximize the delivery and absorption of medicaments within the oral cavity.

A first medicament delivery configuration for the multifilament mesh configuration of carrier 110 may include a space filling configuration. In the space filling configuration, the spaces between the dissolvable filaments of the multifilament mesh may serve as reservoirs for the medicament. In embodiments, these spaces may be strategically positioned within the mesh structure to ensure that, upon dissolution of the filaments, the medicament is released directly into the gingival crevice. The design of the space filling configuration is such that it maximizes the contact area between the medicament and the gingival crevice, facilitating efficient and direct absorption of the medicament into the patient's system.

The space filling configuration may be particularly advantageous for treatments requiring a rapid onset of action, as the medicament stored within the spaces can be released quickly upon the initial dissolution of the filaments. This allows for an immediate therapeutic effect, which is beneficial in acute situations where prompt delivery of the medicament may be desired. The size and shape of the spaces can be configured to accommodate varying amounts of medicament, depending on the dosage requirements and the specific medicament being used.

In addition to the immediate release benefits, the space filling configuration can be configured to control the sustained release of the medicament. By adjusting the density and arrangement of the filaments, the size of the spaces can be varied, which in turn influences the amount of medicament that can be held within the mesh and the rate at which it is released. A denser mesh with smaller spaces may be used to hold a smaller volume of medicament for a slower, more controlled release, while a looser mesh with larger spaces can accommodate a larger volume of medicament for a quicker release.

This controlled release is particularly useful for managing chronic conditions that require a consistent level of medicament over an extended period. The multifilament mesh configuration with space filling allows for a customizable release profile, enabling the delivery system to be tailored to the pharmacokinetics of the medicament and the therapeutic goals of the treatment. By providing a controlled and localized delivery of medicament, the space filling configuration enhances the efficacy of the treatment while potentially reducing systemic side effects associated with more traditional routes of administration.

Another medicament delivery configuration for the multifilament mesh configuration of carrier 110 may include a surface coating configuration. In the surface coating configuration, the surface of one or more of the dissolvable filaments may be coated with the medicaments. As the multifilament mesh remains within the gingival crevice and the dissolvable filaments of the multifilament mesh begins to dissolve, the medicament on the surface of the filaments may progressively be released and absorbed through the gingival crevice into the patient's system. The surface coating technique allows for an immediate and localized delivery of the medicament upon the dissolution of the carrier, providing a direct and efficient means of administration that is designed to enhance the bioavailability of the medicament for the patient.

Still another medicament delivery configuration for the multifilament mesh configuration of carrier 110 may include a polymer/medicament mixture configuration. In the polymer/medicament mixture configuration, the dissolvable filaments may be composed of a polymer mix that includes both the polymer and the medicament. This composition means that the medicament is an integral part of the filament structure, allowing for a uniform distribution of the medicament throughout the mesh. As the moist environment of the gingival crevice interacts with the filaments, the filaments begin to dissolve, releasing the medicament in a controlled and localized manner.

This polymer/medicament mixture configuration may be particularly advantageous for achieving a sustained release of the medicament. By embedding the medicament within the polymer matrix of the filaments, the release is not merely surface-level but is maintained throughout the dissolution process of the filament material. This ensures a consistent and prolonged therapeutic effect, which is ideal for managing conditions that require a steady administration of medication over time.

In embodiments, choice of polymer is influenced by factors such as biocompatibility, dissolution rate, and the desired therapeutic outcome. In embodiments, polymers used for the polymer/medicament mixture configuration may include polymers that are biodegradable and have a safety profile for use in medical applications.

In embodiments, the dissolution rate of the dissolvable filaments, which directly affects the release rate of the medicament, is a tunable parameter within this polymer/medicament mixture configuration. By selecting polymers with specific characteristics, such as molecular weight and hydrophilicity, the dissolution rate can be precisely controlled. This allows for the tailoring of the medicament release profile to match the therapeutic requirements of the patient's treatment plan. Factors such as the polymer's biocompatibility and dissolution rate may be considered to ensure that the chosen polymer not only provides the desired release kinetics but also maintains a high safety profile suitable for medical applications.

Yet another medicament delivery configuration for the multifilament mesh configuration of carrier 110 may include a multi-stage delivery configuration. The multi-stage delivery configuration represents a combination of the surface coating configuration, the polymer/medicament mixture configuration, and/or the space filling configuration. This multi-stage configuration leverages on the strengths of each individual configuration to provide a robust and versatile delivery mechanism. In this combined configuration, at least a portion of the surface of one or more dissolvable filament may be coated with the medicament, and one or more of the dissolvable filaments may also be intrinsically composed of a polymer/medicament mixture, ensuring a uniform distribution of the medicament both on the surface and within the structure of the dissolvable filaments. Additionally, the interstitial spaces between the dissolvable filaments may operate as reservoirs, further loaded with the medicament to enhance the delivery capacity.

In embodiments, the multi-stage configuration may allow for an initial burst of medicament release from the surface coating upon insertion into the gingival crevice, followed by a sustained release from both the polymer/medicament mixture within the filaments and the medicament contained in the spaces. The initial release provides immediate therapeutic action, while the sustained release maintains the therapeutic levels over an extended period, catering to both acute and chronic treatment requirements. The combined delivery system may be configured to control the release kinetics by adjusting the ratio of surface coating to the polymer/medicament mixture and the volume of medicament in the spaces.

In embodiments, the medicament in each of the surface of the dissolvable filaments, the polymer/medicament mixture used to make the dissolvable filaments, and the medicament used to fill the spaces between the dissolvable filaments may include different types of medicaments, may include different doses of the same medicament, or may include same doses of the same medicament.

The multi-stage release profile of the multi-stage configuration may be particularly advantageous for complex treatment regimens that require a carefully orchestrated release of multiple medicaments or varying doses over time. For example, the surface coating could be designed to deliver an anti-inflammatory agent for immediate relief, while the polymer/medicament mixture and the space filling reservoirs could contain an antibiotic for a prolonged effect to combat infection.

### JET Device Operation

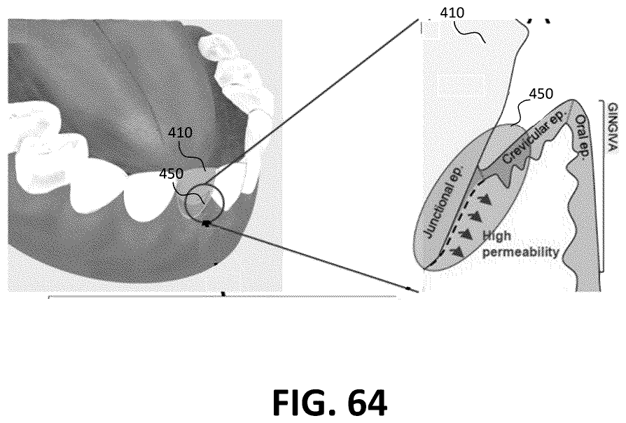

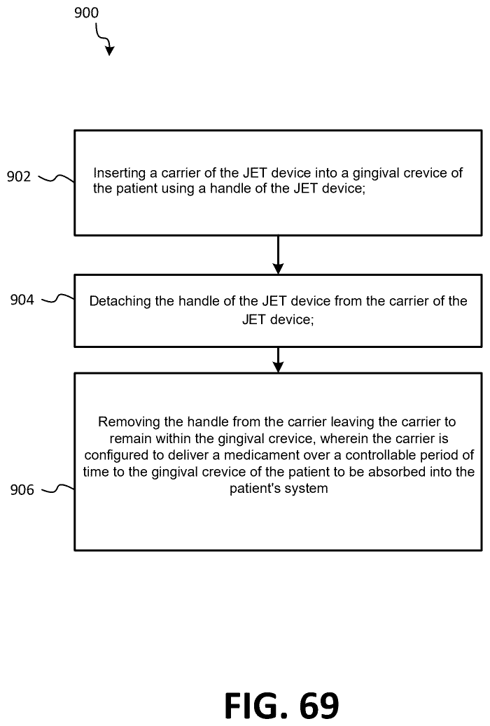

Operation of JET device 100 will now be discussed with respect to FIG. 69, as well as FIGS. 64, 65A-65C, 66A-66C, 67A-67C, and 68A-68C, in accordance with aspects of the present disclosure. FIG. 69 shows a high-level flow diagram of operations of a JET device for controlled delivery of medicaments to the gingival crevice of a patient in accordance with embodiments of the present disclosure.

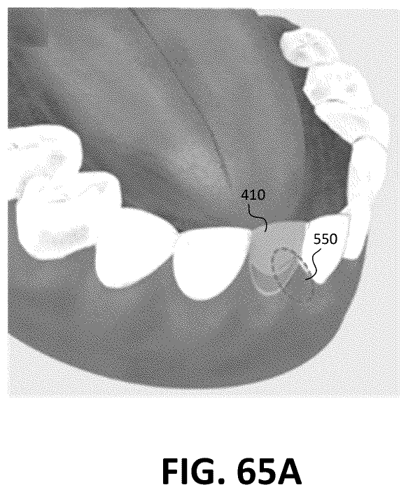

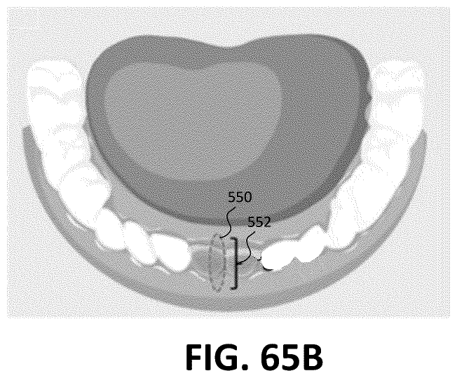

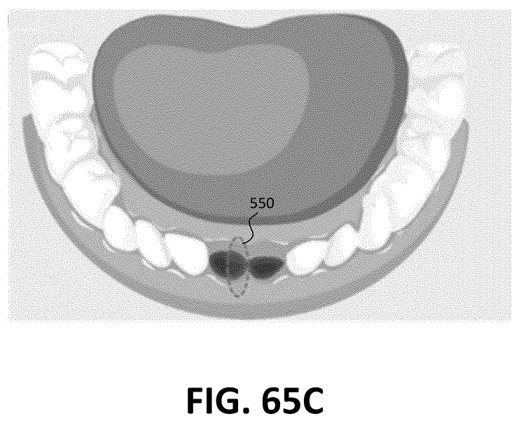

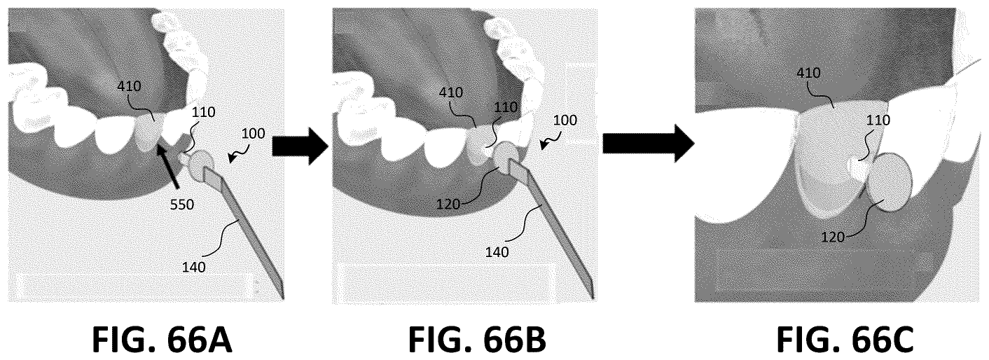

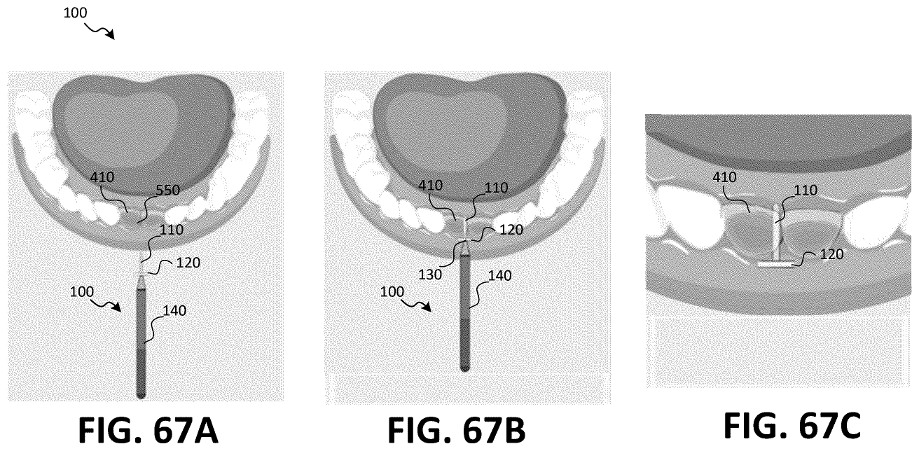

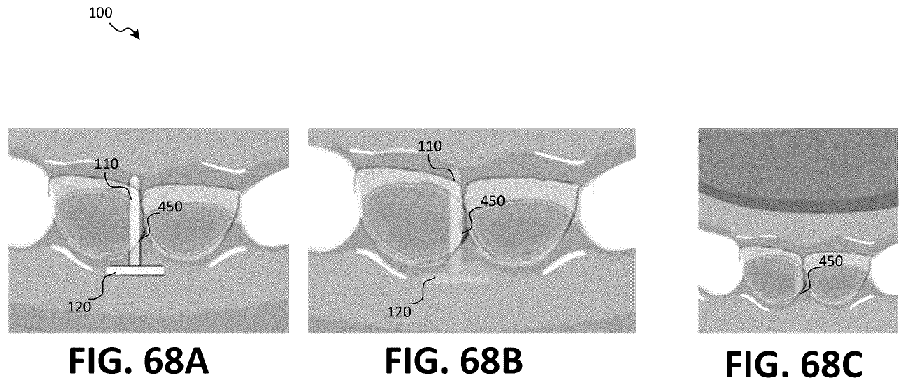

FIG. 64 shows an exemplary location of a gingival crevice and a junctional epithelium in accordance with embodiments of the present disclosure. FIG. 65A-65C illustrate various views of an exemplary location of a target area for delivery of medicaments into a gingival crevice in accordance with embodiments of the present disclosure. FIG. 66A-66C illustrate example operations for delivery of medicaments into a gingival crevice in accordance with embodiments of the present disclosure. FIG. 67A-67C illustrate another view of the example operations for delivery of medicaments into a gingival crevice in accordance with embodiments of the present disclosure. FIG. 68A-68C illustrate example operations for delivery of medicaments into a gingival crevice via dissolvement of the carrier in accordance with embodiments of the present disclosure.

FIG. 64 provides a detailed diagrammatic representation of the anatomical location targeted for medicament delivery using the JET device 100. In particular, FIG. 64 shows the gingival crevice 450 adjacent to tooth 410 within a patient's mouth. Gingival crevice 450 includes the gingival crevice, which includes a narrow space between the tooth and the surrounding gum tissue. The gingival crevice area is of particular interest for the delivery of medicaments due to the presence of the junctional epithelium (JE), which has a high permeability. The JE is a specialized epithelial layer that facilitates the efficient absorption of substances directly into the patient's system.

Gingival crevice 450 represents the precise placement location for the carrier 110 of the JET device 100. In some embodiments, the location for placement of carrier 110 may specifically target the JE high permeability region of the gingival crevice 450. In these embodiments, by focusing on this area, the JET device 100 is configured to maximize the bioavailability of the medicaments, ensuring that they are delivered directly to the region where they can be rapidly absorbed and utilized by the body. The diagram shown in FIG. 64 serves as a visual guide to identify the correct anatomical site for the placement of the JET device 100, ensuring accurate and effective delivery of the therapeutic agents to the patient.

FIGS. 65A-65C provide a series of views that detail the anatomical target area for the placement of the carrier 110 of the JET device 100 within the oral cavity. These figures illustrate an example of the precise location for the insertion of the carrier 110, which is designed to deliver medicaments directly to the gingival crevice of a patient. The illustrations depict the gingival crevice, also known as the gingival crevice, which is situated adjacent to the teeth and is the specific site where the JET device 100 is to be applied. The figures collectively offer different perspectives that enhance the understanding of the spatial relationship between the JET device 100 and the surrounding oral structures, ensuring accurate placement and effective medicament delivery.

For example, FIG. 65A presents an anterior view of a human mouth, emphasizing the target area 550 for the placement of a medical device such as the carrier 110 of the JET device 100. The target area 550 is identified as the gingival crevice 450, the gingival crevice 450 located adjacent to tooth 410, and/or the JE of gingival crevice 450. This view is particularly useful for visualizing the frontal access to the gingival crevice where the carrier 110 is to be inserted. The anterior perspective provides a clear view of the spacing between the teeth, accurately illustrating the appropriate insertion point for the carrier 110 to ensure effective delivery of medicaments.

In FIG. 65B, the caudal view of the target area 550 is depicted, illustrating the orientation of the geometric space into which the carrier 110 is to be inserted, with the teeth present. This perspective offers a view from behind the teeth, showcasing the depth and contours of the gingival crevice where the carrier 110 will reside. The average depth of the target area is noted as depth 552. In embodiments, depth 552 averages approximately 1-3 mm, which is a relevant measurement for ensuring that the carrier 110 is of suitable size and shape for insertion without causing discomfort or injury to the patient.

FIG. 65C provides a caudal view of the target area 550, similar to FIG. 65B, but with the teeth removed to offer an unobstructed view of the gingival crevice within the target are 550. This representation may serve to provide understanding the geometry of the gingival crevice without the visual interference of the teeth. It highlights that the JET device 100 can be applied to any gingival crevice between any teeth within the mouth (e.g., not limited to the gingival crevice illustrated in the Figures but can be applied to any gingival crevice within the mouth of the patient), demonstrating the versatility of the carrier 110 in terms of its placement. This figure underscores the adaptability of the JET device 100 to various locations within the oral cavity, ensuring that the carrier 110 can be inserted into the appropriate gingival crevice for effective medicament delivery.

FIGS. 66A-66C illustrate operations of the JET device 100 for the delivery of medicaments to the gingival crevice of a patient, as also illustrated in FIG. 69. In embodiments, the operations of the JET device 100 for the delivery of medicaments to the gingival crevice of a patient is a multi-step process. These figures illustrate the sequential actions taken to ensure the precise and effective placement of the carrier 110 within the target area 550, which includes the gingival crevice adjacent to the teeth.

At block 902 (as shown in FIG. 69), a carrier of the JET device is inserted into a gingival crevice of the patient using a handle of the JET device. For example, as shown in FIG. 66A, the initial step involves positioning the JET device 100 such that the carrier 110 is aligned with the target area 550. The user holds the handle 140 and guides the carrier 110 towards the target area 550, which may include the gingival crevice, ensuring that the carrier is directed towards the gingival crevice. This step is instrumental in preparing for the insertion of the carrier 110, which contains the medicament intended for delivery to the patient.

As shown in FIG. 66B, the carrier 110 is inserted into the target area 550 using the handle 140. The user applies gentle pressure to advance the carrier 110 into the gingival crevice, ensuring that the medicament is positioned for optimum absorption, until the stop tab 120 presses against tooth 410 and the carrier 110 is physically prevented from being inserted further. The handle 140 provides the leverage and control needed to insert the carrier 110 without causing discomfort to the patient. The stop tab 120 plays a crucial role during this step, acting as a physical boundary to prevent over-insertion of the carrier 110 into the gingival crevice. This safeguard ensures that the carrier 110 is positioned at the correct depth for the medicament to be released in the desired location without causing discomfort or injury to the patient. The handle 140, combined with the stop tab 120, provides the user with the control and confidence to perform the insertion accurately and comfortably.

At block 904 (as shown in FIG. 69), the handle of the JET device is detached from the carrier of the JET device, and at block 906, the handle is removed from the carrier leaving the carrier to remain within the gingival crevice. In embodiments, the carrier is configured to deliver a medicament over a controllable period of time to the gingival crevice of the patient to be absorbed into the patient's system. For example, as shown in FIG. 66C, the handle 140 is detached from the carrier 110, and the carrier 110 is left, along with stop tab 120, within the target area 550. For example, the user applies a specific motion, such as a pull or twist, facilitated by the detachable connection 130, to separate the handle 140 from the carrier 110. Once detached, the carrier 110, may remain within the gingival crevice, and the handle 140 is removed. At this stage, the carrier 110 is now in the correct position to begin the controlled release of the medicament directly into the gingival crevice, where it will dissolve over time and be absorbed into the patient's system.

The JET device 100 is configured to ensure that the medicament is delivered in a targeted manner, maximizing the therapeutic benefits while minimizing the potential for systemic side effects. The ease of use and precision of the JET device 100 make it an effective tool for delivering a wide range of medicaments to the gingival crevice, addressing various conditions and nutritional deficiencies.

FIGS. 67A-67C offer a caudal representation that complements the operations described in FIGS. 66A-66C, providing a different perspective for ease of understanding. These Figures visually guide the user through the same sequence of steps for the JET device 100 operation, but from a viewpoint that is posterior to the teeth, offering a clear visualization of the depth and orientation within the oral cavity. This caudal viewpoint is particularly helpful in illustrating the precise positioning of the carrier 110 within the gingival crevice and the role of the stop tab 120 in preventing over-insertion, ensuring that the medicament delivery is executed as intended.

FIGS. 68A-68C depict the progressive dissolution of the carrier 110 within the gingival crevice 450 after insertion into the gingival crevice 450 for the delivery of medicaments. FIGS. 68A-68C illustrate the stages of dissolution that the carrier 110 undergoes once it is in the moist environment of the gingival crevice. In particular, FIG. 68A shows the carrier 110 immediately after insertion into the gingival crevice 450, positioned adjacent to the tooth. At this initial stage, the carrier 110 may be almost intact, and the stop tab 120 may be in place to prevent further insertion. The moist environment of the gingival crevice begins to interact with the carrier 110, initiating the dissolution process, and also initiating the medicament delivery.

As illustrated in FIG. 68B, after a first time frame (e.g., approximately 20 seconds in the specific example illustrated in FIG. 68B but may be any time between a few seconds to a few minutes, to a few hours), the carrier 110 may start to dissolve, releasing the medicament into the gingival crevice 450. The dissolution process is designed to be controlled, in accordance with embodiments of the present disclosure, allowing the medicament to be released at a rate that maximizes absorption and therapeutic efficacy.

By the stage shown in FIG. 68C, which may represent a second time frame period (e.g., approximately 45 seconds in the specific example illustrated in FIG. 68C but may be any time between a few seconds to a few minutes, to a few hours), the carrier 110 is nearing complete dissolution. Only remnants of the carrier 110 may be visible, indicating that the majority of the medicament has been released. In some embodiments, the stop tab 120, which may also be made of a dissolvable material, dissolves along with the carrier 110, leaving no residue and ensuring patient comfort.

At a subsequent time (not illustrated in the Figures) following the second time frame, both the carrier 110 and the stop tab 120 may have completely dissolved, ensuring that the full dose of the medicament is delivered to the gingival crevice. This complete dissolution facilitates the delivery of the medicament in its entirety, maximizing the therapeutic potential directly at the site of action within the oral cavity.

In various embodiments of the JET device 100, the carrier 110 may be configured to dissolve within a time range that can vary from as little as 5 seconds to as long as 24 hours, depending on the specific treatment requirements and the composition of the carrier 110. This flexibility in dissolution time allows for the delivery of medicaments to be tailored to the individual patient's absorption rates and the prescribed dosage schedule, ensuring a personalized treatment approach. The controlled dissolution of the carrier 110 within the gingival crevice 450 represents a novel and inventive functionality of the JET device, providing a targeted and effective means of medicament delivery directly to the site of action.

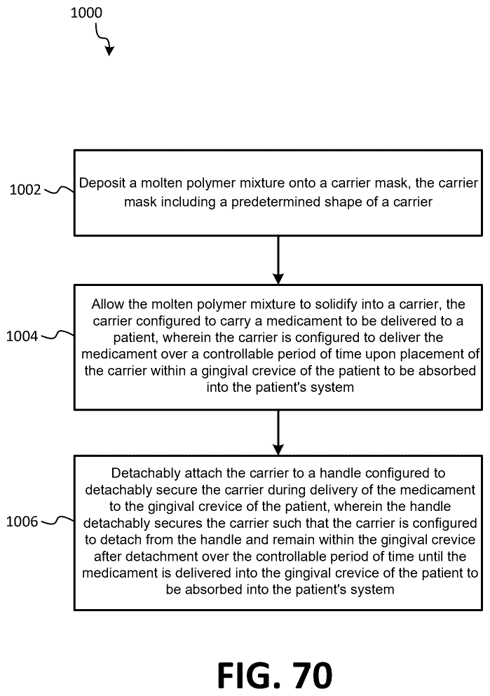

FIG. 70 shows an exemplary flow diagram of operations for manufacturing a JET device configured with functionality for controlled delivery of medicaments to the gingival crevice of a patient in accordance with aspects of the present disclosure. For example, the steps illustrated in the example blocks shown in FIG. 70 may be performed to manufacture JET device 100 of FIGS. 61-67C, according to embodiments herein.

At block 1002, a molten polymer mixture may be deposited onto a carrier mask. In embodiments, the carrier mask may include a predetermined shape of a carrier, such as carrier 110 of FIGS. 61-67C. In embodiments, the molten polymer mixture includes a polymer configured to dissolve in response to placement of the carrier within the gingival crevice of the patient. In embodiments, the dissolvement of the carrier causes the medicament to be released from the carrier into the gingival crevice of the patient to be absorbed into the patient's system.

At block 1004, the molten polymer mixture is allowed to solidify into a carrier. In embodiments, the carrier may be configured to carry a medicament to be delivered to a patient and may be configured to deliver the medicament over a controllable period of time upon placement of the carrier within a gingival crevice of the patient to be absorbed into the patient's system.

At block 1006, the carrier is detachably attached to a handle configured to detachably secure the carrier during delivery of the medicament to the gingival crevice of the patient. In embodiments, the handle detachably secures the carrier such that the carrier is configured to detach from the handle and remain within the gingival crevice after detachment over the controllable period of time until the medicament is delivered into the gingival crevice of the patient to be absorbed into the patient's system.

In embodiments, the molten polymer mixture further includes the medicament such that the polymer and the medicament are mixed together with the medicament being contained within the intrinsic constitution of the polymer.

In embodiments, the shape of the carrier defines an internal well defined by a carrier frame. In embodiments, at least a portion of the medicament is encapsulated within the internal well, such that the at least a portion of the medicament is trapped within the internal well and begins to be released from the internal well upon dissolvement of at least a portion of the carrier frame sufficient to reach the internal well and allow the first portion of the medicament to escape from the internal well.

In embodiments, at least a portion of a surface of the carrier is coated with the medicament such that the medicament begins to be released into the gingival crevice upon placement of the carrier into the gingival crevice.

In embodiments, a stop tab may be disposed between the carrier and the handle. The stop tab may be configured to prevent the carrier from being inserted beyond the gingival crevice during delivery of the medicament to the gingival crevice of the patient.

In embodiments, the carrier mask may be textured to alter the surface topography and surface energy of the carrier to provide a rough factor (Rₐ). In embodiments, the rough factor Rₐ may provide different patterns including perpendicular lay pattern, parallel lay pattern, wave lay pattern, dimpling, roughing (Rₐ) zigzag etching, circular Rₐ pattern, multi Rₐ pattern, radial Rₐ pattern onto the carrier surface.

Various embodiments of the present disclosure are directed to a JET device and system, and/or methods of manufacturing and/or using a JET device, that includes functionality for delivery of medicaments by agitation. In particular embodiments, the JET device may include an arm attached to a handle. The arm may be configured to carry medicament on at least a portion of the surface of the arm. The arm may be configured to be inserted into the gingival crevice of a patient, and to release the medicament into the gingival crevice in response to an agitation action applied to the handle of the JET device by the patient. The agitation action, which may include a back-and-forth motion, may cause the medicament coated surface of the arm to brush, graze, or otherwise rub against the gingival crevice causing the medicament to be scraped off the surface of the arm and to be deposited into the gingival crevice to be absorbed into the patient's system.

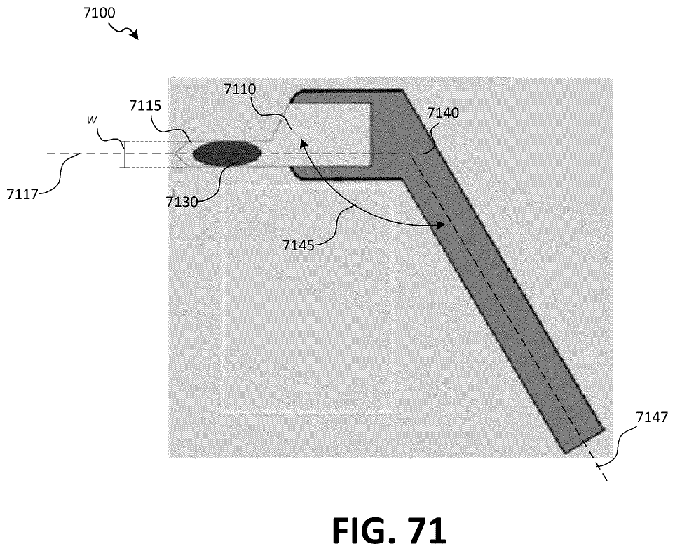

FIG. 71 shows an exemplary JET device 7100 configured with capabilities and functionality for delivery of medicaments by agitation action in accordance with embodiments of the present disclosure. As shown in the particular embodiment illustrated in FIG. 71, JET device 7100 may include arm 7110 and handle 7140. In embodiments, the arm 7110 may include an insertable portion 7115 configured to be inserted into the gingival crevice of a patient. At least a portion of a surface of the insertable portion 7115 may be configured to carry medicament 7130 (e.g., by coating the at least a portion of the surface of the insertable portion 7115 with the medicament) and to release the medicament 7130 into the gingival crevice in response to an agitation action. For example, a user may manipulate the handle 7140 to insert the insertable portion 7115 of the arm 7110 into the gingival crevice of the patient, and to apply the agitation action to the JET device 7100. In embodiments, the agitation action may include a back-and-forth motion upon the JET device 7100 while the insertable portion 7115 of the arm 7110 is within the gingival crevice of the patient. The back-and-forth motion may cause the insertable portion 7115 of the arm 7110 to rub or brush against the gingival crevice causing the medicament 7130 to be scraped off the arm 7110 and deposited into the gingival crevice, where the medicament may be absorbed into the patient's system. In embodiments, these components of JET device 7100 may be configured to include various designs and/or configurations for providing functionality as described in various embodiments of the present disclosure.

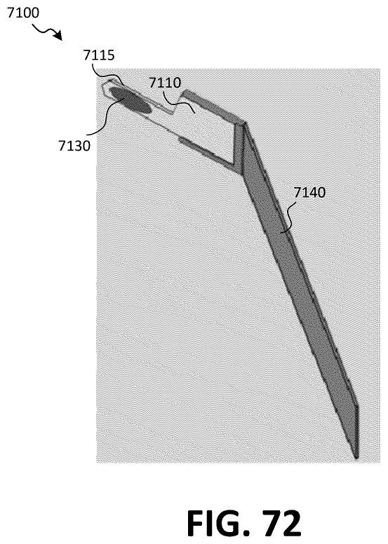

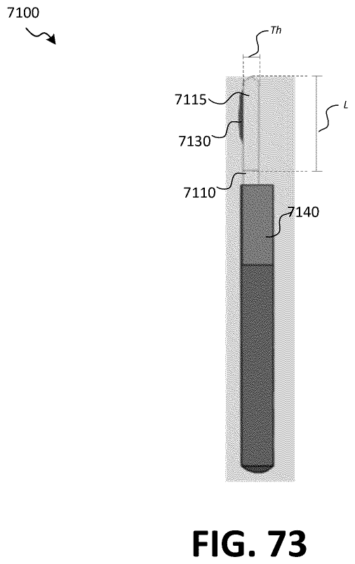

FIG. 72 shows a perspective view of the exemplary JET device 7100 configured with capabilities and functionality for delivery of medicaments to the gingival crevice of a patient in accordance with embodiments of the present disclosure. FIG. 73 shows a caudal view of the exemplary JET device 7100 configured with capabilities and functionality for delivery of medicaments to the gingival crevice of a patient in accordance with embodiments of the present disclosure.

In embodiments, the handle 7140 is configured to attach to the arm 7110 of the JET device 7100 to provide a comfortable and secure grip for the user, allowing for precise manipulation of the JET device 7100 during insertion and use. The handle 7140 may be constructed from materials that offer durability and stability (e.g., plastic, steel, etc.), ensuring that the handle 7140 is able to withstand the forces exerted during the agitation action without compromising its structural integrity.

In some embodiments, the handle 7140 may be ergonomically shaped to conform to the natural contours of a user's hand, reducing the potential for user fatigue and improving the overall experience during the application of the medicament. The ergonomic design of the handle 7140 may include features such as a thumb rest, finger grooves, or a non-slip surface, which may contribute to a more controlled and steady insertion into the gingival crevice and/or application of the agitation action. These features may be particularly beneficial when the user is applying the back-and-forth motion that is configured to deliver the medicament into the gingival crevice.

The handle 7140 may also be configured to facilitate the precise positioning of the arm for insertion into the gingival crevice. For example, the handle 7140 may incorporate visual indicators on the handle, such as markings or notches, which may operate to guide the user in aligning the insertable portion 7115 of the arm 7110 with the target area within the mouth. Additionally, the handle 7140 may include an adjustable angle mechanism that allows the user to customize the angle between the handle 7140 and the arm 7110, optimizing the orientation for different gingival crevice locations and user preferences. For example, an angle 7145 may be defined between the longitudinal axis 7117 of the arm 7110 and the longitudinal axis 7147 of the handle 7140. In some embodiments, the adjustable angle mechanism of the handle 7140 may operate to customize or change angle 7145. In some embodiments, angle 7145 (as shown in FIG. 71) may be a fixed angle and may not be changeable or customizable. In embodiments, angle 7145 may be any angle between 30 degrees to 180 degrees.

In embodiments, the handle 7140 may be configured to facilitate the application of the agitation action upon the JET device 7100. For example, after the insertable portion 7115 of the arm 7110 is inserted into the gingival crevice of the patient, the handle 7140 may be used by the patient to apply a back-and-forth motion or action upon the JET device 7100, which may cause the medicament 7130 to be effectively scraped off the insertable portion 7115 and deposited into the gingival crevice of the patient. The agitation action (e.g., the back-and-forth motion) enabled by the handle 7140 may be smooth and consistent, minimizing the risk of injury to the delicate tissues within the gingival crevice while maximizing the efficiency of medicament delivery.

In some embodiments, the handle 7140 may be detachable or interchangeable, allowing for different handle configurations to be used with the same arm 7110 or for the handle to be replaced if damaged. This modularity may also accommodate handles of various sizes to cater to users with different hand sizes or those who require a larger or smaller handle for comfort.

The arm 7110 of the JET device 7100 may be configure for the delivery of medicaments to the gingival crevice. The arm 7110 may include an insertable portion 7115, which may be specifically configured to be comfortably inserted into the gingival crevice of a patient. The insertable portion 7115 may be configured to have at least a portion of its surface coated with a medicament 7130, which may be configured for delivery and absorption into the patient's system. The configuration of the arm 7110 may be such that it may facilitate the deposition of the medicament 7130 directly into the gingival crevice upon insertion.

The insertable portion 7115 may be configured to interact with the gingival crevice in a way that maximizes the transfer of the medicament 7130. For example, the insertable portion 7115 may be configured to release the medicament 7130 in response to an agitation action, which may involve a controlled back-and-forth movement (e.g., once or a plurality of times) of the insertable portion 7115 within the gingival crevice. This back-and-forth movement may cause the medicament 7130 to be effectively scraped off from the surface of the insertable portion 7115, ensuring that the medicament 7130 is deposited within the gingival crevice where it can be readily absorbed into the patient's system.

In embodiments, the insertable portion 7115 of the arm 7110 may be configured to facilitate targeted delivery of medicaments into the gingival crevice. In some embodiments, the insertable portion 7115 may include a semi-rigid flat-bodied extension that may be configured for easy insertion into the gingival crevice. The semi-rigid nature of the insertable portion 7115 ensures that it has enough flexibility to conform to the contours of the gingival crevice while maintaining the structural integrity to perform the agitation action effectively.

In some embodiments, the insertable portion 7115 may have an extended spear-like shape, which may enhance the insertable portion 7115's ability to penetrate the gingival crevice with precision and ease. The spear-like shape may be conducive to reaching deeper into the gingival crevice, allowing for the medicament 7130 to be delivered directly to the junctional epithelium, which may be the target site for absorption of the medicament 7130.

In embodiments, the dimensions of the insertable portion 7115 may be such that it may fit comfortably within the gingival crevice without causing discomfort to the patient. For example, as shown in FIG. 73, a length L of the insertable portion 7115 may be within a range of 1 to 30 mm, allowing it to reach sufficiently into the gingival crevice to target the junctional epithelium effectively. A thickness Th of the insertable portion 7115 may be within a range that includes 0.3 mm (e.g., between 0.01 and 1 mm), providing a balance between flexibility and the structural rigidity that is requisite for the agitation action to scrape off the medicament. As shown in FIG. 71, a width W of the insertable portion 7115 may fall within a range that includes 3 mm (e.g., between 0.05 and 10 mm), which may be narrow enough to fit within the gingival crevice without causing undue pressure or discomfort to the patient.

In embodiments, the insertable portion 7115 may be configured to take into account the delicate nature of the gingival tissue. For example, the edges of the semi-rigid flat-bodied extension may be smoothed and rounded to prevent any inadvertent injury or irritation during insertion and use. The surface of the insertable portion 7115 that carries the medicament 7130 may also be configured to maximize the contact with the gingival crevice lining, ensuring that the medicament 7130 is efficiently transferred or scraped off from the insertable portion 7115, and deposited into the gingival crevice for absorption into the patient's system.

In embodiment, the arm 7110 may be composed of monofilaments, which may be selected based on various characteristics to suit specific application requirements. The monofilaments may be unwaxed, providing a natural texture that may enhance the adherence of the medicament 7130 to the surface. In additional or alternative embodiments, waxed monofilaments may be used to create a smoother surface that may facilitate the insertion of the insertable portion 7115 of the arm 7110 into the gingival crevice. Braided monofilaments may offer increased surface area and mechanical strength, which may be beneficial for carrying and releasing the medicament 7130. Non-braided monofilaments, on the other hand, may provide a simpler structure that may be preferred for ease of manufacturing or specific release characteristics. Monolithic monofilaments represent a single, solid structure that may be advantageous for uniformity and precision in medicament coating. Tape monofilaments may offer a flat profile that may be useful for creating a larger surface area for medicament application. The arm 7110 may be constructed from any one or any combination of these monofilament types to achieve a balance of properties or to tailor the device to specific therapeutic or user requirements.

In embodiments, the insertable portion 7115, as well as the arm 7110 as a whole, may be composed of a particular material. For example, in some embodiments, the insertable portion 7115 and/or the arm 7110 may be cut from the particular material into the appropriate shape (e.g., the spear-like shape).

In embodiments, the insertable portion 7115 and/or the arm 7110 may be constructed from a material consisting of cellulose, ethylene vinyl acetate, polyvinyl alcohols, polyester, polycarbonate, polyvinyl acetate, vinyl acetate, teflon, nylon, polymethacrylate, polystyrene, polypropylene, polyoxymethylene, kapton polyimide, polyether ether ketone, acrylonitrile butadiene styrene, polyterepthalate, silicon polymers, and/or any combination thereof.

In a particular example, the insertable portion 7115 may be made from a biocompatible polymer. The selection of a biocompatible polymer is important to ensure compatibility with the delicate tissues of the oral cavity and to prevent any adverse reactions during the medicament delivery process. Biocompatible polymers offer the advantage of being non-toxic, non-irritating, and non-immunogenic, which are all desirable properties for materials that come into direct contact with mucosal tissues. The polymer material may be chosen based on its mechanical properties, such as flexibility and durability, to withstand the repeated agitation actions without degrading or losing its medicament-carrying capabilities. In embodiments, the biocompatible polymer may include polymers of hydroxy acids, lactic acid polymers, glycolic acid polymers, lactic acid and glycolic acid polymers, poly (hydroxyl acids), poly(lactic acid) (PLA), poly(glycolic acid) (PGA), poly(lactic-co-glycolic acid) (PLGA), and copolymers with PEG, polyanhydrides, poly(ortho) esters, polyesters, polyurethanes, poly(butyric acid), poly(valeric acid), poly(caprolactone), poly (hydroxyalkanoates), poly(lactide-co-caprolactone), blends and copolymers thereof, natural polymers, proteins, albumin, collagen, gelatin, prolamines, zein, polysaccharides, alginate, cellulose derivatives and polyhydroxyalkanoates, polyhydroxy butyrate blends, and copolymers thereof, and/or any combination thereof. In embodiments, a solvent for the selected biocompatible polymer may include dichloromethane, ethyl acetate, acetone, and/or any combination thereof.

The insertable portion 7115 of the arm 7110 may be configured to carry the medicament 7130, which may be intended for delivery into the gingival crevice of the patient. At least a portion of the surface of the insertable portion 7115 may be coated with the medicament 7130, facilitating the transfer of the medicament 7130 directly to the targeted area within the oral cavity. The medicament coating may be applied in various ways to achieve the desired release profile and dosage control.

The nature of the coating of medicament 7130 on the insertable portion 7115 may vary depending on the intended application and release characteristics. In some embodiments, the medicament coating may be uniform, providing a consistent layer of medicament across the surface of the insertable portion 7115. Alternatively, the medicament coating may be irregular or “spotty,” resulting in a non-uniform distribution of the medicament. This non-uniformity may be configured to achieve specific release patterns, to target different areas within the gingival crevice, and/or to modulate the absorption rate of the medicament into the patient's system. The flexibility in medicament coating configuration allows for a tailored approach to medicament delivery, catering to the specific therapeutic requirements of the patient.

The insertable portion 7115 of the arm 7110 may be uniformly coated on its surface with a diverse array of medicaments, which may include, but are not limited to, micronutrients, minerals, antibiotics, anti-inflammatory agents, antimicrobials, antifungals, antibodies, steroids, antiparasitics, anti-amoebics, anti-helminthics, anti-protozoals, antinematodes, anti-cestodes, anti-trematodes, and/or any combination thereof. This uniform coating ensures a consistent and controlled delivery of the medicaments to the gingival crevice, potentially providing a broad spectrum of therapeutic benefits.

In some embodiments, the insertable portion 7115 may feature a nonuniform coating on its surface with a diverse array of medicaments, which may include, but are not limited to, micronutrients, minerals, antibiotics, anti-inflammatory agents, antimicrobials, antifungals, antibodies, steroids, antiparasitics, anti-amoebics, anti-helminthics, anti-protozoals, antinematodes, anti-cestodes, anti-trematodes, and/or any combination thereof. This nonuniformity may manifest as randomly placed medicament, single geometric shapes, or an array or pattern of geometric shapes, each potentially containing different medicaments or combinations thereof. Such a nonuniform coating strategy allows for the targeted delivery of specific medicaments to particular areas within the gingival crevice or for the creation of specific release profiles that can be tailored to the patient's individual therapeutic requirements.

In embodiments, at least a portion of the surface of the insertable portion 7115 may be coated with the medicament 7130. The medicament 7130 may include, but is not limited to, micronutrients, minerals, an antibiotic, an anti-inflammatory, an antimicrobial, an antifungal, an antibody, a steroid, an antiparasitic, an anti-amoebic, an anti-helminthic, an anti-protozoal, an antinematode, an anti-cestode, an anti-trematode, and/or any combination thereof. In embodiments, the medicament 7130 may include, but is not limited to, allergy inducing antigens, including allergy inducing molecules and/or any combination thereof, configured to act as allergenic tolerance therapies. This type of medicament may be used to treat and modulate tolerance to allergies, such food allergies to peanut or shell fish, etc.

In embodiments, the micronutrients included in medicament 7130 may include, but are not limited to, retinoid (Vitamin A), carotene (Vitamin A), thiamin (Vitamin B₁), riboflavin (Vitamin B₂), niacin (Vitamin B₃), pantothenic acid (Vitamin B₅), pyridoxine (Vitamin B₆), cobalamin (Vitamin B₁₂), biotin, ascorbic acid (Vitamin C), choline, calciferol (Vitamin D), calcifediol (Vitamin D), cholecalciferol (Vitamin D₃), ergocalciferol (Vitamin D₂), alpha-tocopherol (Vitamin E), folic acid (Vitamin B₉), and phylloquinone menadione (Vitamin K), and/or any combination thereof.

In embodiments, the mineral included in medicament 7130 may include, but is not limited to, calcium, chloride, chromium, copper, fluoride, iodine, iron, magnesium, manganese molybdenum, phosphorus, potassium, selenium, sodium, sulfur, zinc, and/or any combination thereof. In embodiments, the antibiotic included in medicament 7130 may include, but is not limited to, amikacin, betamethasone, clindamycin, clotrimazole, gentamicin, kanamycin, minocycline, oxytetracycline, penicillin, tetracycline, and/or any combination thereof.

In embodiments, the medicament 7130 may be carried by the insertable portion 7115 of the arm 7110 as a free drug. For example, the medicament 7130 may not be contained within or entrapped by any particle or capsule but may be directly coated onto the surface of the arm 7110. As a free drug, the medicament may be readily available for release and absorption upon deposition into the gingival crevice (e.g., in response to the agitation action). This method of carrying the medicament allows for immediate interaction with the surrounding tissue and may be beneficial for rapid onset of action.

In alternative or additional embodiments, the medicament 7130 may be carried by the insertable portion 7115 of the arm 7110 as entrapped in a particle or encapsulated within a capsule. In this form, the medicament is contained within a protective capsule, made of a polymer or other suitable material in some embodiments, which may control the release of the medicament over time. The encapsulation of the medicament ensures that it is not immediately released upon deposition into the gingival crevice. Instead, the capsule or particle dissolves or degrades over time, allowing for a sustained release of the medicament into the surrounding tissue. This controlled release may be advantageous for maintaining therapeutic levels of the medicament over an extended period, potentially reducing the frequency of application.

In embodiments, the encapsulant used for medicament encapsulation (e.g., for encapsulating the medicament within particles or capsules) is selected from a diverse group of polymers, and may include any one of the polymers in the groups and/or any combination thereof. This group includes, but is not limited to, poly(hydroxy acids), poly(lactic acid), poly(glycolic acid), poly(lactic acid-co-glycolic acid), poly(lactic-co-glycolic acid), and their derivatives. PEGylated versions of these polymers, such as PEGylated poly(lactic-co-glycolic acid), are also included.

The group may include poly(anhydrides), PEGylated poly(anhydrides), poly(ortho esters), and their derivatives, including PEGylated poly(ortho esters). Poly(caprolactones) and their derivatives, as well as PEGylated poly(caprolactones), may also be used as encapsulants.

Polyamines such as spermine, spermidine, polylysine, and their derivatives, including PEGylated polylysine, along with polyamides and polycarbonates, are included in the polymer groups, as well as poly(propylene fumarates), polyamides, polyphosphazenes, polyamino acids, polyethers, polyacetals, polylactides, polyhydroxyalkanoates, polyglycolides, polyketals, polyesteramides, poly(dioxanones), polyhydroxybutyrates, polyhydroxyvalyrates, polycarbonates, polyorthocarbonates, and poly(vinyl pyrrolidone).

The group may include polycyanoacrylates, polyalkylene oxalates, polyalkylene succinates, poly(malic acid), poly(methyl vinyl ether), poly(ethylene imine), poly(acrylic acid), poly(maleic anhydride), and their derivatives, including PEGylated forms such as PEGylated poly(ethylene imine) and PEGylated poly(acrylic acid), as well as poly(urethane) and its derivatives, including PEGylated polyurethane, as well as poly(alkylenes) like polyethylene and polypropylene, polyalkylene glycols, poly(ethyleneglycol), polyalkylene oxides such as poly(ethylene oxide), and polyalkylene terepthalates like poly(ethylene terephthalate), and polyvinyl alcohols, polyvinyl ethers, polyvinyl esters, polyvinyl halides such as poly(vinyl chloride), polyvinylpyrrolidone, polysiloxanes, poly(vinyl alcohols), poly(vinylacetate), polystyrene, polyurethanes, and their copolymers.

Derivatized celluloses such as alkyl cellulose, hydroxyalkyl celluloses, cellulose ethers, cellulose esters, nitro celluloses, and specific forms like methyl cellulose, ethyl cellulose, hydroxypropyl cellulose, hydroxy-propyl methyl cellulose, hydroxybutylmethyl cellulose, cellulose acetate, cellulose propionate, cellulose acetate butyrate, cellulose acetate phthalate, carboxylethyl cellulose, cellulose triacetate, and cellulose sulfate sodium salt may be used as encapsulant, as well as polymers of acrylic acid, methacrylic acid, or their copolymers or derivatives, methacrylic acid esters, poly(methyl methacrylate), poly(ethyl methacrylate), poly(butylmethacrylate), polyisobutyl methacrylate, poly(hexylmethacrylate), poly(isodecyl methacrylate), poly(laurylmethacrylate), poly(phenyl methacrylate), poly(methylacrylate), poly(isopropyl acrylate), poly(isobutyl acrylate), and poly(octadecyl acrylate).

The group of polymers to use for encapsulant may include natural polymers such as proteins (e.g., albumin, collagen, gelatin), prolamines (e.g., zein), polysaccharides (e.g., alginate), cellulose derivatives (e.g., hydroxypropyl cellulose, sodium carboxymethyl cellulose, ethyl cellulose, and cellulose acetate), polyhydroxyalkanoates (e.g., poly(hydroxybutyrate)), and their combinations.

In some cases, the medicament 7130 may be carried by the insertable portion 7115 of the arm 7110 using a combination of both free drug and encapsulated forms. This hybrid approach may allow for both immediate and sustained release of the medicament. The free drug portion may provide an initial dose of the medicament for immediate therapeutic action, while the encapsulated portion ensures a continued release, maintaining the therapeutic effect over time. This combination may be tailored to meet specific therapeutic goals and patient requirements, offering a versatile and effective method for medicament delivery.

In some embodiments, at least a portion of the surface of the insertable portion 7115 of the arm 7110 may be coated with the medicament 7130 by immersing or dipping the at least a portion of the surface of the insertable portion 7115 into a solution that contains the medicament 7130. This dipping process ensures that the medicament adheres to the surface of the insertable portion 7115, preparing it for delivery into the gingival crevice. To achieve a desired coating thickness or to ensure a uniform application of the medicament 7130, the insertable portion 7115 may be dipped into the medicament solution multiple times. In some embodiments, the insertable portion 7115 is dipped at least three times, which may enhance the consistency of the medicament layer and potentially increase the dosage of medicament that can be delivered to the patient. Each dipping may be followed by a drying period, allowing the medicament to adhere properly to the insertable portion 7115 before subsequent coatings are applied.

In some embodiments, at least a portion of the surface of the insertable portion 7115 of the arm 7110 may be coated with the medicament 7130 by employing a spray coating technique. This spray coating technique may involve using a solution that comprises the medicament 7130, which may then be atomized and sprayed onto the surface of the insertable portion 7115. The spray coating process may allow for a fine and even distribution of the medicament across the surface, which may be particularly beneficial for achieving a uniform layer of medicament. This technique may also be controlled to apply multiple layers, if desired, by repeating the spray coating process multiple times, with drying intervals in between to ensure proper adhesion and stability of the medicament on the insertable portion 7115. The spray coating technique may provide an efficient way to coat the insertable portion 7115 with the medicament 7130, preparing it for effective delivery into the gingival crevice.

In some embodiments, at least a portion of the surface of the insertable portion 7115 of the arm 7110 may be coated with the medicament 7130 by applying droplets of a solution comprising the medicament 7130 onto the surface of the insertable portion 7115. Applying the droplets onto the surface of the insertable portion 7115 may involve depositing small volumes of the medicament solution onto the insertable portion 7115, creating a pattern or array of droplets that adhere to the surface. The droplet application technique allows for targeted placement of the medicament, which may be beneficial for controlling the dosage and release profile of the medicament. This droplet application technique may also facilitate the creation of nonuniform coatings, where different areas of the insertable portion 7115 may have varying concentrations of the medicament, or different medicaments altogether. The droplets may be allowed to dry, forming a stable coating of the medicament on the insertable portion 7115, ready for insertion into the gingival crevice for medicament delivery.

In embodiments, the surface energy of the surface of the insertable portion 7115 and/or of the arm 7110 may require modification or alteration to enhance the adhesion and stability of the medicament 7130 coating. One approach to modify the surface energy of the insertable portion 7115 and/or of the arm 7110 may be to apply a precoat layer to the arm 7110 and/or the insertable portion 7115 prior to the application of the medicament 7130. This precoat layer may operate to alter the surface energy of the surface, which may improve the interaction between the medicament 7130 and the surface of the arm 7110. By adjusting the surface energy, the precoat layer may facilitate a more uniform coating of the medicament 7130, and/or it may can enhance the adherence of the medicament 7130 in a nonuniform coating application. The composition of the precoat layer may be selected based on its compatibility with both the arm 7110 material and the medicament 7130, ensuring that it does not interfere with the intended release and absorption of the medicament once delivered into the gingival crevice.

In embodiments, the precoat layer applied to the arm 7110 and/or the insertable portion 7115 for modifying the surface energy may include a mixture of a biocompatible polymer and a solvent. The biocompatible polymer may include, but may not be limited to, polymers of hydroxy acids, such as lactic acid polymers, glycolic acid polymers, and copolymers of lactic acid and glycolic acid like poly(lactic-co-glycolic acid) (PLGA), poly(hydroxyl acids), poly(lactic acid) (PLA), poly(glycolic acid) (PGA), and copolymers with polyethylene glycol (PEG), polyanhydrides, poly(ortho) esters, polyesters, polyurethanes, poly(butyric acid), poly(valeric acid), poly(caprolactone), poly(hydroxyalkanoates), poly(lactide-co-caprolactone), as well as blends and copolymers thereof, and/or any combination thereof.

Natural polymers may also be used, such as proteins (e.g., albumin, collagen, gelatin), prolamines (e.g., zein), polysaccharides (e.g., alginate), cellulose derivatives, and polyhydroxyalkanoates, including polyhydroxy butyrate blends and copolymers thereof, and/or any combination thereof. These polymers may be chosen for their biocompatibility, ensuring that they do not cause adverse reactions when in contact with the body's tissues.

The solvent used in the polymer-solvent mixture for the precoat layer may include, but may not be limited to, dichloromethane, ethyl acetate, acetone, and/or any combination thereof. These solvents may be selected for their ability to dissolve the selected polymer and create a solution that can be applied evenly to the surface of the arm 7110 and/or the insertable portion 7115. Once the precoat layer is applied, the solvent evaporates, leaving behind a layer of the polymer that alters the surface energy of the arm 7110, enhancing the adhesion of the subsequent medicament 7130 coating.

In some embodiments, the precoat layer applied to the arm 7110 and/or the insertable portion 7115 may also incorporate medicaments. These medicaments may be present in various forms, such as free form, where the medicament is directly applied to the precoat layer; entrapped within particles, where the medicament is contained within micro or nanoparticles; encapsulated, where the medicament is enclosed within a capsule or a matrix; and/or a combination thereof. The inclusion of medicaments within the precoat layer may serve to provide an initial dose upon application or to create a controlled release profile, where the medicament is released over time as the precoat layer degrades or dissolves.

In embodiments, another approach to modify the surface energy of the insertable portion 7115 and/or of the arm 7110 may include removal of material from the insertable portion 7115 and/or from the arm 7110. This may be achieved through methods such as perforating the arm 7110 or creating distances of cut designs that result in a “window” effect. The material removal may alter the surface energy of the arm 7110, which may influence the amount and pattern of medicament 7130 that may be coated onto the arm 7110.

The insertable portion 7115 and/or of the arm 7110 may be perforated with holes of any shape, such as circular, oval, square, or any other geometric or irregular shape. These perforations may serve multiple functions. For example, the perforations may increase the surface area available for coating, potentially increasing the volume of medicament 7130 that may be carried by the insertable portion 7115 of the arm 7110. In another example, the edges of the perforations may provide additional surface features that may promote the adherence of the medicament 7130 to the insertable portion 7115 of the arm 7110. This may be particularly beneficial for ensuring that the medicament 7130 remains securely attached to the insertable portion 7115 of the arm 7110 until it is released into the gingival crevice during use.

The configuration and pattern of the perforations or cut designs may be tailored to meet specific requirements, such as targeting the release of medicament 7130 to particular areas within the gingival crevice of the patient or creating specific release profiles. By adjusting the surface energy through these physical modifications, the arm 7110 may be optimized for efficient medicament 7130 delivery and adherence, enhancing the overall performance of the JET device 7100.

In embodiments, another approach to modify the surface energy of the insertable portion 7115 and/or of the arm 7110 may include texturing the surface of the insertable portion 7115 and/or of the arm 7110 to alter the surface topography and surface energy of the insertable portion 7115 and/or of the arm 7110. Texturing the surface may create a roughness (Rₐ) factor on the surface of the arm 7110, which may influence the adhesion and release properties of the medicament 7130.

In embodiments, the Rₐ factor may include the average surface roughness, which may include a measure of the small-scale variations in the height of the physical surface of the insertable portion 7115 and/or of the arm 7110. By introducing a specific Rₐ factor, the surface may be configured to provide different patterns that may affect the coating process and the interaction between the medicament 7130 and the insertable portion 7115 of the arm 7110.

In embodiments, the different texturing patterns may include, but are not limited to, a perpendicular lay pattern consisting of grooves that run perpendicular to the direction of the insertable portion 7115 insertion into the gingival crevice, potentially enhancing the mechanical interlocking of the medicament 7130; a parallel lay pattern in which grooves may run parallel to the direction of insertion, which may influence the directional release of the medicament 7130; a wave lay pattern that may include a wavy texture that may increase the surface area and create turbulence in the coating process, potentially leading to a more uniform medicament 7130 distribution; a dimpling pattern in which indentations or dimples may be added to the surface to increase the surface area and create pockets for the medicament 7130; a Rₐ zig-zag etching in which a zig-zag pattern may be etched into the surface to create channels for the medicament 7130, which may control the flow and release of the medicament; a circular Rₐ pattern in which concentric circles may be used to create a radial texture that may influence the spread of the medicament 7130 upon the surface; a multi Rₐ pattern that includes a combination of different roughness patterns that may be used to create a complex surface that may tailor the release profile of the medicament 7130; a radial Rₐ pattern that may include radial lines emanating from a central point that may be used to direct the medicament 7130 outward from the center of the arm 7110; and/or any combination thereof. In embodiments, these texturing patterns may be applied to the insertable portion 7115 and/or the arm 7110 to modify the surface energy and topography, which may affect the coating's adhesion, thickness, uniformity, and/or release characteristics. In embodiments, the selection of the texturing pattern may be based on specific requirements of the medicament delivery system and the desired therapeutic outcome.

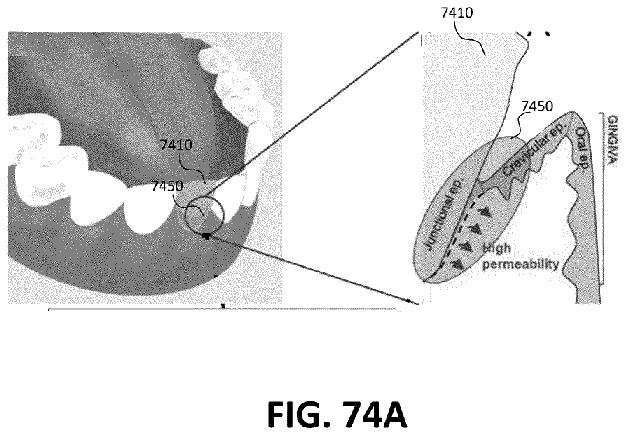

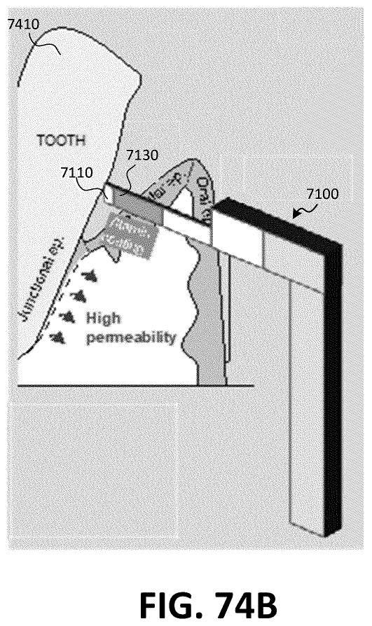

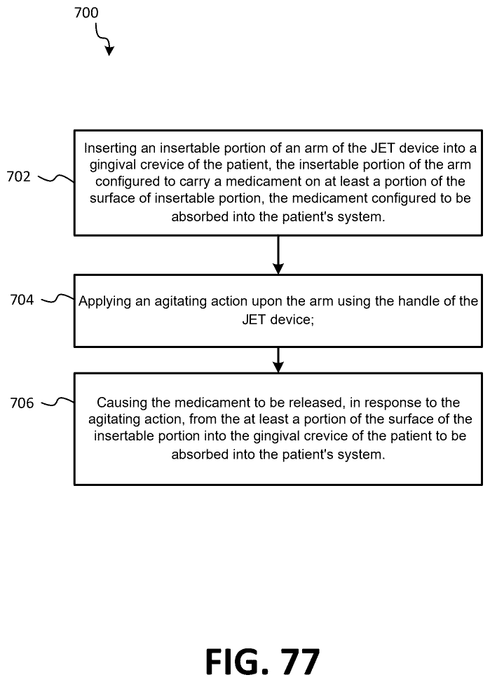

Operation of JET device 7100 will now be discussed with respect to FIG. 77, as well as FIGS. 74A, 74B, 75A-75C, and 76A-76C, in accordance with aspects of the present disclosure. FIG. 77 shows a high-level flow diagram 700 of operations of a JET device (e.g., JET device 7100) for delivery of medicaments to the gingival crevice of a patient by agitation in accordance with embodiments of the present disclosure.

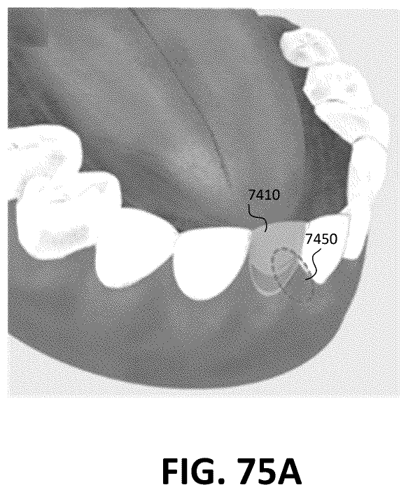

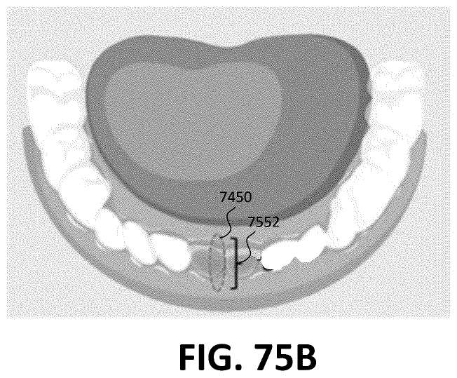

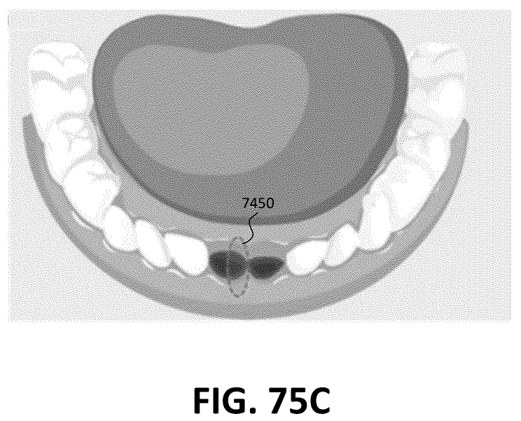

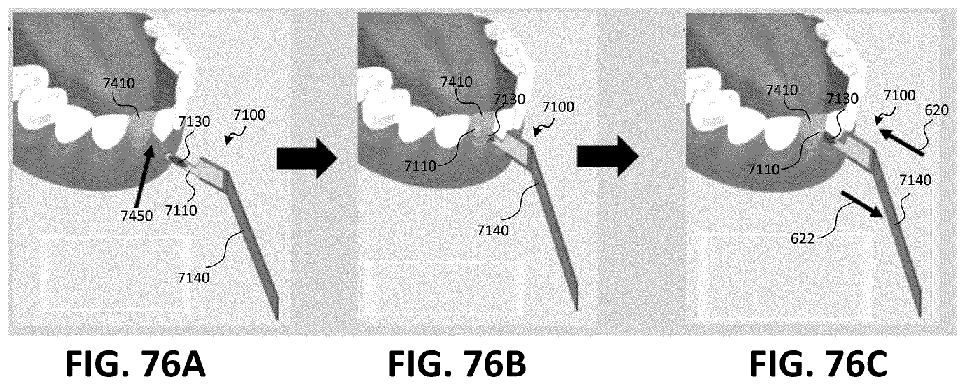

FIG. 74A shows an exemplary location of a gingival crevice and a gingival crevice in accordance with embodiments of the present disclosure. FIG. 74B shows an exemplary location for insertion of a JET device 7100 into a gingival crevice and a gingival crevice in accordance with embodiments of the present disclosure. FIGS. 75A-75C illustrate various views of an exemplary location of a target area for delivery of medicaments into a gingival crevice in accordance with embodiments of the present disclosure. FIGS. 76A-76C illustrate example operations for delivery of medicaments into a gingival crevice using a JET device 7100 in accordance with embodiments of the present disclosure.

FIG. 74A provides a representation of the anatomical location targeted for medicament delivery using the JET device 7100. In particular, FIG. 74 shows the gingival crevice 7450 adjacent to tooth 7410 within a patient's mouth. Gingival crevice 7450 includes the gingival crevice, which includes a narrow space between the tooth and the surrounding gum tissue. The gingival crevice area is of particular interest for the delivery of medicaments due to the presence of the junctional epithelium (JE), which has a high permeability. The JE is a specialized epithelial layer that facilitates the efficient absorption of substances directly into the patient's system.

Gingival crevice 7450 represents the precise insertion location for the insertable portion 7115 of the arm 7110 of the JET device 7100. For example, as shown in FIG. 74B, arm 7110 carrying medicament 7130 may be inserted into the gingival crevice area of tooth 7410. In embodiments, the location for insertion of the insertable portion 7115 of the arm 7110 may specifically target the JE high permeability region of the gingival crevice of gingival crevice 7450. In these embodiments, by focusing on this area, the JET device 7100 may be configured to maximize the bioavailability of the medicaments, ensuring that they are delivered directly to the region where they may be rapidly absorbed and utilized by the body. The diagram shown in FIG. 74A serves as a visual guide to identify the correct anatomical site for the insertion of the insertable portion 7115 of the arm 7110 of the JET device 7100.

FIGS. 75A-75C provide a series of views that detail the anatomical target area for the insertion of the insertable portion 7115 of the arm 7110 of the JET device 7100. These Figures illustrate an example of the precise location for the insertion of the insertable portion 7115 of the arm 7110, which is designed to deliver medicaments directly to the gingival crevice of a patient. The illustrations depict the gingival crevice, also known as the gingival crevice, which is situated adjacent to the teeth and is the specific site where the JET device 7100 is to be applied. The Figures collectively offer different perspectives that enhance the understanding of the spatial relationship between the JET device 7100 and the surrounding oral structures, ensuring accurate placement and effective medicament delivery.

For example, FIG. 75A presents an anterior view of a human mouth, emphasizing the gingival crevice 7450 for the insertion of the insertable portion 7115 of the arm 7110. This view is particularly useful for visualizing the frontal access to the gingival crevice where the insertable portion 7115 of the arm 7110 is to be inserted. The anterior perspective provides a clear view of the spacing between the teeth, accurately illustrating the appropriate insertion point for the insertable portion 7115 of the arm 7110 to ensure effective delivery of medicaments.

In FIG. 75B, the caudal view of the gingival crevice 7450 is depicted, illustrating the orientation of the geometric space into which the insertable portion 7115 of the arm 7110 is to be inserted, with the teeth present. This perspective offers a view from behind the teeth, showcasing the depth and contours of the gingival crevice where the insertable portion 7115 of the arm 7110 is to be inserted. The average depth of the target area is noted as depth 7552. In embodiments, depth 7552 may average approximately 1-3 mm, which may represent a relevant measurement for ensuring that the insertable portion 7115 of the arm 7110 is of suitable size and shape for insertion without causing discomfort or injury to the patient.

FIG. 75C provides a caudal view of the gingival crevice 7450, similar to FIG. 75B, but with the teeth removed to offer an unobstructed view of the gingival crevice within the gingival crevice 7450.

FIGS. 76A-76C illustrate operations of the JET device 7100 for the delivery of medicaments to the gingival crevice of a patient by agitation, as also illustrated in FIG. 77. In embodiments, the operations of the JET device 7100 for the delivery of medicaments to the gingival crevice of a patient by agitation is a multi-step process. These figures illustrate the sequential actions taken to ensure the precise and effective delivery of the medicament into the gingival crevice of a patient.

At block 702, an insertable portion of an arm of the JET device is inserted into a gingival crevice of the patient using a handle of the JET device. In embodiments, the insertable portion of the arm may be configured to carry a medicament on at least a portion of the surface of insertable portion, and the medicament may be configured to be absorbed into the patient's system.

For example, as shown in FIG. 76A, the initial step may involve positioning the JET device 7100 such that the arm 7110, and in particular the insertable portion 7115 of the arm 7110 carrying the medicament 7130, is aligned with the gingival crevice 7450 adjacent to tooth 7410. The user may hold the handle 7140 and may guide the arm 7110 towards the gingival crevice 7450 ensuring that the arm 7110 is directed towards the gingival crevice. This step is instrumental in preparing for the insertion of the arm 7110, which contains the medicament 7130 intended for delivery to the patient.

As shown in FIG. 76B, the arm 7110 is inserted into the gingival crevice 7450 using the handle 7140. The user applies gentle pressure to advance the arm 7110 into the gingival crevice 7450. The handle 7140 provides the leverage and control needed to insert the arm 7110 into the gingival crevice 7450 without causing discomfort to the patient. The insertable portion 7115 of the arm 7110 is configured to fit comfortably within the gingival crevice 7450, reaching the targeted JE without extending too deeply or causing undue pressure. The dimensions and shape of the insertable portion 7115 are such that it may navigate the contours of the gingival crevice 7450 and deliver the medicament 7130 effectively.

At block 704, an agitation action is applied upon the arm using the handle of the JET device 7100. At block 706, the medicament is caused to be released, in response to the agitation action, from the at least a portion of the surface of the insertable portion into the gingival crevice of the patient to be absorbed into the patient's system. For example, as shown in FIG. 76C, upon insertion of the arm 7110 into the gingival crevice 7450 (e.g., with the arm 7110 inserted into the gingival crevice 7450), the user applies an agitation action, which may include a back-and-forth motion (e.g., in the back direction 622 and forth direction 620). The agitation action is intended to be gentle yet effective, causing the medicament 7130 coated on the insertable portion 7115 to be scraped off and deposited into the gingival crevice 7450.

In embodiments, the back-and-forth motion may be facilitated by the ergonomic design of the handle 7140, which may allow for a controlled and steady application of the agitation action. In some embodiments, the agitation action may be one back-and-forth movement, or may be multiple back-and-forth movements. This agitation action may ensure that the medicament 7130 is released from the arm 7110 and becomes available for absorption by the junctional epithelium within the gingival crevice 7450.

In embodiments, the configuration of the JET device 7100 may ensure that the agitation action maximizes the transfer of the medicament 7130 without causing trauma to the delicate tissues of the gingival crevice 7450. The configuration of the JET device 7100, particularly the insertable portion 7115, is such that it can deliver the medicament 7130 effectively through this agitation action, contributing to the successful administration of the medicament and the wellbeing of the patient.

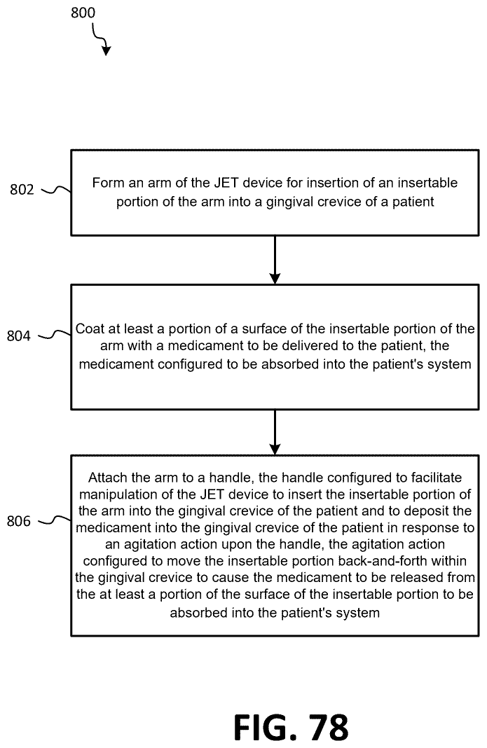

FIG. 78 shows an exemplary flow diagram 800 of operations for manufacturing a JET device configured with functionality for delivery of medicaments to the gingival crevice of a patient in accordance with aspects of the present disclosure. For example, the steps illustrated in the example blocks shown in FIG. 78 may be performed to manufacture JET device 7100 of FIGS. 71-76C, according to embodiments herein.

At block 802, an arm of the JET device is formed for insertion of an insertable portion of the arm into a gingival crevice of a patient. In embodiments, the arm (e.g., the arm 7110) may be formed or crafted by cutting a suitable material, such as a biocompatible and/or biodegradable polymer, into the desired shape, which may include the spear-like configuration as previously described.

In embodiments, the material selected for the arm may be selected based on its biocompatibility, mechanical properties, and ability to interact with the medicament. The spear-like shape may be configured to facilitate easy insertion into the gingival crevice while providing an adequate surface area for medicament coating. The dimensions of the arm, including length, width, and thickness, may be tailored to ensure that the arm can reach the targeted junctional epithelium without causing discomfort or injury to the patient.

In embodiments, the formation of the arm may involve various manufacturing techniques such as precision cutting, molding, or extrusion to achieve the precise dimensions and shape. The process ensures that the arm has a smooth surface to minimize irritation to the gum tissues during insertion and use. Once formed, the arm may serve as the carrier for the medicament, which may be applied in subsequent manufacturing steps.

At block 804, at least a portion of a surface of an insertable portion (e.g., insertable portion 7115) of the arm is coated with a medicament to be delivered to the patient. In embodiments the medicament may be configured to be absorbed into the patient's system. In embodiments, coating the at least a portion of a surface of the insertable portion of the arm with the medicament may be performed using one or more techniques. One surface coating technique may include dipping. In dipping, the insertable portion of the arm may be immersed or dipped in a solution containing the medicament. This technique may provide a thorough and even coating, and the process may be repeated multiple times to build up the desired level of medicament on the at least a portion of the surface of the insertable portion of the arm. Each dipping may be followed by a drying period to allow the medicament to adhere properly to the surface.

Another surface coating technique may include spray coating, which may include atomizing a solution of the medicament and spraying it onto the at least a portion of the surface of the insertable portion. This technique may allow for a fine and controlled distribution of the medicament and may be repeated to apply multiple layers of the medicament, with drying intervals in between applications.

Yet another surface coating technique may include droplet application in which droplets of the medicament solution may be placed onto the at least a portion of the surface of the insertable portion. This technique may be particularly useful for creating patterns or arrays of medicament on the at least a portion of the surface of the insertable portion, which may be beneficial for targeted delivery or controlled release of the medicament. The droplets may be allowed to dry, forming a stable coating on the at least a portion of the surface of the insertable portion.

Each of these coating techniques may be used independently or in combination to achieve the desired medicament coating on the at least a portion of the surface of the insertable portion of the arm of the JET device, preparing it for effective delivery into the gingival crevice of the patient.

In embodiments, prior to the coating of the medicament onto the at least a portion of the surface of the insertable portion, the at least a portion of the surface of the insertable portion may be coated with a precoat layer. This precoat layer may be configured to modify the surface energy of the insertable portion, enhancing the adhesion of the medicament to the at least a portion of the surface of the insertable portion. The precoat layer may consist of a biocompatible and/or biodegradable polymer that is compatible with both the arm material and the medicament, ensuring that the subsequent medicament coating adheres effectively and is released appropriately during use.

The alteration of the surface energy of the insertable portion of the arm may impact the coating process and the interaction between the medicament and the arm of the JET device. By adjusting the surface energy, the medicament coating may be applied more uniformly or in a controlled pattern, depending on the desired release profile and dosage control.

In embodiments, the surface of the insertable portion and/or the arm may be textured to alter the surface topography and surface energy of the surface of the insertable portion and/or the arm to provide a rough factor (Rₐ). In embodiments, the rough factor Rₐ may provide different patterns including a perpendicular lay pattern, a parallel lay pattern, a wave lay pattern, a dimpling pattern, a roughing (Rₐ) zigzag etching pattern, a circular Rₐ pattern, a multi Rₐ pattern, a radial Rₐ pattern, and/or any combination thereof onto the surface of the insertable portion and/or the arm.

At block 806, the arm is attached to a handle. In embodiments, the handle (e.g., the handle 7140) may be configured to facilitate manipulation of the JET device to insert the insertable portion of the arm into the gingival crevice of the patient and to deposit the medicament into the gingival crevice of the patient in response to an agitation action upon the handle. In embodiments, the agitation action may be configured to move the insertable portion back-and-forth within the gingival crevice to cause the medicament to be released from the at least a portion of the surface of the insertable portion to be absorbed into the patient's system.

Various embodiments of the present disclosure are directed to a JET device and system that includes functionality for delivery of medicament films into the gingival crevice. In particular embodiments, the JET device may include an insertable component configured to be inserted into the gingival crevice of the patient and configured to carry one or more medicament films that are to be delivered into the gingival crevice for absorption into the patient's system via the junctional epithelium, as described herein.

In embodiments, the insertable component of the JET device may include one or more structural elements that defines an empty space or cavity configured to receive a medicament formulation. Upon being dispensed into the empty space of the insertable component, the medicament formulation may dry, cure, or otherwise transition into a film-like structure within or supported by the structural element of the insertable component. In embodiments, the resulting medicament film may be attached or adsorbed to the structural elements, which may facilitate delivery of the medicament carried in the medicament film upon insertion of the insertable component into the gingival crevice.

In embodiments, the structural elements of the insertable component may be provided in various forms, including, but not limited to, strings, planes, and/or frames, each configuration configured to support and carry the medicament film into the gingival crevice. For example, in some embodiments, the insertable component may include at least two strings that are spaced apart, defining a vacant space between them. The vacant space between the at least two strings may be configured to receive the medicament formulation. After being dispensed into the vacant space, the medicament formulation may dry or cure to form a medicament film attached at each end or side to the supporting strings. In some embodiments, the insertable component may include two planes spaced apart along a longitudinal axis and defining an empty space between them. The empty space between the two planes may be configured to receive the medicament formulation. After being dispensed into the empty space, the medicament formulation may dry or cure to form a medicament film attached at each end or side to the supporting planes. In some embodiments, the insertable component may include two frames spaced apart and defining a cavity between them. The cavity between the two frames may be configured to receive the medicament formulation. After being dispensed into the cavity, the medicament formulation may dry or cure to form a medicament film attached at each end or side to the frames.

In embodiments, the medicament film may include a majority of an active substance (e.g., above 90% active substance), and in these embodiments the active substance may be configured with sufficient mechanical strength for handling and insertion into the gingival crevice. In some embodiments, the medicament film may include active substances combined with inactive excipients such as mucoadhesives, viscosity enhancers, plasticizers, surfactants, starches, sugar alcohols, natural and synthetic sugars, cellulose derivatives, polyvinyl alcohol, binders, and/or any combinations thereof. These excipients may enhance the medicament film's mechanical properties, adhesion characteristics, retention capabilities, and/or controlled-release profiles.

In embodiments, the medicament film formed between the structural elements of the insertable component may be configured with dimensions configured for effective placement and therapeutic action within the gingival crevice. For example, in some non-limiting examples, the thickness of the medicament film may range from about 0.01 μm to about 1000 μm. In some embodiments, the medicament film may have thickness values within this range, such as about 0.1 μm, about 1 μm, about 10 μm, about 20 μm, about 100 μm, about 200 μm, about 500 μm, and/or about 800 μm. In some embodiments, the length of the medicament film may range from sub-micron dimensions such as 0.01 μm up to about 2 cm. In some embodiments, the medicament film may have a length value within this range, such as 1 μm, 10 μm, 50 μm, 100 μm, 500 μm, 1 mm, 5 mm, 1 cm, and/or 2 cm.

In embodiments, the insertable component may be configured for the formation of single or multiple medicament films between the supporting structural elements. When multiple medicament films are used, these medicament films may carry the same or different medicament formulations, including but not limited to vaccines, allergens, drugs, vitamins, antibiotics, adjuvants, or combinations thereof. Indeed, in embodiments, the medicament formulations carried in the medicament films may include any combination of medicaments as described in this disclosure.

In embodiments, the medicament films may be positioned adjacent to each other or separated by predefined distances, ranging from about 0.01 μm up to about 3 mm. In some embodiments, the separation between medicament films may have a separation value such as 0.01 μm, 0.1 μm, 0.2 μm, 0.3 μm, 0.4 μm, 0.5 μm, 0.6 μm, 0.7 μm, 0.8 μm, 0.9 μm, 1.0 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, and/or higher such as up to 5 mm.

In embodiments, the structural elements supporting the medicament films may be composed of materials configured to provide sufficient mechanical strength, biocompatibility, user comfort, and/or degradation profiles. These materials may include natural polymers, synthetic polymers, dissolvable polymers, disintegrable polymers, biocompatible polymers, biodegradable polymers, swellable polymers, metals, and/or combinations thereof. Specific exemplary polymers may include polylactic acid, polyglycolic acid, poly(lactic-co-glycolic acid), polycaprolactone, polyethylene glycol, polyvinyl pyrrolidone, and/or other similar materials.

In some embodiments, the insertable component may be configured to attach to a handle or grip, which may facilitate the insertion and positioning of the insertable component (along with any medicament film thereon) within the gingival crevice. The attachment mechanism between the handle and the insertable component may be configured to dissolve or weaken upon contact with oral fluids, or alternatively, may require manual breakage by the user to release the medicament film within the gingival crevice.

In some embodiments, the JET device of embodiments may be configured to include flavors, taste-masking agents, and/or color indicators into the structural elements and/or the medicament films.

In particular embodiments, the insertable component of the JET device may include a string-based configuration. The string-based insertable component may include two or more strings positioned adjacent to each other, defining an empty space between the strings. The empty space between the strings (e.g., at least a portion of the empty space) may be configured to receive a medicament film that is intended for delivery into the gingival crevice.

In embodiments, the two or more strings may be configured to run parallel to each other. However, in some embodiments, the two or more strings may be configured in a non-parallel arrangement. The spacing between the two or more strings may be adjustable to accommodate medicament films of varying widths, thicknesses, and/or volumes. In some embodiments, the two or more strings may be positioned at a fixed, predefined distance apart, or the distance between the strings may be adjustable or customizable based on operational requirements.

In embodiments, the two or more strings may be configured from materials having sufficient mechanical strength to allow for handling and insertion into the gingival crevice. Materials that may be used for the two or more strings may include natural polymers, synthetic polymers, dissolvable polymers, disintegrable polymers, biocompatible polymers, biodegradable polymers, swellable polymers, metals, and/or combinations thereof. In some embodiments, the two or more strings may be made of single-thread constructions or multiple threads braided together, providing variable mechanical properties. In embodiments, the string diameters may range up to about 1000 μm, preferably less than 500 μm, and even more preferably less than 100 μm, including intermediate values within these ranges.

In embodiments, the medicament film disposed within the empty space defined by the two or more strings may be created by dispensing a medicament formulation (e.g., including an active substance) into the defined empty space. Upon drying or curing, the medicament formulation may form a stable, film-like structure that remains attached to the two or more strings. However, in some embodiments, the medicament film may be configured such that upon placement within the gingival crevice, the medicament film may disintegrate, dissolve, release, and/or otherwise deliver the medicament into the gingival crevice to be absorbed into the patient's system via the junctional epithelium. In embodiments, the medicaments may include, but are not limited to, vaccines, allergens, pharmaceuticals, nutraceuticals, vitamins, minerals, antibiotics, peptides, proteins, DNA, RNA, chemokines, cytokines, anti-fungal, anti-inflammatory, and combinations thereof, configured for either local therapeutic effects or systemic delivery through the junctional epithelium. Indeed, as mentioned above, the medicament formulations carried in the medicament films may include any combination of medicaments as described in this disclosure.

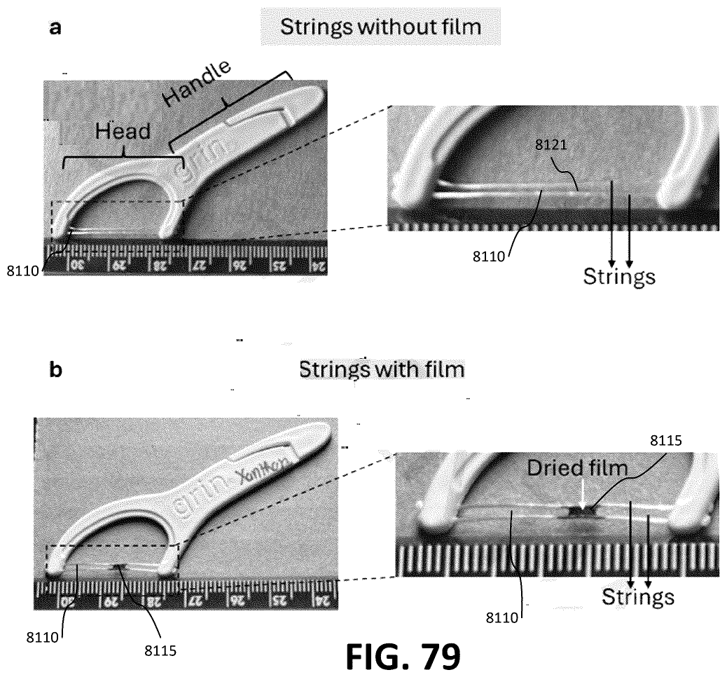

FIG. 79 illustrates an exemplary embodiment of a JET device configured with a string-based insertable component for delivery of medicament films into the gingival crevice in accordance with embodiments of the present disclosure. In particular, as shown, the JET device may include a handle and a head. The head may include an insertable component 8110 comprising two strings configured parallel (or substantially parallel) to each other and defining a space 8121 therebetween. Although two parallel strings are shown in this embodiment, the insertable component 8110 may alternatively include more than two strings, and the strings may be positioned in parallel or non-parallel configurations to each other.

In embodiments, as shown in insert (a) of FIG. 79, the insertable component 8110 may define a space 8121 disposed between the two strings configured to receive a medicament formulation. Insert (b) of FIG. 79 shows the insertable component 8110 after a medicament formulation has been dispensed and dried within the space 8121, resulting in the formation of a medicament film 8115. In embodiments, the medicament film 8115 may be configured to attach to the two strings forming a stable film structure configured for insertion into the gingival crevice.

In embodiments, the medicament film 8115 illustrated in the example shown in FIG. 79 may be formed from a medicament solution comprising about 2 μl to about 10 μl of Xanthan gum at a concentration ranging from about 0.1% (w/v) to about 3% (w/v), and Sulforhodamine B sodium salt (model dye) at a concentration ranging from about 0.01% (w/v) to about 1% (w/v). After dispensing into the space 8121, the medicament solution may be dried by incubating at a suitable temperature, forming the medicament film 8115 configured for insertion and delivery into the gingival crevice. Incubation temperature can range from sub-zero to 200° C. resulting in film formation.

In embodiments, the thickness and width of the medicament film 8115 may be configured based on the volume and concentration of the medicament formulation dispensed into the space 8121, as well as the specific spacing between the strings. For example, increasing the dispensed volume or concentration of the medicament formulation may result in thicker and wider medicament films. On the other hand, reducing the dispensed volume or concentration of the medicament formulation dispensed into the space 8121 may result in thinner, narrower medicament films. In this manner, the insertable component 8110 may be configured to accommodate a wide range of medicament film dimensions, such as thicknesses ranging from about 0.01 μm to about 1000 μm, including intermediate values (e.g., 0.1 μm, 1 μm, 10 μm, 50 μm, 100 μm, 500 μm, etc.).

During operation, a user may handle the JET device by manipulating the handle to insert the insertable component 8110 carrying the medicament film 8115 into the patient's gingival crevice. Upon insertion, the medicament film 8115 may contact gingival crevicular fluid, saliva, moisture, etc. within the gingival crevice, which may cause the medicament film 8115 to disintegrate, dissolve, and/or release the medicament contained or carried therein, delivering the medicament into the gingival crevice for absorption into the patient's system via the junctional epithelium, as described in embodiments of this disclosure. In embodiments, the insertable component 8110 and the medicament film 8115 may be configured to remain within the gingival crevice until sufficient medicament delivery has occurred.

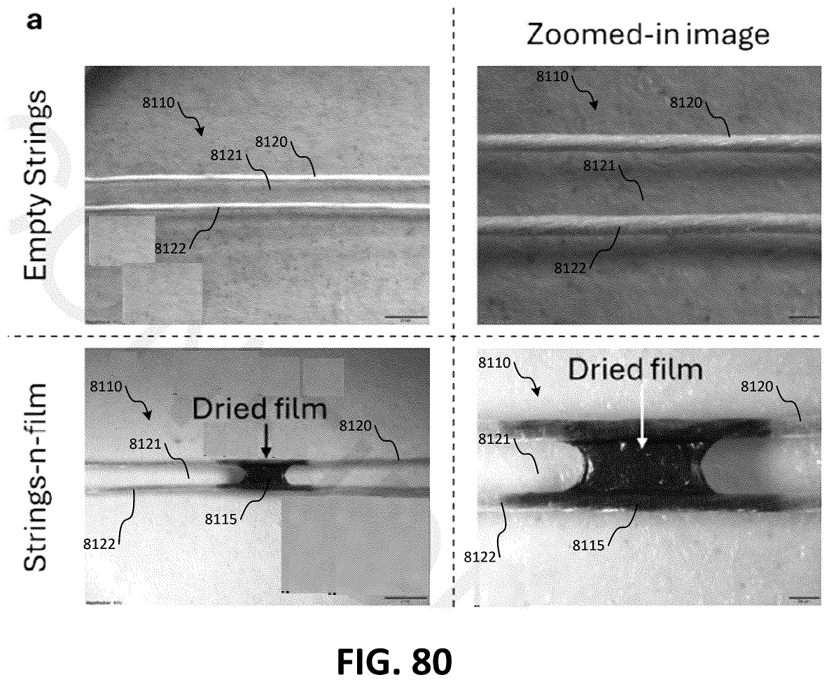

FIG. 80 illustrates another exemplary embodiment of a string-based insertable component 8110 for delivering medicament films into the gingival crevice in accordance with embodiments of the present disclosure. As shown, insertable component 8110 may include an arrangement with a top string 8120 and a bottom string 8122, defining the space 8121 therebetween. It is noted that although two strings are shown in this example, the insertable component may include more than two strings, which may be configured in parallel or non-parallel arrangements, based on operational requirements.

In embodiments, the medicament film 8115 may be configured to be formed within the defined space 8121 by dispensing a medicament formulation therein. In particular, the medicament formulation used to create medicament film 8115 in the example illustrated in FIG. 80 may include approximately 15 μl to about 35 μl of Xanthan gum at a concentration range of about 0.1% (w/v) to about 3% (w/v), and Sulforhodamine B sodium salt (model dye) at a concentration range of about 0.01% (w/v) to about 1% (w/v). After dispensing into the space 8121, the medicament solution may be dried by incubating at a temperature in the range of about 25° C. to about 50° C., forming the medicament film 8115 that may be attached to the top string 8120 and the bottom string 8122.

In particular, the embodiment illustrated in FIG. 80 may demonstrate the effect of using increased solution volume and/or concentration to form a thicker and/or wider medicament film 8115 as compared to the embodiment illustrated in FIG. 79. Indeed, the insertable component 8110 may be configured to accommodate varying medicament film dimensions and thicknesses, based on operational requirements and/or targeted treatment areas within the gingival crevice. For example, the medicament film thickness and width may vary depending on the amount and viscosity of the solution dispensed. Thicknesses of the resulting medicament film may range from about 0.01 μm to about 1000 μm (e.g., 0.1 μm, 1 μm, 10 μm, 50 μm, 100 μm, 500 μm, etc.) in some embodiments.

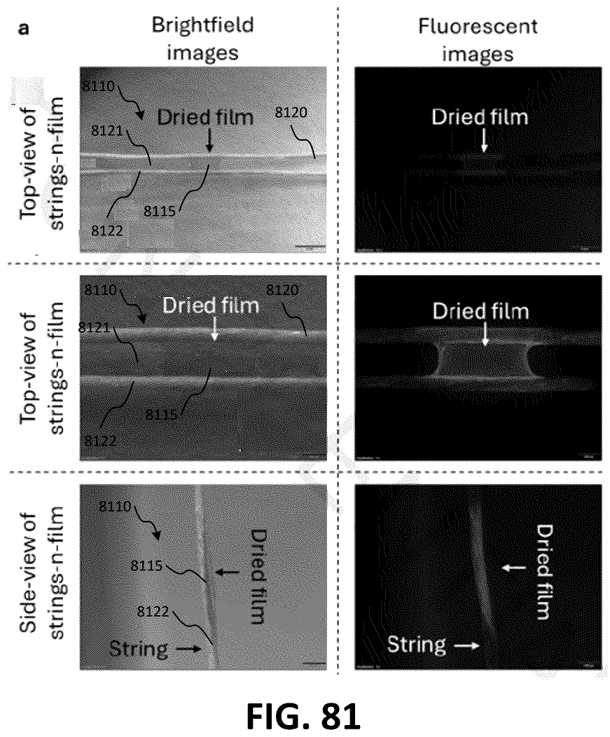

FIG. 81 illustrates yet another exemplary embodiment of the string-based insertable component 8110 of a JET device configured for delivery of medicament films into the gingival crevice in accordance with embodiments of the present disclosure. In this embodiment, the insertable component 8110 may include the top string 8120 and the bottom string 8122 defining the space 8121 between them. In this particular example illustrated in FIG. 81, the medicament film 8115 may be configured from a distinct formulation compared to the examples in FIGS. 80 and 81. In particular, the medicament film 8115 illustrated in FIG. 81 may be formed using a medicament solution comprising approximately 1 μl to about 10 μl of gelatin at a concentration range of about 0.1% (w/v) to about 3% (w/v), and Fluorescein isothiocyanate (FITC)-tagged Ovalbumin (Ova, a model protein) at concentrations ranging from approximately 0.1 mg/ml to about 3 mg/ml. Once dispensed into the space 8121 defined between the top string 8120 and the bottom string 8122, the medicament solution may be dried by incubating at a suitable temperature, forming the medicament film 8115 that may be attached to the top string 8120 and the bottom string 8122. In this example, the medicament film 8115 may be configured to have a thickness substantially similar to the diameter of the bottom string 8122. Incubation temperature can range from sub-zero to 200° C.

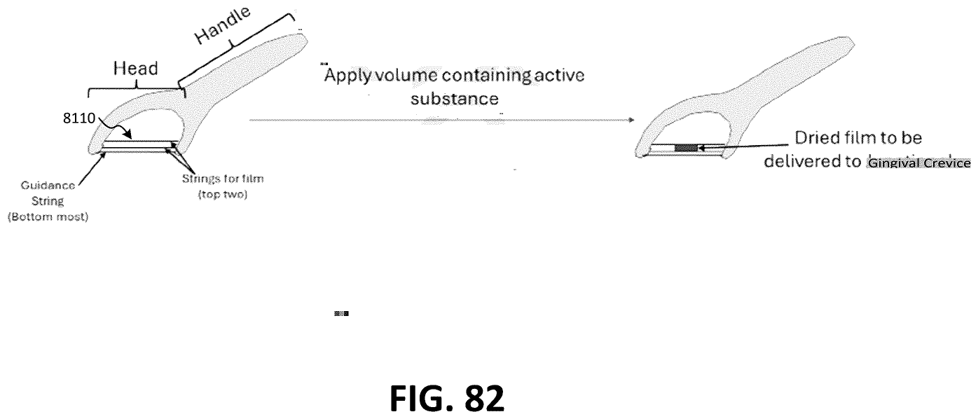

FIG. 82 illustrates another exemplary embodiment of a string-based insertable component 8110 of a JET device configured for delivery of medicament films into the gingival crevice in accordance with embodiments of the present disclosure. In this embodiment, the insertable component 8110 may include a structural configuration including the top string and the bottom string configuration, similar to previous embodiments, but may also include a guide string. In embodiments, the guide string may be configured to operate as a protective guide during insertion into the gingival crevice, and may ensure the integrity and stability of the medicament film carried between the primary strings during operation.

In embodiments, the guide string may be configured to provide support and mechanical protection to the medicament film during the insertion process, which may reduce potential displacement or damage during insertion. In embodiments, the guide string configuration may also facilitate accessing deeper regions within the gingival crevice or positioning the medicament film against the junctional epithelium. In embodiments, the guide string may be disposed as the bottom-most string, which may be configured to contact the users gingival crevice first, before the primary strings (e.g., the strings carrying the medicament film).

During operation, the insertable component 8110, supported by the guide string, may be manipulated using the handle and may be inserted into the gingival crevice. Upon insertion, the medicament film may contact gingival crevicular fluid, saliva, moisture, etc. within the gingival crevice, which may cause the medicament film to disintegrate, dissolve, and/or release the medicament contained or carried therein, delivering the medicament into the gingival crevice for absorption into the patient's system via the junctional epithelium, as described in embodiments of this disclosure. In embodiments, the structural support provided by the guide string may ensure the medicament film's stability until medicament delivery occurs.

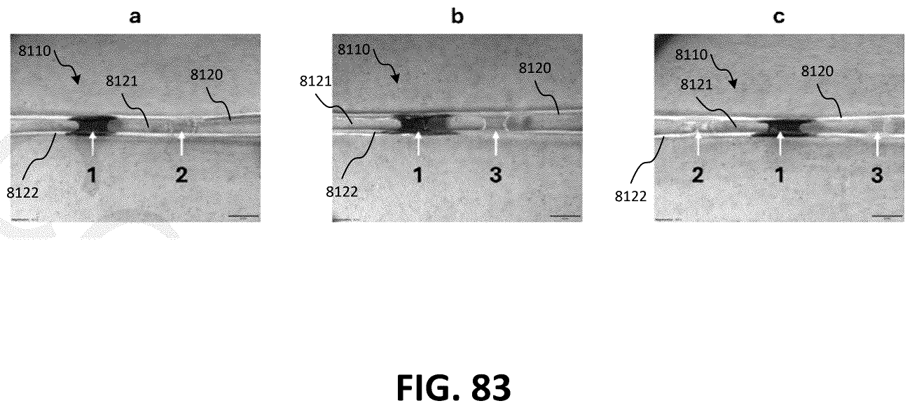

FIG. 83 illustrates another exemplary embodiment of a JET device including a string-based insertable component 8110 configured with functionality for delivering multiple medicament films into the gingival crevice in accordance with embodiments of the present disclosure. As shown, the insertable component 8110 may include at least one top string 8120 and at least one bottom string 8122, defining a space 8121 between them. Although two parallel strings are depicted in FIG. 83, alternative embodiments may include more than two strings configured in parallel or non-parallel arrangements to create multiple spaces for forming multiple medicament films in accordance with the present disclosure.

In embodiment, multiple medicament films (e.g., medicament film 1, medicament film 2, medicament film 3, although in some embodiments there may be two or more medicament films) may be formed at different regions of the space 8121 defined by the top string 8120 and the bottom string 8122. In embodiments, the different medicament films may be adjacent to each other, without a separation distance between them. In other embodiments, different medicament films may be separated by a separation distance. In embodiments, the separation distances between one or more of the medicament films 1, 2, and/or 3 may range from about 0.01 μm up to about 3 mm. In some embodiments, the separation between medicament films may have a separation value such as about 0.01 μm, 0.1 μm, 0.2 μm, 0.3 μm, 0.4 μm, 0.5 μm, 0.6 μm, 0.7 μm, 0.8 μm, 0.9 μm, 1.0 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, and/or higher up to 5 mm.

In embodiments, the medicament films 1, 2 and/or 3 may be formulated from the same or different medicaments or combinations thereof. For example, multiple films may each carry the same medicament for increased dosage delivery or may each carry different medicaments such as combinations of different vaccines, allergens, drugs, vitamins, adjuvants, antibiotics, antifungals, anti-inflammatory, cytokines, chemokines, etc. In embodiments, the medicament films may be configured in alternating sequences or customized patterns, such as sequences including ABCD, BCDA, AABBCCDD, ABBCD, ABBBCD, ABCCD, ABCCCD, ABCDD, ABCDDD, or other customized patterns (e.g., for medicament films A, B, C, and D, as a non-limiting example).

In embodiments, the medicament films formed within insertable component 8110 may be configured with various dimensional properties, including distinct film thicknesses, widths, and/or lengths. Medicament film thicknesses may range from about 0.01 μm to about 8000 μm, including intermediate values (e.g., 0.1 μm, 1 μm, 5 μm, 10 μm, 20 μm, 50 μm, 100 μm, 500 μm).

During operation, the insertable component 8110 configured with multiple medicament films may be inserted into the gingival crevice of a patient using the handle. Once inserted, each medicament film (e.g., medicament film 1, 2, and/or 3 in the example illustrated in FIG. 83) may contact gingival crevicular fluid, saliva, moisture, etc. within the gingival crevice, which may cause each medicament film to individually or collectively disintegrate, dissolve, and/or release the medicament contained or carried therein, delivering the medicament into the gingival crevice for absorption into the patient's system via the junctional epithelium, as described in embodiments of this disclosure. In embodiments, each medicament film may deliver the medicament concurrently with the other medicament films, or sequentially (e.g., following a sequence such as medicament film 1, 2, then 3) for medicament release.

In embodiments, multiple strings could run parallel to one another and the medicaments film(s) (which may be the same or different) may be formed between different sets of the parallel strings to be delivered to the gingival crevice. In embodiments, the length, width, and/or thickness of each individual string may be the same or different. In embodiments, the length, width, and/or thickness of each medicament film may be the same or different.

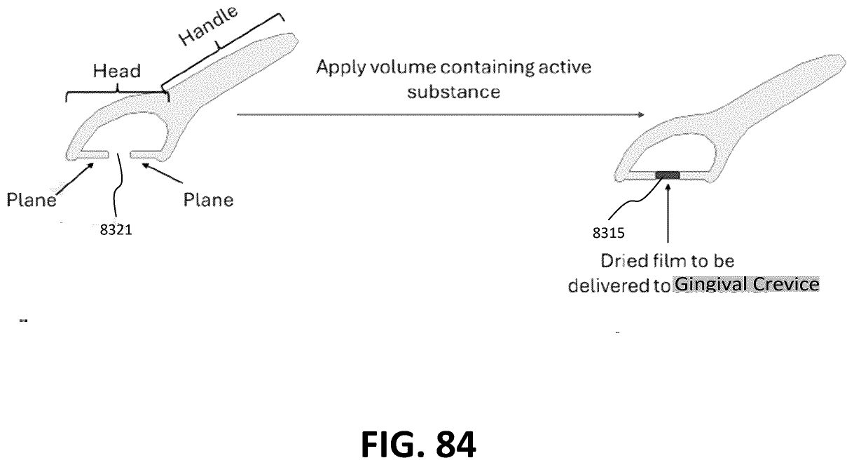

FIG. 84 illustrates another exemplary embodiment of a JET device with a plane-based insertable component configured with functionality for delivery of medicament films into the gingival crevice in accordance with embodiments of the present disclosure. In this example, the JET device may include a handle and a head including an insertable component that includes two planar structural elements (e.g., two planes) disposed along a longitudinal axis and defining an intervening space 8321 configured to accommodate and support a medicament film 8315.

In embodiments, the medicament film 8315 may be formed by dispensing a medicament formulation (e.g., as described herein) into the space 8321 defined between the two planes of the insertable component. Upon dispensing into the space 8321, the medicament formulation may be dried or cured, resulting in the formation of the medicament film 8315 that may be attached or adsorbed to the two planes at each side of the medicament film 8315.

In embodiments, the medicament film 8315 formed within the space 8321 may be configured to have varying dimensions, such as thicknesses and length as described herein with respect to the medicament films described with respect to FIGS. 79-83.

During operation, a user may manipulate the JET device illustrated in FIG. 84 (e.g., using the handle) and may insert the insertable component, including the medicament film 8315, into the gingival crevice. Upon insertion, the medicament film 8315 may contact gingival crevicular fluid, saliva, moisture, etc. within the gingival crevice, which may cause the medicament film 8315 to disintegrate, dissolve, and/or release the medicament contained or carried therein, delivering the medicament into the gingival crevice for absorption into the patient's system via the junctional epithelium, as described in embodiments of this disclosure. In these embodiments, the planar configuration of the insertable component may provide sufficient structural support for insertion to deliver the medicament into the gingival crevice.

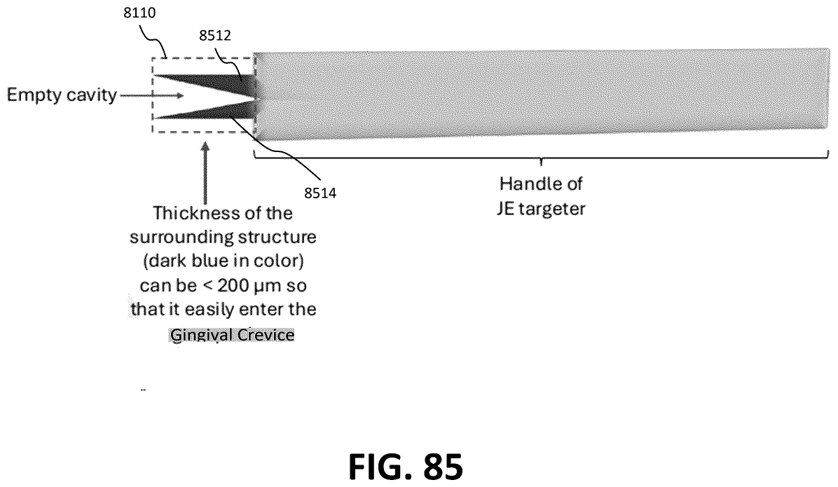

FIG. 85 illustrates an exemplary embodiment of a JET device including a frame-based insertable component 8110 configured for delivery of medicament films into the gingival crevice in accordance with embodiments of the present disclosure. As shown, the JET device may include a handle and the insertable component 8110. The insertable component 8110 may include an upper arm 8512 and a lower arm 8514 that may collectively define an empty cavity configured to support and/or deliver a medicament film into the gingival crevice.

In embodiments, the upper arm 8512 and the lower arm 8514 of the insertable component 8110 may be configured to provide mechanical stability for the medicament film, which may ensure secure placement and retention of the medicament film during insertion and delivery. In some embodiments, the upper arm 8512 and the lower arm 8514 may be configured substantially parallel to one another. In alternative embodiments, the upper arm 8512 and the lower arm 8514 may be configured in non-parallel arrangements, adjusted angles, and/or other configurations based upon operational requirements.

In embodiments, the material used to construct the upper arm 8512 and the lower arm 8514 may include natural polymers, synthetic polymers, dissolvable polymers, disintegrable polymers, biodegradable polymers, biocompatible polymers, metals, and/or combinations thereof.

In embodiments, the cavity defined between the upper arm 8512 and the lower arm 8514 may be configured to receive a medicament formulation, which upon dispensing, drying, and/or curing, may form a medicament film. The medicament film may be composed of active substances such as vaccines, allergens, drugs, vitamins, or therapeutic proteins, and may include additional excipients to enhance mechanical properties, controlled release profiles, or mucoadhesive characteristics. Such excipients may include but are not limited to mucoadhesives, viscosity enhancers, plasticizers, surfactants, cellulose derivatives, sugars, starches, polyvinyl alcohol, or combinations thereof. Indeed, the medicament formulations carried in the medicament film may include any combination of medicaments as described in this disclosure.

In embodiments, the medicament film formed within the cavity may be configured with various dimensions, such as thicknesses and length as described herein with respect to the medicament films described with respect to FIGS. 79-83. In embodiments, medicament film width, thickness, and length may be adjusted based on the dispensing volume, therapeutic objectives, and/or gingival crevice anatomy. In embodiments, the upper arm 8512 and the lower arm 8514 dimensions may be configured based upon the operational requirements needed for insertion and support, including thickness values ranging from about 1 μm to about 1000 μm, or more.

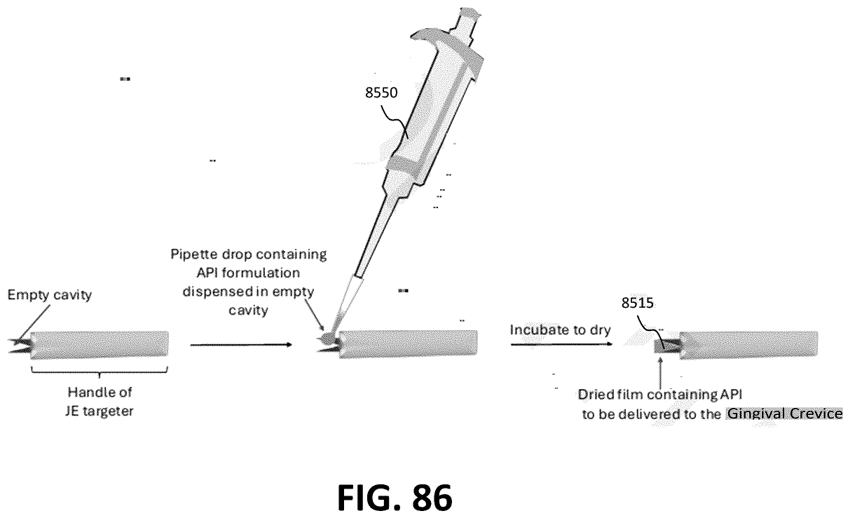

FIG. 86 illustrates exemplary operations for loading a medicament formulation into a frame-based insertable component of a JET device configured for delivery of medicament films into the gingival crevice in accordance with embodiments of the present disclosure. As shown, a medicament film 8515 may be configured to be formed within the cavity defined by upper arm 8512 and lower arm 8514 of the insertable component 8110. In particular, a medicament dropper 8550 may be configured to dispense the medicament formulation into the empty cavity between the upper arm 8512 and lower arm 8514. In embodiments, the medicament formulation may be allowed to dry or cure to form the medicament film 8515.

During operation, the insertable component 8110, comprising the upper arm 8512 and lower arm 8514, may be manipulated using the handle to insert the insertable component 8110 carrying the medicament film 8515 into the gingival crevice. Upon insertion, the medicament film 8515 may contact gingival crevicular fluid, saliva, moisture, etc. within the gingival crevice, which may cause the medicament film 8515 to disintegrate, dissolve, and/or release the medicament contained or carried therein, delivering the medicament into the gingival crevice for absorption into the patient's system via the junctional epithelium, as described in embodiments of this disclosure.

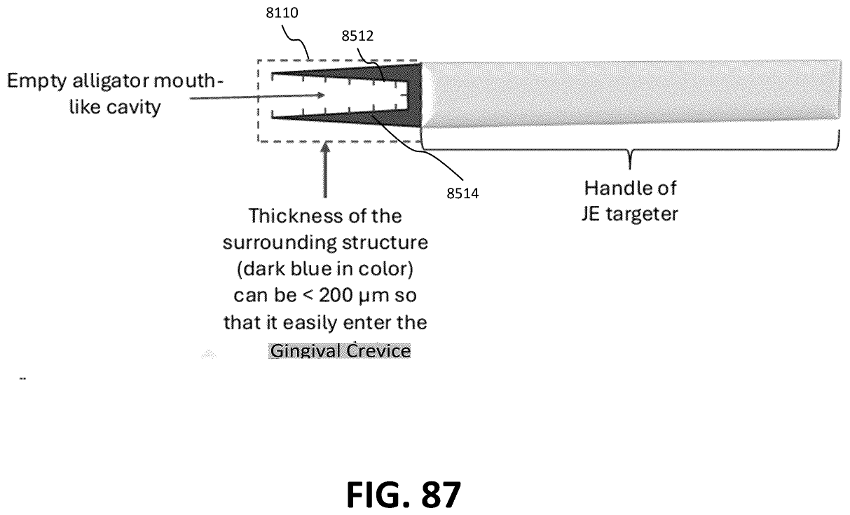

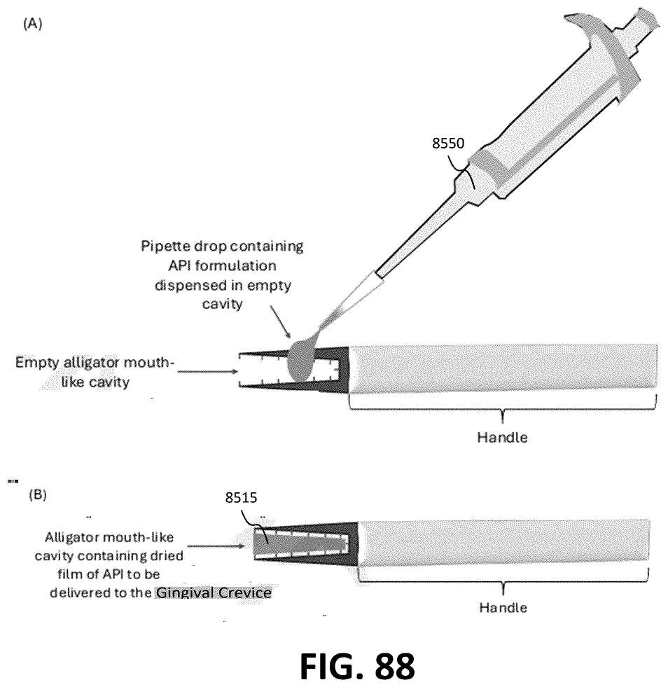

FIGS. 87 and 88 illustrate another exemplary embodiment of a JET device including a frame-based insertable component 8110 configured for delivery of medicament films into the gingival crevice in accordance with embodiments of the present disclosure. As shown, insertable component 8110 may include an upper arm 8512 and a lower arm 8514, with functionality similar to embodiments described with reference to FIGS. 85 and 86, and may be configured with one or more teeth or protrusions extending from the respective surfaces of the upper arm 8512 and the lower arm 8514 into the cavity defined between them. In embodiments, the one or more teeth may be configured to minimize contact between the medicament film 8515 and the surfaces of the upper arm 8512 and the lower arm 8514.

For example, FIG. 88 illustrates operations for forming the medicament film 8515 within the cavity between the upper arm 8512 and the lower arm 8514. Insert (A) of FIG. 88 shows a medicament dropper 8550 configured to dispense a medicament formulation into the cavity. The medicament formulation dispensed into the cavity comprises active substances selected from vaccines, allergens, drugs, vitamins, therapeutic proteins, biologically active molecules, or combinations thereof, along with excipients such as mucoadhesives, viscosity enhancers, plasticizers, surfactants, cellulose derivatives, sugars, starches, and polyvinyl alcohol, configured to enhance film strength, adhesion, or controlled dissolution. Indeed, the medicament formulation carried in the medicament film may include any combination of medicaments as described in this disclosure.

Insert (B) of FIG. 88 illustrates the medicament film 8515 formed after drying or curing. In this configuration, the medicament film 8515 may be supported primarily by the one or more teeth on the upper arm 8512 and the lower arm 8514, ensuring minimal direct surface contact with the main surfaces of the upper arm 8512 and the lower arm 8514. In embodiments, the minimal contact configuration may facilitate the release of the medicament film 8515 upon insertion into the gingival crevice, which may reduce potential sticking or incomplete delivery.

In embodiments, the one or more teeth or protrusions extending from the respective surfaces of the upper arm 8512 and the lower arm 8514 may be configured to varying sizes, shapes, dimensions, numbers, and/or distributions across the upper arm 8512 and the lower arm 8514 to optimize the minimal-contact support of the medicament film.

During operation, a user may insert the insertable component 8110, including medicament film 8515, into the gingival crevice using the handle. Upon insertion, the minimal-contact support provided by the one or more teeth may facilitate dislodgement or detachment of the medicament film 8515 from the upper arm 8512 and the lower arm 8514, allowing the medicament film 8515 to disintegrate, dissolve, and/or release the medicament contained or carried therein, delivering the medicament into the gingival crevice for absorption into the patient's system via the junctional epithelium, as described in embodiments of this disclosure.

What follows is a description of various materials, dimensions, and/or configurations that may be used for various embodiments of the JET device described herein, especially a JET device including string-based, plane-based, or frame-based insertable components as described herein. As such, the following description should not be read as limiting to any particular implementation of a JET device. When particular features are mentioned or described with reference to a particular embodiment of a JET device, it should be understood to be for illustrative purposes, and not by way of limitation. Indeed, the features may be applicable to other embodiments of a JET device as described herein. Similarly, features not described with reference to particular embodiments of a JET device, but described with reference to other embodiments of a JET device, should be understood to be applicable to any embodiment of a JET device. As such, merely because a feature (e.g., functionality, structure, material, composition, etc.) is not explicitly described with reference to a particular JET device does not mean that the feature may not be applicable to the particular JET device. Indeed, the feature may be contemplated to be applicable to the particular JET device.

In embodiments, materials that may be used for constructing insertable components for a JET device may include, but are not limited to, natural polymers, synthetic polymers, dissolvable polymers, disintegrable polymers, biodegradable polymers, biocompatible polymers, swellable polymers, metals, or any combination thereof, and/or other materials described in the present disclosure. Such materials may be configured to provide structural rigidity and flexibility for handling, placement, retention, and/or insertion into the targeted gingival crevice.

In embodiments, the structural elements (e.g., strings, planes, frames, substrates, etc.) of the JET device may include single-threaded configurations, multiple-thread braided structures, planar tapes, and/or structural frames of varying geometries. In embodiments, threads and strings utilized in insertable components may be configured to have diameters ranging from less than about 1000 μm, preferably less than about 500 μm, and even more preferably less than about 100 μm (including intermediate values such as 10 μm, 20 μm, 50 μm, and so forth).

In embodiments, planar structural elements (e.g., as shown in FIG. 84) may be configured with thicknesses ranging from about 1 μm to about 1000 μm. For example, in embodiments, the planar structural elements may be configured with thicknesses of 1 μm, 2 μm, 3 μm, 4 μm, 5 μm, 6 μm, 7 μm, 8 μm, 9 μm, 10 μm, or greater. In one embodiment, the planar structural elements may be configured with thicknesses of 10 μm, 20 μm, 30 μm, 40 μm, 50 μm, 60 μm, 70 μm, 80 μm, 90 μm, 100 μm, or greater. In one embodiment, the planar structural elements may be configured with thicknesses of 100 μm, 200 μm, 300 μm, 400 μm, 500 μm, 600 μm, 700 μm, 800 μm, 900 μm, 1000 μm, or greater. In embodiments, either both the planes have same thickness or different thickness.

In embodiments, structural elements such as frames or substrates (e.g., as shown in FIGS. 85-88) may be configured in various geometries, including, without limitation, thread-like structures, planar shapes, polygons, star shapes, circular shapes, or other free-form shapes, or any combination thereof, to securely contain, hold, or support medicament films. In embodiments, the structural elements may include biodegradable, dissolvable, or generally recognized as safe (GRAS) materials. Examples of such materials may include, but are not limited to, polylactic acid (PLA), poly glycolic acid (PGA), poly(lactic-co-glycolic acid) (PLGA), polycaprolactone (PCL), polyethylene glycol (PEG), polyvinyl pyrrolidone (PVP), sugars, starches, or combinations thereof.

In embodiments, the medicament films within the JET device insertable components may be configured substantially (e.g., 90% or more) of active substances such as vaccines, allergens, pharmaceuticals, nutraceuticals, vitamins, therapeutic proteins, small molecules, peptides, DNA, RNA, anti-inflammatory, antibiotic, antifungal, cytokine, chemokine or combinations thereof.

In embodiments, structural elements and medicament films may be optionally reinforced or modified with inactive excipients or additional compounds to improve mechanical properties, adhesion, mucoadhesion, dissolution profiles, or therapeutic effectiveness. Suitable excipients may include mucoadhesives, viscosity enhancers, plasticizers, surfactants, cellulose derivatives, starches, sugar alcohols, sugars (natural or synthetic), amino acids, and polyvinyl alcohol, individually or in combination. These excipients may be configured in the medicament formulation or applied to the surface of structural elements to facilitate enhanced film adherence, controlled release profiles, etc.

In embodiments, the insertable structures of the JET device may be configured with features such as flavoring agents, taste-masking substances, coloring agents, etc. to improve user acceptance and compliance. In embodiments, the flavoring agents, taste-masking substances, coloring agents, etc. may be included into structural elements or medicament films, and may provide visual indicators for users or may enhance the overall user experience during insertion and medicament delivery.

In some embodiments, the medicament films may be configured with varied dissolution and release profiles, ranging from rapid disintegration (e.g., within 180 seconds), medium disintegration (e.g., within 15 mins) to prolonged dissolution (greater than 15 minutes to hours or days). In embodiments, the dissolution characteristics may be configured by incorporating excipients such as mucoadhesives, hygroscopic agents, humectants, plasticizers, surfactants, viscosity enhancers, or materials known to modulate dissolution rates.

In some embodiments, the medicament films may be formed as homogeneous structures or layered configurations. For example, the medicament films may initially be formed from hydrophobic materials containing active substances, then subsequently coated or layered with hydrophilic materials to enhance stability, protect active substances during storage, modulate release profiles upon contact with gingival crevicular fluid, saliva, moisture, etc.

In embodiments, the medicament film may be configured in one of multiple physical states at the time of insertion and delivery into the gingival crevice. For example, a medicament film may be in liquid, semi-solid, gel-like, or solid dried forms, or combinations thereof, when inserted into the gingival crevice. In some embodiments, such as when multiple medicament films are used in a single insertable component (e.g., in a multi-medicament film configuration such as illustrated in FIG. 83), the different medicament films may be in different physical states at the time of insertion and delivery into the gingival crevice.

In some embodiments, the medicament film configurations may include medicament films formed from liquids that, upon mixing or contacting fluids within the gingival crevice, rapidly transition into a gel or solid. Examples of such medicament formulations may include cyanoacrylate blends (e.g., butyl and octyl cyanoacrylates) that polymerize upon moisture contact, thermoplastic polymers like polyvinyl pyrrolidone or polyethylene glycol configured for moisture or temperature-responsive phase transitions, or polysaccharide-based formulations (e.g., chitosan) configured to gel in the presence of ions such as calcium found naturally in saliva.

In embodiments, the structural elements supporting the various medicament film configurations may maintain sufficient mechanical strength and integrity for handling and insertion into the gingival crevice. Structural components may include configurations configured to hold and protect medicament films until delivery occurs, utilizing geometries such as wedge shapes, cones, frustums, and/or other optimized forms to enhance insertion comfort and/or retention.

In embodiments, the medicament formulations used to form the medicament films may be dispensed into the insertable component of the JET device using various techniques, such as pipette-based dispensing, automated dispensing systems, 3D dispensing, dipping of structural components into solution reservoirs, precision 3D printing methods, spray coating, etc. In some embodiments, the medicament films may be initially prepared as larger sheets, and subsequently cut or sized to fit within the insertable components. The pre-formed films may be attached to structural elements by methods including physical adsorption, chemical adhesion, biological binding, and/or combinations thereof.

In some embodiments, the medicament formulations may be configured to form layered structures, allowing multiple layers with distinct functional or therapeutic properties to form the medicament films. For example, a medicament film initially composed of hydrophobic material containing active substances may subsequently receive a protective hydrophilic coating to enhance stability, modulate dissolution rates, protect the active substances during storage and handling, etc. On the other hand, medicament films initially composed of hydrophilic materials may be subsequently coated with hydrophobic layers to achieve controlled or delayed release profiles upon contact with moisture in the gingival crevice environment.

In some embodiments, medicament film formulations may include reactive configurations configured to rapidly form gels or solid matrices upon contact with gingival crevicular fluid, saliva, or physiological ions. For example, reactive cyanoacrylate blends (e.g., butyl and octyl cyanoacrylate) may polymerize in situ upon moisture contact to entrap active substances at the site of administration. Hydrogel-forming substances, such as chemically modified polyvinyl alcohol, polyethylene glycol, or chitosan-based formulations, may similarly respond to moisture or ion concentrations present in saliva or gingival crevicular fluid, and may transition into gel or solid forms. Thermoplastic or thermos-reversible polymers like polyvinyl pyrrolidone may undergo phase transitions in response to moisture or temperature variations within the oral cavity, providing additional control over the release and therapeutic delivery profile.

In embodiments, structural elements (e.g., strings or threads) may be configured in single-thread constructions or braided configurations comprising multiple threads. In embodiments, diameters of individual strings or threads may range from less than about 8000 μm, preferably less than about 500 μm, and more preferably less than about 100 μm, with intermediate values such as about 10 μm, 20 μm, 50 μm, or 75 μm, based on operational requirements.

In embodiments, structural planes or tapes configured to support medicament films may be composed of single-thread or braided-thread configurations. In embodiments, the thicknesses of structural planes or tapes may range from about 1 μm to about 1000 μm, including intermediate values such as 2 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, or 900 μm, and so on.

In embodiments, structural frames or substrates may be configured in various geometric forms, including thread-like structures, planar shapes, windows, circles, polygons, stars, free-form shapes, or combinations thereof, configured to support medicament films. In embodiments, the structural frames or substrates may incorporate biodegradable, dissolvable, GRAS, or edible materials to ensure safety and compatibility during intraoral therapeutic administration. Suitable materials may include polylactic acid (PLA), poly glycolic acid (PGA), poly(lactic-co-glycolic acid) (PLGA), polycaprolactone (PCL), polyethylene glycol (PEG), polyvinyl pyrrolidone (PVP), cellulose derivatives, starches, sugars, or combinations thereof.

In embodiments, structural elements may be configured with different mechanical joint structures to attach the insertable component to a grip or handle. Joint configurations may include butt joints, lap joints, mortise-and-tenon joints, dado joints, tongue-and-groove joints, half-lap joints, or combinations thereof. Adhesive methods such as glue, hot melt adhesives, solvent melting, or mechanical interlocking features may be used. In embodiments, the joints may be configured to be fluid-sensitive, dissolvable upon saliva contact, or intentionally breakable, to facilitate the release and retention of the medicament films within the gingival crevice upon insertion and deployment.

In embodiments, the JET device of embodiments may include delivery mechanisms including the use of swellable materials within the medicament films or structural assemblies. In embodiments, the swellable materials, upon contact with gingival crevicular fluid, saliva, or moisture, may expand or swell, to facilitate the release of the medicaments into the gingival crevice.

In embodiments, the medicament films may include encapsulated or entrapped medicament within micro- or nano-sized carriers, such as liposomes, polymeric particles, lipid-based particles, inorganic nanoparticles, or hybrid structures thereof. These carriers may provide protection of the medicament from premature degradation, control of the release rates, targeted cellular uptake within the gingival tissues, and more. In embodiments, the encapsulated carriers may range in size from a few nanometers (e.g., about 10 nm, 20 nm, 50 nm, 100 nm) up to micrometer-scale dimensions (e.g., about 1 μm, 5 μm, 10 μm).

In embodiments, the medicament films may be configured to facilitate controlled mechanical action, such as gentle agitation, slight frictional motion, or sustained placement within the gingival crevice, to achieve medicament release. In embodiments, the structural assemblies supporting the medicament films may be configured to maintain sufficient mechanical strength and integrity, ensuring proper positioning, insertion comfort, and medicament delivery within the gingival crevice.

In embodiments, the medicament films or structural assemblies may include mucoadhesive substances configured to enhance the retention and adhesion of the medicament films to the gingival tissues upon insertion. Suitable mucoadhesive materials may include, without limitation, polysaccharides (such as chitosan, alginate, cellulose derivatives), polyvinyl alcohol, polyvinyl pyrrolidone, polyethylene glycol, gelatin, or combinations thereof. These mucoadhesive materials may be included at concentrations sufficient to enhance medicament film retention and adherence to the gingival crevice tissues to ensure delivery of the medicament into the gingival crevice.

In embodiments, hygroscopic substances may be included within the medicament films or structural elements to facilitate controlled moisture uptake, enhanced dissolution behavior, optimized swelling characteristics, etc. Suitable hygroscopic materials may include, for example, glycerol, sorbitol, mannitol, polyethylene glycol, polyvinyl pyrrolidone, or combinations thereof.

In embodiments, medicament formulations may include viscosity enhancers or plasticizers configured to optimize medicament film mechanical properties, such as flexibility and handling characteristics. In embodiments, viscosity-enhancing substances suitable for use within the medicament formulations may include, without limitation, xanthan gum, hydroxypropyl methylcellulose, carboxymethylcellulose, polyvinyl alcohol, polyvinyl pyrrolidone, gelatin, alginate derivatives, or combinations thereof. Plasticizers utilized to enhance medicament film flexibility and reduce brittleness may include glycerol, propylene glycol, polyethylene glycol, dibutyl phthalate, triethyl citrate, triacetin, or combinations thereof.

In embodiments, surfactants may be included within the medicament film formulations to improve wettability, dispersion characteristics, dissolution rates upon contact with gingival crevicular fluid, etc. Suitable surfactants may include, but are not limited to, polysorbates, sorbitan esters, sodium lauryl sulfate, sodium cholate, lecithin, or combinations thereof. In embodiments, the concentration and composition of the surfactants may be configured to modulate the immediate or sustained release of the medicament into the gingival crevice, configured medicament film dissolution profiles, etc.

In some embodiments, the medicament films may be configured into composite structures or layered configurations including combinations of mucoadhesives, hygroscopic materials, viscosity enhancers, plasticizers, humectants, and/or surfactants. In embodiments, the medicament films may include multiple active substances, including distinct vaccines, allergens, pharmaceuticals, nutraceuticals, vitamins, proteins, peptides, cytokines, chemokines, DNA, RNA, antibiotics, anti-inflammatory, and/or other therapeutic agents, arranged in distinct layers or matrices to achieve sequential, staged, and/or combined release profiles.

In embodiments, the medicament films may be configured with protective and control layers. For example, in embodiments, the protective and control layers applied to medicament films may be configured with a thicknesses that may range from about 0.01 μm to about 1000 μm, including intermediate values such as about 0.1 μm, 1 μm, 5 μm, 10 μm, 20 μm, 50 μm, 100 μm, 500 μm, or combinations thereof. In embodiments, the protective and control layers may be composed of materials such as natural polymers, synthetic polymers, biodegradable polymers, biocompatible polymers, polysaccharides, cellulose derivatives, polyvinyl alcohol, polyethylene glycol, polyvinyl pyrrolidone, chitosan, gelatin, alginate derivatives, or combinations thereof.

In embodiments, the protective and control layers may be configured with varying solvent configurations to enable layering of materials that dissolve sequentially, simultaneously, concurrently, and/or in response to specific environmental triggers (e.g., moisture, temperature, or ionic strength) present within the oral cavity. In embodiments, these configurations may involve sequential layering of hydrophobic and hydrophilic materials, facilitating staged dissolution and controlled active substance release. In embodiments, the protective and control layers may include surfactants, plasticizers, mucoadhesives, or viscosity enhancers.

In embodiments, the insertable component of the JET device of embodiments may be configured with geometries including shapes that may include configurations such as flat surfaces, wedge shapes, cylindrical shapes, tapered cylindrical shapes, bullet-shaped profiles, parabolic shapes, cones, frustums, or combinations thereof. In embodiments, these geometries may be configured based upon anatomical considerations, desired insertion depths, required mechanical strength, targeted therapeutic outcomes within the gingival crevice, etc. For example, wedge-shaped, conical, or frustum-shaped assemblies may be configured to wedge or anchor the medicament films within the gingival crevice, minimizing potential displacement or unintended removal during use.

In embodiments, the overall thickness of functional assemblies (e.g., including the medicament film and the structural support elements) may be less than about 1 mm, and preferably less than about 200 μm, with intermediate values including about 1 μm, 5 μm, 10 μm, 20 μm, 50 μm, 100 μm, 150 μm, or combinations thereof. In embodiments, the height of functional assemblies may range up to about 1 cm, preferably less than about 1 mm, with intermediate values including about 10 μm, 50 μm, 100 μm, 200 μm, 300 μm, 500 μm, 750 μm, or combinations thereof. In embodiments, the lengths of functional assemblies may range from sub-millimeter dimensions (e.g., about 100 μm, 500 μm, 1000 μm) to about 0.5 cm, 1 cm, or 2 cm.

In embodiments, functional assemblies may include surface features configured to enhance film retention, bioadhesion, and/or controlled medicament release profiles. In embodiments, surface textures may include grooves, dimples, ridges, patterned microstructures, etc.

Various embodiments of the present disclosure are directed to a JET device and system that includes functionality for delivery of medicament to multiple gingival crevices. In particular embodiments, the multi-headed JET (M-JET) device may include a multi-headed insertable component configured to be inserted into multiple gingival crevices of the patient concurrently to deliver medicament to the multiple gingival crevices concurrently for absorption into the patient's system via the junctional epithelium, as described herein.

In embodiments, the M-JET device may be configured to addresses limitations associated with conventional JET devices that typically target only a single gingival crevice at a time. In this manner, the M-JET device of embodiments may enhance the total volume and/or amount of medicament that can be delivered at a single instance, and may expand the capability to concurrently deliver different types of medicaments having varying physical, biological, or chemical characteristics into different gingival crevices.

In particular embodiments, the M-JET device may include multiple insertable heads or arms, each configured to independently be inserted into and deliver medicament to a corresponding gingival crevice. For example, the M-JET device may include a plurality of heads (e.g., attached to a common base assembly, each head configured for concurrent insertion into respective gingival crevices of the patient), which may include any number of heads greater than one, up to 15 heads, or even mode in some embodiments. By concurrently inserting multiple heads, the M-JET device is configured to concurrently deliver either the same medicaments or different medicaments concurrently into the gingival crevice of a patient for absorption via the junctional epithelium in accordance with the present disclosure.

In some embodiments, during operation, not all heads of the M-JET may be inserted into a gingival crevice. In some embodiments, less than all the multiple heads of the M-JET may be inserted into a gingival crevice. For example, the M-JET may be configured with four heads. During operation, two heads may be inserted into a gingival crevice, but the other three may remain un-inserted.

In embodiments, the M-JET device may be configured with multiple insertable heads configured with different lengths, widths, thicknesses, and/or base materials to fit varying dimensions of individual gingival crevices in a patient's oral cavity. In some embodiments, the insertable heads of the M-JET device may be individually customized based on a patient's specific anatomy to improve patient compliance.

In embodiments, the M-JET device may be configured for delivering a spectrum of medicaments. For example, embodiments of the M-JET device may concurrently deliver medicaments including active substances including, but not limited to, vaccines, allergens, drugs, vitamins, performance-enhancing substances, DNA, RNA, antibiotics, anti-inflammatory agent, cytokine, chemokines, or any combination thereof. Indeed, the medicaments that may be carried and delivered by the M-JET device may include any combination of medicaments as described in this disclosure.

In embodiments, the medicaments delivered via the M-JET device may be the same medicament on all heads, which may operate to increase the total dosage of a single medicament delivered at one instance. In other embodiments, different heads of the M-JET device may carry different medicaments, enabling medicament combination therapies and treatment modalities that may not be possible with single-head JET devices. In some embodiments, the different medicaments carried by the different heads of the M-JET device may be incompatible with each other due to differences in their chemical, biological, or physical nature, in which case may not be able to be carried in a single carrier head. In embodiments, each of the different heads of the M-JET device may carry the same or different amounts of medicament.

In embodiments, the M-JET device heads may be individually configured to be coated, dissolvable, disintegrable, swellable, film attached to string and/or a plane, and/or combinations thereof. For example, dissolvable heads may be configured to dissolve upon contact with gingival crevicular fluid or saliva, releasing their medicament load directly into the gingival crevice. Disintegrable or swellable heads may be configured with distinct dissolution, swelling, or disintegration rates.

In some embodiments, the multiple heads of the M-JET device may be configured to have the same or varying dissolution rates, which may provide different therapeutic profiles across multiple gingival crevices concurrently. In some embodiments, each head may include medicament formulations including viscosity enhancers, surfactants, mucoadhesive substances, humectants, plasticizers, stabilizers such as sugars or amino acids, or combinations thereof, to further refine the medicament delivery characteristics such as adhesion, stability, release kinetics, and bioavailability.

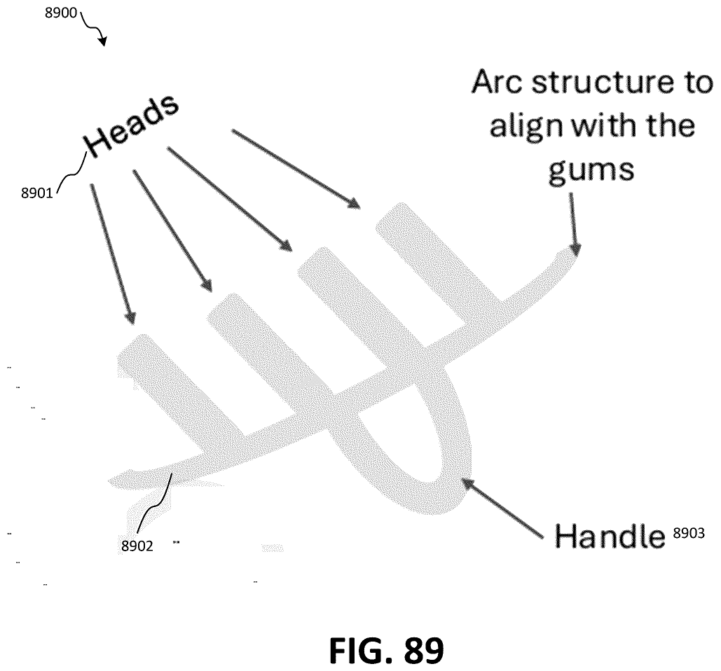

FIG. 89 shows an exemplary multi-headed JET device 8900 configured with functionality for concurrent delivery of medicament to multiple gingival crevices in accordance with embodiments of the present disclosure. As shown, M-JET device 8900 may include multiple insertable heads 8901, an arc structure 8902, and a handle 8903.

In embodiments, each of the multiple insertable heads 8901 of the M-JET device 8900 may be configured to individually be inserted and deliver medicament into a corresponding gingival crevice. As shown, the M-JET device 8900 may be configured to include a plurality of insertable heads (e.g., multiple insertable heads 8901) attached to the arc structure 8902. In this example, the plurality of insertable heads 8901 may include four insertable heads, but this is for illustrative purposes only, and in other embodiments, more or less than four insertable heads may be used (e.g., two or more heads may be used).

In embodiments, the arc structure 8902 may be configured to provide alignment of the multiple insertable heads 8901 with the gums of the patient. The arc structure 8902 may facilitate accurate and stable positioning of the M-JET device 8900, which may ensure that each of multiple insertable heads 8901 may be aligned for insertion into a corresponding gingival crevice. In embodiments, the dimensions, curvature, and flexibility of the arc structure 8902 may be configured to match the natural curvature of a patient's gum line.

In embodiments, the handle 8903 of the M-JET device 8900 may be configured to enable handling and placement of the device by the user. In embodiments, the handle 8903 may be composed of materials selected to ensure suitable mechanical strength, comfort, and stability during insertion of the multiple insertable heads 8901 into the gingival crevices of the patient. In embodiments, materials for the handle 8903 may include natural or synthetic polymers, metals, glass, or combinations thereof. In some embodiments, the handle 8903 may be made from biodegradable, disintegrable, dissolvable, or mucoadhesive materials, including sugars, polymers (natural, synthetic, or combinations thereof), or combinations thereof.

In some embodiments, the handle 8903 may be made from biodegradable, dissolvable, or disintegrable materials that may be left in the oral cavity post-insertion, and may enable the handle 8903 to dissolve within the oral cavity. In alternative embodiments, the handle 8903 may be configured for removal from the oral cavity after successful insertion of the multiple insertable heads 8901 into their respective gingival crevices.

In embodiments, each of insertable head 8901 of the M-JET device 8900 may be configured with varying lengths, widths, and heights configured to accommodate particular dimensions of different gingival crevices within a patient's mouth. For example, in embodiments, the multiple insertable heads 8901 may be configured with lengths ranging from approximately 1 mm to about 30 mm, including intermediate lengths such as about 2 mm, 5 mm, 10 mm, 15 mm, 20 mm, or 25 mm. In embodiments, the multiple insertable heads 8901 may be configured with widths ranging from approximately 0.01 mm to about 5 mm, including intermediate widths such as 0.05 mm, 0.1 mm, 0.5 mm, 1 mm, 2 mm, or 3 mm. In embodiments, the multiple insertable heads 8901 may be configured with thickness ranging from approximately 0.001 mm to 1 mm. The thickness may be less than 5 mm, less than 3 mm, and preferably less than 1 mm.

In embodiments, the insertable heads 8901 may be made from a variety of base materials suitable for subsequent medicament coating or incorporation, including but not limited to dissolvable, disintegrable, swellable, or other biocompatible polymeric materials. In embodiments, the base materials may be subsequently coated or formulated to deliver various medicaments, as described in embodiments of the present disclosure.

In some embodiments, the multiple insertable heads 8901 of the M-JET device 8900 may be configured to concurrently deliver the same medicament to multiple gingival crevices. In other embodiments, different heads of the multiple insertable heads 8901 may be individually configured to carry and deliver different medicaments concurrently. In some embodiments, the multiple insertable heads 8901 of the M-JET device 8900 may be configured to carry the medicaments as coatings to the various heads of the multiple insertable heads 8901. In other embodiments, the multiple insertable heads 8901 of the M-JET device 8900 may be configured to carry the medicaments as embedded or incorporated into the heads of the multiple insertable heads 8901. In still some embodiments, some insertable heads of the multiple insertable heads 8901 may be configured to carry the medicaments as coatings while other insertable heads of the multiple insertable heads 8901 may be configured to carry the medicaments embedded or incorporated into these heads.

In some embodiments, the medicament formulations carried by the multiple insertable heads 8901 may include additional excipients or modifiers within the medicament formulations, such as viscosity enhancers, surfactants, mucoadhesive substances, plasticizers, stabilizers (including sugars or amino acids), or combinations thereof. These additional excipients may be configured to enhance medicament retention, optimize therapeutic release profiles, and/or improve patient comfort and compliance. In embodiments, the medicament formulations may be configured to obtain particular release kinetics, including immediate release, medium release, sustained (e.g., prolonged) release, burst release, and/or other controlled release profiles.

In embodiments, the multiple insertable heads 8901 may be configured with varying dissolution, disintegration, and/or swelling characteristics. For example, dissolvable or disintegrable insertable heads may be configured with different rates of dissolution or disintegration upon contact with gingival crevicular fluid, saliva, or moisture within the gingival crevice. Swellable insertable heads may be configured to absorb gingival crevicular fluid and swell to deliver medicaments over controlled periods.

In embodiments, the multiple insertable heads 8901 may be configured to deliver medicaments into respective gingival crevices via coating-based delivery configurations. For example, in embodiments, each of the insertable heads 8901 may be coated with medicament formulations that are subsequently released into the respective gingival crevice upon insertion of the insertable head into the respective gingival crevice.

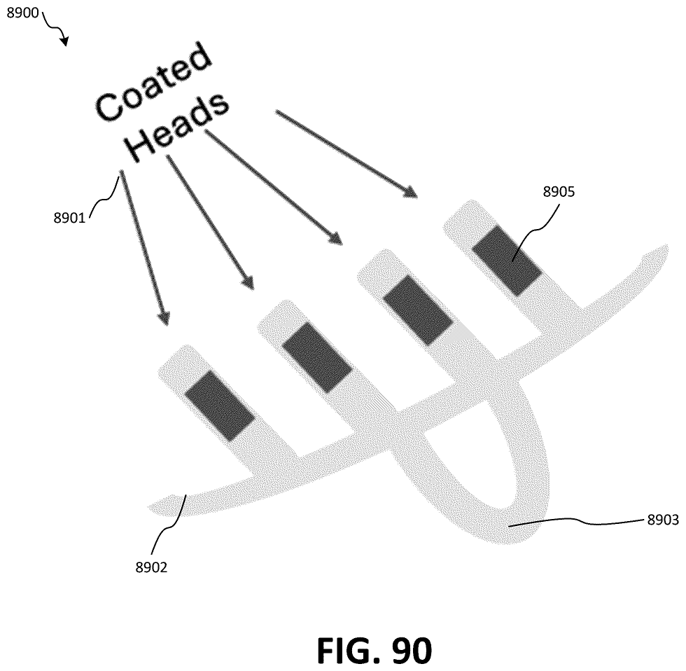

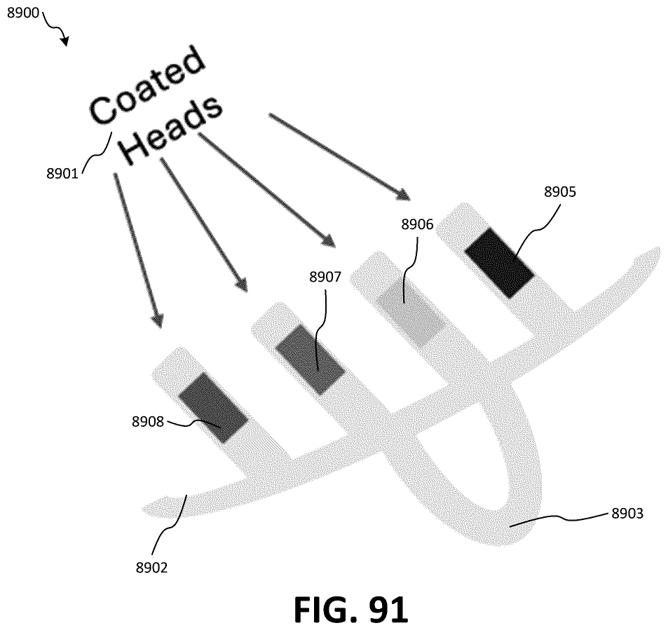

FIGS. 90 and 91 show exemplary embodiments of coated-head configurations of the M-JET device 8900 configured with functionality for concurrent delivery of medicament to multiple gingival crevices in accordance with embodiments of the present disclosure. As shown in FIG. 90, in embodiments, each of the multiple insertable heads 8901 may be coated with the same type of medicament 8905. In this configuration, the M-JET device may be enabled for concurrent delivery of the same medicament formulation to multiple gingival crevices, which may increase the total dosage delivered at a single instance (e.g., when compared to the use of single-head JET device).

In alternative embodiments, as shown in FIG. 91, each insertable head of the multiple insertable heads 8901 may be individually coated with a different medicament type. For example, a first head may be coated with medicament 8908, a second head with medicament 8907, a third head with medicament 8906, and a fourth head with medicament 8905. In these embodiments, each of the medicaments 8905, 8906, 8907, and 8908 may be different from one another. In some embodiments, any subset of the medicaments may be the same while other subsets may differ. For example, medicaments 8907 and 8908 may be the same type of medicament, while medicaments 8905 and 8906 may differ, or medicaments 8905-8907 may be the same type of medicament, while medicament 8908 may differ from medicaments 8905-8907.

In embodiments, medicament coatings applied to the multiple insertable heads 8901 may be configured to control the quantity of medicament delivered. For example, each insertable head may carry either the same amount or different amounts of medicament, which may be adjusted based on therapeutic objectives, gingival crevice dimensions, and/or other operational requirements. For example, medicament quantities per insertable head may range from about 0.1 picogram to about 100 mg or more, with intermediate amounts such as about 1 μg, 1 ng, 1 μg, 10 μg, 100 μg, 500 μg, 1 mg, 5 mg, 10 mg, 25 mg, or 50 mg.

In embodiments, the same or different medicament coatings may be applied to different portions of the surface of individual insertable heads of the multiple insertable heads 8901. In embodiments, the same or different amount of the same or different medicament may be applied to the entire or at least a portion of the surfaces of the individual insertable head of the multiple insertable heads 8901.

In some embodiments, medicament coatings may be applied to the multiple insertable heads 8901 using various application techniques, such as spray coating, pipette coating, 3D inkjet printing, dip coating, immersion coating, and/or combinations thereof. In embodiments, the coating process may enable control over medicament layer thickness, uniformity, stability on each insertable head, etc. In some embodiments, different insertable heads may use different coating application methods, which may allow individual customization based on the physical or chemical nature of the medicament being applied.

In embodiments, the medicament formulations used for coating the multiple insertable heads 8901 may include additional functional excipients to enhance therapeutic effectiveness, stability, adhesion, or release profiles. For example, viscosity enhancers, surfactants, mucoadhesive substances, plasticizers, and stabilizers such as sugars or amino acids may be used. In embodiments, these excipients may be used individually or in combination, and their concentrations may be configured to achieve specific delivery characteristics, including immediate (e.g., initial burst) release, sustained (e.g., prolonged) release, and/or other customized release profiles.

In embodiments, the coatings on individual insertable heads may differ in their solvent requirements, physical nature, chemical compatibility, and/or biological characteristics to allows concurrent delivery of medicaments that may otherwise be incompatible due to differing solubilities, viscosities, or stability requirements.

In embodiments, the multiple insertable heads 8901 may be configured to deliver medicaments into respective gingival crevices via dissolvable or disintegrable delivery configurations. For example, in embodiments, each of the insertable heads 8901 may be composed of, or be coated with, medicament formulations configured to dissolve or disintegrate within the gingival crevice environment after insertion of the multiple insertable heads 8901 into the gingival crevice.

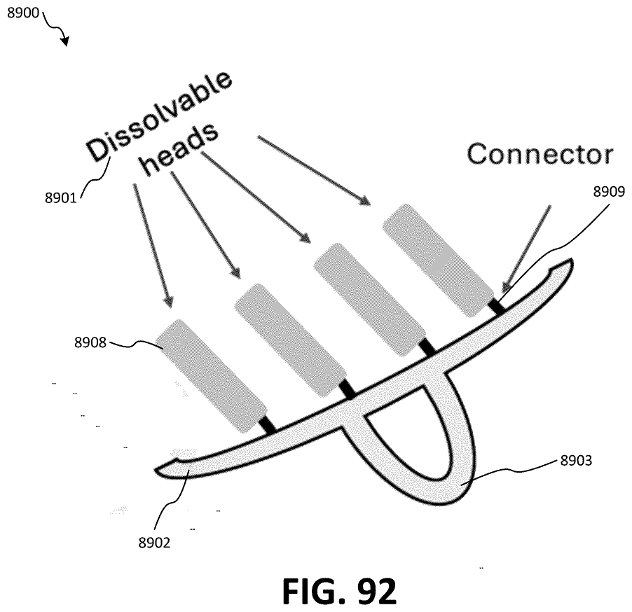

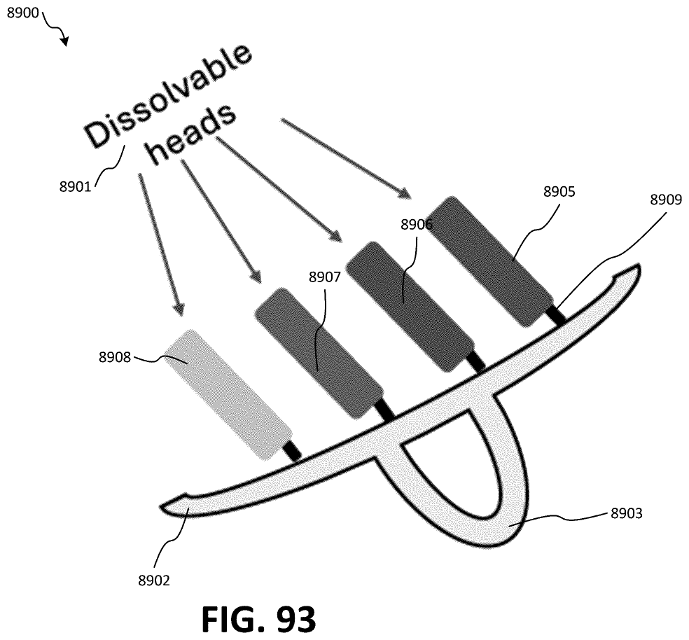

FIGS. 92 and 93 show exemplary embodiments of dissolvable configurations of the M-JET device 8900 configured with functionality for concurrent delivery of medicament to multiple gingival crevices in accordance with embodiments of the present disclosure. As shown in FIG. 92, each of insertable head 8901 may be individually coated or configured as a dissolvable medicament head. In this configuration, each of insertable head 8901 may be composed of dissolvable material that contains or carries a medicament (e.g., medicament 8908). Upon insertion into a respective gingival crevice and subsequent contact with gingival crevicular fluid, saliva, or moisture, each insertable head 8901 may be configured to dissolve, releasing the medicament into the gingival crevice.

In alternative embodiments, as shown in FIG. 93, each of the multiple insertable heads 8901 may be individually coated or composed of dissolvable or disintegrable materials containing different medicament types. For example, a first head may include medicament 8908, a second head may include medicament 8907, a third head may include medicament 8906, and a fourth head may include medicament 8905. In embodiments, medicaments 8905, 8906, 8907, and 8908 may be different from one another, or alternatively, subsets of these medicaments may be the same while others may differ.

In embodiments, each dissolvable or disintegrable multiple insertable head 8901 may be composed from either the same dissolvable or disintegrable material or from different dissolvable or disintegrable materials selected based on specific therapeutic needs. For example, dissolvable or disintegrable materials may include biocompatible, biodegradable polymers, sugars, polysaccharides, cellulose derivatives, polyvinyl alcohol, polyethylene glycol, polyvinyl pyrrolidone, starches, or combinations thereof, and/or other materials described elsewhere herein. In embodiments, these dissolvable or disintegrable materials may be configured to achieve specific dissolution or disintegration characteristics, ranging from immediate (e.g., burst) release to sustained (e.g., prolonged) release, and/or other customized release profiles.

In some embodiments, the dissolvable or disintegrable multiple insertable heads 8901 may include additional functional excipients to optimize medicament delivery properties, such as mucoadhesive substances, viscosity enhancers, surfactants, plasticizers, stabilizers (e.g., sugars, amino acids), or combinations thereof. Such excipients may be individually or collectively configured at concentrations to modulate head dissolution rates, enhance retention within gingival crevices, improve therapeutic outcomes and patient comfort, etc.

In embodiments, the dissolvable or disintegrable multiple insertable heads 8901 may be configured with different dissolution or disintegration rates, thicknesses, and/or material compositions. In embodiments, insertable head thicknesses may range from about 0.01 mm to about 5 mm, including intermediate thicknesses such as about 0.05 mm, 0.1 mm, 0.5 mm, 1 mm, or 2 mm.

In embodiments, each of the multiple insertable heads 8901 may be connected to the arc structure 8902 via a connector 8909, as shown in FIGS. 92 and 93. In embodiments, each connector 8909 may be configured to release or detach the connected insertable head from the arc structure 8902 following insertion into the gingival crevice. For example, connectors 8909 may be composed of materials configured to weaken or dissolve upon exposure to the oral cavity environment and/or may be mechanically pre-weakened to allow user-initiated release (e.g., by twisting or breaking).

In embodiments, one or more of the multiple insertable heads 8901 may be configured with a swellable head configuration. For example, one or more of the multiple insertable heads 8901 may be made or composed of swellable materials that expand upon contact with gingival crevicular fluid or moisture, enabling a controlled and targeted release of medicaments into the gingival crevice.

In embodiments, swellable heads of the multiple insertable heads 8901 may be configured to deliver the same or different medicaments concurrently into multiple gingival crevices. In embodiments, each swellable head of the multiple insertable heads 8901 may be made from materials configured to absorb gingival crevicular fluid, moisture, or saliva and swell in response thereto. Suitable swellable materials may include biocompatible and biodegradable hydrogels, polymers such as crosslinked polyvinyl alcohol, polyethylene glycol, polysaccharides (including chitosan, alginate derivatives), cellulose derivatives, gelatin, starch-based materials, or combinations thereof. These swellable materials may be configured to achieve distinct swelling characteristics and release profiles, such as immediate swelling and rapid release or gradual swelling for sustained therapeutic release over extended periods of time.

In embodiments, swellable heads of the multiple insertable heads 8901 may be configured to swell incrementally from an initial thickness or volume upon exposure to gingival crevicular fluid. For example, initial head thicknesses may range from about 0.01 mm to about 5 mm, including intermediate values such as about 0.05 mm, 0.1 mm, 0.5 mm, 1 mm, 2 mm, or 3 mm. Upon swelling, the swellable heads may be configured to expand incrementally, for example, by approximately 10% to about 500% or more of their initial dimensions, including intermediate expansion values such as about 25%, 50%, 100%, 150%, 200%, or 300%.

In embodiments, each swellable head of the multiple insertable heads 8901 may be individually configured with different swelling rates, materials, or medicament compositions.

In embodiments, each swellable head of the multiple insertable heads 8901 may differ in solvent requirements or in their physical, biological, or chemical compatibility characteristics to ensure compatibility of multiple medicaments that may otherwise be difficult to co-administer concurrently.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A junctional epithelial targeting (JET) device, comprising:
an arm including an insertable portion having at least a portion of a surface coated with a medicament to be delivered to a patient, the medicament configured to be absorbed into the patient's system, wherein the arm is configured to:
facilitate insertion of the insertable portion of the arm into a gingival crevice of the patient; and
deposit, upon insertion of the insertable portion into the gingival crevice of the patient, the medicament into the gingival crevice of the patient via an agitation action, the agitation action configured to move the insertable portion back-and-forth within the gingival crevice to cause the medicament to be released from the at least a portion of the surface of the insertable portion to be absorbed into the patient's system through a junctional epithelium; and
a handle configured to attach to the arm to facilitate insertion of the insertable portion of the arm into the gingival crevice of the patient and to facilitate the agitation action.

2. The JET device of claim 1, wherein an angle defined by a longitudinal axis of the handle and a longitudinal axis of the arm is less than ninety degrees.

3. The JET device of claim 1, wherein the arm is made of a material including cellulose, ethylene vinyl acetate, polyvinyl alcohols, polyester, polycarbonate, polyvinyl acetate, vinyl acetate, teflon, nylon, polymethacrylate, polystyrene, polypropylene, polyoxymethylene, kapton polyimide, polyether ether ketone, acrylonitrile butadiene styrene, polyterepthalate, silicon polymers, or any combination thereof.

4. The JET device of claim 1, wherein the insertable portion includes a semi-rigid flat-bodied extension configured to be inserted into the gingival crevice.

5. The JET device of claim 4, wherein a length of the semi-rigid flat-bodied extension is between 6 and 12 mm, a width of the semi-rigid flat-bodied extension is between 0.1 and 4 mm, and a thickness of the semi-rigid flat-bodied extension is between 0.001 and 1 mm.

6. The JET device of claim 1, wherein the at least a portion of the surface of the insertable portion coated with the medicament is one of:
uniformly coated with the medicament; and
non-uniformly coated with the medicament.

7. The JET device of claim 1, wherein the at least a portion of the surface of the insertable portion coated with the medicament includes a plurality of perforations configured to increase a coating volume of the at least a portion of the surface of the insertable portion.

8. The JET device of claim 1, wherein the medicament to be absorbed into the patient's system is encapsulated within a plurality of polymer capsules, wherein each of the plurality of capsules is configured to dissolve upon release into the gingival crevice of the patient releasing a portion of the medicament encapsulated therein to be absorbed into the patient's system.

9. The JET device of claim 1, wherein the medicament to be absorbed into the patient's system is free-form medicament, wherein the medicament is unencapsulated within a polymer capsule and is configured to be absorbed into the patient's system without delay upon release into the gingival crevice of the patient.

10. The JET device of claim 1, wherein the medicament includes one or more micronutrients.

11. The JET device of claim 10, wherein the one or more micronutrients include one or more of: vitamin B1, vitamin B12, and vitamin D.

12. A method of manufacturing a junctional epithelial targeting (JET) device, comprising:
forming an arm of the JET device for insertion of an insertable portion of the arm into a gingival crevice of a patient;
coating at least a portion of a surface of the insertable portion of the arm with a medicament to be delivered to the patient, the medicament configured to be absorbed into the patient's system; and
attaching the arm to a handle, the handle configured to facilitate manipulation of the JET device to insert the insertable portion of the arm into the gingival crevice of the patient and to deposit the medicament into the gingival crevice of the patient via an agitation action, the agitation action configured to move the insertable portion back-and-forth within the gingival crevice to cause the medicament to be released from the at least a portion of the surface of the insertable portion to be absorbed into the patient's system through a junctional epithelium.

13. The method of claim 12, wherein attaching the arm to the handle includes defining an angle between a longitudinal axis of the handle and a longitudinal axis of the arm to be less than ninety degrees.

14. The method of claim 12, forming the arm from a material including cellulose, ethylene vinyl acetate, polyvinyl alcohols, polyester, polycarbonate, polyvinyl acetate, vinyl acetate, teflon, nylon, polymethacrylate, polystyrene, polypropylene, polyoxymethylene, kapton polyimide, polyether ether ketone, acrylonitrile butadiene styrene, polyterepthalate, silicon polymers, or any combination thereof.

15. The method of claim 12, wherein coating the at least a portion of the surface of the insertable portion with the medicament includes dipping the at least a portion of the surface of the insertable portion into a solution including the medicament to coat the at least a portion of the surface of the insertable portion of the arm with the medicament.

16. The method of claim 12, wherein coating the at least a portion of the surface of the insertable portion with the medicament includes spraying the at least a portion of the surface of the insertable portion with a solution including the medicament to coat the at least a portion of the surface of the insertable portion with the medicament.

17. The method of claim 12, wherein coating the at least a portion of the surface of the insertable portion with the medicament includes applying a plurality of droplets of a solution including the medicament onto the at least a portion of the surface of the insertable portion to coat the at least a portion of the surface of the insertable portion with the medicament.

18. The method of claim 12, wherein coating the at least a portion of the surface of the insertable portion includes:
coating the at least a portion of the surface of the insertable portion of the arm with a polymer prior to coating the at least a portion of the surface of the insertable portion with the medicament, such that the medicament is deposited over the polymer.

19. The method of claim 18, wherein coating the at least a portion of the surface of the insertable portion with the polymer includes one or more of:
dipping the at least a portion of the surface of the insertable portion into a polymer solution including the polymer and a solvent;
spraying the at least a portion of the surface of the insertable portion with the polymer solution including the polymer and a solvent; and
applying a plurality of droplets of the polymer solution including the polymer and a solvent onto the at least a portion of the surface of the insertable portion.

20. The method of claim 12, further comprising:
encapsulating the medicament to be absorbed into the patient's system within a plurality of polymer capsules, wherein each of the plurality of capsules is configured to dissolve upon release into the gingival crevice of the patient releasing a portion of the medicament encapsulated therein to be absorbed into the patient's system.

21. The method of claim 12, further comprising:
providing the medicament to be absorbed into the patient's system as free-form medicament, wherein the medicament is unencapsulated within a polymer capsule and is configured to be absorbed into the patient's system without delay upon release into the gingival crevice of the patient.

22. The method of claim 12, wherein the medicament includes one or more micronutrients.

23. The method of claim 22, wherein the one or more micronutrients include one or more of: vitamin B1, vitamin B12, and vitamin D.
